(19) United States
(12) Patent Application Publication
(10) Pub. No.: US 2025/0224847 A1
(43) Pub. Date: Jul. 10, 2025

(54) USER INTERFACES WITH DYNAMIC CONTENT

(71) Applicant: Apple Inc., Cupertino, CA (US)

(72) Inventors: Chun Kin Minor WONG, Portland, OR (US); Mani AMINI, Santa Cruz, CA (US); Pavel PIVONKA, San Francisco, CA (US); Raymond S. SEPULVEDA, Portland, OR (US); William M. TYLER, San Francisco, CA (US)

(21) Appl. No.: 19/082,307

(22) Filed: Mar. 18, 2025

Related U.S. Application Data
(63) Continuation of application No. 18/625,552, filed on Apr. 3, 2024, now abandoned.
(60) Provisional application No. 63/464,533, filed on May 5, 2023.
(60) Provisional application No. 63/470,976, filed on Jun. 4, 2023.
(60) Provisional application No. 63/528,404, filed on Jul. 23, 2023.

(51) Int. Cl. G06F 3/0481

(52) U.S. Cl. CPC G06F 3/0481

(57) ABSTRACT

The present disclosure generally relates to displaying user interfaces with dynamic content. In some examples, a method for transitioning user interface, a method for displaying a user interface, a method for displaying a widget, a method for placing a widget, a method for displaying widget information is described.

### CROSS-REFERENCE TO RELATED APPLICATIONS

This application is a continuing application of U.S. Non-Provisional patent application Ser. No. 18/625,552, entitled “USER INTERFACES WITH DYNAMIC CONTENT,” filed Apr. 3, 2024, which claim priority to U.S. Provisional Application No. 63/464,533, entitled “USER INTERFACES WITH DYNAMIC CONTENT”, and filed on May 5, 2023, and to U.S. Provisional Application No. 63/470,976, entitled “USER INTERFACES WITH DYNAMIC CONTENT”, and filed on Jun. 4, 2023, and to U.S. Provisional Application No. 63/528,404, entitled “USER INTERFACES WITH DYNAMIC CONTENT”, and filed on Jul. 23, 2023, which are hereby incorporated by reference in their entireties for all purposes.

### FIELD

The present disclosure relates generally to computer user interfaces, and more specifically to techniques for displaying user interfaces with dynamic content.

### BACKGROUND

Users often use computer systems to perform various tasks. Such tasks often include interactions with user interface objects, such as folders, files, and widgets, and locking and unlocking the computer systems.

### SUMMARY

Some techniques for displaying user interfaces with dynamic content using computer systems, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices and/or computer system with faster, more efficient methods and interfaces for displaying user interfaces with dynamic content. Such methods and interfaces optionally complement or replace other methods for displaying user interfaces with dynamic content. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a display generation component and one or more input devices is described. In some embodiments, the method comprises: while the computer system is in a locked state and while displaying, via the display generation component, a first user interface with a first background for the first user interface that includes animated visual content, detecting, via the one or more input devices, input corresponding to a request to unlock the computer system; and in response to detecting the input corresponding to the request to unlock the computer system: in accordance with a determination that the input was detected while the animated visual content had a first appearance, displaying, via the display generation component, a second user interface with a first background for the second user interface; and in accordance with a determination that the input was detected while the animated visual content had a second appearance that is different from the first appearance, displaying, via the display generation component, the second user interface with a second background for the second user interface that is different from the first background for the second user interface.

In some embodiments, a non-transitory computer-readable storage medium storing one or more programs configured to be executed by one or more processors of a computer system that is in communication with a display generation component and one or more input devices is described. In some embodiments, the one or more programs includes instructions for: while the computer system is in a locked state and while displaying, via the display generation component, a first user interface with a first background for the first user interface that includes animated visual content, detecting, via the one or more input devices, input corresponding to a request to unlock the computer system; and in response to detecting the input corresponding to the request to unlock the computer system: in accordance with a determination that the input was detected while the animated visual content had a first appearance, displaying, via the display generation component, a second user interface with a first background for the second user interface; and in accordance with a determination that the input was detected while the animated visual content had a second appearance that is different from the first appearance, displaying, via the display generation component, the second user interface with a second background for the second user interface that is different from the first background for the second user interface.

In some embodiments, a transitory computer-readable storage medium storing one or more programs configured to be executed by one or more processors of a computer system that is in communication with a display generation component and one or more input devices is described. In some embodiments, the one or more programs includes instructions for: while the computer system is in a locked state and while displaying, via the display generation component, a first user interface with a first background for the first user interface that includes animated visual content, detecting, via the one or more input devices, input corresponding to a request to unlock the computer system; and in response to detecting the input corresponding to the request to unlock the computer system: in accordance with a determination that the input was detected while the animated visual content had a first appearance, displaying, via the display generation component, a second user interface with a first background for the second user interface; and in accordance with a determination that the input was detected while the animated visual content had a second appearance that is different from the first appearance, displaying, via the display generation component, the second user interface with a second background for the second user interface that is different from the first background for the second user interface.

In some embodiments, a computer system that is in communication with a display generation component and one or more input devices is described. In some embodiments, the computer system that is in communication with a display generation component and one or more input devices comprises one or more processors and memory storing one or more program configured to be executed by the one or more processors. In some embodiments, the one or more programs includes instructions for: while the computer system is in a locked state and while displaying, via the display generation component, a first user interface with a first background for the first user interface that includes animated visual content, detecting, via the one or more input devices, input corresponding to a request to unlock the computer system; and in response to detecting the input corresponding to the request to unlock the computer system: in accordance with a determination that the input was detected while the animated visual content had a first appearance, displaying, via the display generation component, a second user interface with a first background for the second user interface; and in accordance with a determination that the input was detected while the animated visual content had a second appearance that is different from the first appearance, displaying, via the display generation component, the second user interface with a second background for the second user interface that is different from the first background for the second user interface.

In some embodiments, a computer system that is in communication with a display generation component and one or more input devices is described. In some embodiments, the computer system that is in communication with a display generation component and one or more input devices comprises means for performing each of the following steps: while the computer system is in a locked state and while displaying, via the display generation component, a first user interface with a first background for the first user interface that includes animated visual content, detecting, via the one or more input devices, input corresponding to a request to unlock the computer system; and in response to detecting the input corresponding to the request to unlock the computer system: in accordance with a determination that the input was detected while the animated visual content had a first appearance, displaying, via the display generation component, a second user interface with a first background for the second user interface; and in accordance with a determination that the input was detected while the animated visual content had a second appearance that is different from the first appearance, displaying, via the display generation component, the second user interface with a second background for the second user interface that is different from the first background for the second user interface.

In some embodiments, a computer program product is described. In some examples, the computer program product comprises one or more programs configured to be executed by one or more processors of a computer system that is in communication with a display generation component and one or more input devices. In some embodiments, the one or more programs include instructions for: while the computer system is in a locked state and while displaying, via the display generation component, a first user interface with a first background for the first user interface that includes animated visual content, detecting, via the one or more input devices, input corresponding to a request to unlock the computer system; and in response to detecting the input corresponding to the request to unlock the computer system: in accordance with a determination that the input was detected while the animated visual content had a first appearance, displaying, via the display generation component, a second user interface with a first background for the second user interface; and in accordance with a determination that the input was detected while the animated visual content had a second appearance that is different from the first appearance, displaying, via the display generation component, the second user interface with a second background for the second user interface that is different from the first background for the second user interface.

In some embodiments, a method that is performed at a computer system that is in communication with a display generation component and one or more input devices, wherein the computer system is associated with available user accounts is described. In some embodiments, the method comprises: while the computer system is in a locked state: displaying, via the display generation component, a user interface that includes concurrently displaying: a representation of first visual content corresponding to a first user account available on the computer system; and a representation of a second user account available on the computer system, wherein the first user account is different from the second user account; and while displaying the user interface that includes the representation of first visual content corresponding to the first user account, detecting, via the one or more input devices, an input corresponding to selection of the representation of the second user account; and in response to detecting the input corresponding to selection of the representation of the second user account, concurrently displaying, via the display generation component, a representation of second visual content corresponding to the second user account and one or more options for initiating a process to unlock the computer system for the second user account.

In some embodiments, a non-transitory computer-readable storage medium storing one or more programs configured to be executed by one or more processors of a computer system that is in communication with a display generation component and one or more input devices, wherein the computer system is associated with available user accounts is described. In some embodiments, the one or more programs includes instructions for: while the computer system is in a locked state: displaying, via the display generation component, a user interface that includes concurrently displaying: a representation of first visual content corresponding to a first user account available on the computer system; and a representation of a second user account available on the computer system, wherein the first user account is different from the second user account; and while displaying the user interface that includes the representation of first visual content corresponding to the first user account, detecting, via the one or more input devices, an input corresponding to selection of the representation of the second user account; and in response to detecting the input corresponding to selection of the representation of the second user account, concurrently displaying, via the display generation component, a representation of second visual content corresponding to the second user account and one or more options for initiating a process to unlock the computer system for the second user account.

In some embodiments, a transitory computer-readable storage medium storing one or more programs configured to be executed by one or more processors of a computer system that is in communication with a display generation component and one or more input devices, wherein the computer system is associated with available user accounts is described. In some embodiments, the one or more programs includes instructions for: while the computer system is in a locked state: displaying, via the display generation component, a user interface that includes concurrently displaying: a representation of first visual content corresponding to a first user account available on the computer system; and a representation of a second user account available on the computer system, wherein the first user account is different from the second user account; and while displaying the user interface that includes the representation of first visual content corresponding to the first user account, detecting, via the one or more input devices, an input corresponding to selection of the representation of the second user account; and in response to detecting the input corresponding to selection of the representation of the second user account, concurrently displaying, via the display generation component, a representation of second visual content corresponding to the second user account and one or more options for initiating a process to unlock the computer system for the second user account.

In some embodiments, a computer system that is in communication with a display generation component and one or more input devices, wherein the computer system is associated with available user accounts is described. In some embodiments, the computer system that is in communication with a display generation component and one or more input devices, wherein the computer system is associated with available user accounts comprises one or more processors and memory storing one or more program configured to be executed by the one or more processors. In some embodiments, the one or more programs includes instructions for: while the computer system is in a locked state: displaying, via the display generation component, a user interface that includes concurrently displaying: a representation of first visual content corresponding to a first user account available on the computer system; and a representation of a second user account available on the computer system, wherein the first user account is different from the second user account; and while displaying the user interface that includes the representation of first visual content corresponding to the first user account, detecting, via the one or more input devices, an input corresponding to selection of the representation of the second user account; and in response to detecting the input corresponding to selection of the representation of the second user account, concurrently displaying, via the display generation component, a representation of second visual content corresponding to the second user account and one or more options for initiating a process to unlock the computer system for the second user account.

In some embodiments, a computer system that is in communication with a display generation component and one or more input devices, wherein the computer system is associated with available user accounts is described. In some embodiments, the computer system that is in communication with a display generation component and one or more input devices, wherein the computer system is associated with available user accounts comprises means for performing each of the following steps: while the computer system is in a locked state: displaying, via the display generation component, a user interface that includes concurrently displaying: a representation of first visual content corresponding to a first user account available on the computer system; and a representation of a second user account available on the computer system, wherein the first user account is different from the second user account; and while displaying the user interface that includes the representation of first visual content corresponding to the first user account, detecting, via the one or more input devices, an input corresponding to selection of the representation of the second user account; and in response to detecting the input corresponding to selection of the representation of the second user account, concurrently displaying, via the display generation component, a representation of second visual content corresponding to the second user account and one or more options for initiating a process to unlock the computer system for the second user account.

In some embodiments, a computer program product is described. In some examples, the computer program product comprises one or more programs configured to be executed by one or more processors of a computer system that is in communication with a display generation component and one or more input devices, wherein the computer system is associated with available user accounts. In some embodiments, the one or more programs include instructions for: while the computer system is in a locked state: displaying, via the display generation component, a user interface that includes concurrently displaying: a representation of first visual content corresponding to a first user account available on the computer system; and a representation of a second user account available on the computer system, wherein the first user account is different from the second user account; and while displaying the user interface that includes the representation of first visual content corresponding to the first user account, detecting, via the one or more input devices, an input corresponding to selection of the representation of the second user account; and in response to detecting the input corresponding to selection of the representation of the second user account, concurrently displaying, via the display generation component, a representation of second visual content corresponding to the second user account and one or more options for initiating a process to unlock the computer system for the second user account.

In some embodiments, a method that is performed at a computer system that is in communication with a display generation component and one or more input devices is described. In some embodiments, the method comprises: displaying, via the display generation component, a respective user interface that includes a plurality of user interface objects including a widget corresponding to an application, wherein: in accordance with a determination that the respective user interface is selected for display as a focused user interface for the computer system, the widget has a first visual appearance corresponding to a selected state for the respective user interface while one or more other user interface objects in the respective user interface are displayed with a respective appearance; and in accordance with a determination that the respective user interface is not selected for display as a focused user interface for the computer system, the widget is displayed with a second visual appearance corresponding to a non-selected state, wherein the first visual appearance is different from the second visual appearance while one or more other user interface objects in the respective user interface are displayed with the respective appearance.

In some embodiments, a non-transitory computer-readable storage medium storing one or more programs configured to be executed by one or more processors of a computer system that is in communication with a display generation component and one or more input devices is described. In some embodiments, the one or more programs includes instructions for: displaying, via the display generation component, a respective user interface that includes a plurality of user interface objects including a widget corresponding to an application, wherein: in accordance with a determination that the respective user interface is selected for display as a focused user interface for the computer system, the widget has a first visual appearance corresponding to a selected state for the respective user interface while one or more other user interface objects in the respective user interface are displayed with a respective appearance; and in accordance with a determination that the respective user interface is not selected for display as a focused user interface for the computer system, the widget is displayed with a second visual appearance corresponding to a non-selected state, wherein the first visual appearance is different from the second visual appearance while one or more other user interface objects in the respective user interface are displayed with the respective appearance.

In some embodiments, a transitory computer-readable storage medium storing one or more programs configured to be executed by one or more processors of a computer system that is in communication with a display generation component and one or more input devices is described. In some embodiments, the one or more programs includes instructions for: displaying, via the display generation component, a respective user interface that includes a plurality of user interface objects including a widget corresponding to an application, wherein: in accordance with a determination that the respective user interface is selected for display as a focused user interface for the computer system, the widget has a first visual appearance corresponding to a selected state for the respective user interface while one or more other user interface objects in the respective user interface are displayed with a respective appearance; and in accordance with a determination that the respective user interface is not selected for display as a focused user interface for the computer system, the widget is displayed with a second visual appearance corresponding to a non-selected state, wherein the first visual appearance is different from the second visual appearance while one or more other user interface objects in the respective user interface are displayed with the respective appearance.

In some embodiments, a computer system that is in communication with a display generation component and one or more input devices is described. In some embodiments, the computer system that is in communication with a display generation component and one or more input devices comprises one or more processors and memory storing one or more program configured to be executed by the one or more processors. In some embodiments, the one or more programs includes instructions for: displaying, via the display generation component, a respective user interface that includes a plurality of user interface objects including a widget corresponding to an application, wherein: in accordance with a determination that the respective user interface is selected for display as a focused user interface for the computer system, the widget has a first visual appearance corresponding to a selected state for the respective user interface while one or more other user interface objects in the respective user interface are displayed with a respective appearance; and in accordance with a determination that the respective user interface is not selected for display as a focused user interface for the computer system, the widget is displayed with a second visual appearance corresponding to a non-selected state, wherein the first visual appearance is different from the second visual appearance while one or more other user interface objects in the respective user interface are displayed with the respective appearance.

In some embodiments, a computer system that is in communication with a display generation component and one or more input devices is described. In some embodiments, the computer system that is in communication with a display generation component and one or more input devices comprises means for performing each of the following steps: displaying, via the display generation component, a respective user interface that includes a plurality of user interface objects including a widget corresponding to an application, wherein: in accordance with a determination that the respective user interface is selected for display as a focused user interface for the computer system, the widget has a first visual appearance corresponding to a selected state for the respective user interface while one or more other user interface objects in the respective user interface are displayed with a respective appearance; and in accordance with a determination that the respective user interface is not selected for display as a focused user interface for the computer system, the widget is displayed with a second visual appearance corresponding to a non-selected state, wherein the first visual appearance is different from the second visual appearance while one or more other user interface objects in the respective user interface are displayed with the respective appearance.

In some embodiments, a computer program product is described. In some examples, the computer program product comprises one or more programs configured to be executed by one or more processors of a computer system that is in communication with a display generation component and one or more input devices. In some embodiments, the one or more programs include instructions for: displaying, via the display generation component, a respective user interface that includes a plurality of user interface objects including a widget corresponding to an application, wherein: in accordance with a determination that the respective user interface is selected for display as a focused user interface for the computer system, the widget has a first visual appearance corresponding to a selected state for the respective user interface while one or more other user interface objects in the respective user interface are displayed with a respective appearance; and in accordance with a determination that the respective user interface is not selected for display as a focused user interface for the computer system, the widget is displayed with a second visual appearance corresponding to a non-selected state, wherein the first visual appearance is different from the second visual appearance while one or more other user interface objects in the respective user interface are displayed with the respective appearance.

In some embodiments, a method that is performed at a computer system that is in communication with a display generation component and one or more input devices is described. In some embodiments, the method comprises: displaying, via the display generation component, a user interface that includes a first widget at a respective location; detecting, via the one or more input devices, an input corresponding to a request to move a second widget to a first drag location in the user interface; and in response to detecting the input corresponding to the request to move the second widget to the first drag location: in accordance with a determination that the first drag location is within a predetermined distance from the respective location of the first widget, moving the second widget to a first snapping location that is based on the respective location of the first widget but is different from the first drag location; and in accordance with a determination that the first drag location is not within the predetermined distance from the respective location of the first widget, moving the second widget to the first drag location.

In some embodiments, a non-transitory computer-readable storage medium storing one or more programs configured to be executed by one or more processors of a computer system that is in communication with a display generation component and one or more input devices is described. In some embodiments, the one or more programs includes instructions for: displaying, via the display generation component, a user interface that includes a first widget at a respective location; detecting, via the one or more input devices, an input corresponding to a request to move a second widget to a first drag location in the user interface; and in response to detecting the input corresponding to the request to move the second widget to the first drag location: in accordance with a determination that the first drag location is within a predetermined distance from the respective location of the first widget, moving the second widget to a first snapping location that is based on the respective location of the first widget but is different from the first drag location; and in accordance with a determination that the first drag location is not within the predetermined distance from the respective location of the first widget, moving the second widget to the first drag location.

In some embodiments, a transitory computer-readable storage medium storing one or more programs configured to be executed by one or more processors of a computer system that is in communication with a display generation component and one or more input devices is described. In some embodiments, the one or more programs includes instructions for: displaying, via the display generation component, a user interface that includes a first widget at a respective location; detecting, via the one or more input devices, an input corresponding to a request to move a second widget to a first drag location in the user interface; and in response to detecting the input corresponding to the request to move the second widget to the first drag location: in accordance with a determination that the first drag location is within a predetermined distance from the respective location of the first widget, moving the second widget to a first snapping location that is based on the respective location of the first widget but is different from the first drag location; and in accordance with a determination that the first drag location is not within the predetermined distance from the respective location of the first widget, moving the second widget to the first drag location.

In some embodiments, a computer system that is in communication with a display generation component and one or more input devices is described. In some embodiments, the computer system that is in communication with a display generation component and one or more input devices comprises one or more processors and memory storing one or more program configured to be executed by the one or more processors. In some embodiments, the one or more programs includes instructions for: displaying, via the display generation component, a user interface that includes a first widget at a respective location; detecting, via the one or more input devices, an input corresponding to a request to move a second widget to a first drag location in the user interface; and in response to detecting the input corresponding to the request to move the second widget to the first drag location: in accordance with a determination that the first drag location is within a predetermined distance from the respective location of the first widget, moving the second widget to a first snapping location that is based on the respective location of the first widget but is different from the first drag location; and in accordance with a determination that the first drag location is not within the predetermined distance from the respective location of the first widget, moving the second widget to the first drag location.

In some embodiments, a computer system that is in communication with a display generation component and one or more input devices is described. In some embodiments, the computer system that is in communication with a display generation component and one or more input devices comprises means for performing each of the following steps: displaying, via the display generation component, a user interface that includes a first widget at a respective location; detecting, via the one or more input devices, an input corresponding to a request to move a second widget to a first drag location in the user interface; and in response to detecting the input corresponding to the request to move the second widget to the first drag location: in accordance with a determination that the first drag location is within a predetermined distance from the respective location of the first widget, moving the second widget to a first snapping location that is based on the respective location of the first widget but is different from the first drag location; and in accordance with a determination that the first drag location is not within the predetermined distance from the respective location of the first widget, moving the second widget to the first drag location.

In some embodiments, a computer program product is described. In some examples, the computer program product comprises one or more programs configured to be executed by one or more processors of a computer system that is in communication with a display generation component and one or more input devices. In some embodiments, the one or more programs include instructions for: displaying, via the display generation component, a user interface that includes a first widget at a respective location; detecting, via the one or more input devices, an input corresponding to a request to move a second widget to a first drag location in the user interface; and in response to detecting the input corresponding to the request to move the second widget to the first drag location: in accordance with a determination that the first drag location is within a predetermined distance from the respective location of the first widget, moving the second widget to a first snapping location that is based on the respective location of the first widget but is different from the first drag location; and in accordance with a determination that the first drag location is not within the predetermined distance from the respective location of the first widget, moving the second widget to the first drag location.

In some embodiments, a method that is performed at a first computer system that is in communication with a display generation component and one or more input devices is described. In some embodiments, the method comprises: displaying, via the display generation component, a widget that includes a widget user interface representing widget data, wherein the widget data is provided by an application on a second computer system that is different from the first computer system; detecting, via the one or more input devices of the first computer system, an input corresponding to a request to place the widget at a location on a user interface; and in response to detecting the input, displaying, via the display generation component, the widget at the location on the user interface.

In some embodiments, a non-transitory computer-readable storage medium storing one or more programs configured to be executed by one or more processors of a first computer system that is in communication with a display generation component and one or more input devices is described. In some embodiments, the one or more programs includes instructions for: displaying, via the display generation component, a widget that includes a widget user interface representing widget data, wherein the widget data is provided by an application on a second computer system that is different from the first computer system; detecting, via the one or more input devices of the first computer system, an input corresponding to a request to place the widget at a location on a user interface; and in response to detecting the input, displaying, via the display generation component, the widget at the location on the user interface.

In some embodiments, a transitory computer-readable storage medium storing one or more programs configured to be executed by one or more processors of a first computer system that is in communication with a display generation component and one or more input devices is described. In some embodiments, the one or more programs includes instructions for: displaying, via the display generation component, a widget that includes a widget user interface representing widget data, wherein the widget data is provided by an application on a second computer system that is different from the first computer system; detecting, via the one or more input devices of the first computer system, an input corresponding to a request to place the widget at a location on a user interface; and in response to detecting the input, displaying, via the display generation component, the widget at the location on the user interface.

In some embodiments, a first computer system that is in communication with a display generation component and one or more input devices is described. In some embodiments, the first computer system that is in communication with a display generation component and one or more input devices comprises one or more processors and memory storing one or more program configured to be executed by the one or more processors. In some embodiments, the one or more programs includes instructions for: displaying, via the display generation component, a widget that includes a widget user interface representing widget data, wherein the widget data is provided by an application on a second computer system that is different from the first computer system; detecting, via the one or more input devices of the first computer system, an input corresponding to a request to place the widget at a location on a user interface; and in response to detecting the input, displaying, via the display generation component, the widget at the location on the user interface.

In some embodiments, a first computer system that is in communication with a display generation component and one or more input devices is described. In some embodiments, the first computer system that is in communication with a display generation component and one or more input devices comprises means for performing each of the following steps: displaying, via the display generation component, a widget that includes a widget user interface representing widget data, wherein the widget data is provided by an application on a second computer system that is different from the first computer system; detecting, via the one or more input devices of the first computer system, an input corresponding to a request to place the widget at a location on a user interface; and in response to detecting the input, displaying, via the display generation component, the widget at the location on the user interface.

In some embodiments, a computer program product is described. In some examples, the computer program product comprises one or more programs configured to be executed by one or more processors of a first computer system that is in communication with a display generation component and one or more input devices. In some embodiments, the one or more programs include instructions for: displaying, via the display generation component, a widget that includes a widget user interface representing widget data, wherein the widget data is provided by an application on a second computer system that is different from the first computer system; detecting, via the one or more input devices of the first computer system, an input corresponding to a request to place the widget at a location on a user interface; and in response to detecting the input, displaying, via the display generation component, the widget at the location on the user interface.

In some embodiments, a method that is performed at a computer system that is in communication with a display generation component is described. In some embodiments, the method comprises: displaying, via the display generation component, a set of two or more widgets in a first widget spatial arrangement within a widget display area that has a first set of one or more spatial bounds; detecting a request to display the set of two or more widgets in a widget display area with a respective set of one or more spatial bounds; and in response to detecting the request to display the set of two or more widgets in a widget display area with the respective set of one or more spatial bounds: in accordance with a determination that the respective set of one or more spatial bounds is a second set of one or more spatial bounds different from the first set of one or more spatial bounds, displaying, via the display generation component, the set of two or more widgets in a second widget spatial arrangement different from the first widget spatial arrangement; and in accordance with a determination that the respective set of one or more spatial bounds is a third set of one or more spatial bounds different from the first set of one or more spatial bounds and different from the second set of one or more spatial bounds, displaying, via the display generation component, the set of two or more widgets in a third widget spatial arrangement different from the first widget spatial arrangement and the second widget spatial arrangement.

In some embodiments, a non-transitory computer-readable storage medium storing one or more programs configured to be executed by one or more processors of a computer system that is in communication with a display generation component is described. In some embodiments, the one or more programs includes instructions for: displaying, via the display generation component, a set of two or more widgets in a first widget spatial arrangement within a widget display area that has a first set of one or more spatial bounds; detecting a request to display the set of two or more widgets in a widget display area with a respective set of one or more spatial bounds; and in response to detecting the request to display the set of two or more widgets in a widget display area with the respective set of one or more spatial bounds: in accordance with a determination that the respective set of one or more spatial bounds is a second set of one or more spatial bounds different from the first set of one or more spatial bounds, displaying, via the display generation component, the set of two or more widgets in a second widget spatial arrangement different from the first widget spatial arrangement; and in accordance with a determination that the respective set of one or more spatial bounds is a third set of one or more spatial bounds different from the first set of one or more spatial bounds and different from the second set of one or more spatial bounds, displaying, via the display generation component, the set of two or more widgets in a third widget spatial arrangement different from the first widget spatial arrangement and the second widget spatial arrangement.

In some embodiments, a transitory computer-readable storage medium storing one or more programs configured to be executed by one or more processors of a computer system that is in communication with a display generation component is described. In some embodiments, the one or more programs includes instructions for: displaying, via the display generation component, a set of two or more widgets in a first widget spatial arrangement within a widget display area that has a first set of one or more spatial bounds; detecting a request to display the set of two or more widgets in a widget display area with a respective set of one or more spatial bounds; and in response to detecting the request to display the set of two or more widgets in a widget display area with the respective set of one or more spatial bounds: in accordance with a determination that the respective set of one or more spatial bounds is a second set of one or more spatial bounds different from the first set of one or more spatial bounds, displaying, via the display generation component, the set of two or more widgets in a second widget spatial arrangement different from the first widget spatial arrangement; and in accordance with a determination that the respective set of one or more spatial bounds is a third set of one or more spatial bounds different from the first set of one or more spatial bounds and different from the second set of one or more spatial bounds, displaying, via the display generation component, the set of two or more widgets in a third widget spatial arrangement different from the first widget spatial arrangement and the second widget spatial arrangement.

In some embodiments, a computer system that is in communication with a display generation component is described. In some embodiments, the computer system comprises one or more processors and memory storing one or more programs configured to be executed by the one or more processors. In some embodiments, the one or more programs includes instructions for: displaying, via the display generation component, a set of two or more widgets in a first widget spatial arrangement within a widget display area that has a first set of one or more spatial bounds; detecting a request to display the set of two or more widgets in a widget display area with a respective set of one or more spatial bounds; and in response to detecting the request to display the set of two or more widgets in a widget display area with the respective set of one or more spatial bounds: in accordance with a determination that the respective set of one or more spatial bounds is a second set of one or more spatial bounds different from the first set of one or more spatial bounds, displaying, via the display generation component, the set of two or more widgets in a second widget spatial arrangement different from the first widget spatial arrangement; and in accordance with a determination that the respective set of one or more spatial bounds is a third set of one or more spatial bounds different from the first set of one or more spatial bounds and different from the second set of one or more spatial bounds, displaying, via the display generation component, the set of two or more widgets in a third widget spatial arrangement different from the first widget spatial arrangement and the second widget spatial arrangement.

In some embodiments, a computer system that is in communication with a display generation component is described. In some embodiments, the computer system comprises means for performing each of the following steps: displaying, via the display generation component, a set of two or more widgets in a first widget spatial arrangement within a widget display area that has a first set of one or more spatial bounds; detecting a request to display the set of two or more widgets in a widget display area with a respective set of one or more spatial bounds; and in response to detecting the request to display the set of two or more widgets in a widget display area with the respective set of one or more spatial bounds: in accordance with a determination that the respective set of one or more spatial bounds is a second set of one or more spatial bounds different from the first set of one or more spatial bounds, displaying, via the display generation component, the set of two or more widgets in a second widget spatial arrangement different from the first widget spatial arrangement; and in accordance with a determination that the respective set of one or more spatial bounds is a third set of one or more spatial bounds different from the first set of one or more spatial bounds and different from the second set of one or more spatial bounds, displaying, via the display generation component, the set of two or more widgets in a third widget spatial arrangement different from the first widget spatial arrangement and the second widget spatial arrangement.

In some embodiments, a computer program product is described. In some examples, the computer program product comprises one or more programs configured to be executed by one or more processors of a computer system that is in communication with a display generation component. In some embodiments, the one or more programs include instructions for: displaying, via the display generation component, a set of two or more widgets in a first widget spatial arrangement within a widget display area that has a first set of one or more spatial bounds; detecting a request to display the set of two or more widgets in a widget display area with a respective set of one or more spatial bounds; and in response to detecting the request to display the set of two or more widgets in a widget display area with the respective set of one or more spatial bounds: in accordance with a determination that the respective set of one or more spatial bounds is a second set of one or more spatial bounds different from the first set of one or more spatial bounds, displaying, via the display generation component, the set of two or more widgets in a second widget spatial arrangement different from the first widget spatial arrangement; and in accordance with a determination that the respective set of one or more spatial bounds is a third set of one or more spatial bounds different from the first set of one or more spatial bounds and different from the second set of one or more spatial bounds, displaying, via the display generation component, the set of two or more widgets in a third widget spatial arrangement different from the first widget spatial arrangement and the second widget spatial arrangement.

In some embodiments, a method that is performed at a computer system is described. In some embodiments, the method comprises: while the computer system is in communication with a first set of display generation components corresponding to a first display arrangement, wherein the first set of display generation components includes a first display generation component and a second display generation component different from the first display generation component: displaying, via the first display generation component of the first set of display generation components, a first set of one or more widgets; and displaying, via the second display generation component of the first set of display generation components, a second set of one or more widgets, wherein the second set of one or more widgets is different from the first set of one or more widgets; and after displaying the first set of one or more widgets and the second of the set of one or more widgets, detecting an event corresponding to a request to switch to a second set of display generation components corresponding to a second display arrangement different from the first display arrangement, wherein the second set of display generation components includes a third display generation component and a fourth display generation component different from the third display generation component; and in response to detecting the event: in accordance with a determination that the second display arrangement corresponds to a first display order: displaying, via the third display generation component of the second set of display generation components, a third set of one or more widgets that is based on the first set of one or more widgets; and displaying, via the fourth display generation component of the second set of display generation components, a fourth set of one or more widgets that is based on the second set of one or more widgets, wherein the fourth set of widgets is different from the third set of one or more widgets; and in accordance with a determination that the second display arrangement corresponds to a second display order different from the first display order: displaying, via the third display generation component of the second set of display generation components, the fourth set of one or more widgets that is based on the second set of one or more widgets; and displaying, via the fourth display generation component of the second set of display generation components, the third set of one or more widgets that is based on the first set of one or more widgets.

In some embodiments, a non-transitory computer-readable storage medium storing one or more programs configured to be executed by one or more processors of a computer system is described. In some embodiments, the one or more programs includes instructions for: while the computer system is in communication with a first set of display generation components corresponding to a first display arrangement, wherein the first set of display generation components includes a first display generation component and a second display generation component different from the first display generation component: displaying, via the first display generation component of the first set of display generation components, a first set of one or more widgets; and displaying, via the second display generation component of the first set of display generation components, a second set of one or more widgets, wherein the second set of one or more widgets is different from the first set of one or more widgets; and after displaying the first set of one or more widgets and the second of the set of one or more widgets, detecting an event corresponding to a request to switch to a second set of display generation components corresponding to a second display arrangement different from the first display arrangement, wherein the second set of display generation components includes a third display generation component and a fourth display generation component different from the third display generation component; and in response to detecting the event: in accordance with a determination that the second display arrangement corresponds to a first display order: displaying, via the third display generation component of the second set of display generation components, a third set of one or more widgets that is based on the first set of one or more widgets; and displaying, via the fourth display generation component of the second set of display generation components, a fourth set of one or more widgets that is based on the second set of one or more widgets, wherein the fourth set of widgets is different from the third set of one or more widgets; and in accordance with a determination that the second display arrangement corresponds to a second display order different from the first display order: displaying, via the third display generation component of the second set of display generation components, the fourth set of one or more widgets that is based on the second set of one or more widgets; and displaying, via the fourth display generation component of the second set of display generation components, the third set of one or more widgets that is based on the first set of one or more widgets.

In some embodiments, a transitory computer-readable storage medium storing one or more programs configured to be executed by one or more processors of a computer system is described. In some embodiments, the one or more programs includes instructions for: while the computer system is in communication with a first set of display generation components corresponding to a first display arrangement, wherein the first set of display generation components includes a first display generation component and a second display generation component different from the first display generation component: displaying, via the first display generation component of the first set of display generation components, a first set of one or more widgets; and displaying, via the second display generation component of the first set of display generation components, a second set of one or more widgets, wherein the second set of one or more widgets is different from the first set of one or more widgets; and after displaying the first set of one or more widgets and the second of the set of one or more widgets, detecting an event corresponding to a request to switch to a second set of display generation components corresponding to a second display arrangement different from the first display arrangement, wherein the second set of display generation components includes a third display generation component and a fourth display generation component different from the third display generation component; and in response to detecting the event: in accordance with a determination that the second display arrangement corresponds to a first display order: displaying, via the third display generation component of the second set of display generation components, a third set of one or more widgets that is based on the first set of one or more widgets; and displaying, via the fourth display generation component of the second set of display generation components, a fourth set of one or more widgets that is based on the second set of one or more widgets, wherein the fourth set of widgets is different from the third set of one or more widgets; and in accordance with a determination that the second display arrangement corresponds to a second display order different from the first display order: displaying, via the third display generation component of the second set of display generation components, the fourth set of one or more widgets that is based on the second set of one or more widgets; and displaying, via the fourth display generation component of the second set of display generation components, the third set of one or more widgets that is based on the first set of one or more widgets.

In some embodiments, a computer system is described. In some embodiments, the computer system comprises one or more processors and memory storing one or more programs configured to be executed by the one or more processors. In some embodiments, the one or more programs includes instructions for: while the computer system is in communication with a first set of display generation components corresponding to a first display arrangement, wherein the first set of display generation components includes a first display generation component and a second display generation component different from the first display generation component: displaying, via the first display generation component of the first set of display generation components, a first set of one or more widgets; and displaying, via the second display generation component of the first set of display generation components, a second set of one or more widgets, wherein the second set of one or more widgets is different from the first set of one or more widgets; and after displaying the first set of one or more widgets and the second of the set of one or more widgets, detecting an event corresponding to a request to switch to a second set of display generation components corresponding to a second display arrangement different from the first display arrangement, wherein the second set of display generation components includes a third display generation component and a fourth display generation component different from the third display generation component; and in response to detecting the event: in accordance with a determination that the second display arrangement corresponds to a first display order: displaying, via the third display generation component of the second set of display generation components, a third set of one or more widgets that is based on the first set of one or more widgets; and displaying, via the fourth display generation component of the second set of display generation components, a fourth set of one or more widgets that is based on the second set of one or more widgets, wherein the fourth set of widgets is different from the third set of one or more widgets; and in accordance with a determination that the second display arrangement corresponds to a second display order different from the first display order: displaying, via the third display generation component of the second set of display generation components, the fourth set of one or more widgets that is based on the second set of one or more widgets; and displaying, via the fourth display generation component of the second set of display generation components, the third set of one or more widgets that is based on the first set of one or more widgets.

In some embodiments, a computer system is described. In some embodiments, the computer system comprises means for performing each of the following steps: while the computer system is in communication with a first set of display generation components corresponding to a first display arrangement, wherein the first set of display generation components includes a first display generation component and a second display generation component different from the first display generation component: displaying, via the first display generation component of the first set of display generation components, a first set of one or more widgets; and displaying, via the second display generation component of the first set of display generation components, a second set of one or more widgets, wherein the second set of one or more widgets is different from the first set of one or more widgets; and after displaying the first set of one or more widgets and the second of the set of one or more widgets, detecting an event corresponding to a request to switch to a second set of display generation components corresponding to a second display arrangement different from the first display arrangement, wherein the second set of display generation components includes a third display generation component and a fourth display generation component different from the third display generation component; and in response to detecting the event: in accordance with a determination that the second display arrangement corresponds to a first display order: displaying, via the third display generation component of the second set of display generation components, a third set of one or more widgets that is based on the first set of one or more widgets; and displaying, via the fourth display generation component of the second set of display generation components, a fourth set of one or more widgets that is based on the second set of one or more widgets, wherein the fourth set of widgets is different from the third set of one or more widgets; and in accordance with a determination that the second display arrangement corresponds to a second display order different from the first display order: displaying, via the third display generation component of the second set of display generation components, the fourth set of one or more widgets that is based on the second set of one or more widgets; and displaying, via the fourth display generation component of the second set of display generation components, the third set of one or more widgets that is based on the first set of one or more widgets.

In some embodiments, a computer program product is described. In some embodiments, the computer program product comprises one or more programs configured to be executed by one or more processors of a computer system. In some embodiments, the one or more programs include instructions for: while the computer system is in communication with a first set of display generation components corresponding to a first display arrangement, wherein the first set of display generation components includes a first display generation component and a second display generation component different from the first display generation component: displaying, via the first display generation component of the first set of display generation components, a first set of one or more widgets; and displaying, via the second display generation component of the first set of display generation components, a second set of one or more widgets, wherein the second set of one or more widgets is different from the first set of one or more widgets; and after displaying the first set of one or more widgets and the second of the set of one or more widgets, detecting an event corresponding to a request to switch to a second set of display generation components corresponding to a second display arrangement different from the first display arrangement, wherein the second set of display generation components includes a third display generation component and a fourth display generation component different from the third display generation component; and in response to detecting the event: in accordance with a determination that the second display arrangement corresponds to a first display order: displaying, via the third display generation component of the second set of display generation components, a third set of one or more widgets that is based on the first set of one or more widgets; and displaying, via the fourth display generation component of the second set of display generation components, a fourth set of one or more widgets that is based on the second set of one or more widgets, wherein the fourth set of widgets is different from the third set of one or more widgets; and in accordance with a determination that the second display arrangement corresponds to a second display order different from the first display order: displaying, via the third display generation component of the second set of display generation components, the fourth set of one or more widgets that is based on the second set of one or more widgets; and displaying, via the fourth display generation component of the second set of display generation components, the third set of one or more widgets that is based on the first set of one or more widgets.

In some embodiments, a method that is performed at a computer system that is in communication with a display generation component and one or more input devices is described. In some embodiments, the method comprises: displaying, via the display generation component, a user interface that includes a first widget and a second widget different from the first widget; and while the first widget is spaced apart from the second widget by more than a threshold distance: detecting, via the one or more input devices, an input corresponding to a request to move the first widget within the user interface; and in response to detecting the input corresponding to the request to move the first widget within the user interface: moving the first widget within the user interface; and in accordance with a determination that the first widget satisfies a set of one or more snapping criteria for alignment with the second widget, displaying, via the display generation component, an indication that the first widget will be snapped into alignment with the second widget while the first widget remains spaced apart from other widgets in the user interface by more than the threshold distance when the input ends.

In some embodiments, a non-transitory computer-readable storage medium storing one or more programs configured to be executed by one or more processors of a computer system that is in communication with a display generation component and one or more input devices is described. In some embodiments, the one or more programs includes instructions for: displaying, via the display generation component, a user interface that includes a first widget and a second widget different from the first widget; and while the first widget is spaced apart from the second widget by more than a threshold distance: detecting, via the one or more input devices, an input corresponding to a request to move the first widget within the user interface; and in response to detecting the input corresponding to the request to move the first widget within the user interface: moving the first widget within the user interface; and in accordance with a determination that the first widget satisfies a set of one or more snapping criteria for alignment with the second widget, displaying, via the display generation component, an indication that the first widget will be snapped into alignment with the second widget while the first widget remains spaced apart from other widgets in the user interface by more than the threshold distance when the input ends.

In some embodiments, a transitory computer-readable storage medium storing one or more programs configured to be executed by one or more processors of a computer system that is in communication with a display generation component and one or more input devices is described. In some embodiments, the one or more programs includes instructions for: displaying, via the display generation component, a user interface that includes a first widget and a second widget different from the first widget; and while the first widget is spaced apart from the second widget by more than a threshold distance: detecting, via the one or more input devices, an input corresponding to a request to move the first widget within the user interface; and in response to detecting the input corresponding to the request to move the first widget within the user interface: moving the first widget within the user interface; and in accordance with a determination that the first widget satisfies a set of one or more snapping criteria for alignment with the second widget, displaying, via the display generation component, an indication that the first widget will be snapped into alignment with the second widget while the first widget remains spaced apart from other widgets in the user interface by more than the threshold distance when the input ends.

In some embodiments, a computer system that is in communication with a display generation component and one or more input devices is described. In some embodiments, the computer system that is in communication with a display generation component and one or more input devices comprises one or more processors and memory storing one or more programs configured to be executed by the one or more processors. In some embodiments, the one or more programs includes instructions for: displaying, via the display generation component, a user interface that includes a first widget and a second widget different from the first widget; and while the first widget is spaced apart from the second widget by more than a threshold distance: detecting, via the one or more input devices, an input corresponding to a request to move the first widget within the user interface; and in response to detecting the input corresponding to the request to move the first widget within the user interface: moving the first widget within the user interface; and in accordance with a determination that the first widget satisfies a set of one or more snapping criteria for alignment with the second widget, displaying, via the display generation component, an indication that the first widget will be snapped into alignment with the second widget while the first widget remains spaced apart from other widgets in the user interface by more than the threshold distance when the input ends.

In some embodiments, a computer system that is in communication with a display generation component and one or more input devices is described. In some embodiments, the computer system that is in communication with a display generation component and one or more input devices comprises means for performing each of the following steps: displaying, via the display generation component, a user interface that includes a first widget and a second widget different from the first widget; and while the first widget is spaced apart from the second widget by more than a threshold distance: detecting, via the one or more input devices, an input corresponding to a request to move the first widget within the user interface; and in response to detecting the input corresponding to the request to move the first widget within the user interface: moving the first widget within the user interface; and in accordance with a determination that the first widget satisfies a set of one or more snapping criteria for alignment with the second widget, displaying, via the display generation component, an indication that the first widget will be snapped into alignment with the second widget while the first widget remains spaced apart from other widgets in the user interface by more than the threshold distance when the input ends.

In some embodiments, a computer program product is described. In some embodiments, the computer program product comprises one or more programs configured to be executed by one or more processors of a computer system that is in communication with a display generation component and one or more input devices. In some embodiments, the one or more programs include instructions for: displaying, via the display generation component, a user interface that includes a first widget and a second widget different from the first widget; and while the first widget is spaced apart from the second widget by more than a threshold distance: detecting, via the one or more input devices, an input corresponding to a request to move the first widget within the user interface; and in response to detecting the input corresponding to the request to move the first widget within the user interface: moving the first widget within the user interface; and in accordance with a determination that the first widget satisfies a set of one or more snapping criteria for alignment with the second widget, displaying, via the display generation component, an indication that the first widget will be snapped into alignment with the second widget while the first widget remains spaced apart from other widgets in the user interface by more than the threshold distance when the input ends.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying user interfaces with dynamic content, thereby increasing the effectiveness, efficiency, and user satisfaction with such devices. Such methods and interfaces may complement or replace other methods for displaying user interfaces with dynamic content.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6T illustrate exemplary user interfaces for transitioning user interfaces in accordance with some embodiments.

FIG. 7 is a flow diagram illustrating a method for transitioning user interface in accordance with some embodiments.

FIGS. 8A-8J illustrate exemplary user interfaces for displaying a user interface in accordance with some embodiments.

FIG. 9 is a flow diagram illustrating a method for displaying a user interface in accordance with some embodiments.

FIGS. 10A-10AT illustrate exemplary user interfaces for managing widgets in accordance with some embodiments.

FIG. 11 is a flow diagram illustrating a method for displaying a widget in accordance with some embodiments.

FIG. 12 is a flow diagram illustrating a method for placing a widget in accordance with some embodiments.

FIG. 13 is a flow diagram illustrating a method for displaying widget information in accordance with some embodiments.

FIGS. 14A-14J illustrate exemplary user interfaces for managing widgets in accordance with some embodiments.

FIG. 15 is a flow diagram illustrating a method for arranging widgets with respect to sets of one or more spatial bounds in accordance with some embodiments.

FIGS. 16A-16E illustrate exemplary user interfaces for managing widgets in accordance with some embodiments.

FIG. 17 is a flow diagram illustrating a method for arranging widgets with respect to sets of display generation components, in accordance with some embodiments.

FIGS. 18A-18Z illustrates exemplary user interfaces for managing widgets in accordance with some embodiments.

FIG. 19 is a flow diagram illustrating a method for aligning widgets, in accordance with some embodiment.

### DETAILED DESCRIPTION

The following description sets forth exemplary methods, parameters, and the like. It should be recognized, however, that such description is not intended as a limitation on the scope of the present disclosure but is instead provided as a description of examples.

There is a need for computer systems that provide efficient methods and interfaces for displaying user interfaces with dynamic content. For example, dynamic content can continue to be displayed while a computer system is transitioning between a locked state and an unlocked state. Such techniques can reduce the cognitive burden on a user who lock and unlock computer systems, thereby enhancing productivity. Further, such techniques can reduce processor and battery power otherwise wasted on redundant user inputs.

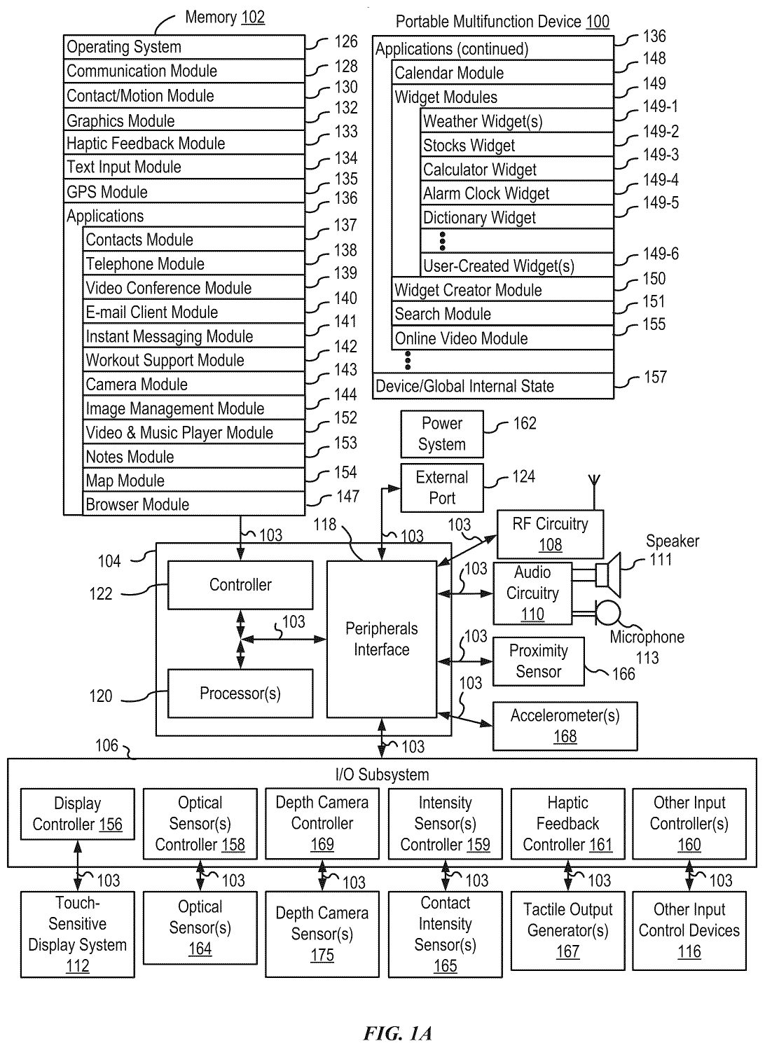

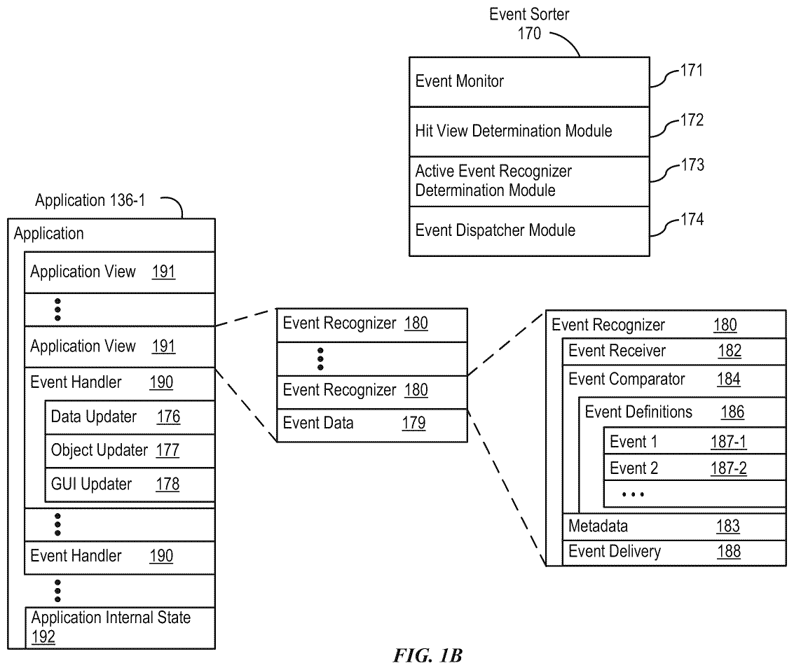

Below, FIGS. 1A-1B, 2, 3, 4A-4B, and 5A-5B provide a description of exemplary devices for performing the techniques for displaying user interfaces with dynamic content.

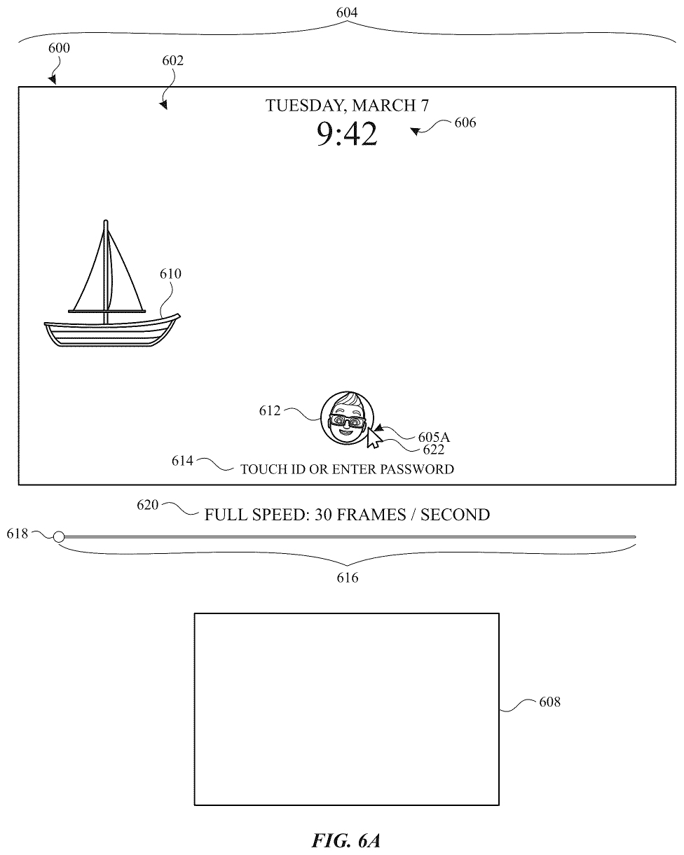

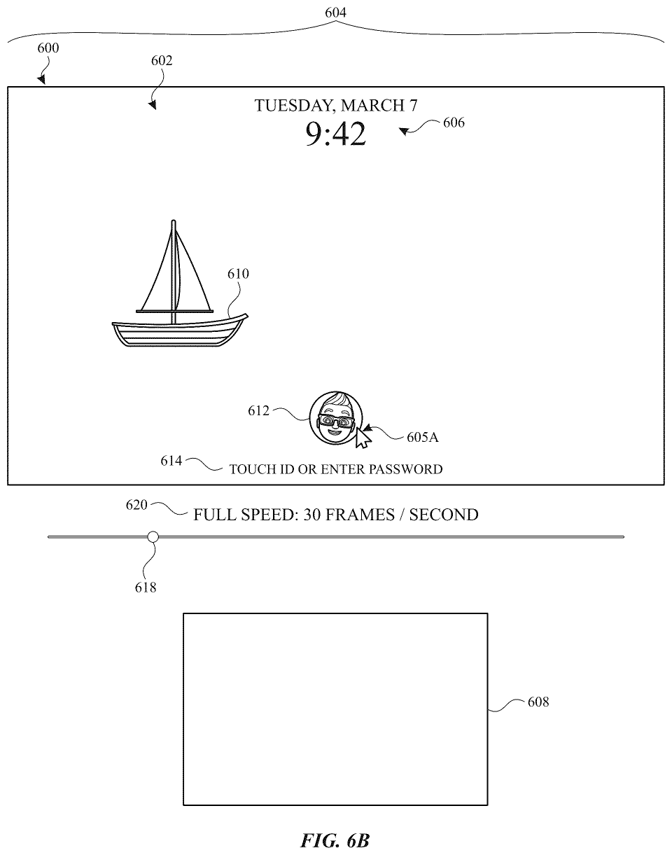

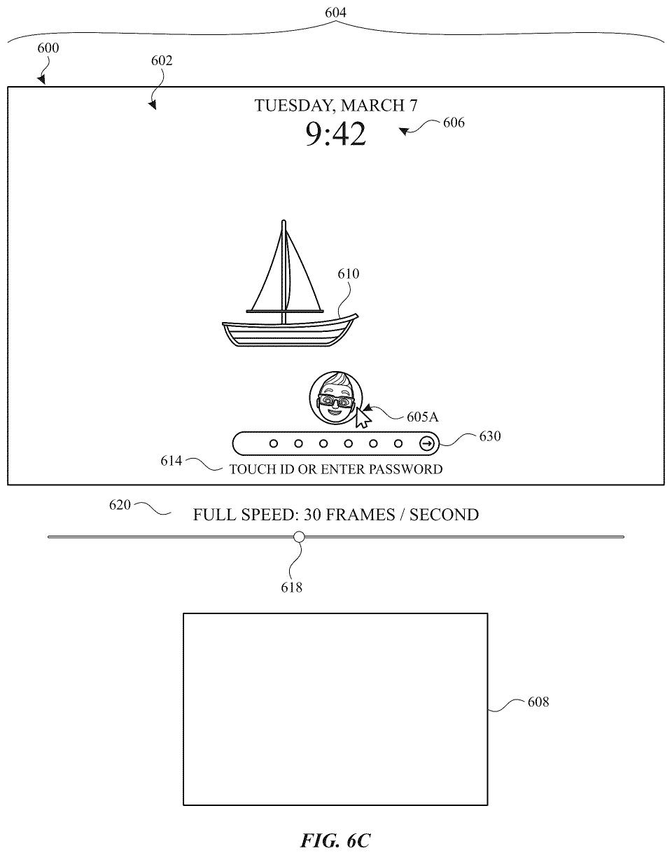

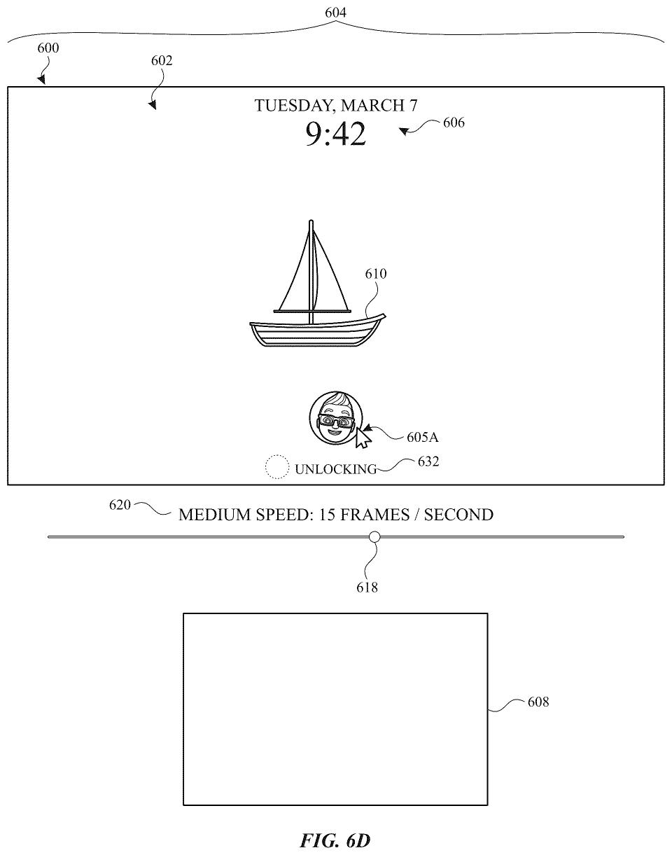

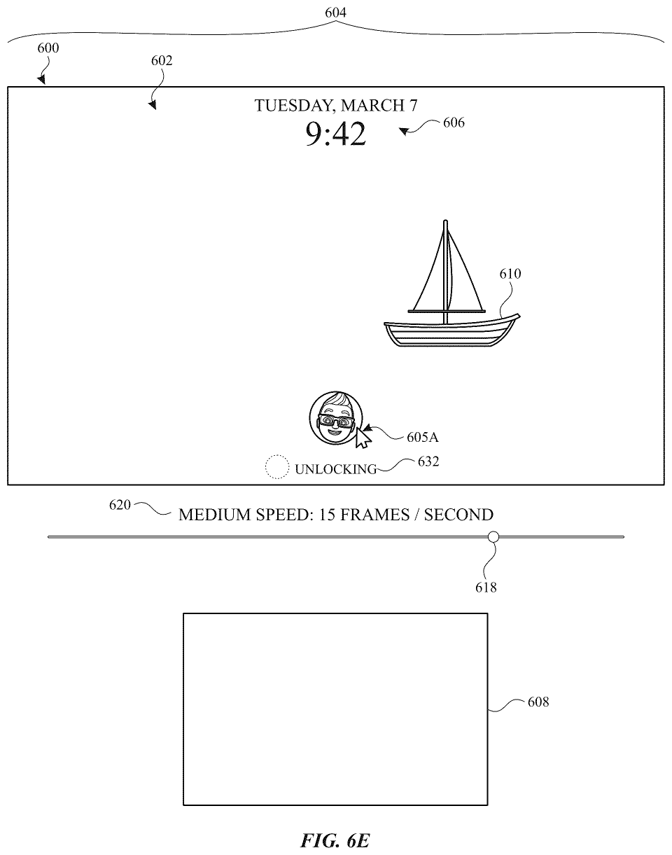

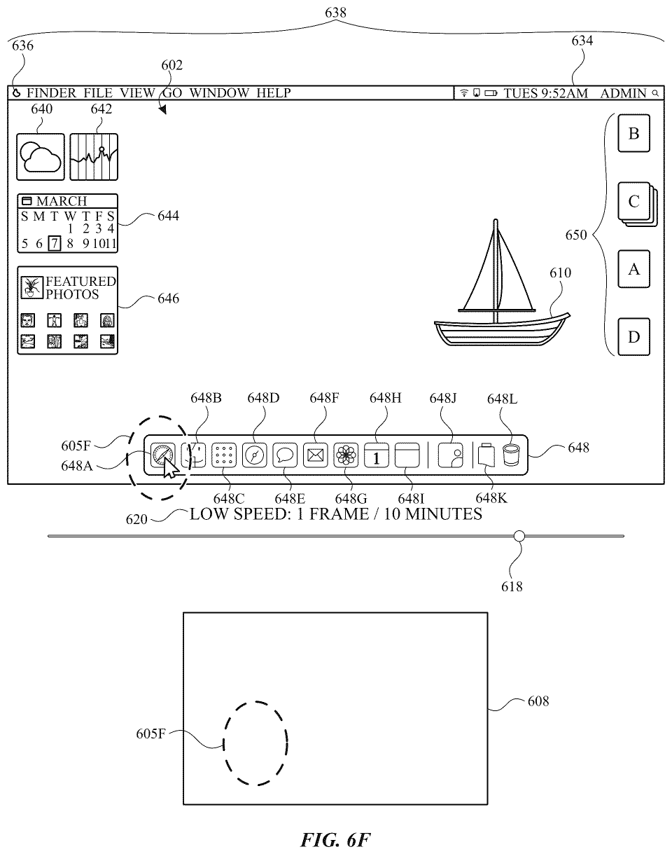

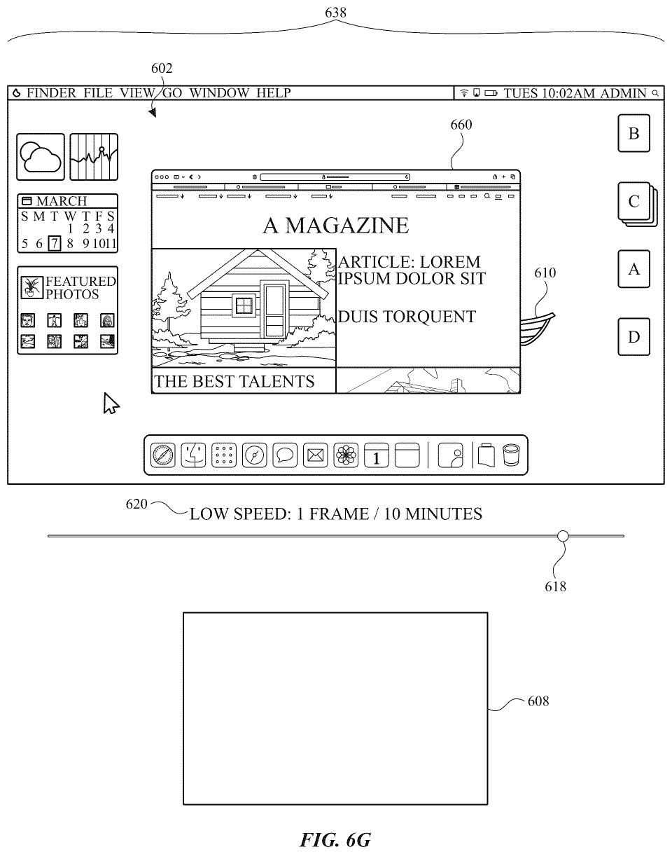

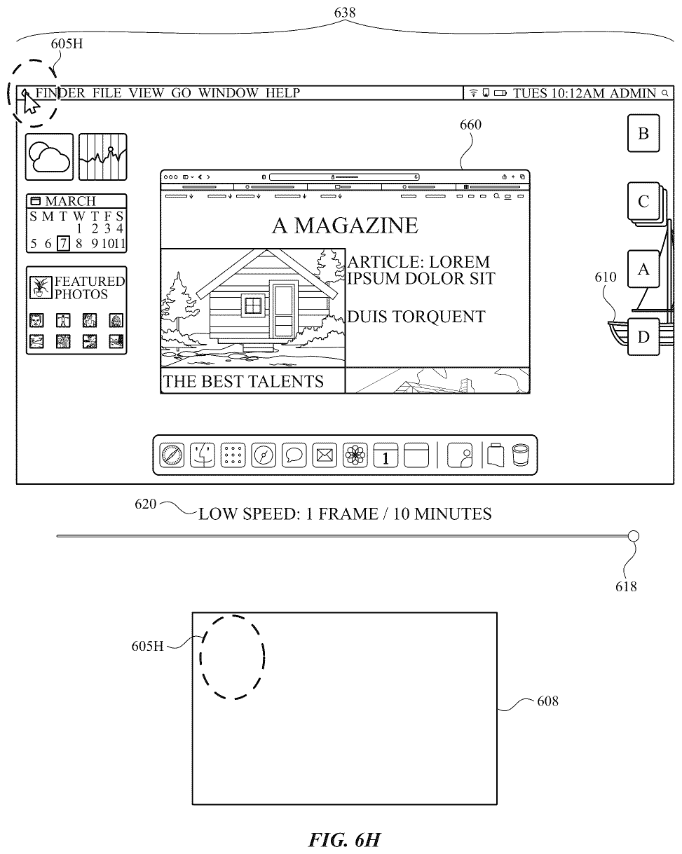

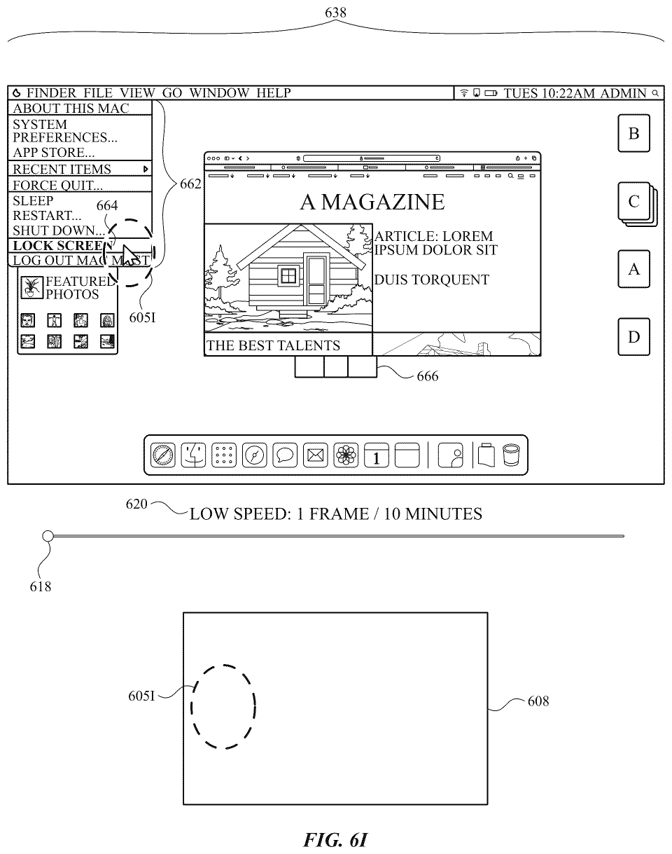

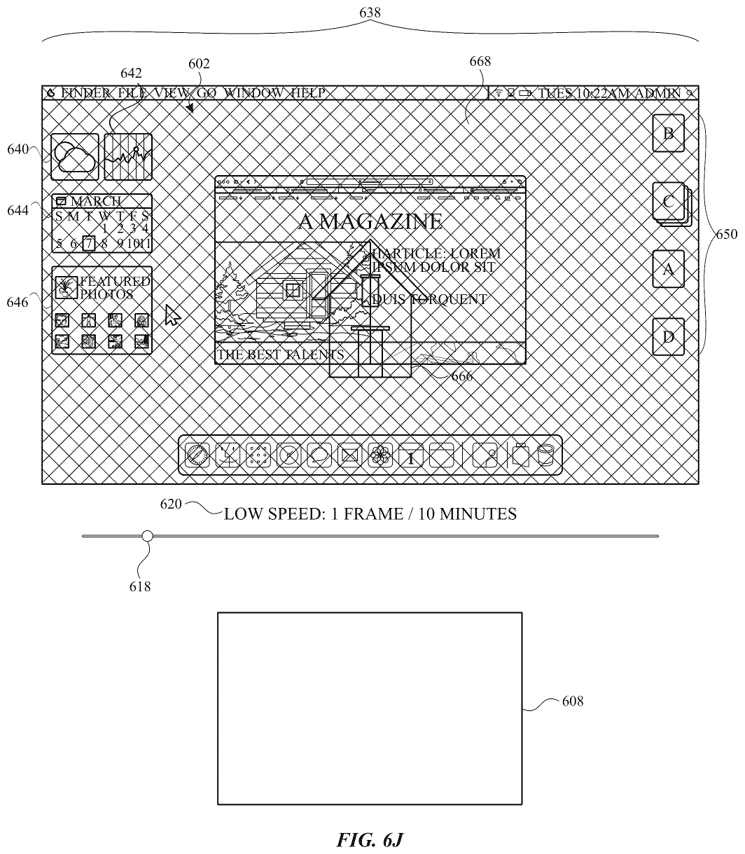

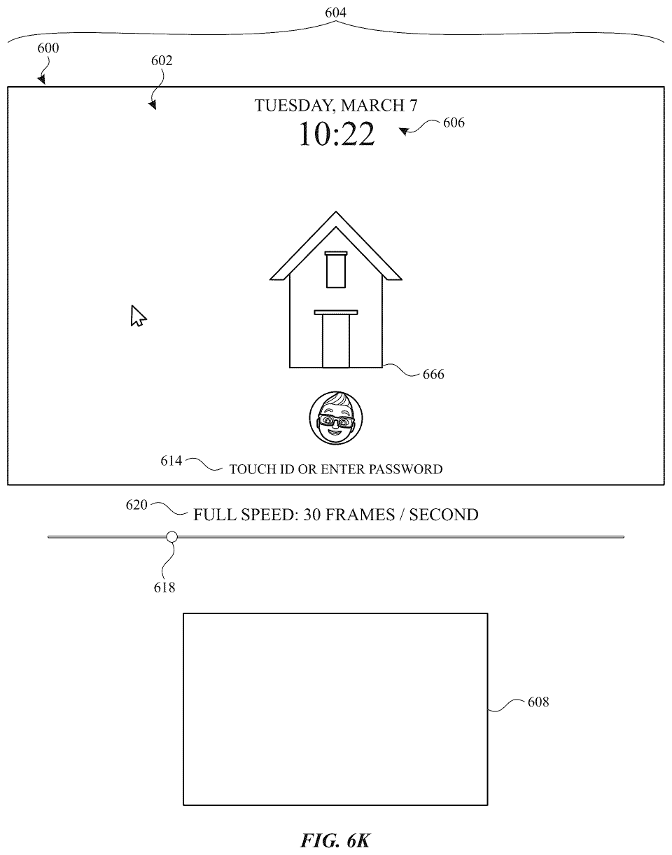

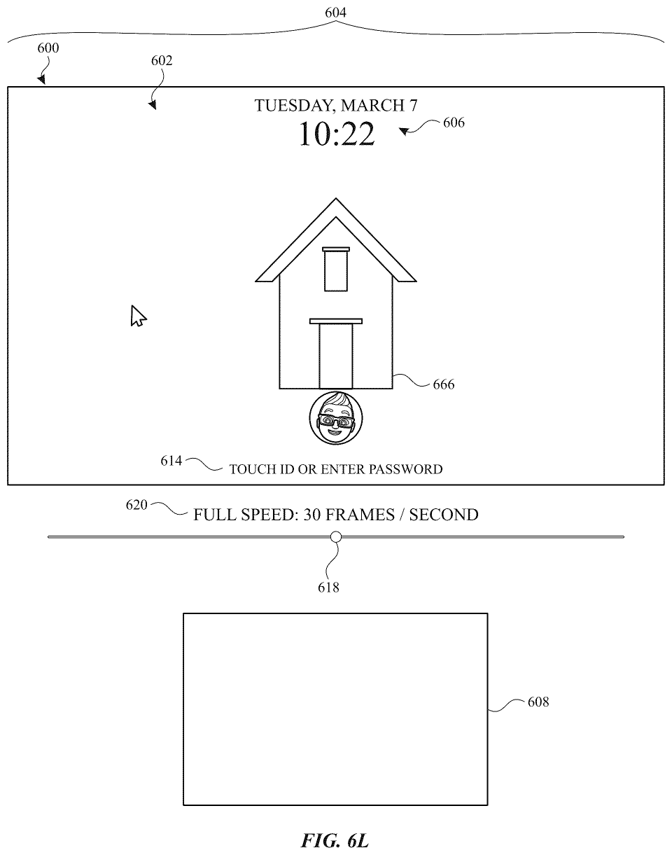

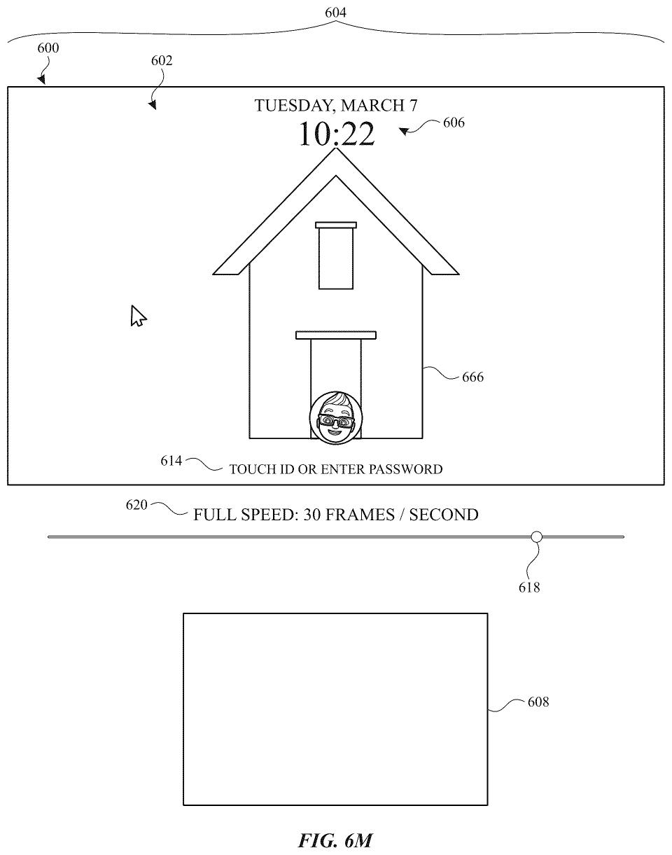

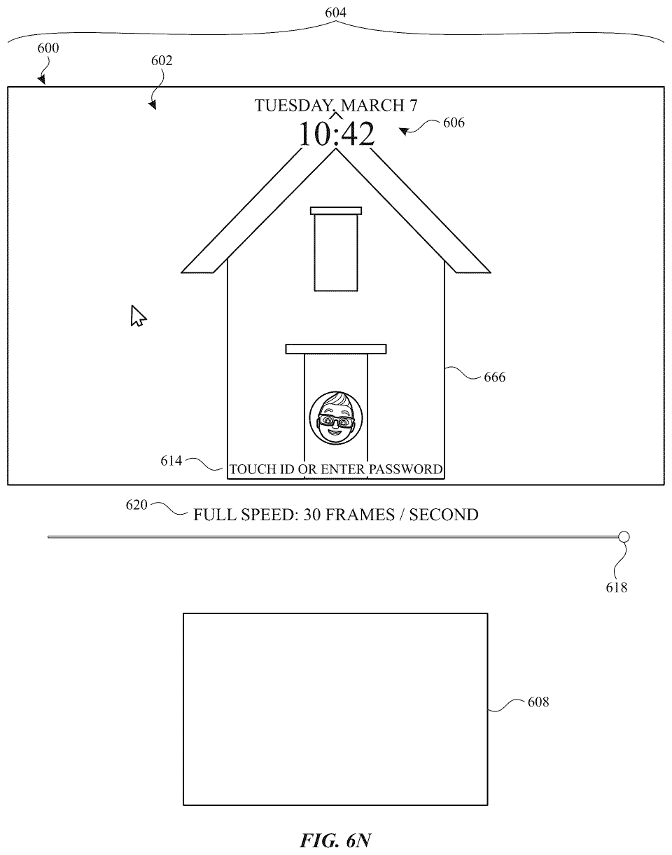

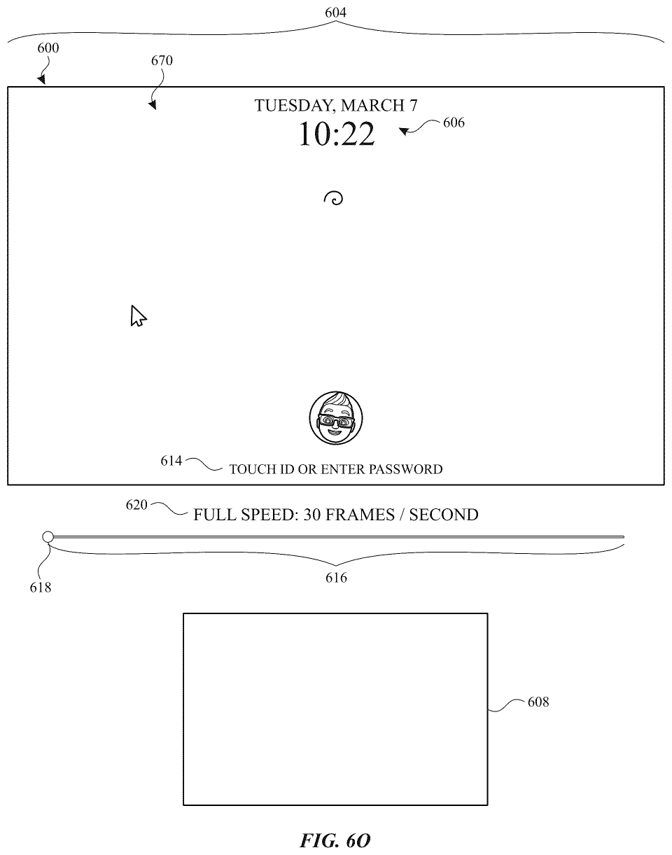

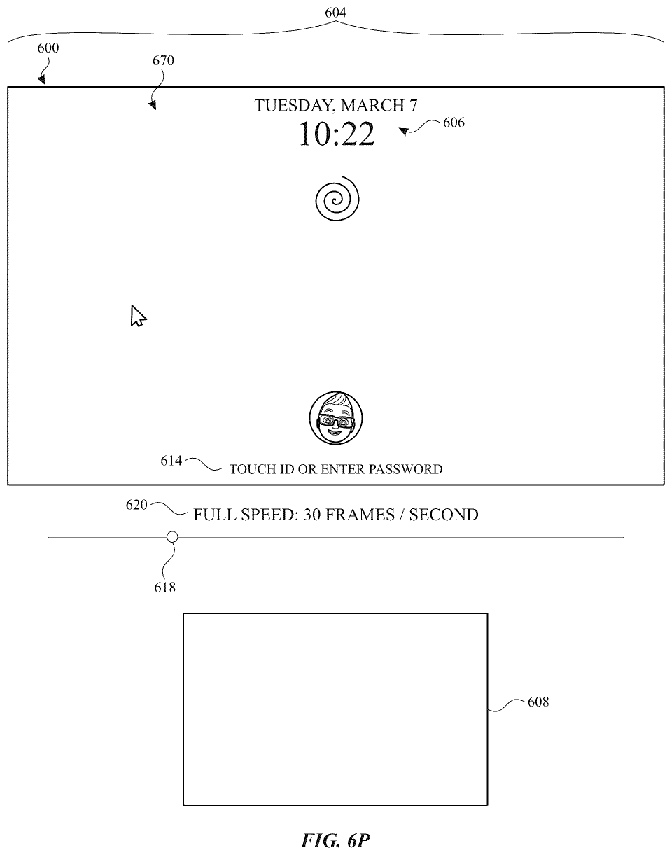

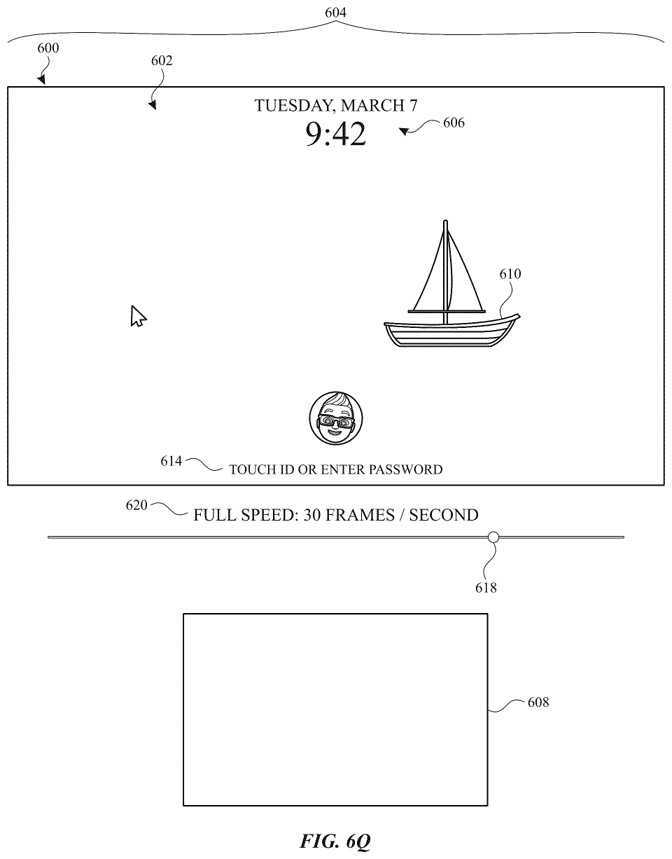

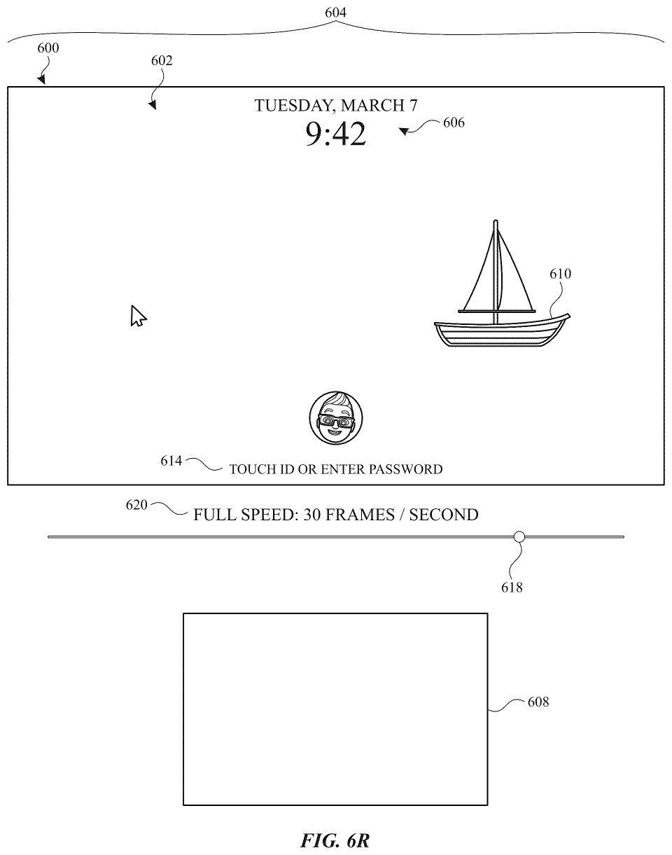

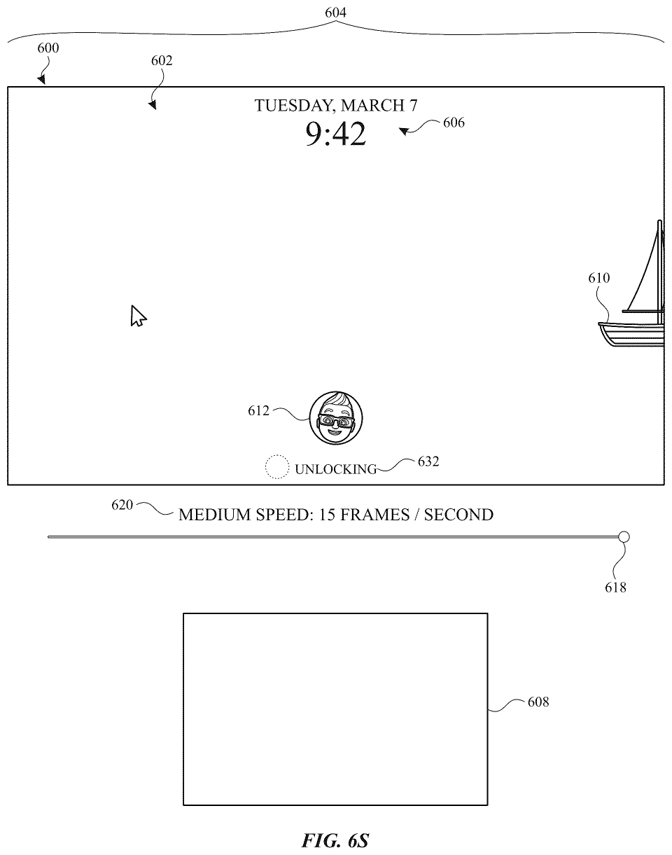

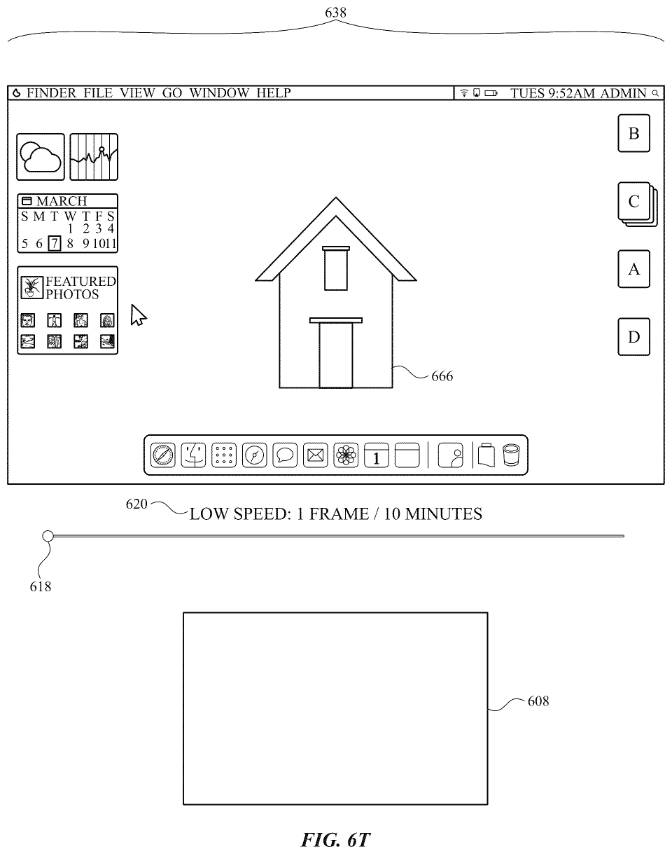

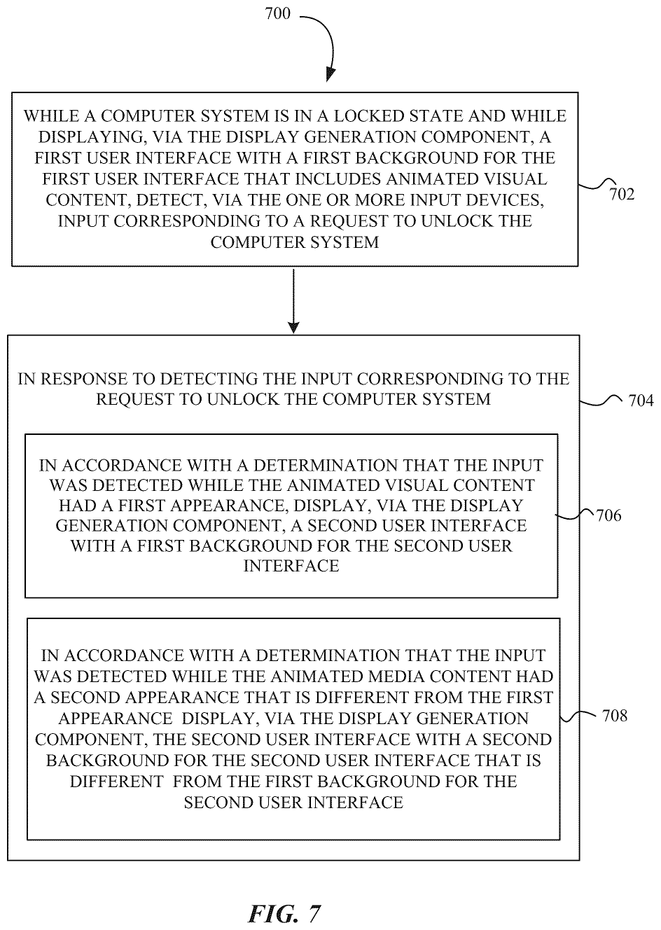

FIGS. 6A-6T illustrate exemplary user interfaces for transitioning user interfaces in accordance with some embodiments. FIG. 7 is a flow diagram illustrating a method for transitioning user interface in accordance with some embodiments. The user interfaces in FIGS. 6A-6T are used to illustrate the processes described below, including the processes in FIG. 7.

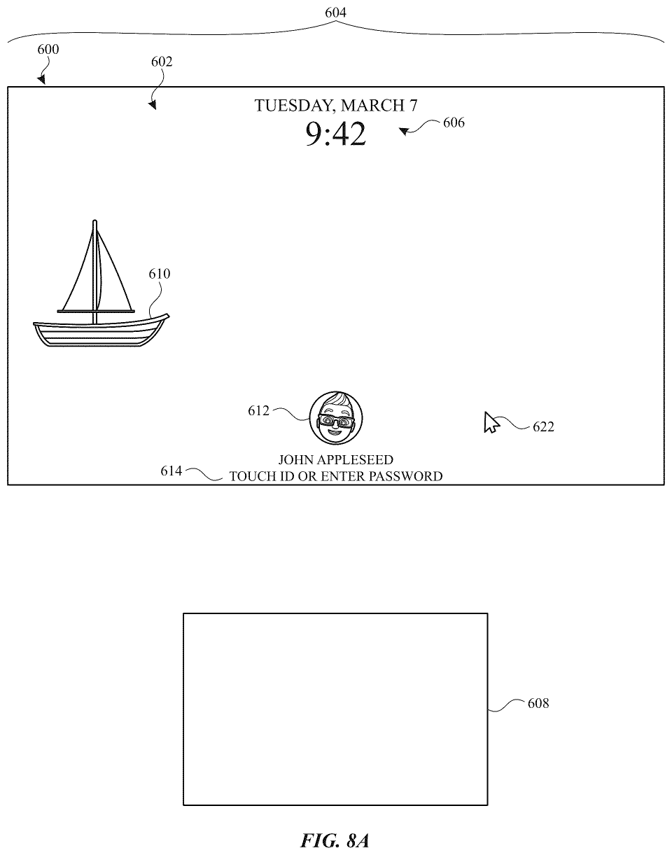

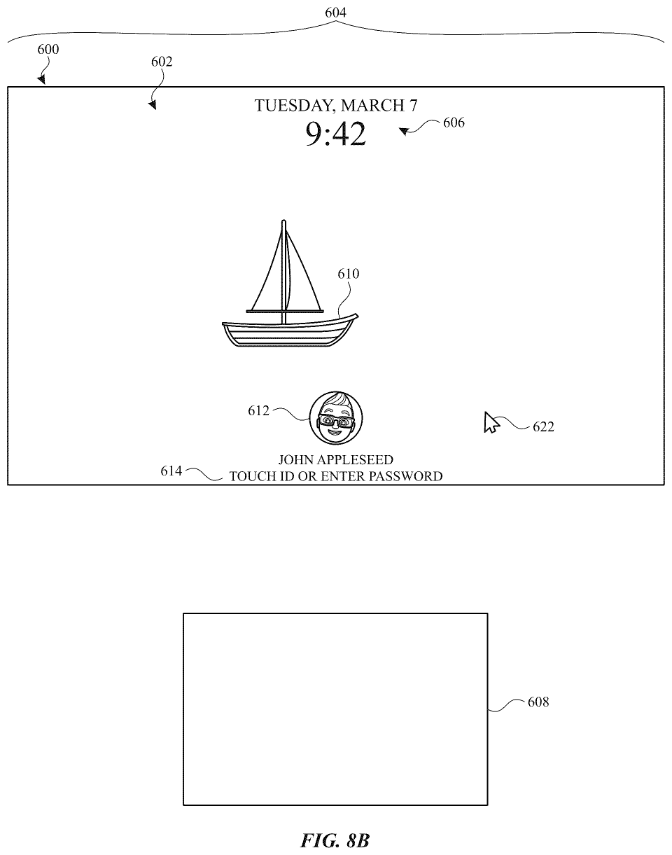

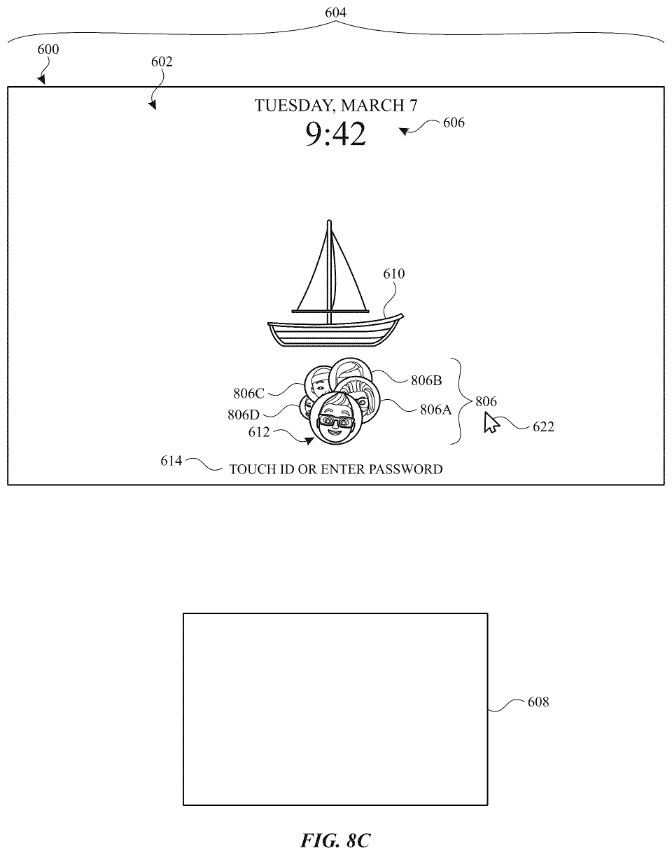

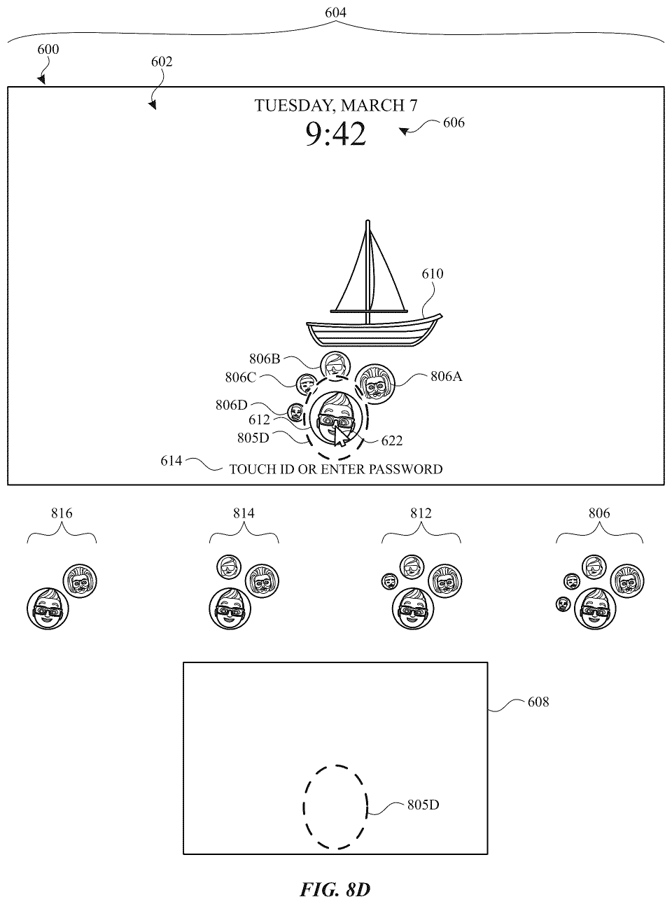

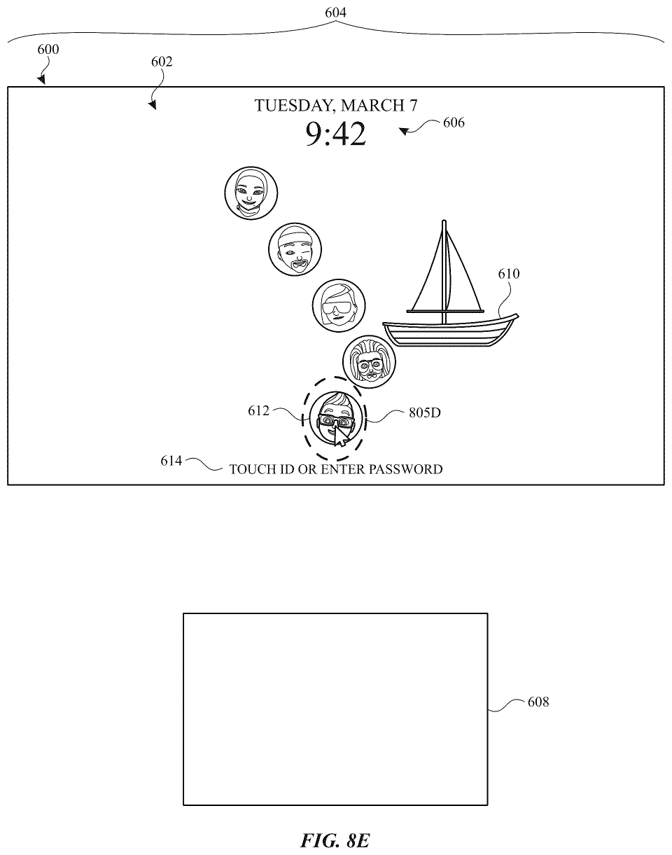

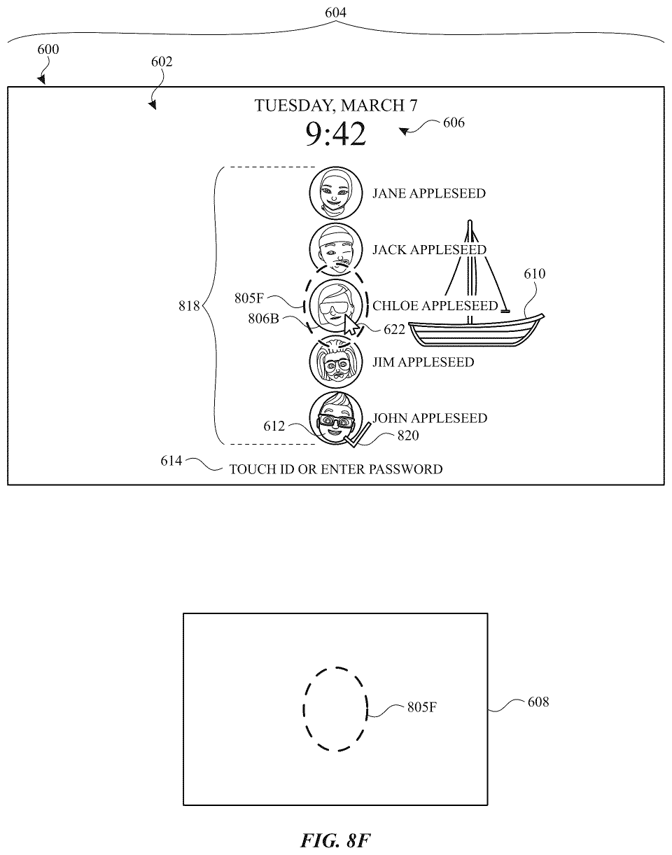

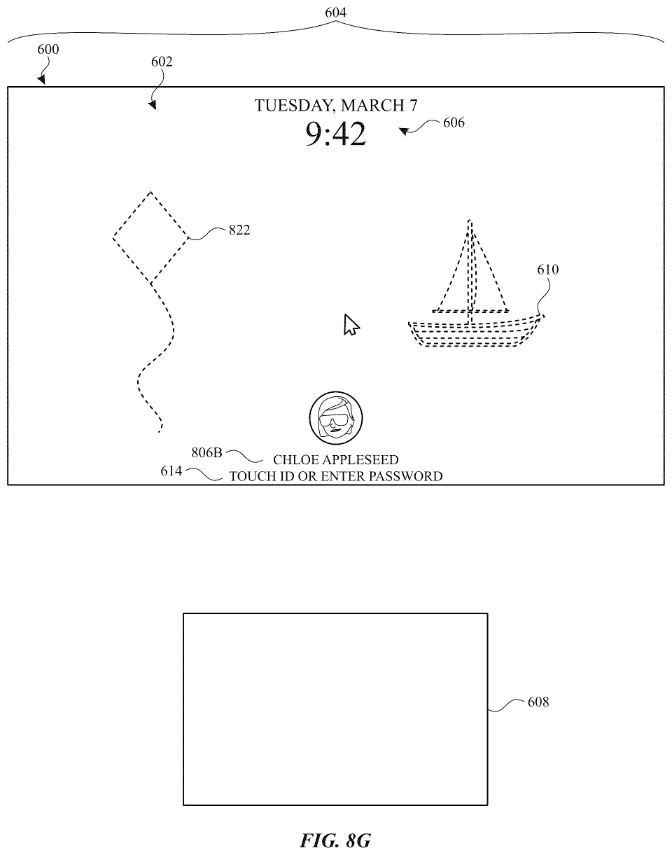

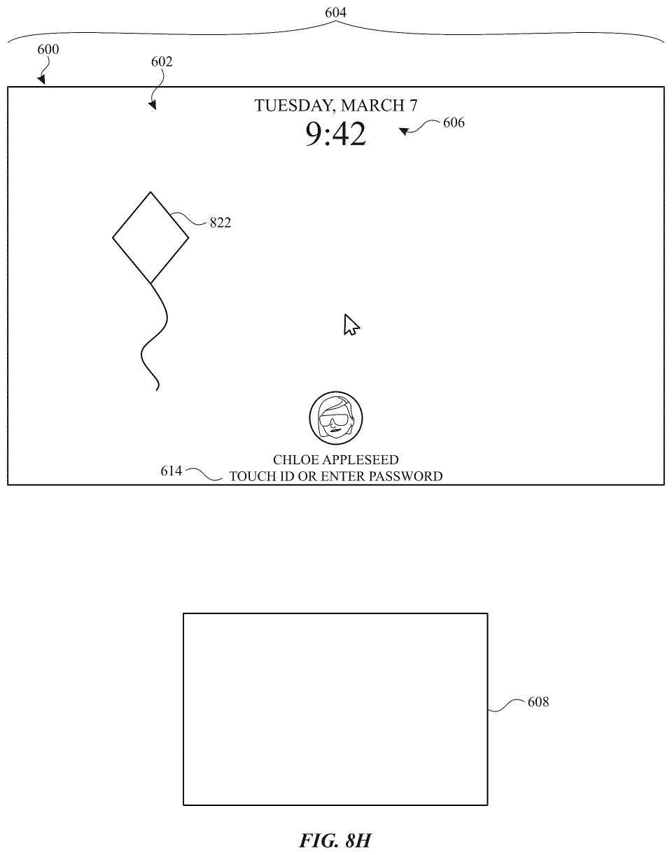

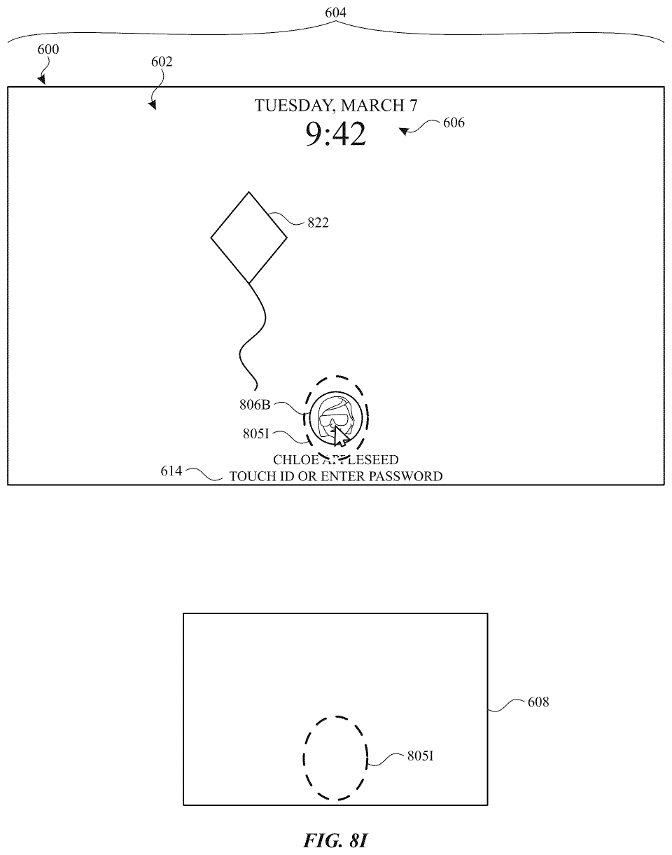

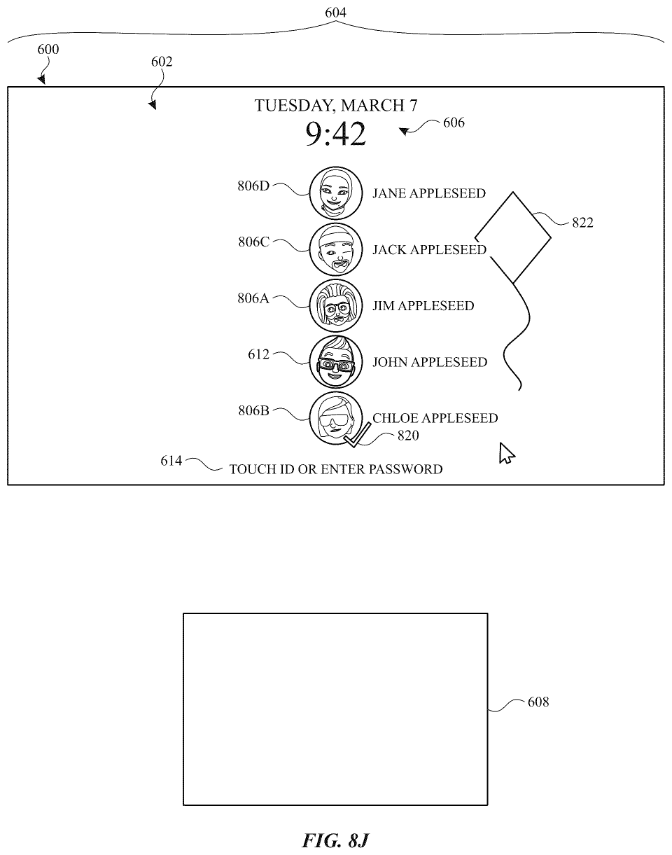

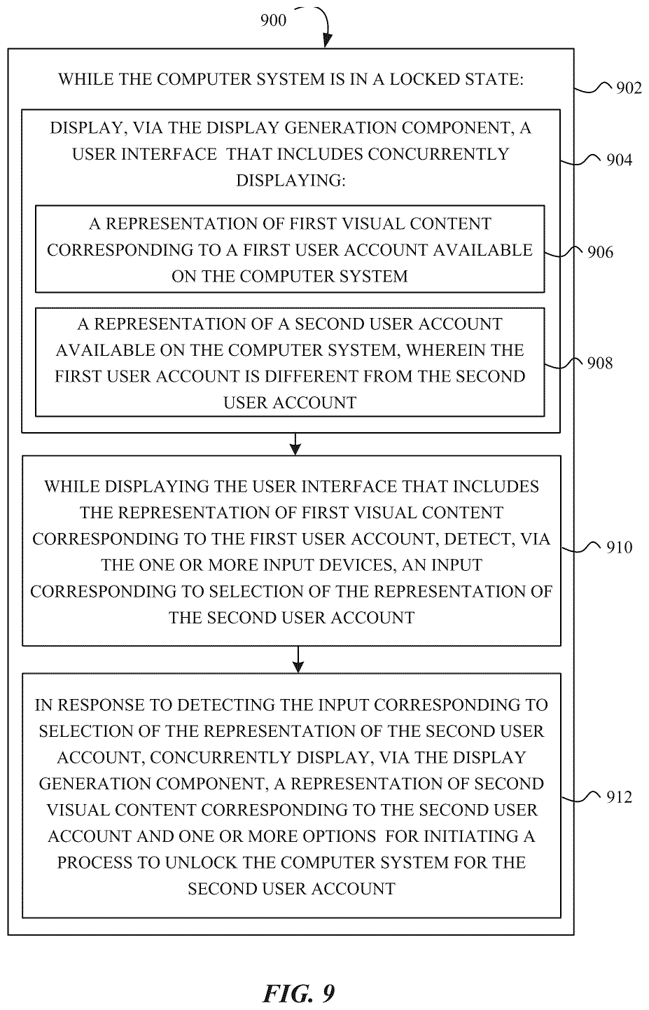

FIGS. 8A-8J illustrates exemplary user interfaces for displaying a user interface in accordance with some embodiments. FIG. 9 is a flow diagram illustrating a method for displaying a user interface in accordance with some embodiments. The user interfaces in FIGS. 8A-8J are used to illustrate the processes described below, including the processes in FIG. 9.

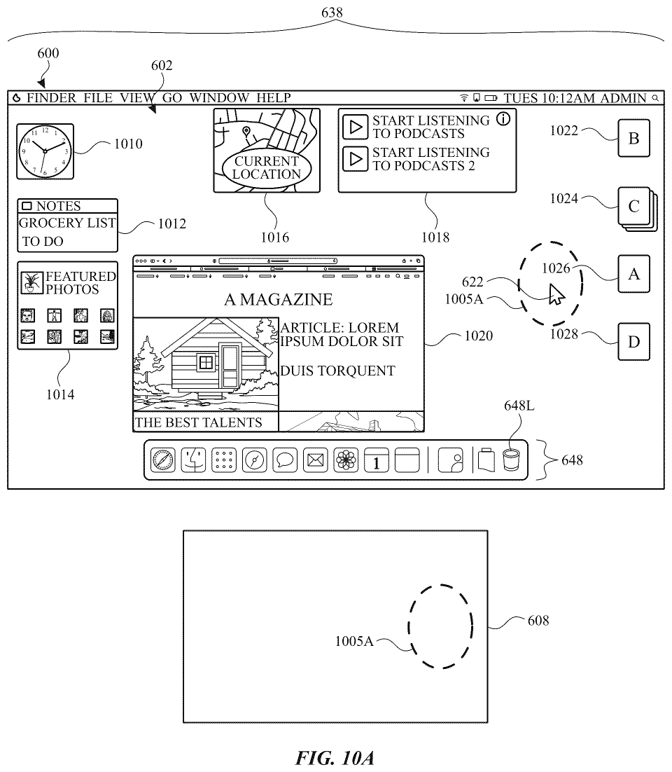

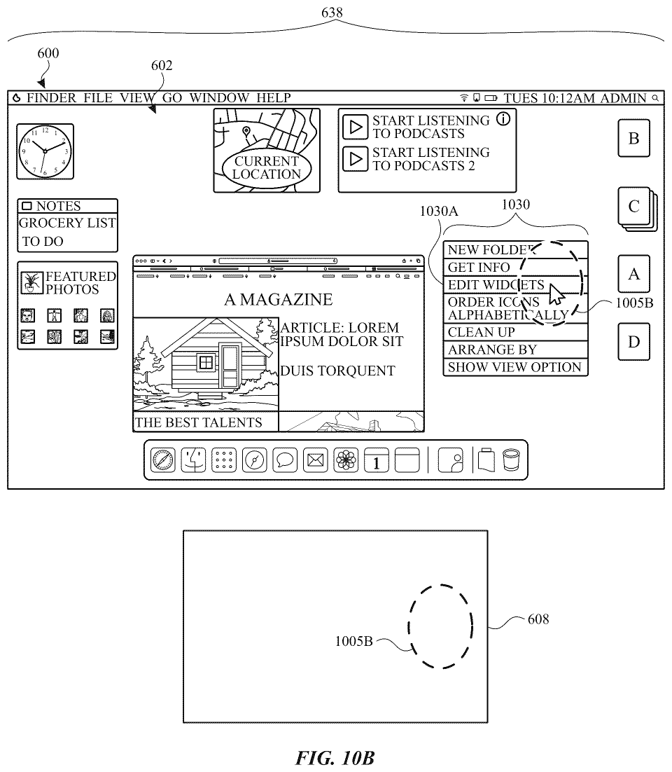

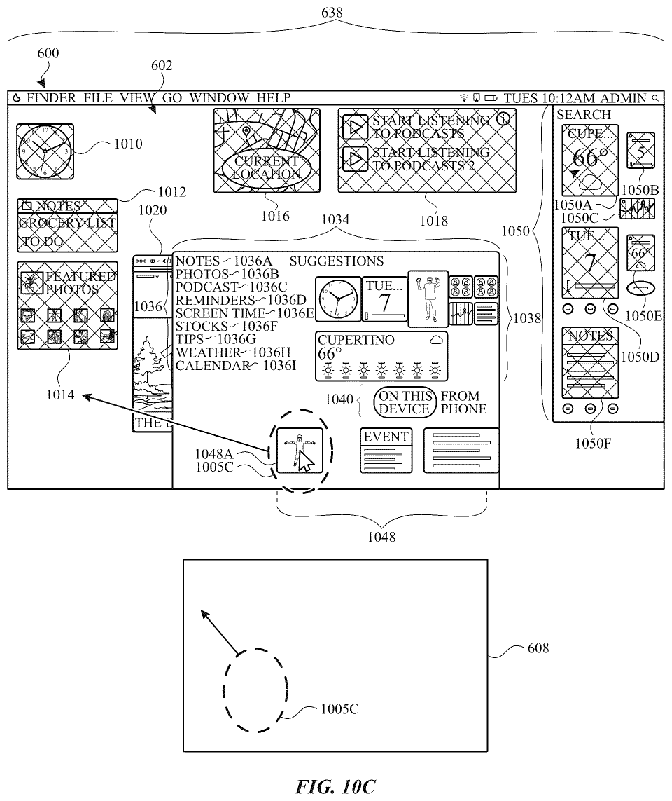

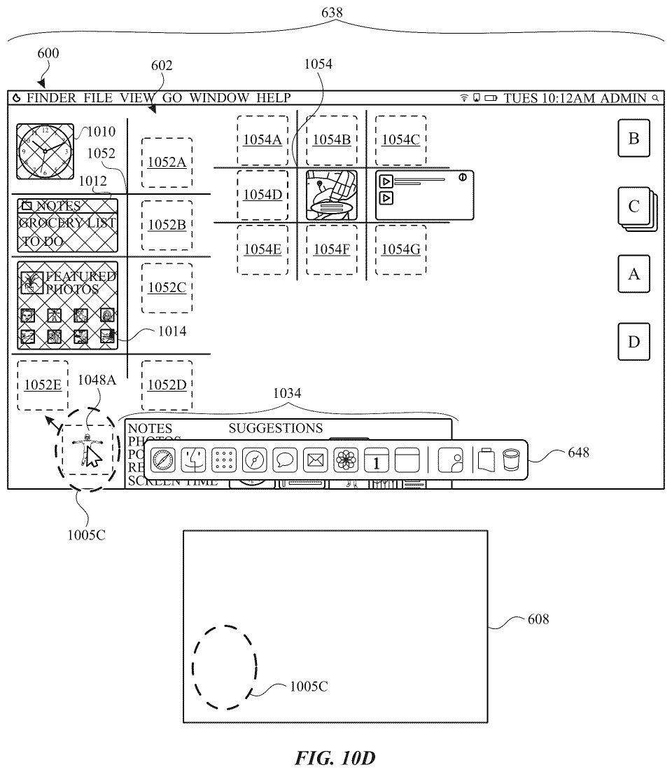

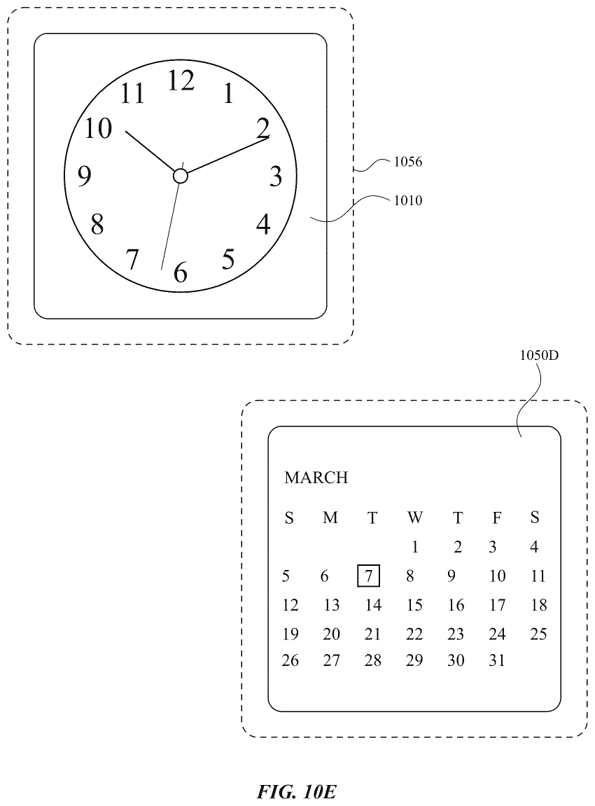

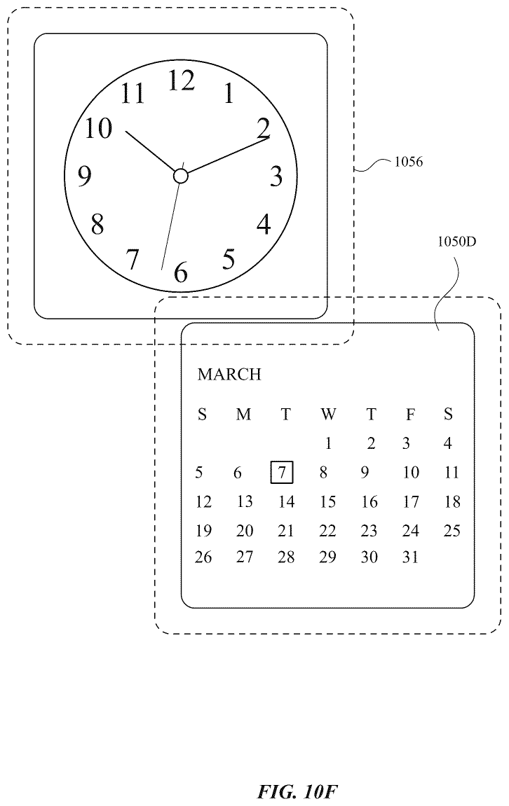

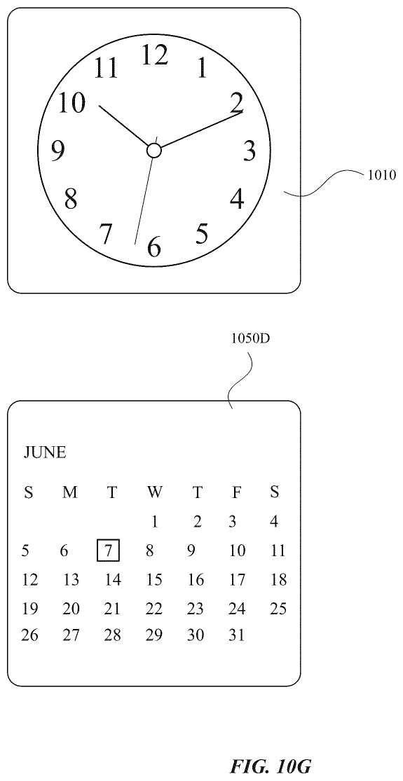

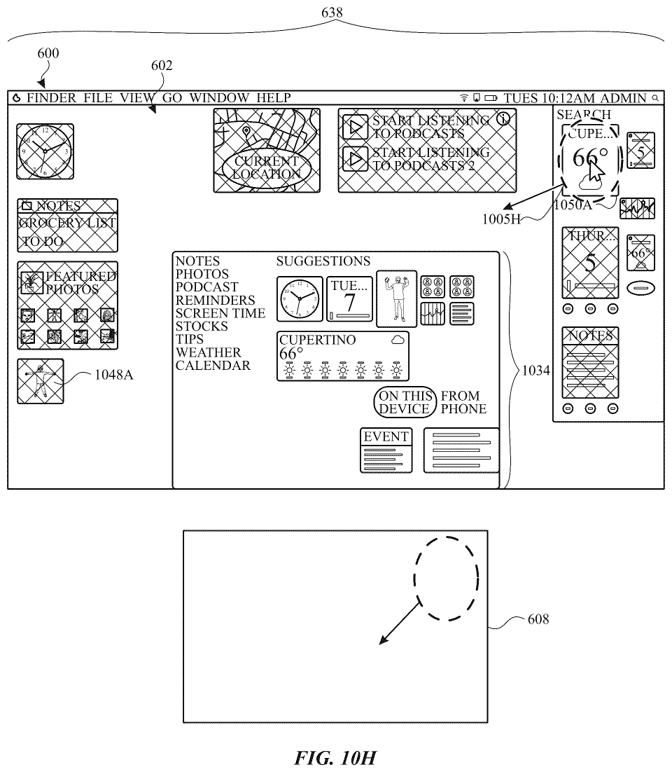

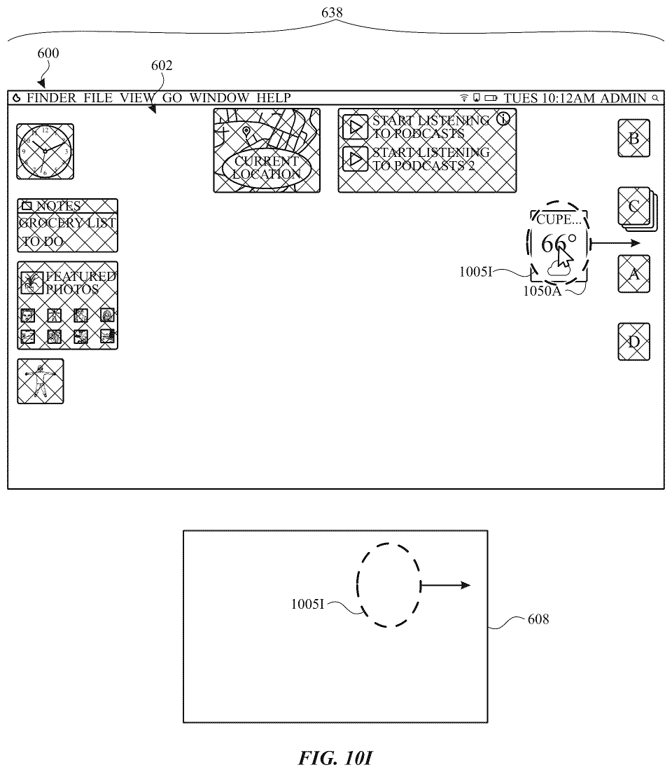

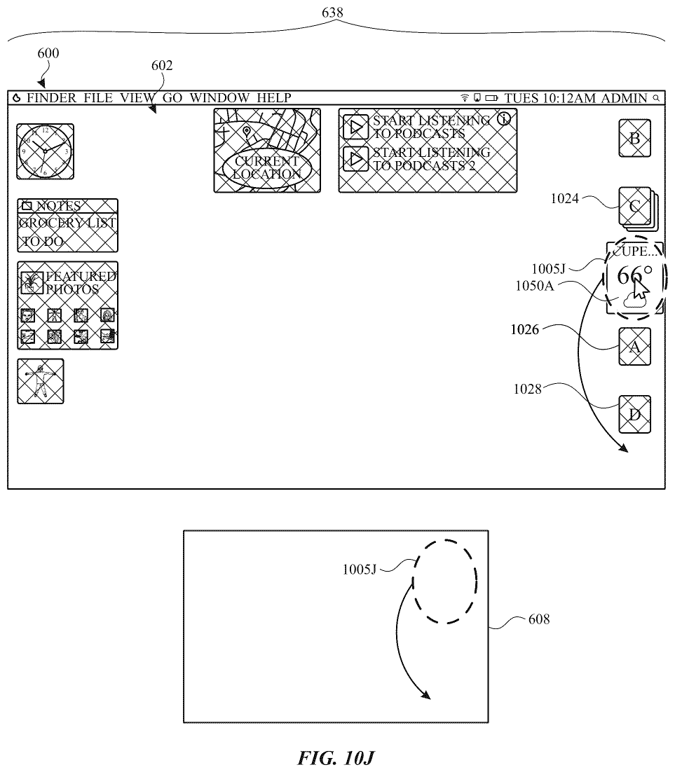

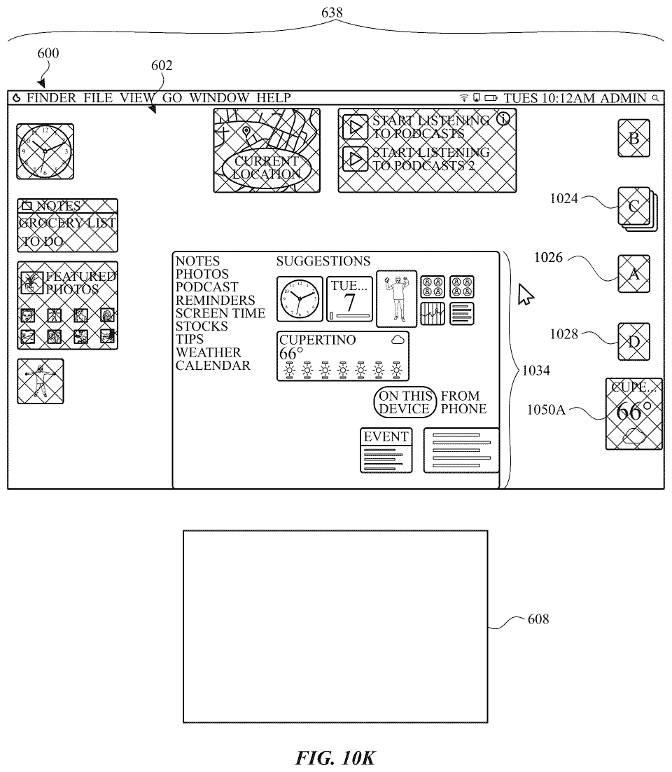

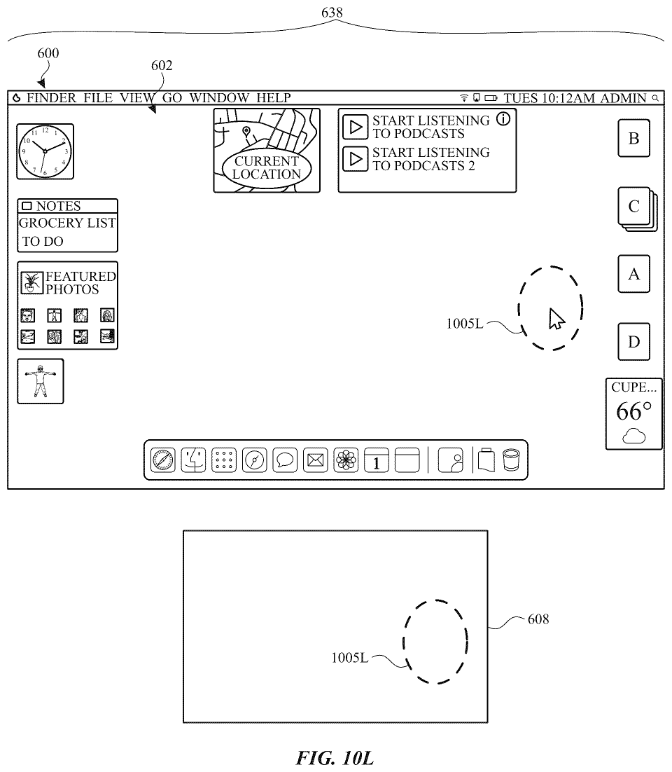

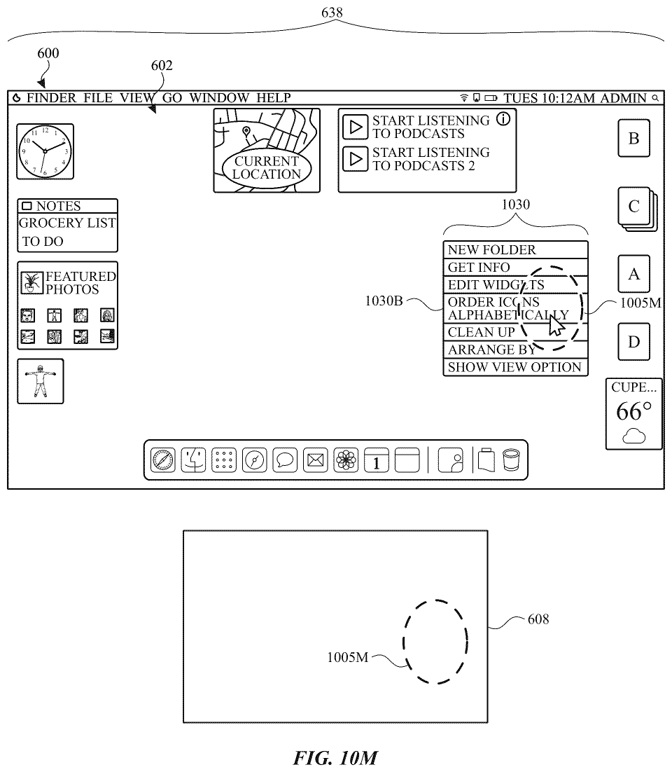

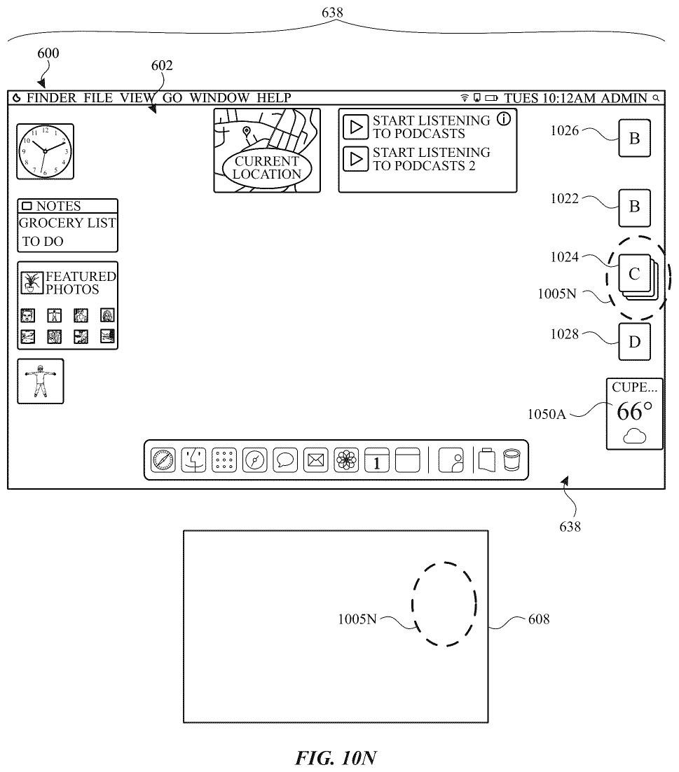

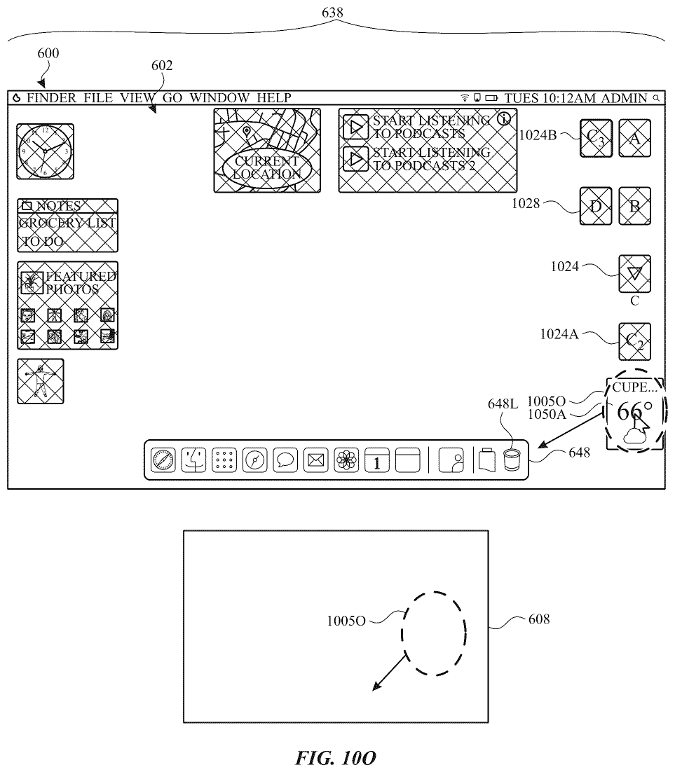

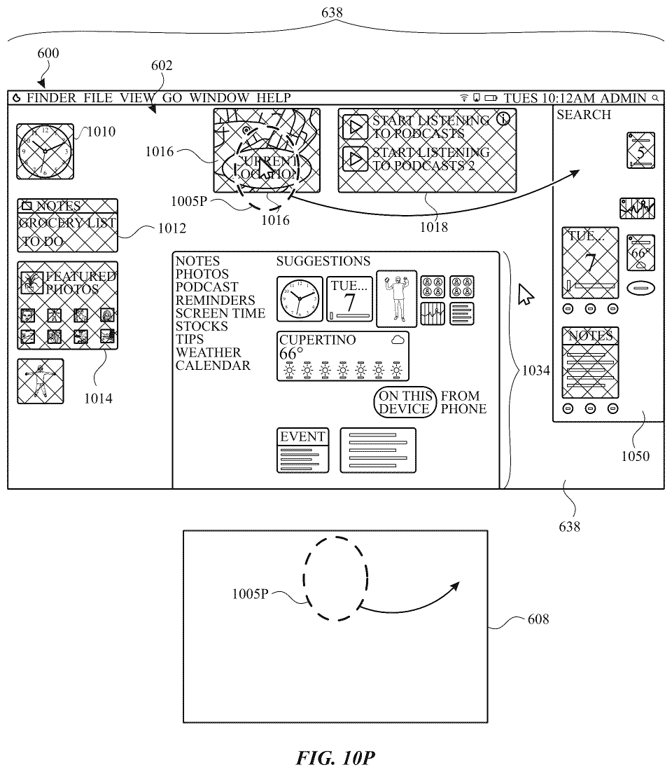

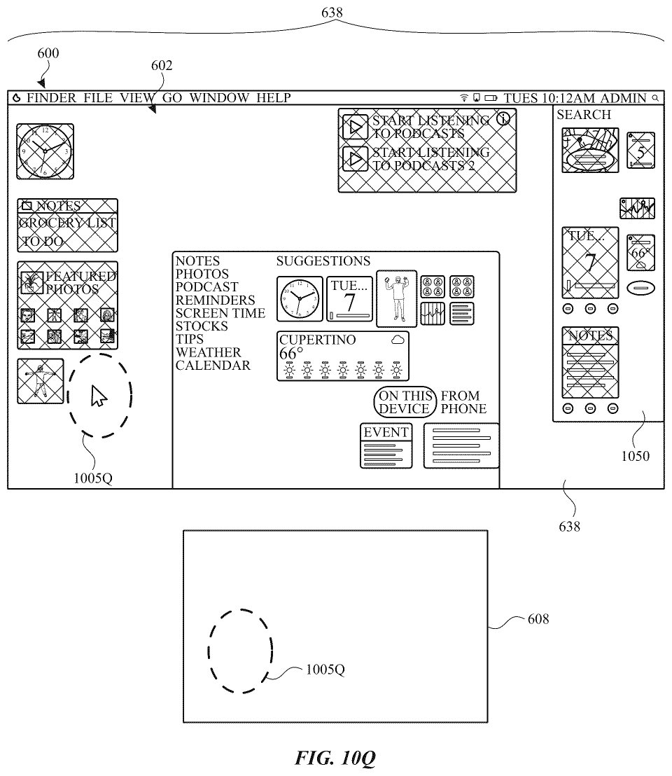

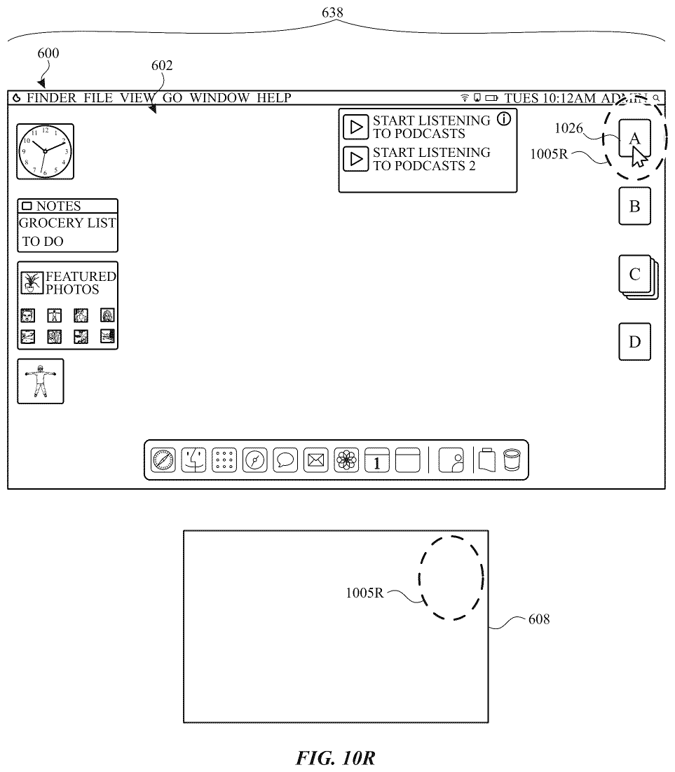

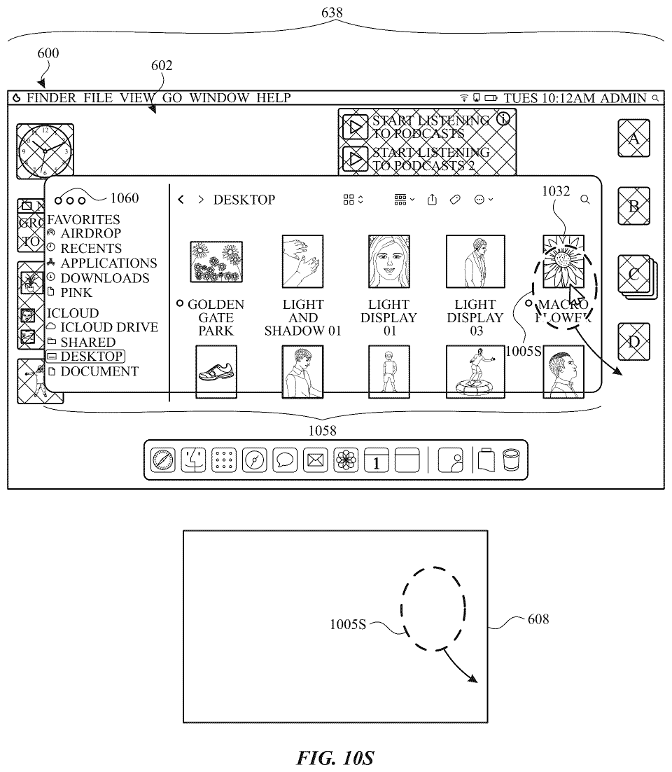

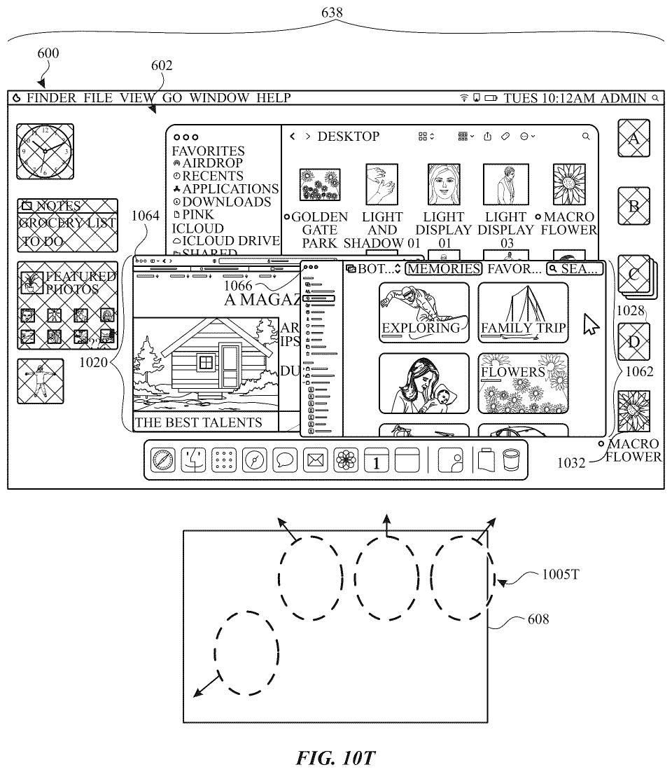

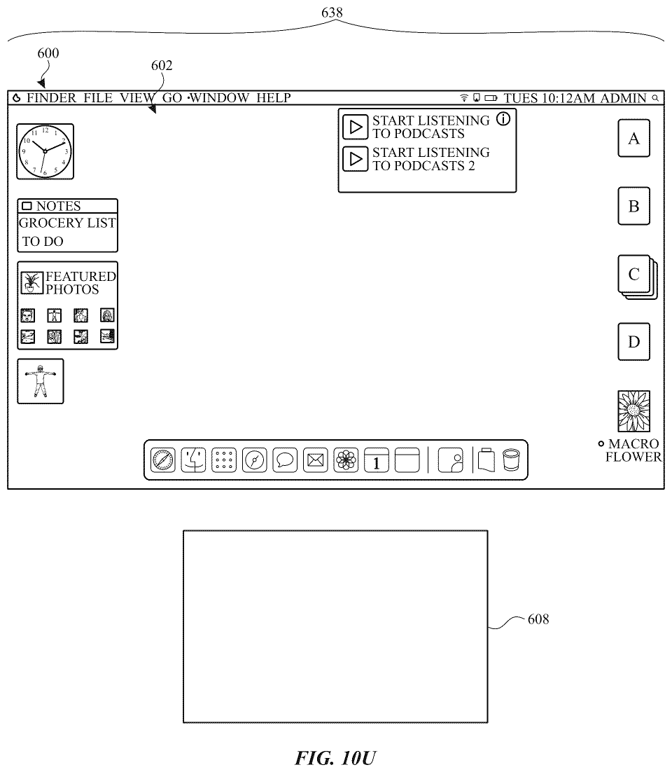

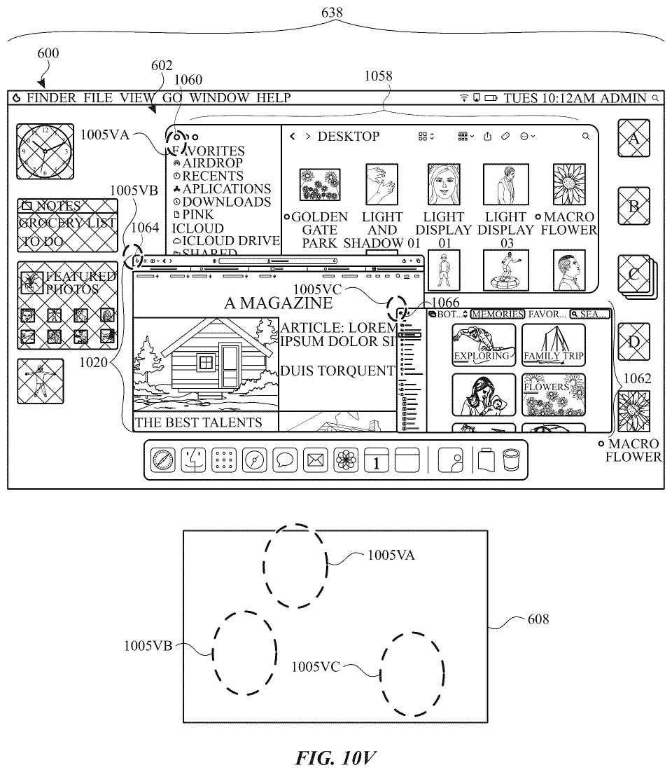

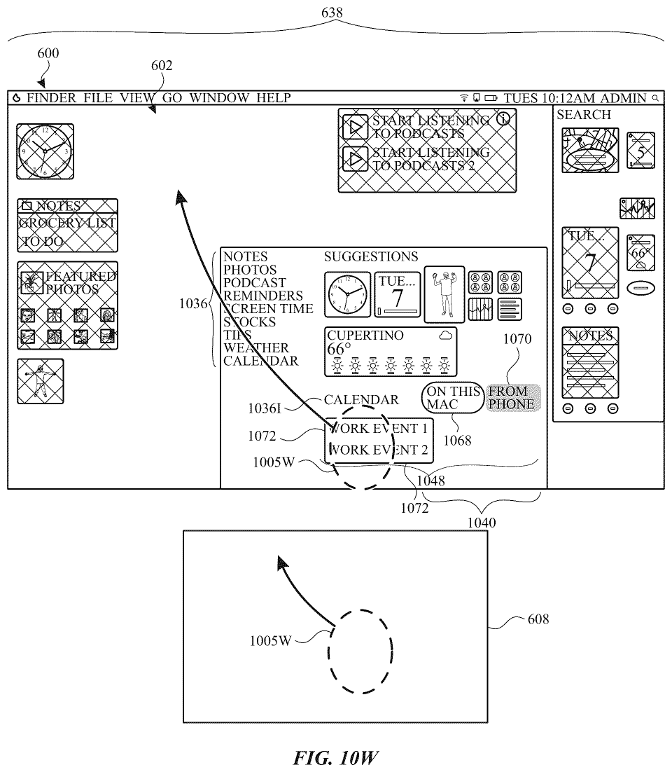

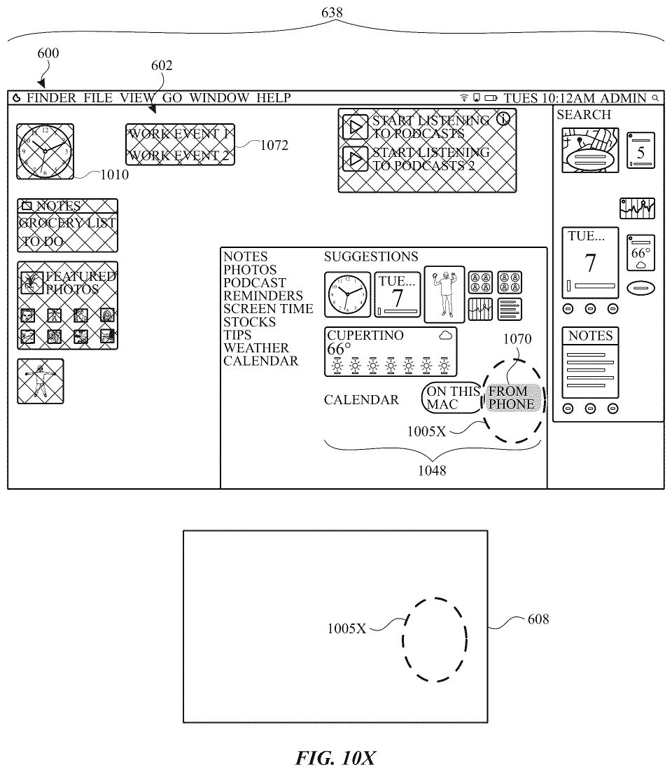

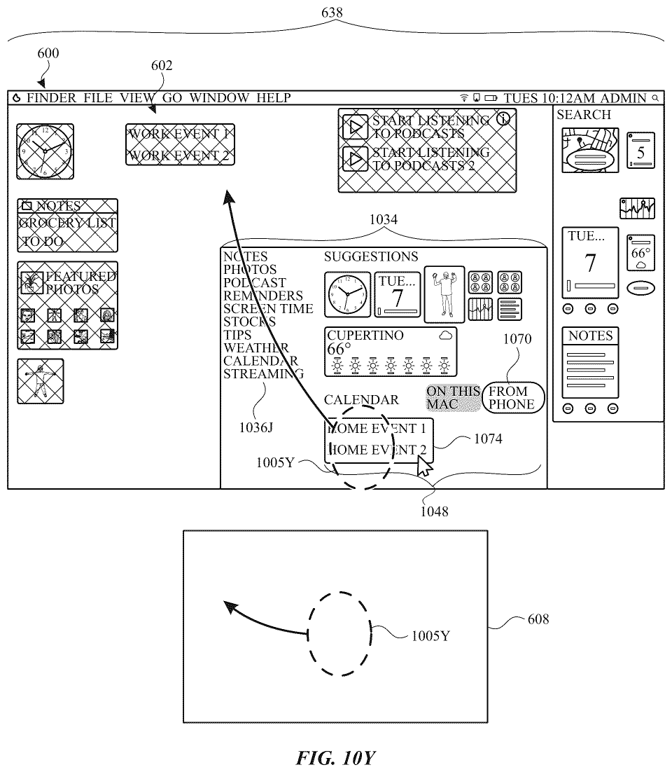

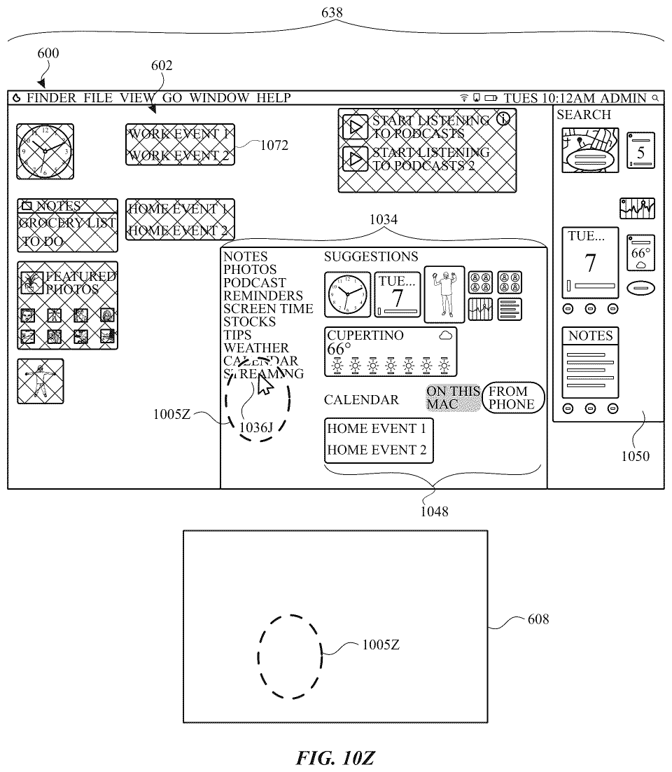

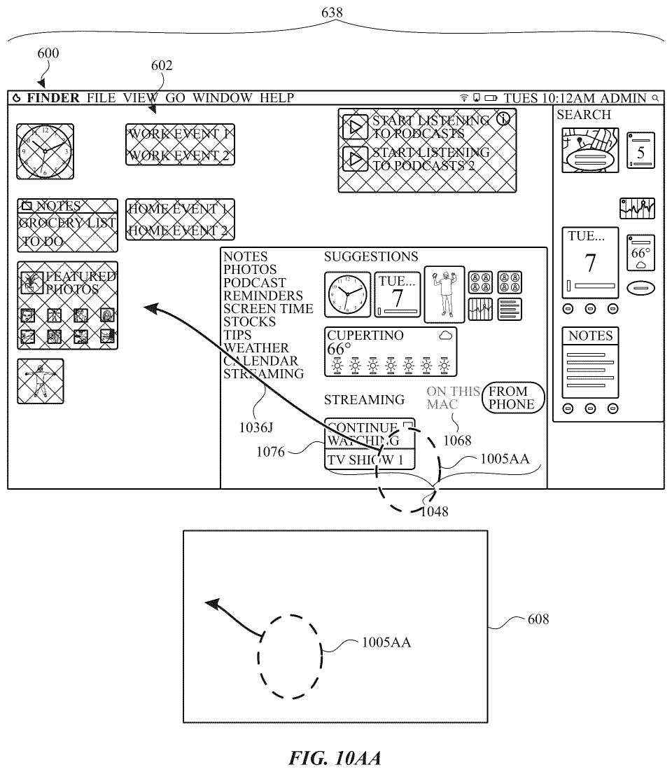

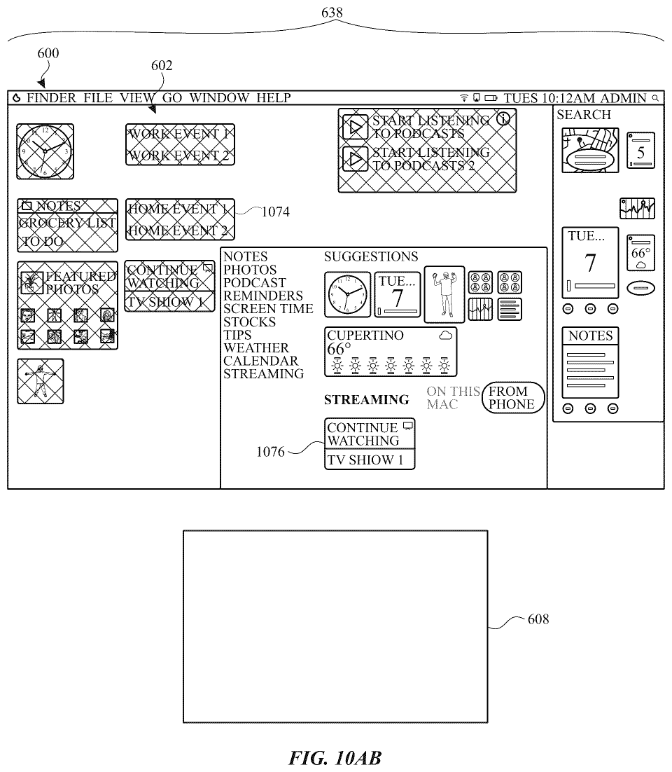

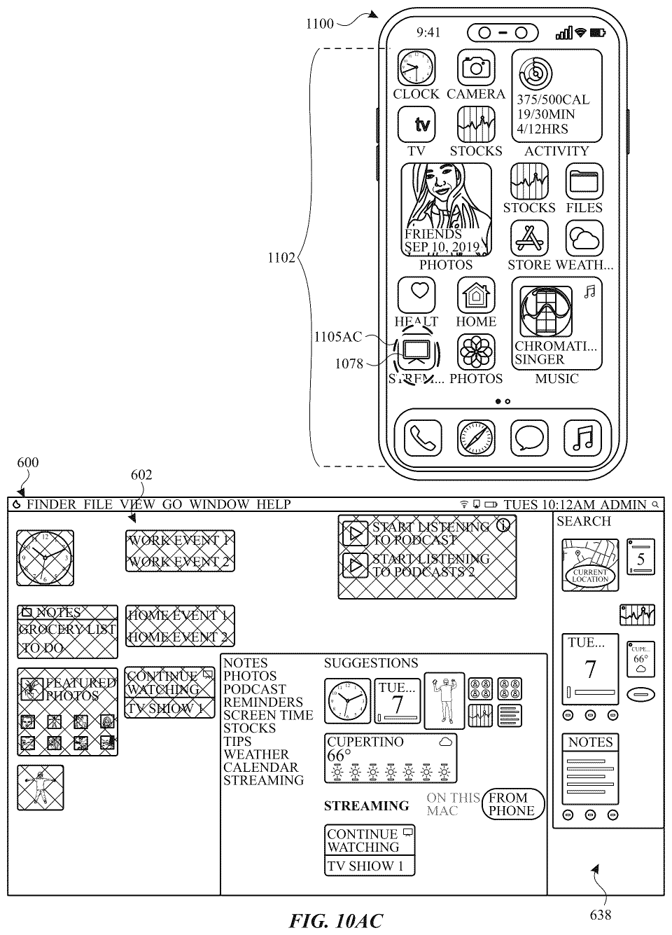

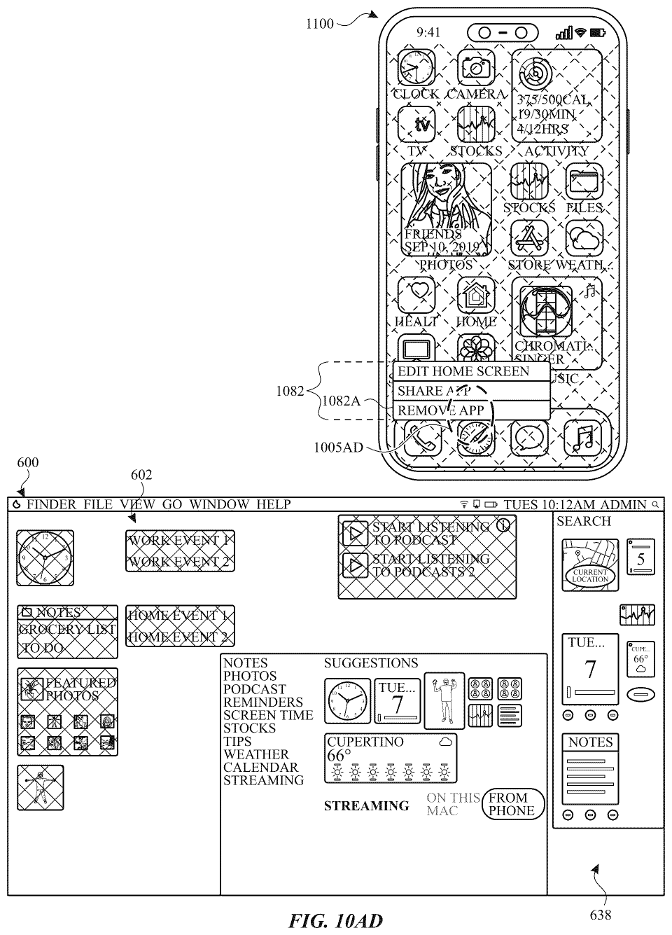

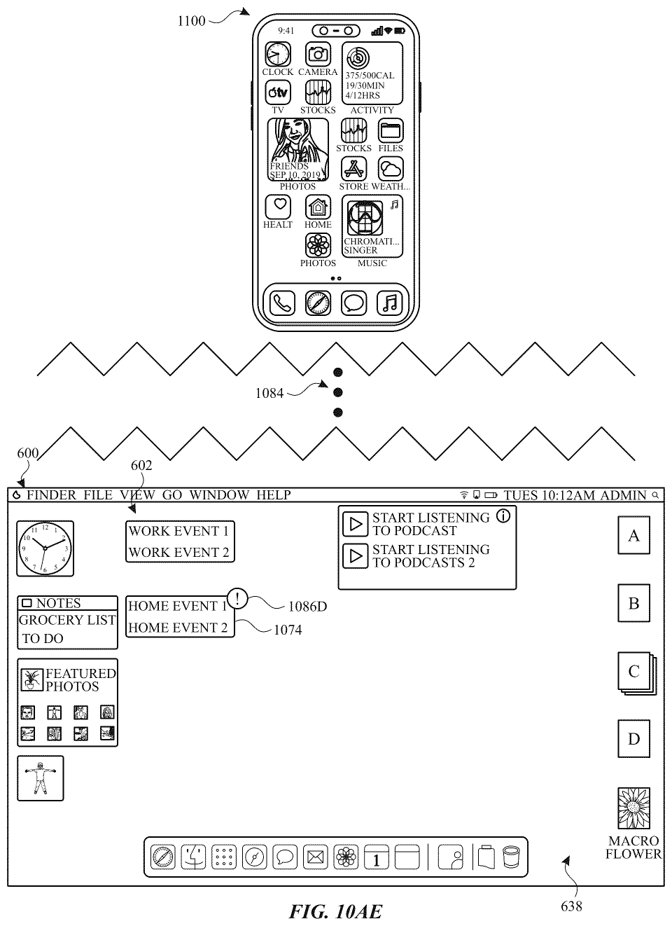

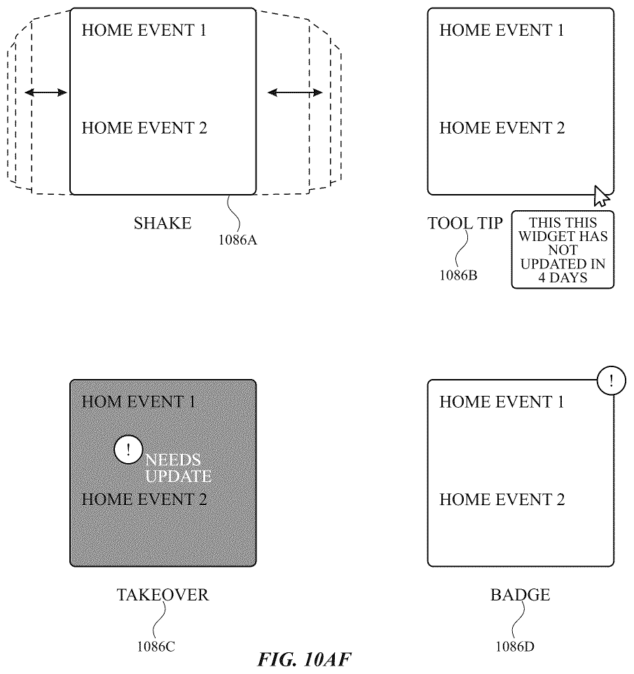

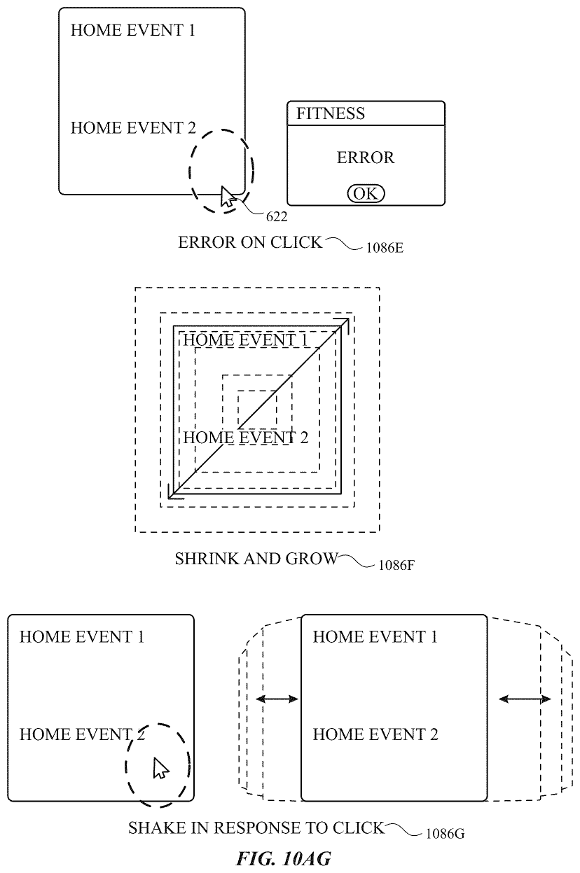

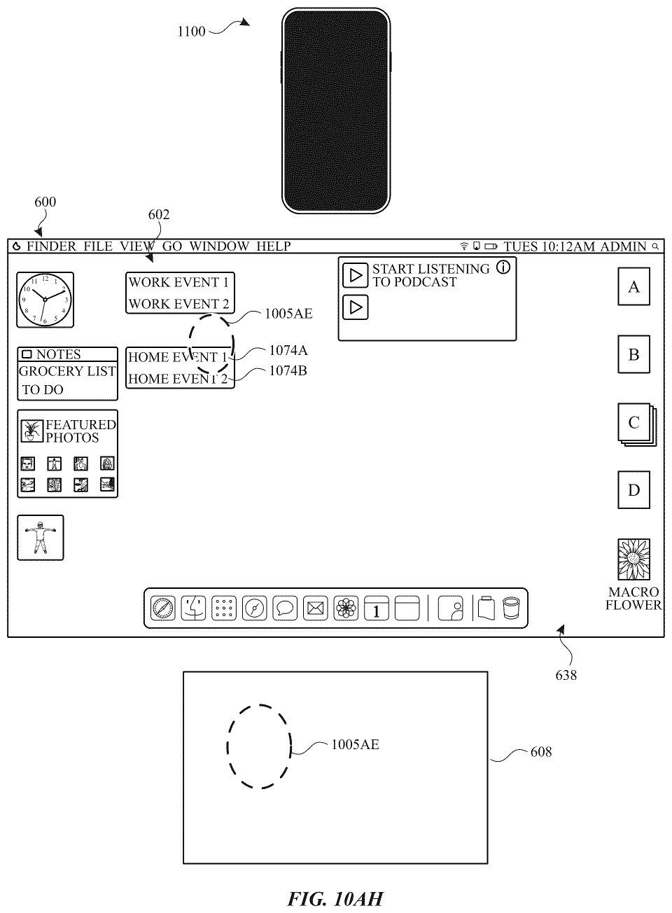

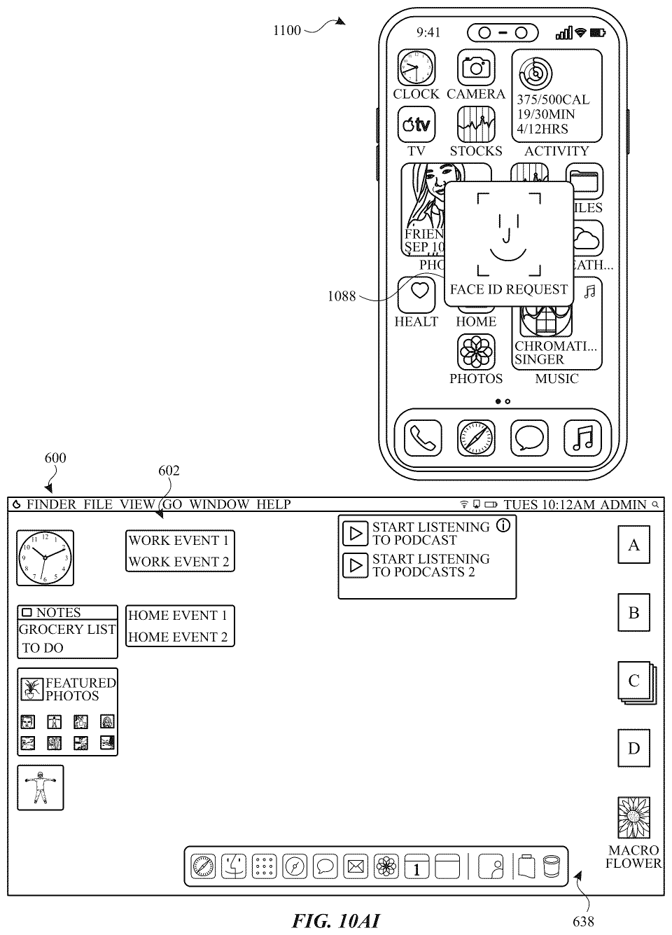

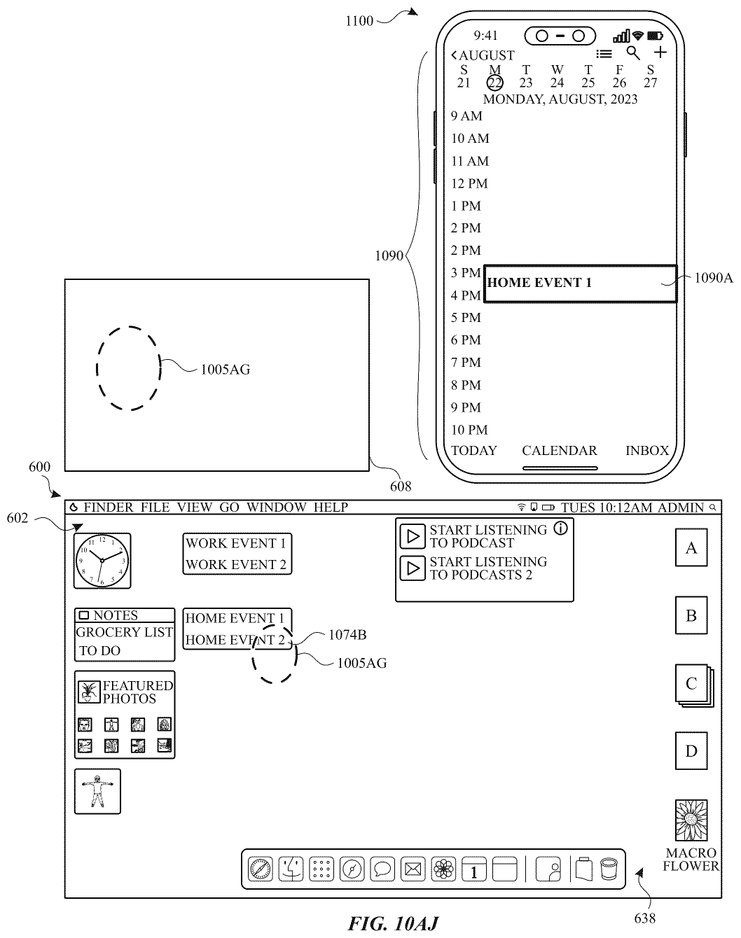

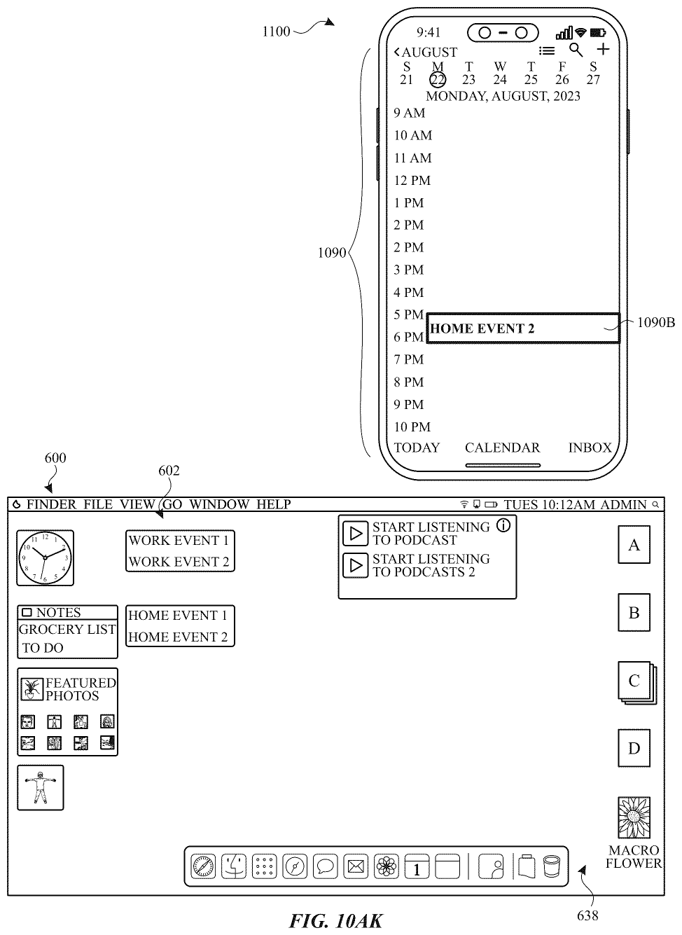

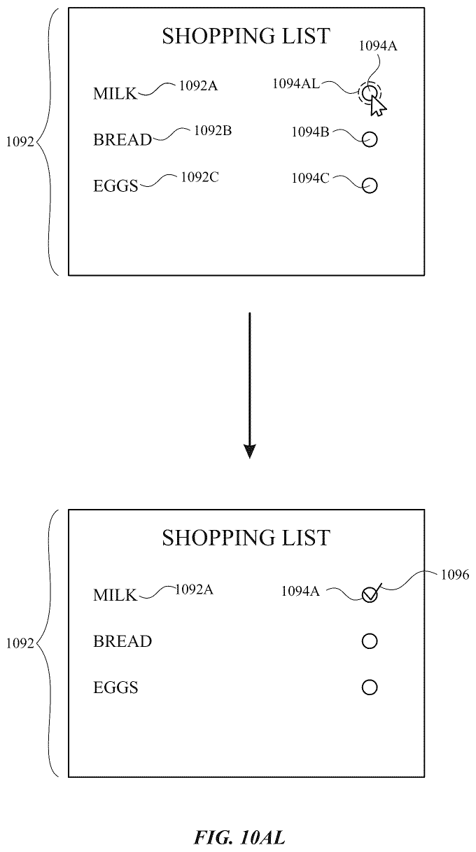

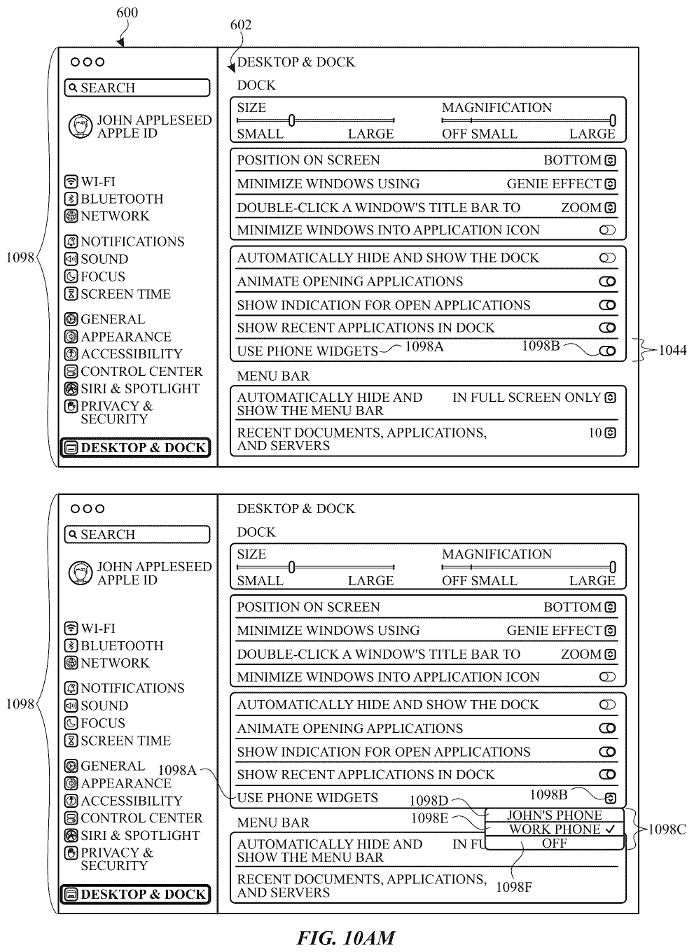

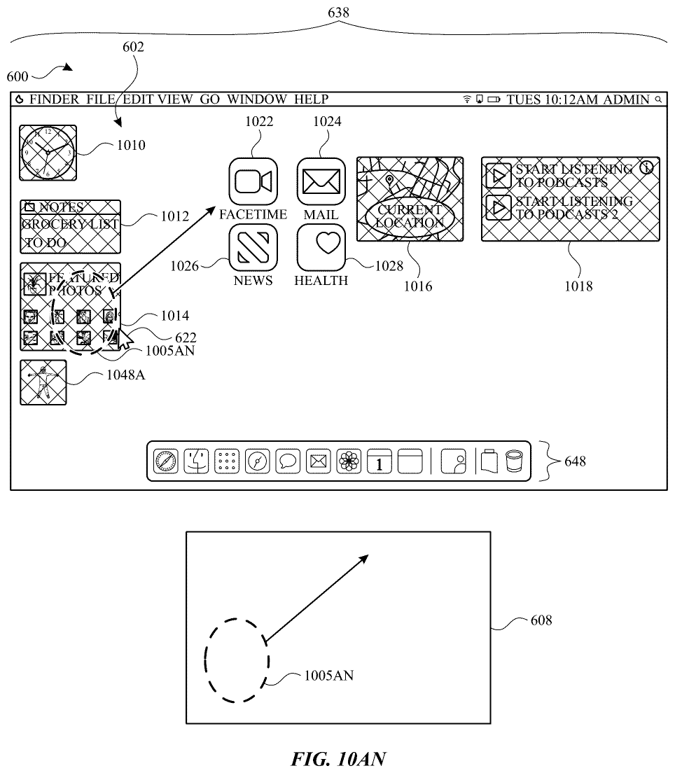

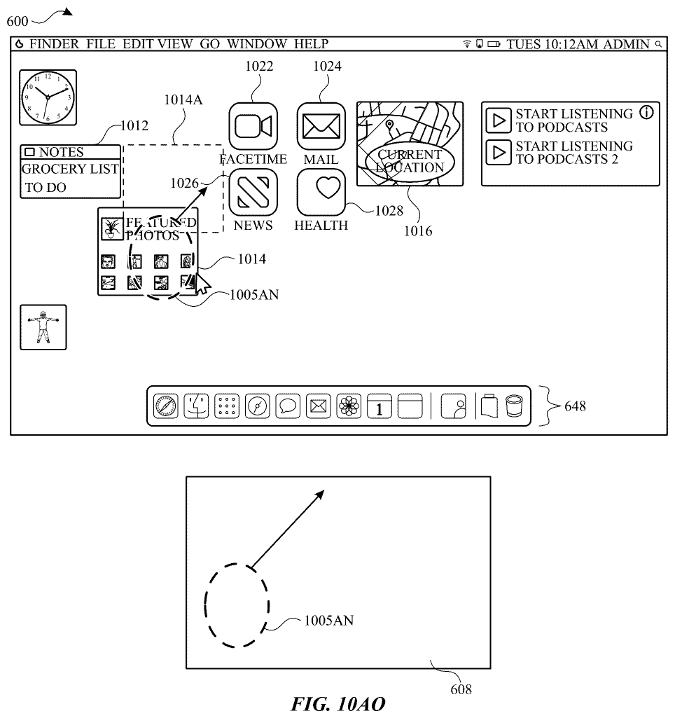

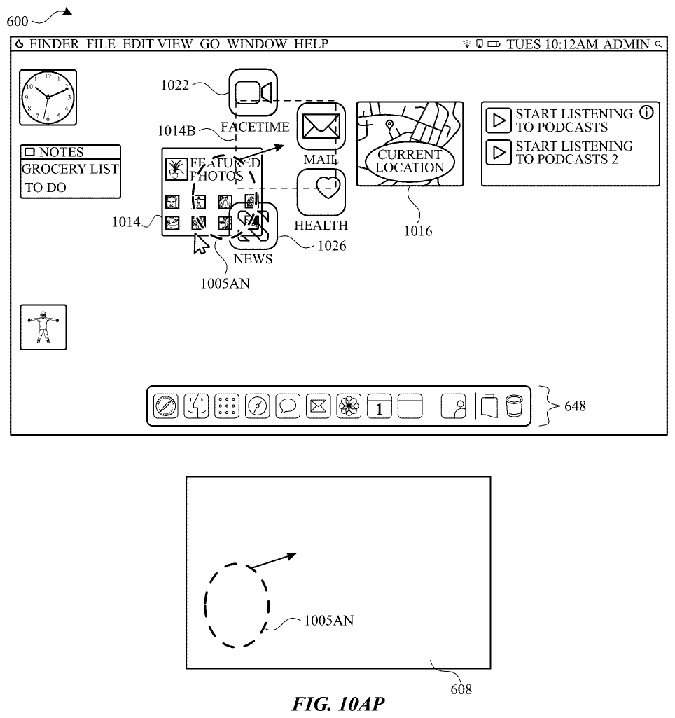

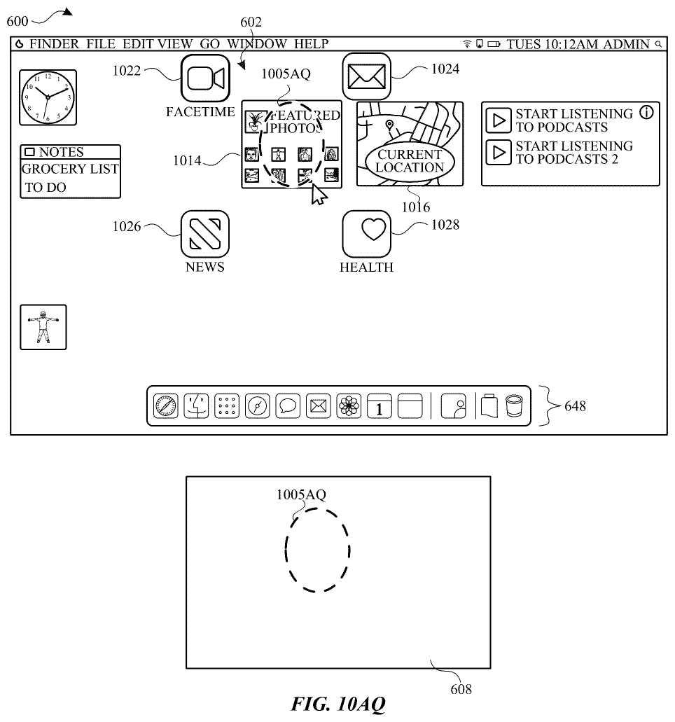

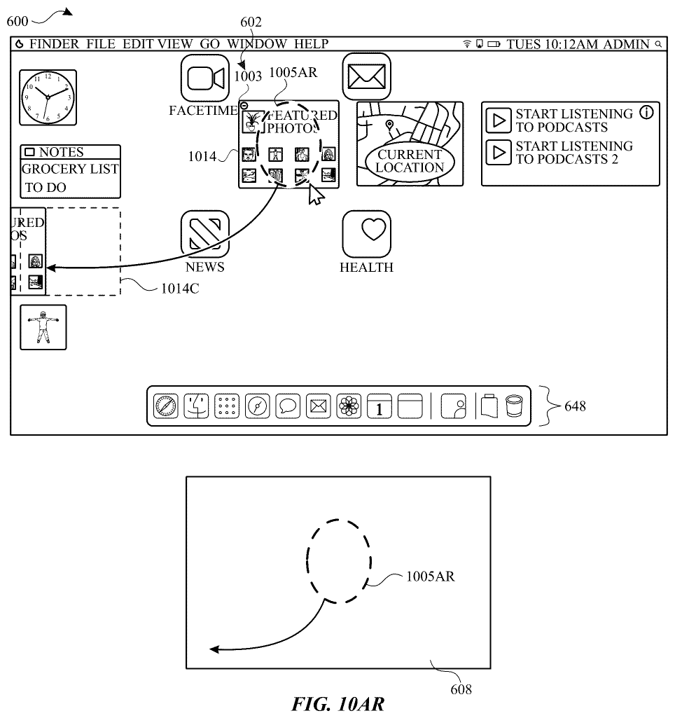

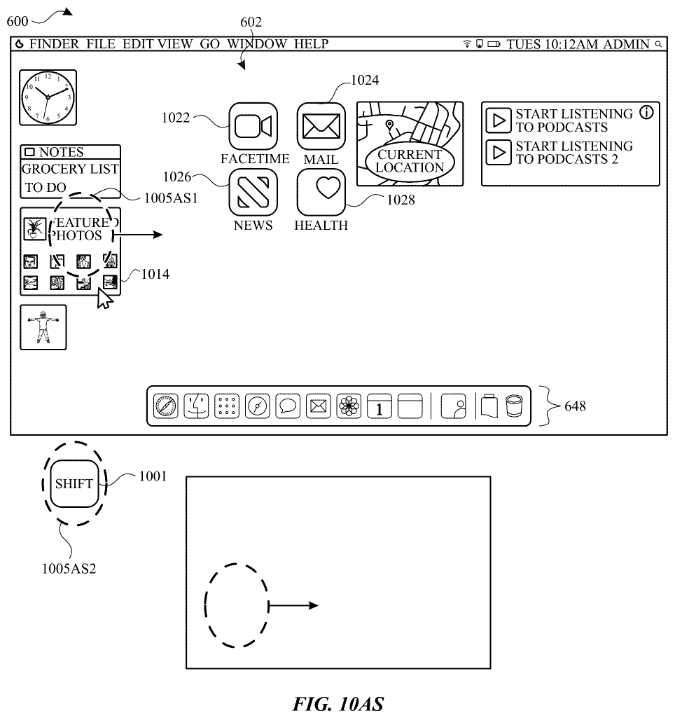

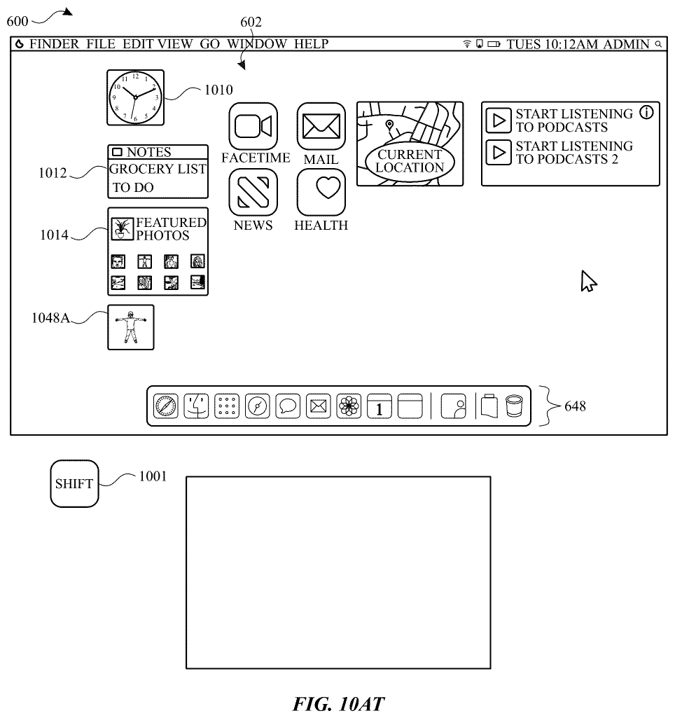

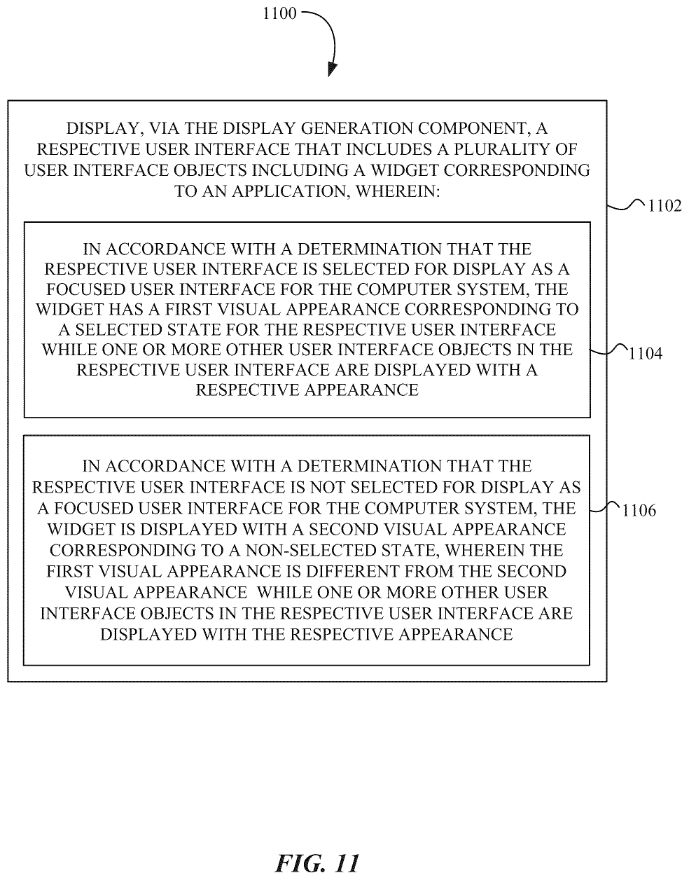

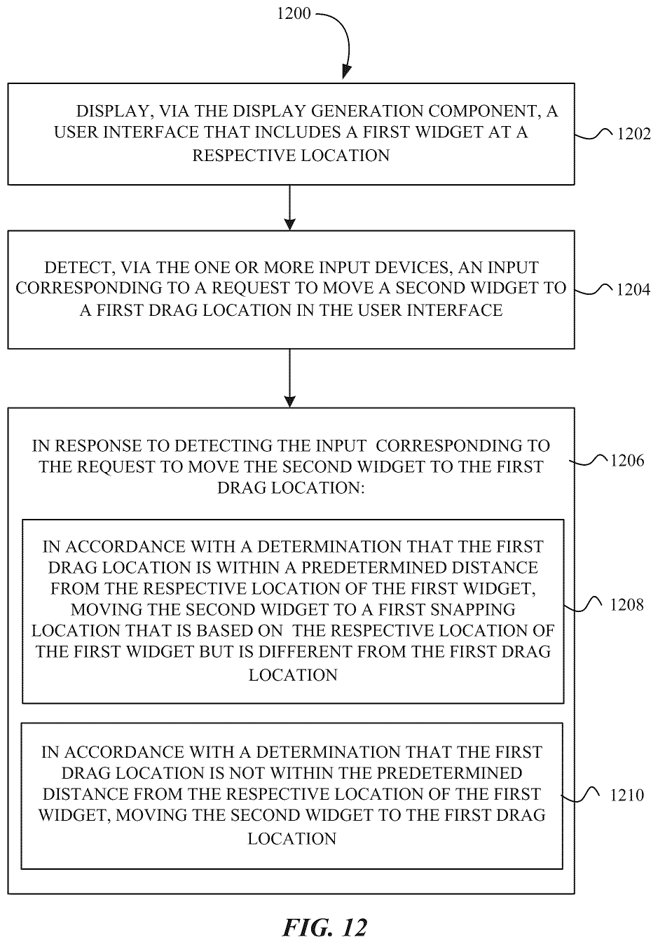

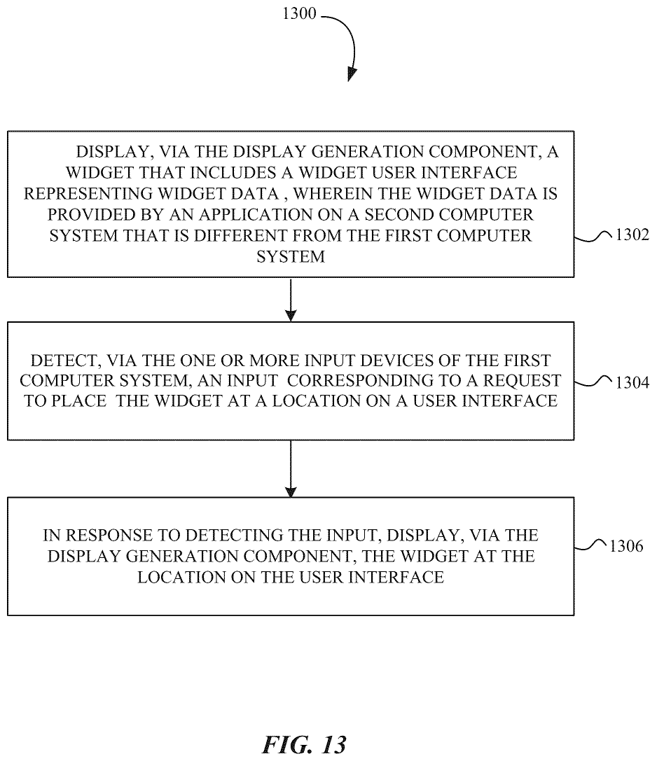

FIGS. 10A-10AT illustrate exemplary user interfaces for managing widgets in accordance with some embodiments. FIG. 11 is a flow diagram illustrating a method for displaying a widget in accordance with some embodiments. FIG. 12 is a flow diagram illustrating a method for placing a widget in accordance with some embodiments. FIG. 13 is a flow diagram illustrating a method for displaying widget information in accordance with some embodiments. The user interfaces in FIGS. 10A-10AT are used to illustrate the processes described below, including the processes in FIGS. 11-13.

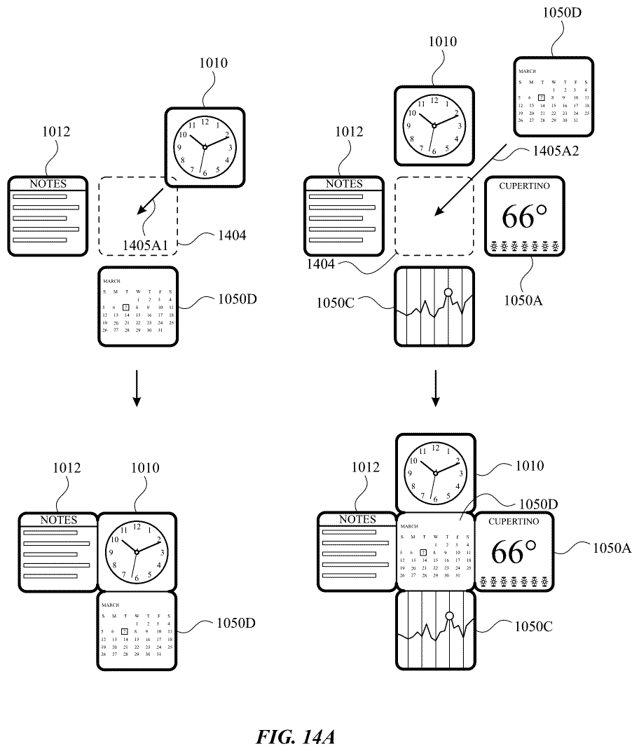

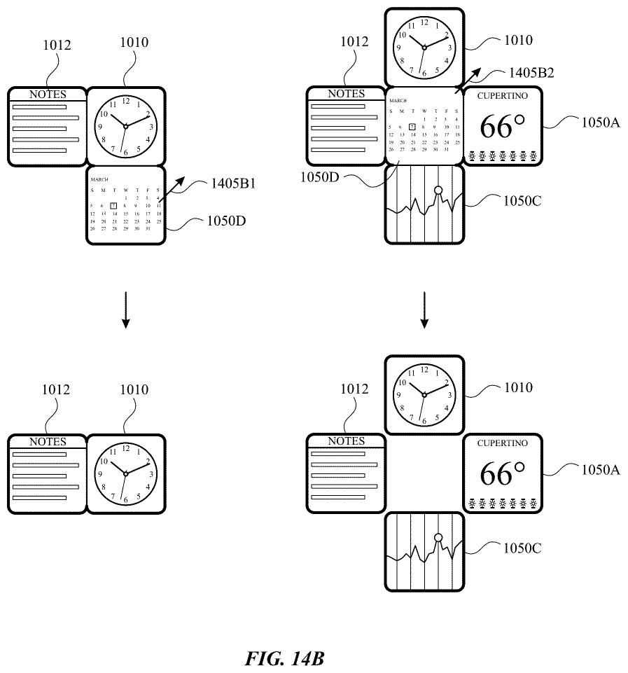

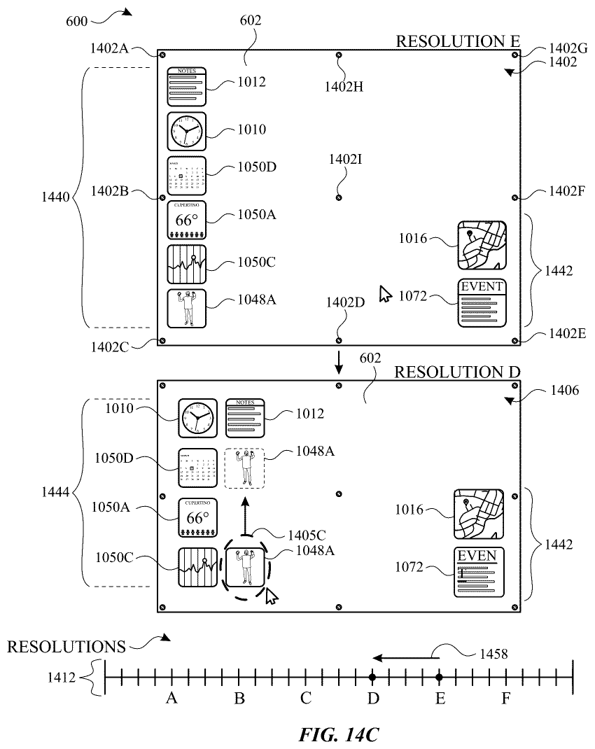

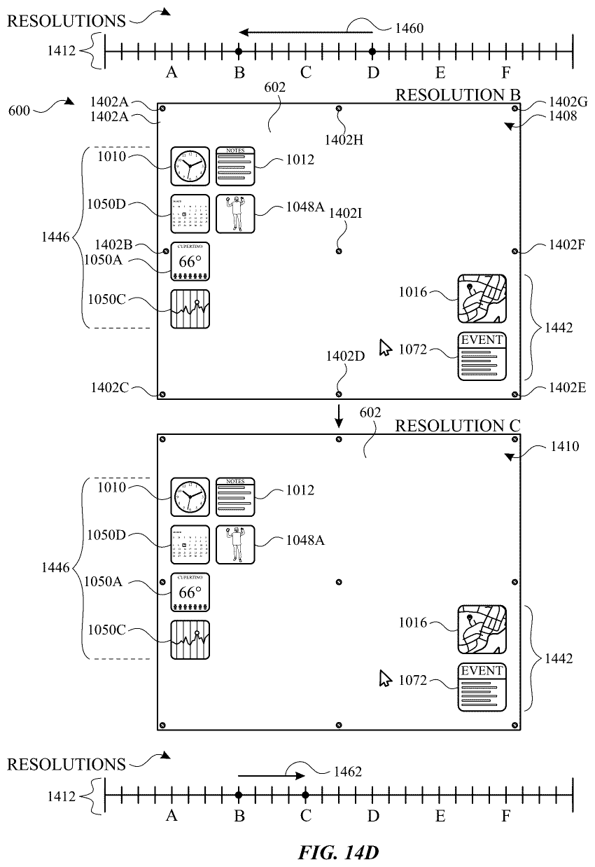

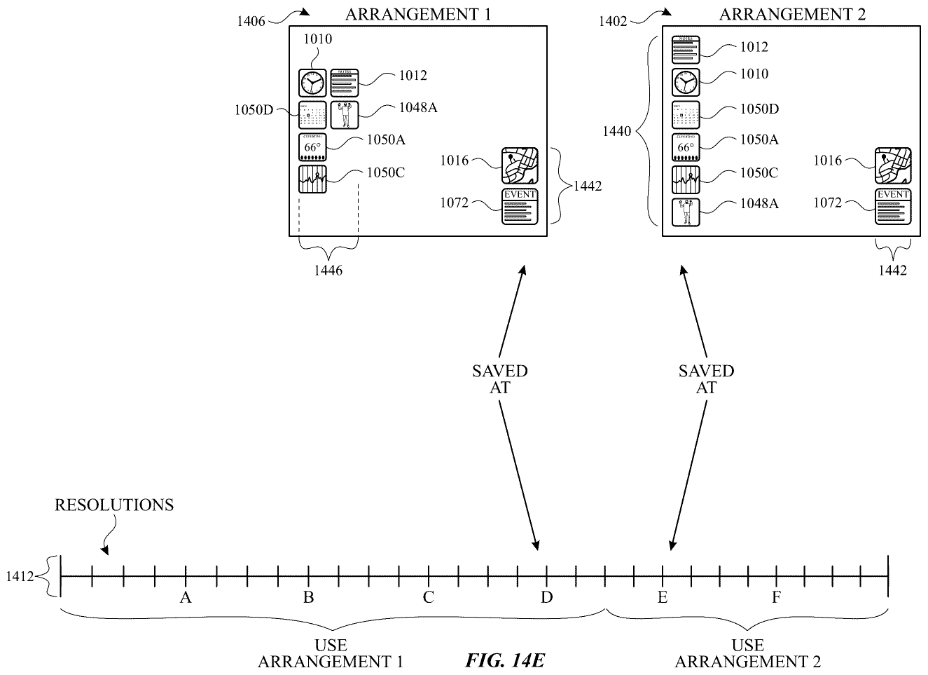

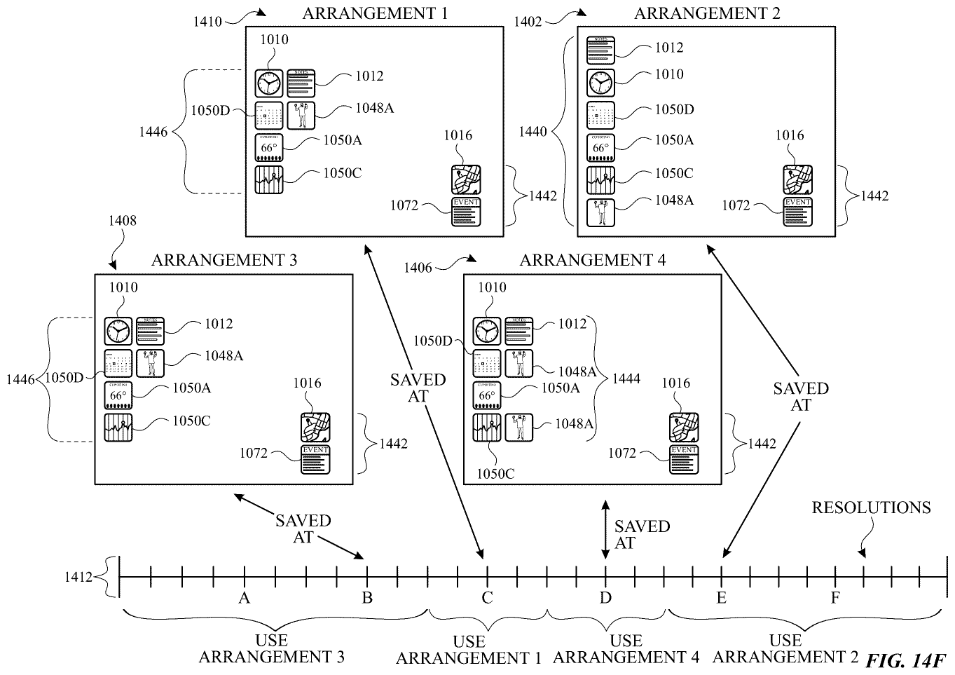

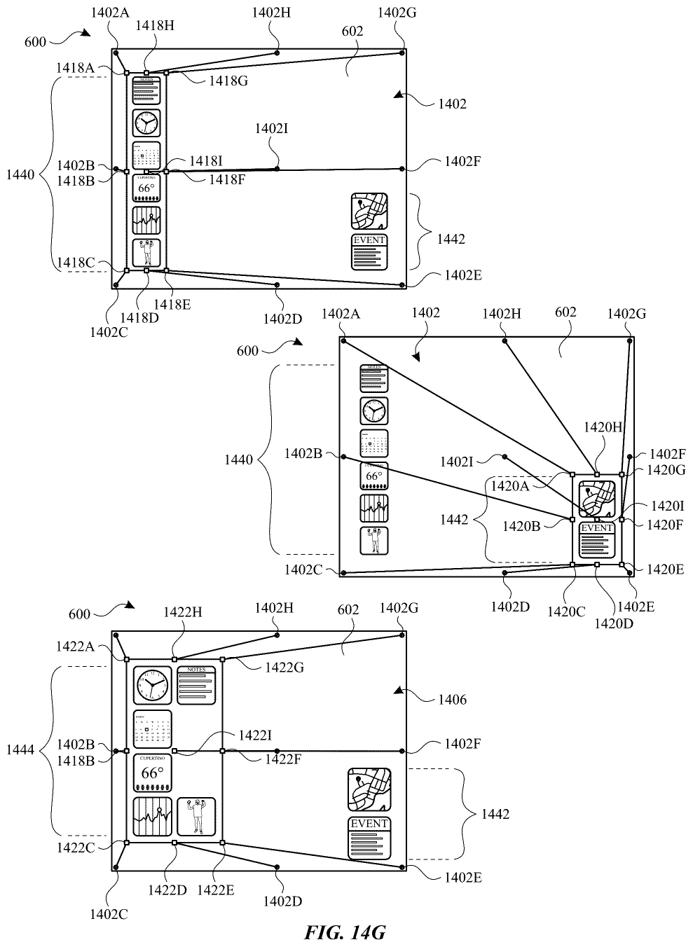

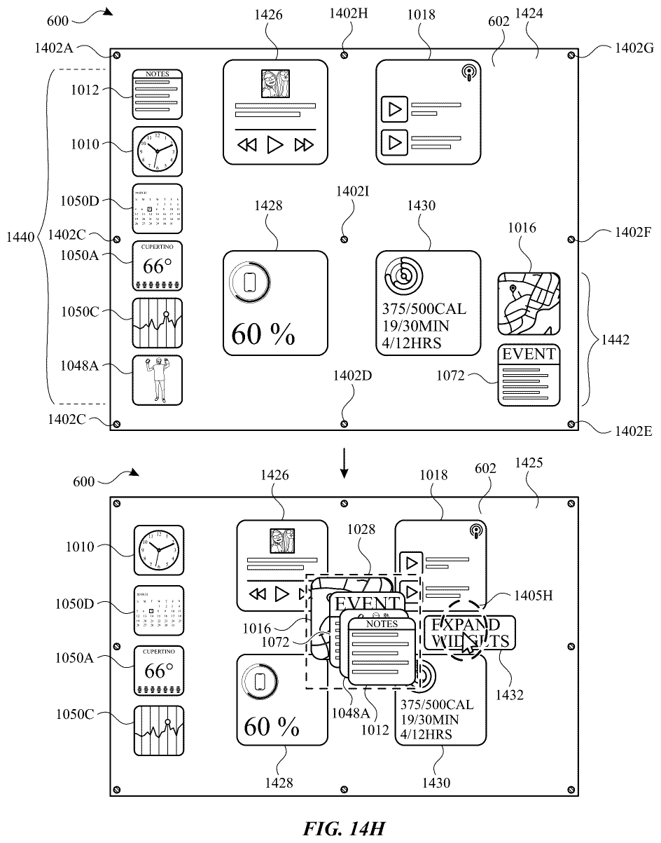

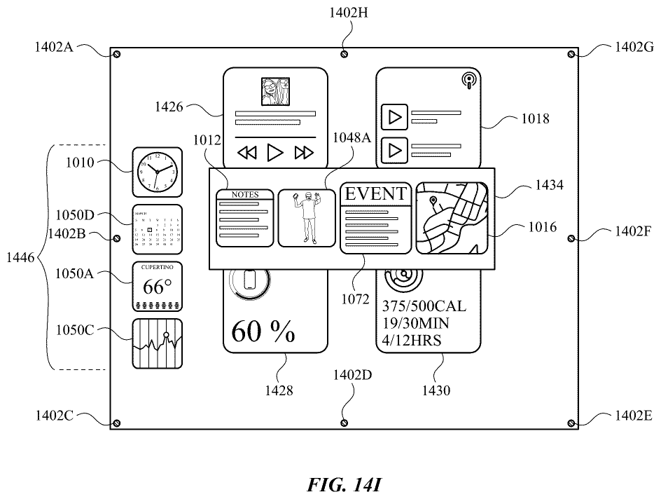

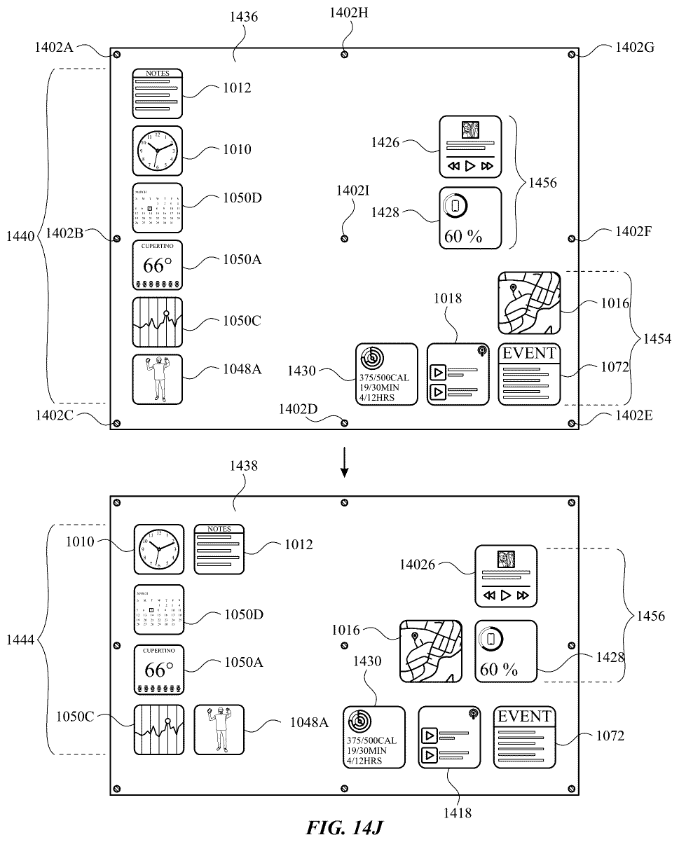

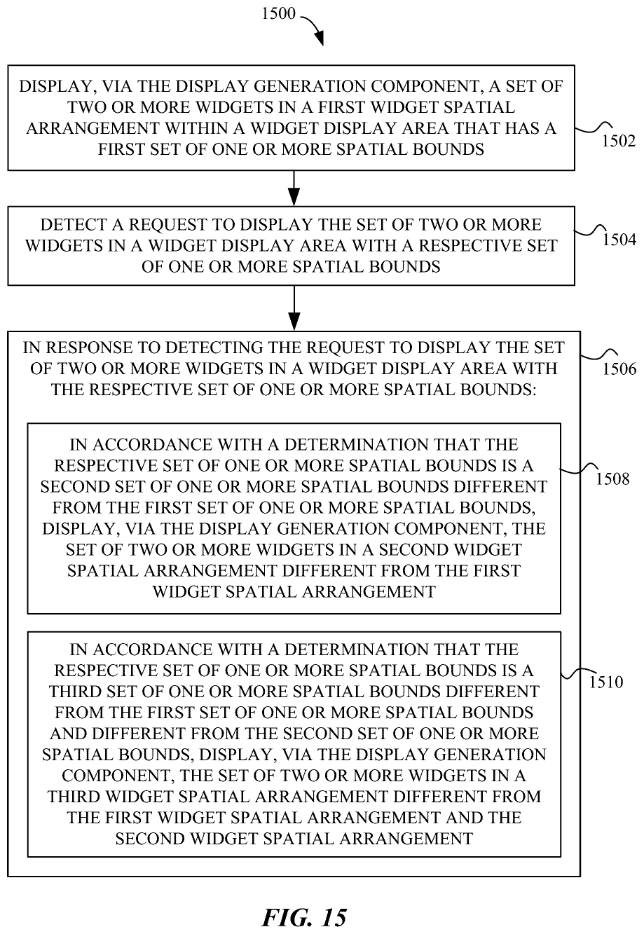

FIGS. 14A-14J illustrate exemplary user interfaces for managing widgets in accordance with some embodiments. FIG. 15 is a flow diagram illustrating a method for arranging widgets with respect to sets of one or more spatial bounds in accordance with some embodiments. The user interfaces in FIGS. 14A-14J are used to illustrate the processes described below, including the processes in FIG. 15.

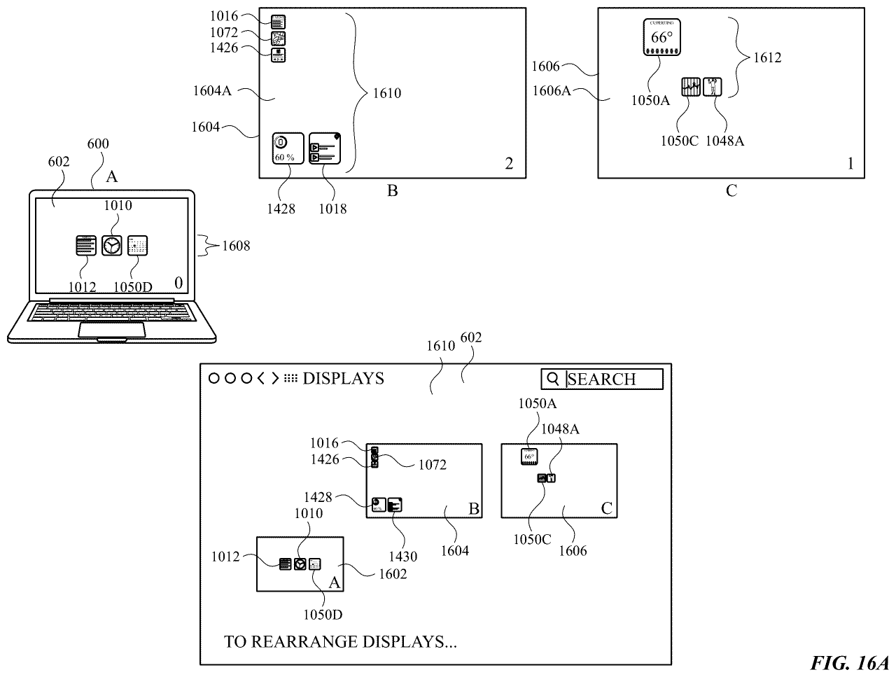

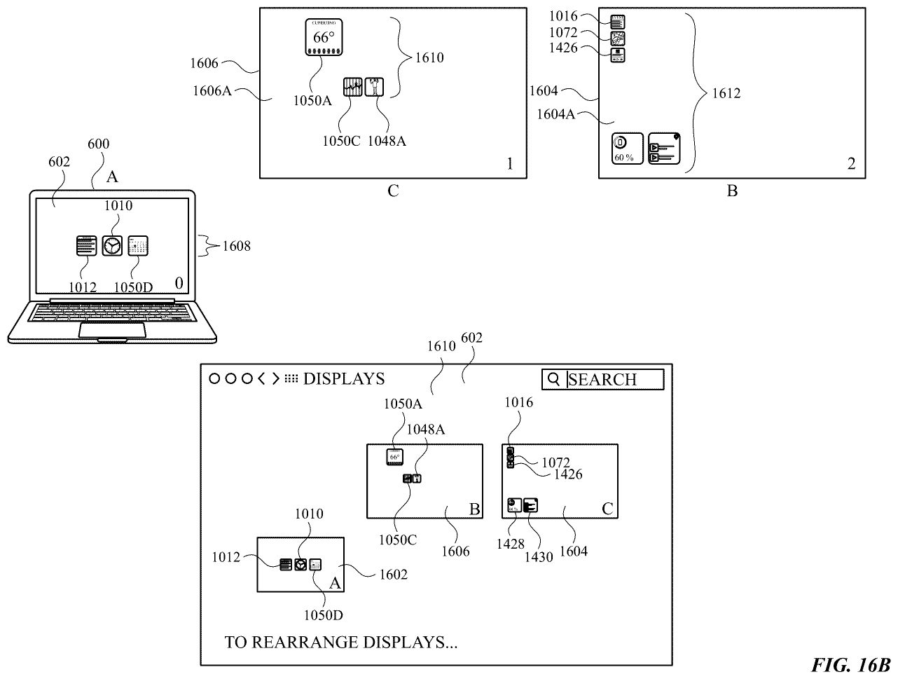

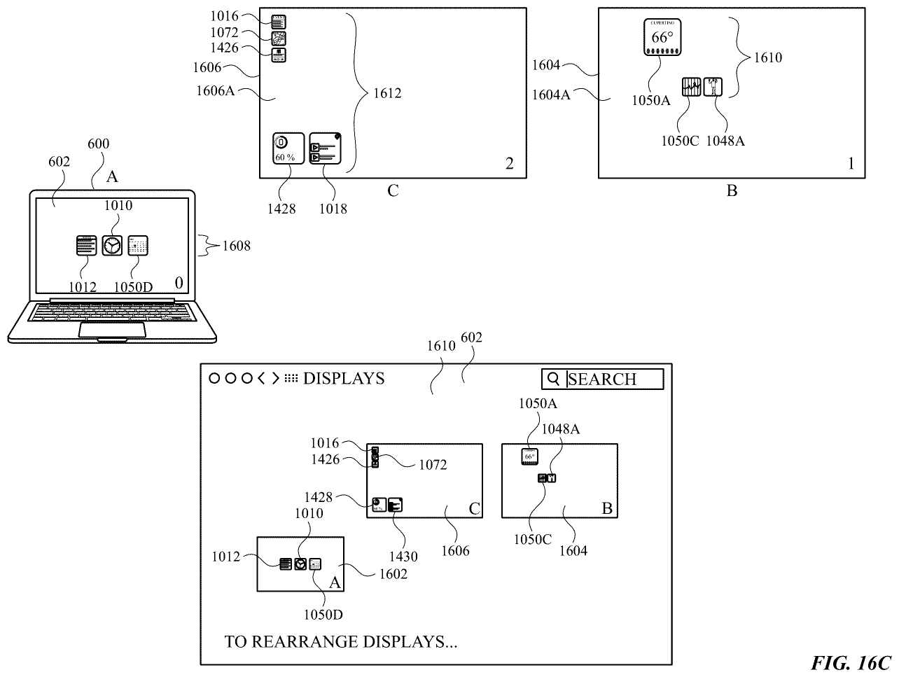

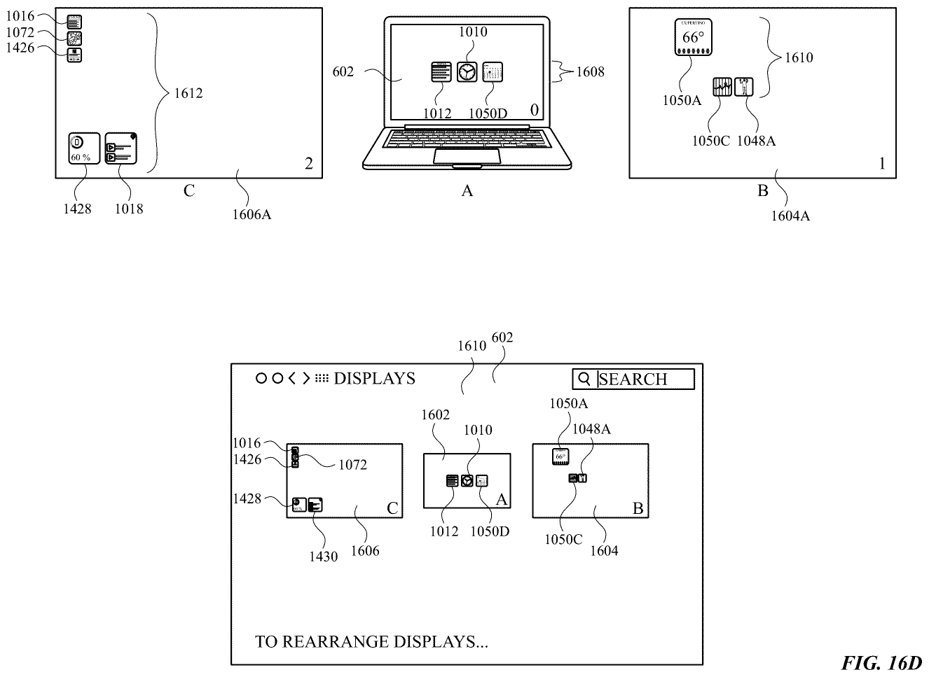

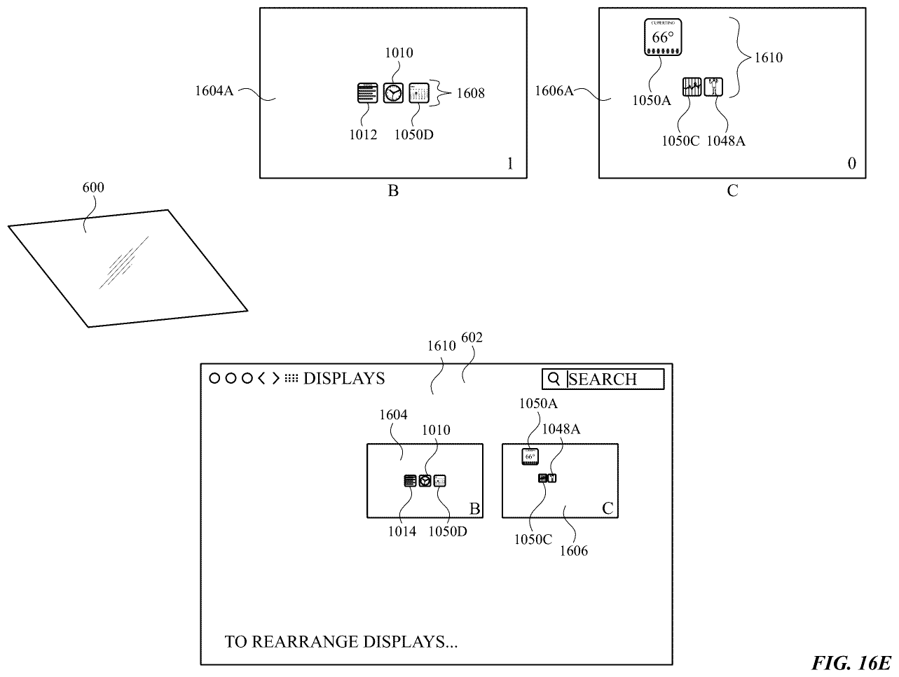

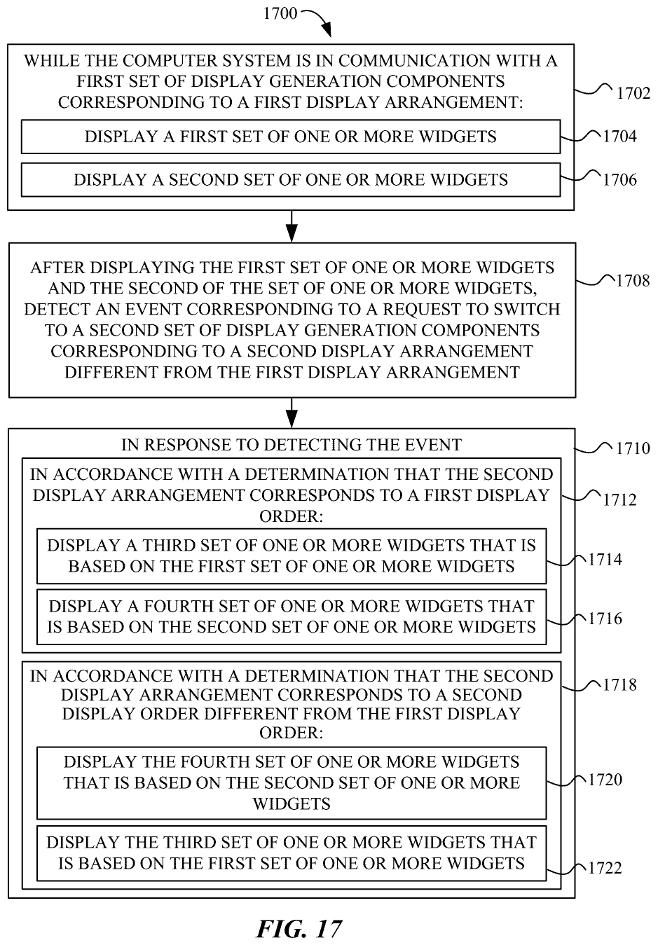

FIGS. 16A-16E illustrate exemplary user interfaces for managing widgets in accordance with some embodiments. FIG. 17 is a flow diagram illustrating a method for arranging widgets with respect to sets of display generation components, in accordance with some embodiments. The user interfaces in FIGS. 16A-16E are used to illustrate the processes described below, including the processes in FIG. 17.

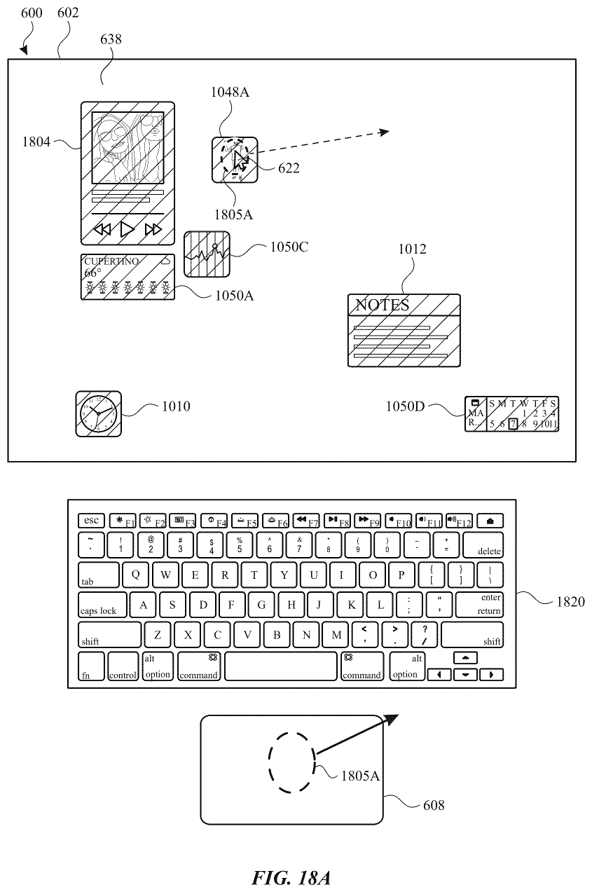

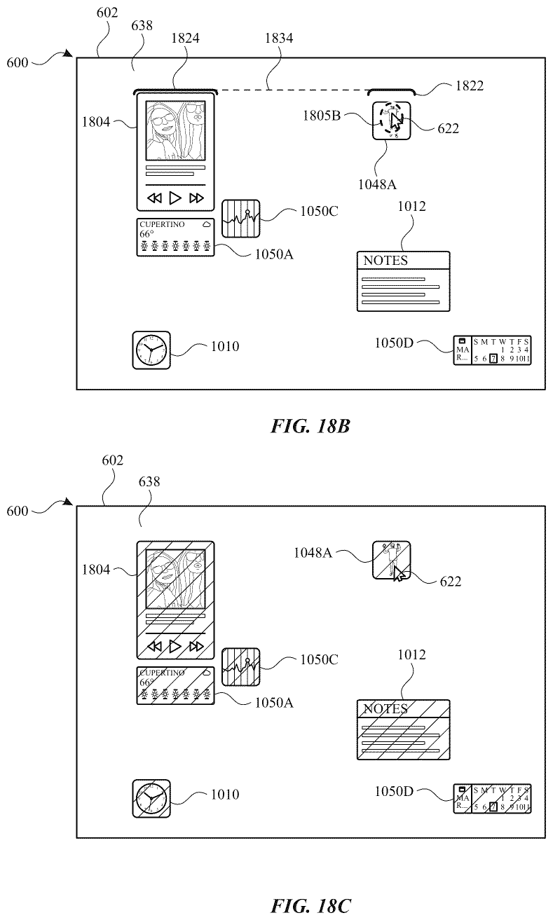

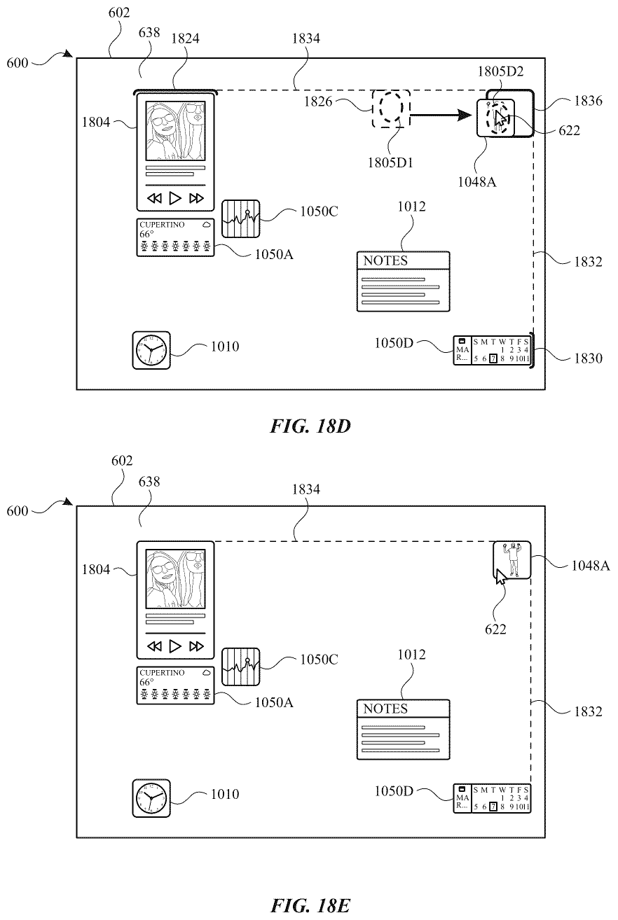

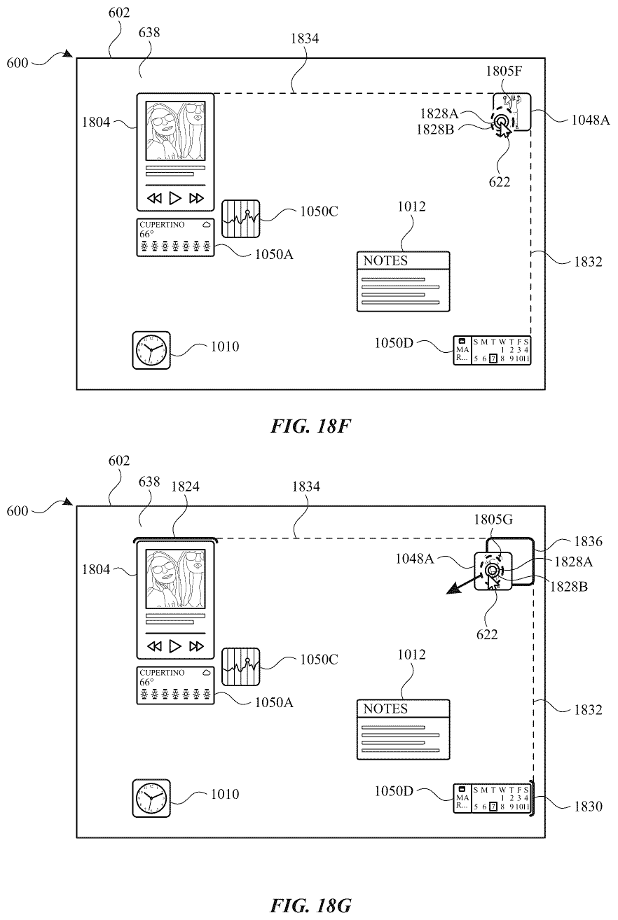

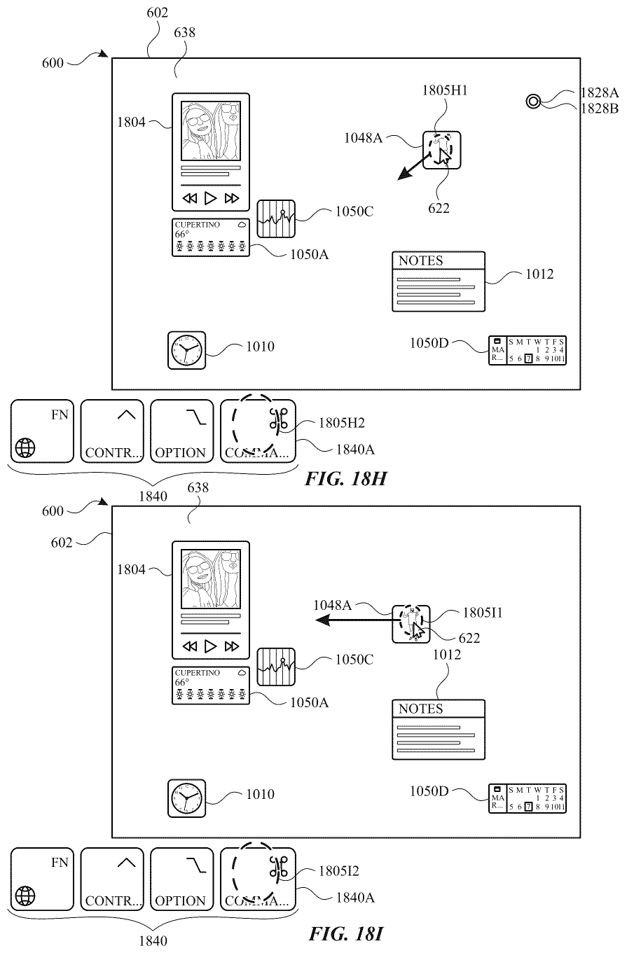

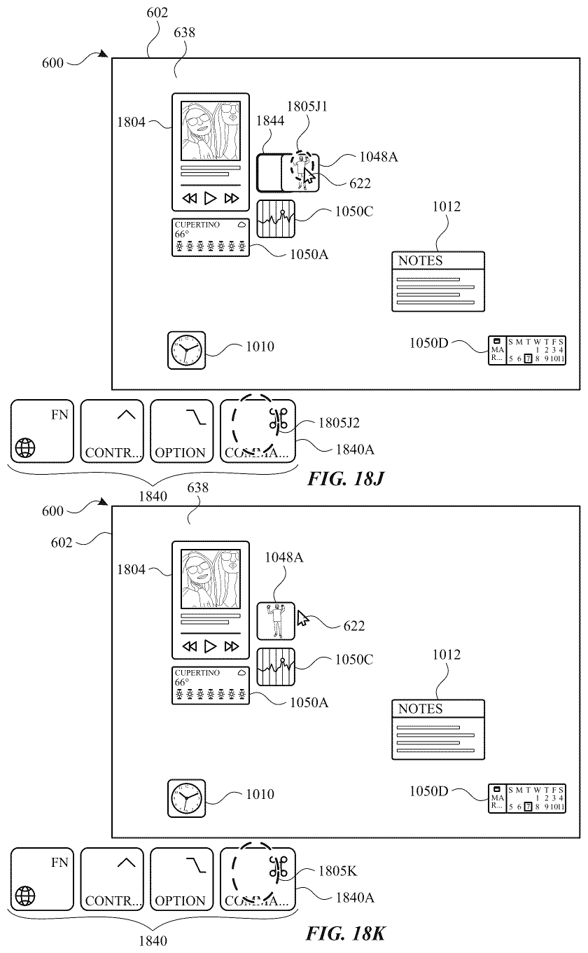

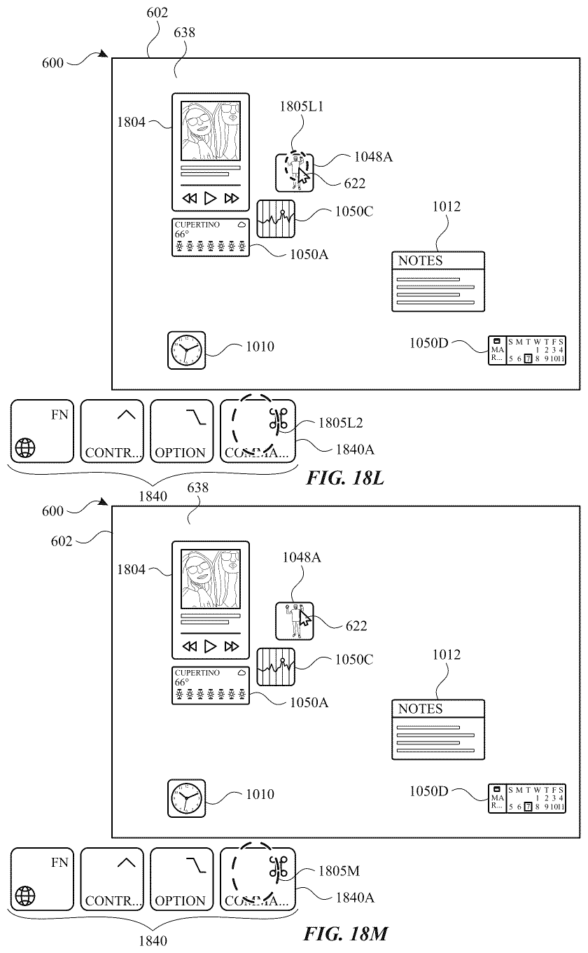

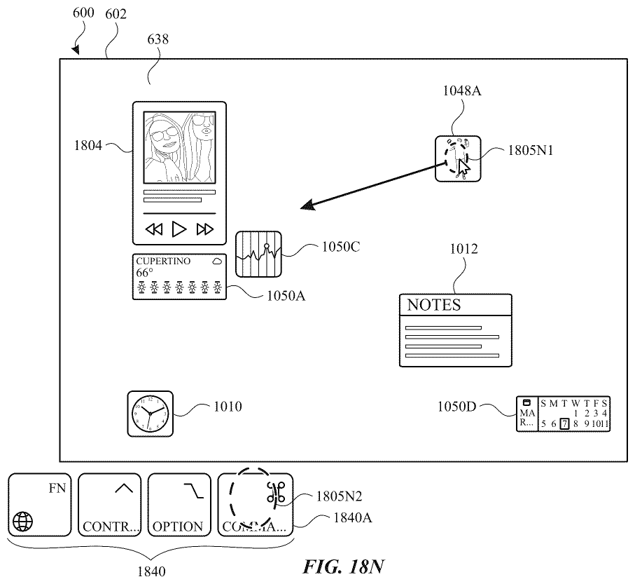

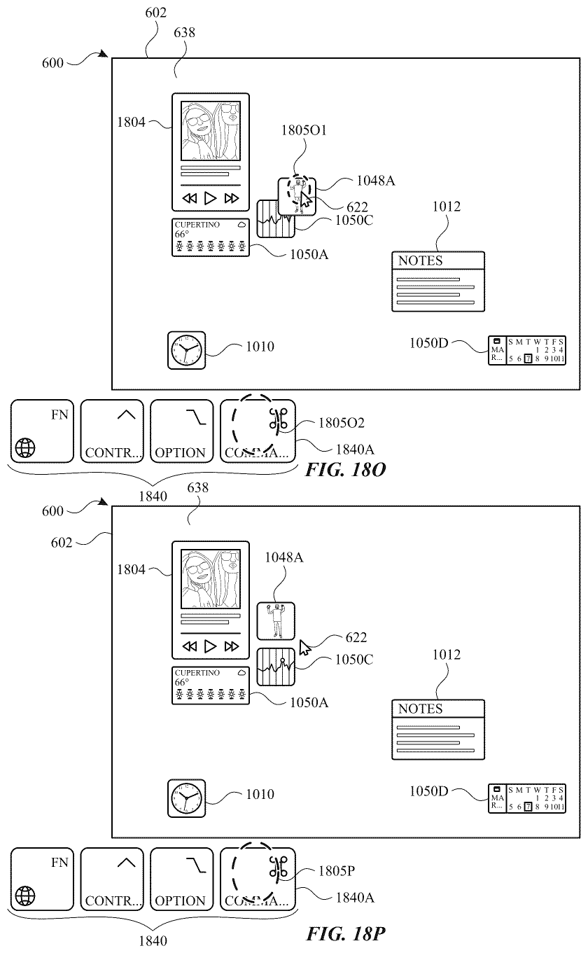

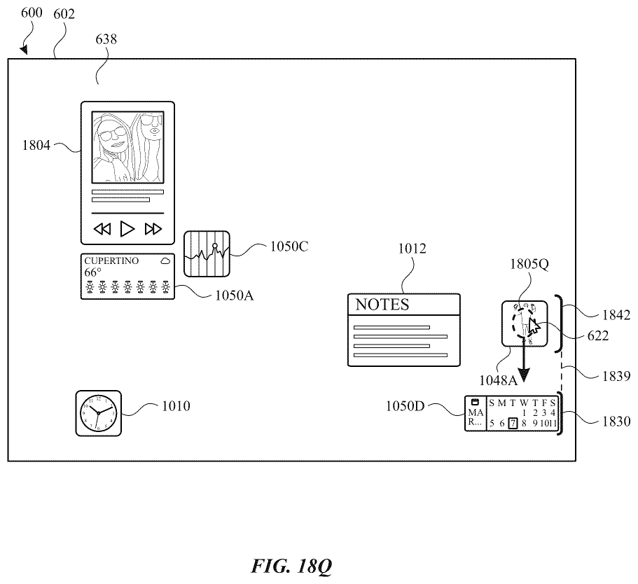

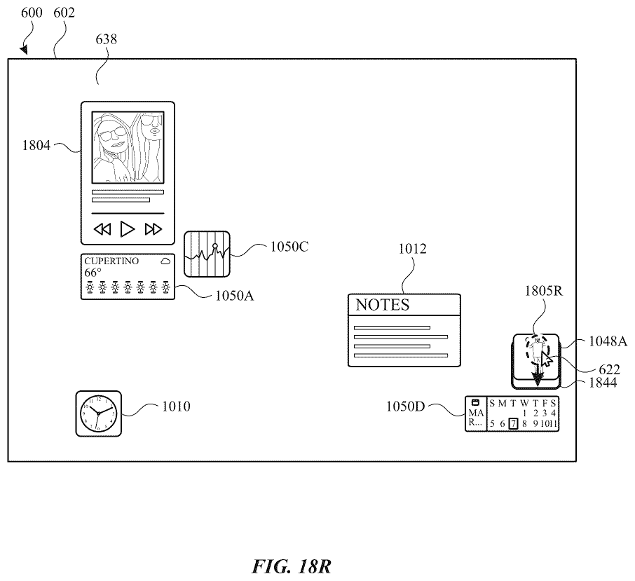

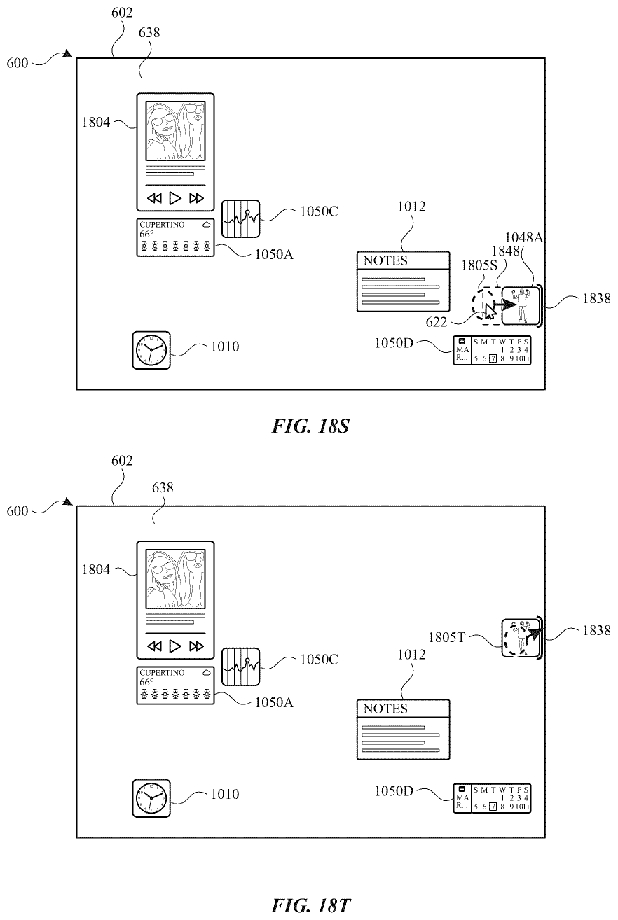

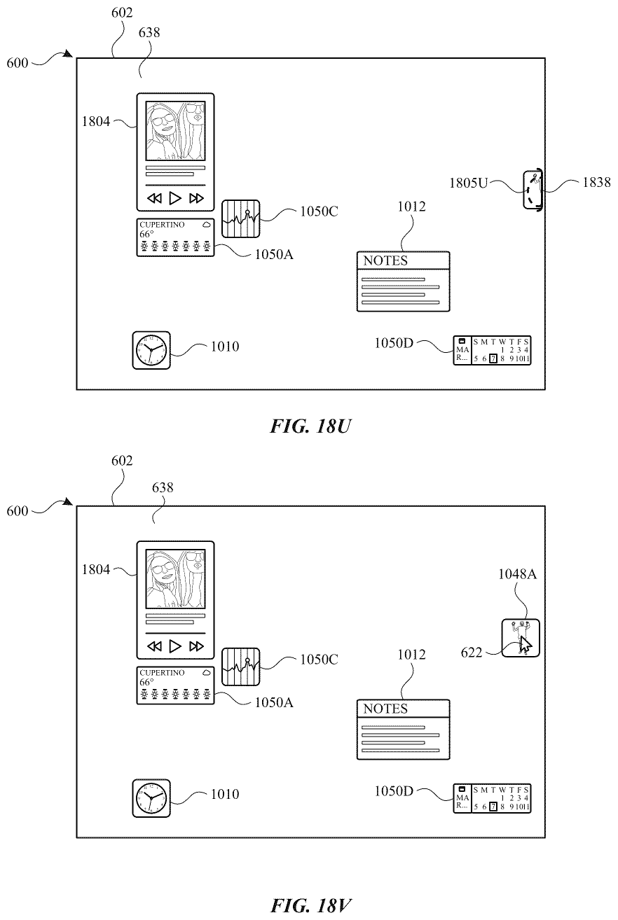

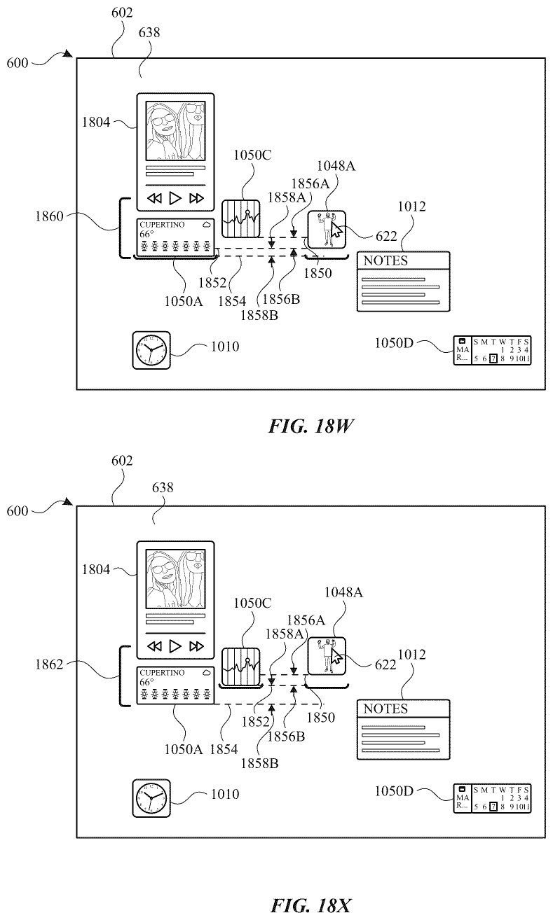

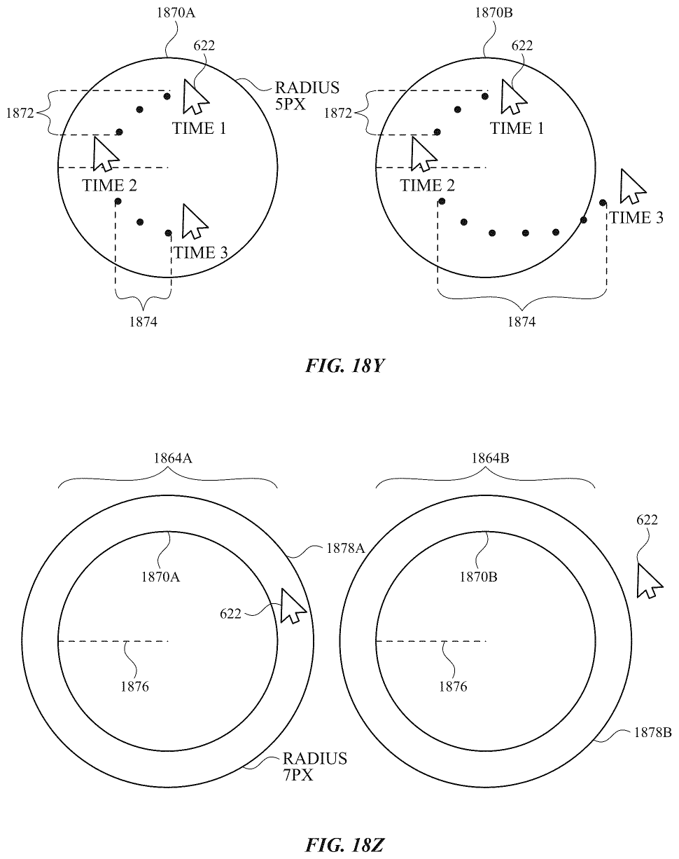

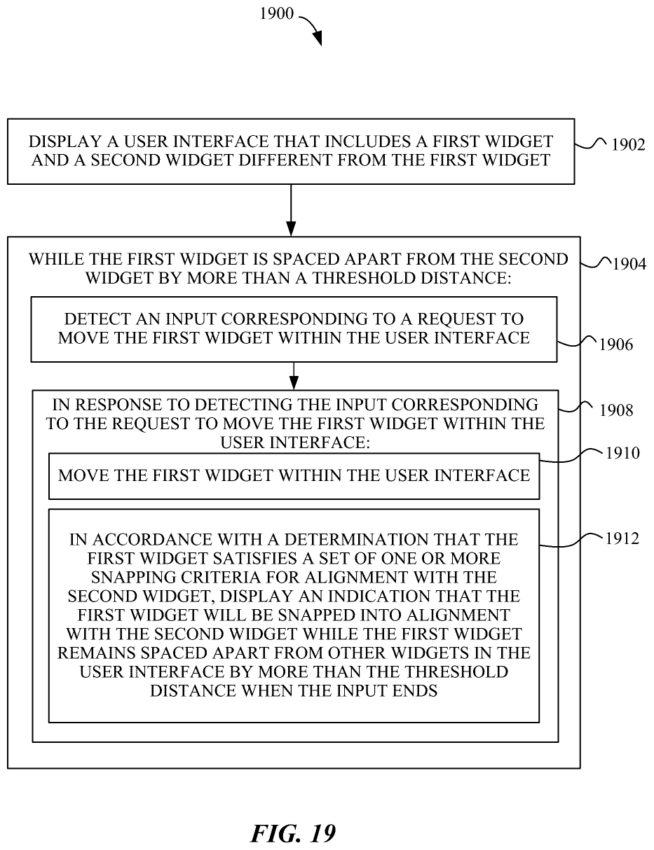

FIGS. 18-18Z illustrate exemplary user interfaces for managing widgets in accordance with some embodiments. FIG. 19 is a flow diagram illustrating a method for aligning widgets, in accordance with some embodiments. The user interfaces in FIGS. 18A-18Z are used to illustrate the processes described below, including the processes in FIG. 19.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

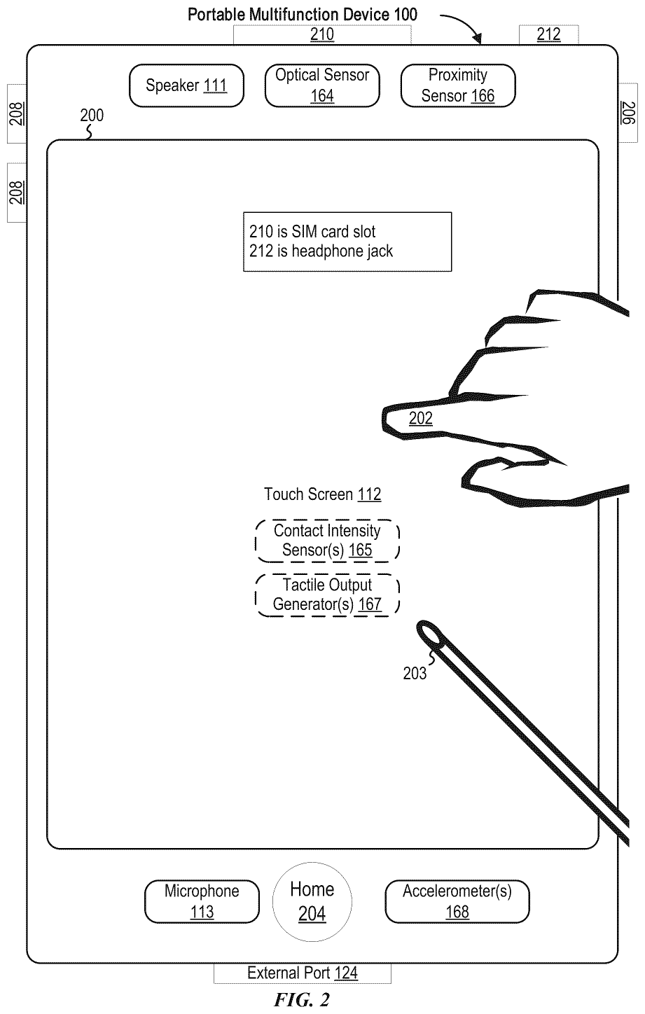

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

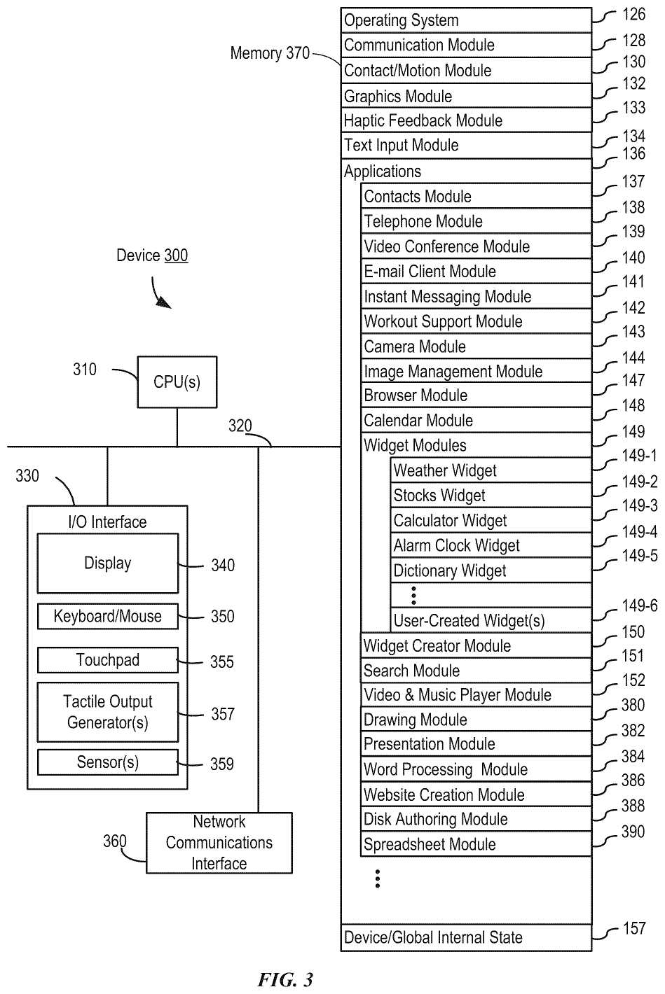

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

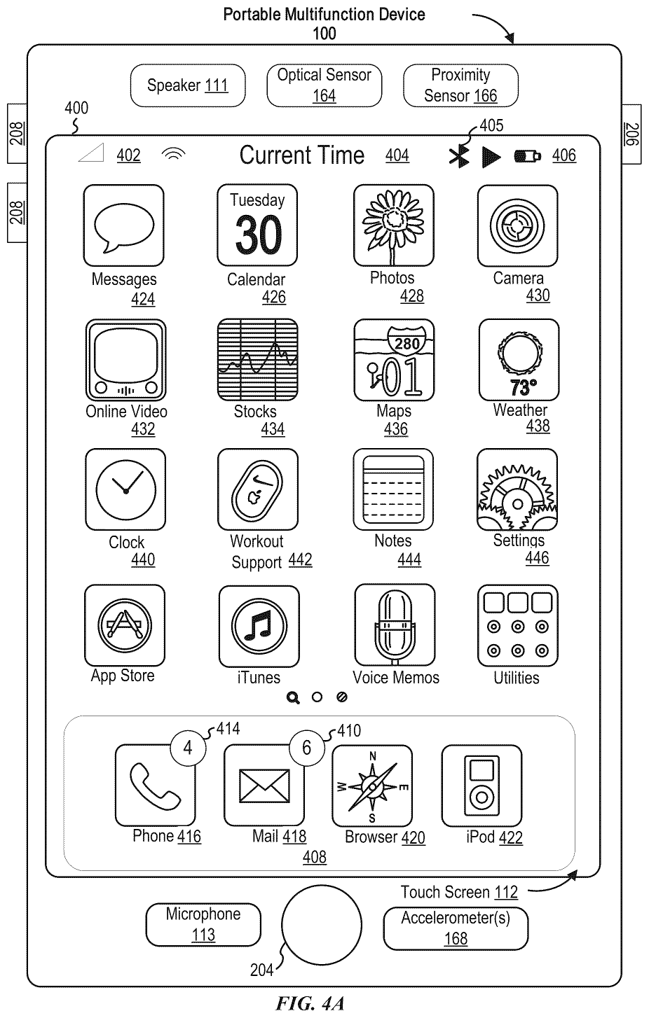

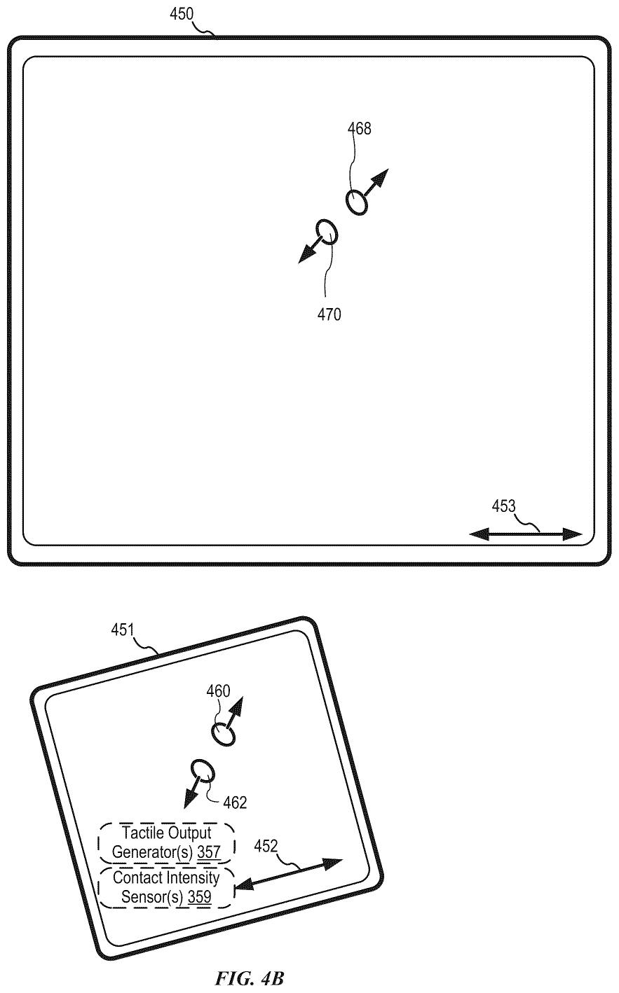

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with touch-sensitive surface 451 (e.g., a tablet or touchpad 355, FIG. 3) that is separate from display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

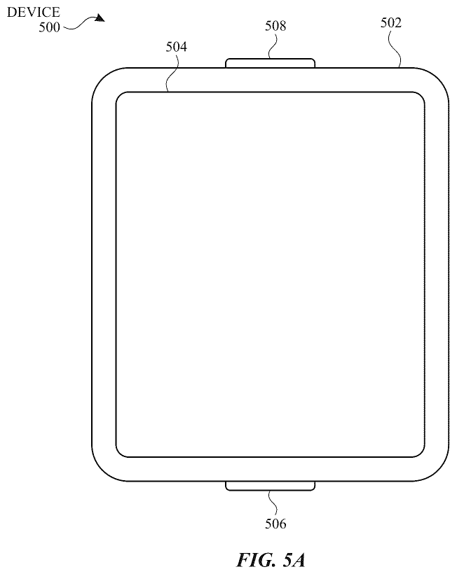

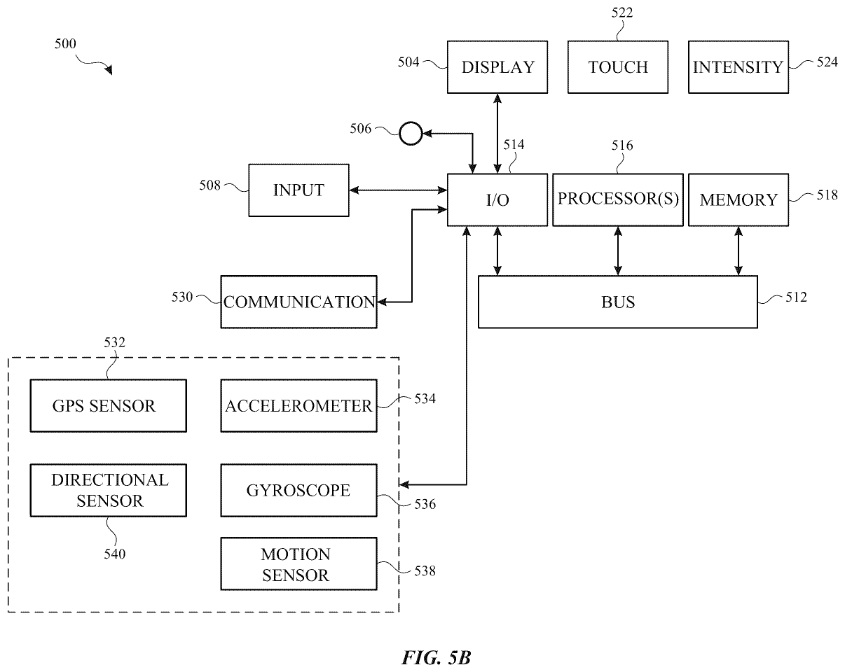

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, carrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some embodiments.

Input mechanism 508 is, optionally, a microphone, in some embodiments. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, 1100, 1200, 1300, 1500, 1700, and 1900 (FIGS. 7, 9, 11, 12, 13, 15, 17, and 19). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6T illustrate exemplary user interfaces for transitioning user interfaces in accordance with some embodiments. The user interfaces in these figures are used to illustrate the processes described below, including the processes in FIG. 7.

FIGS. 6A-6E illustrate computer system 600 displaying an animated background while locked. In some embodiments, computer system 600 includes one or more features as described above with respect to portable multifunction device 100, device 300, or device 500.

FIG. 6A illustrates computer system 600 displaying lockscreen interface 604 on display 602. In this embodiment, computer system 600 is a laptop computer that includes display 602 and touch-sensitive surface 608. As a visual aid, display 602 and touch-sensitive surface 608 are illustrated each in a head-on view and not necessarily in a relative positioning as they would be positioned and/or attached to an enclosure of laptop computer system 600.

As illustrated in FIG. 6A, lockscreen interface 604 includes animated background 610, time/date indicator 606, user account representation 612, and authentication option indicator 614. In some embodiments, animated background 610 is a visually dynamic video (e.g., includes multiple frames with different content) that plays in the background of lockscreen interface 604. In some embodiments, time/date indicator 606 represents the current time and date. In some examples, time/date indicator 606 is displayed based on a size and/or resolution of the display (e.g., 602). In some embodiments, user account representation 612 is displayed based on a size and/or resolution of the display (e.g., 602). In some embodiments, user account representation 612 is a visual representation of the user account that is currently selected. In some embodiments, authentication option indicator 614 indicates (e.g., to the user) that computer system 600 (e.g., and/or the selected user account) can be unlocked using a password and/or using biometric authentication process. As illustrated in FIG. 6A, authentication option indicator 614 is displayed beneath user account representation 612. As illustrated in FIG. 6A, computer system 600 displays pointer 622 overlaid on user account representation 612. In some embodiments, pointer 622 indicates the position (e.g., a current position and/or a last position) of user input detected via an input device (e.g., touch-sensitive surface 608) in communication with computer system 600. In some embodiments, time/date indicator 606, user account representation 612, pointer 622, and/or authentication option indicator 614 are at least partially overlaying a portion of animated background 610.

In some embodiments, an animated background is customized based on a user account (e.g., a user account that is active, most recently active, selected, and/or logged in). For example, animated background 610 corresponds to the user account associated with user account representation 612. In some embodiments, if a different user account representation is selected (e.g., as shown in FIG. 8H), lockscreen interface 604 can display a different animated background (e.g., 822 of FIG. 8H).

FIG. 6A also includes, as a schematic not included in lockscreen interface 604, content duration indicator 616, which is a representation of the time duration of the currently displayed animated background of lockscreen interface 604, which in FIG. 6A is animated background 610 (e.g., where the left most position represents the beginning time of an animated visual content item, and the right most position represents the end time of the animated media item). Background progress indicator 618 displays the current progress of the animation (e.g., relative to the duration of animated background 610). FIG. 6A also includes, as a schematic not included in lockscreen interface 604, animation speed indicator 620, which is a representation of the current playback speed at which the animated background progresses through frames of the animated media (e.g., expressed as a framerate). For the purposes of this example, framerate correlates with the playback speed. In some embodiments, framerate does not necessarily correlate with playback speed (e.g., changing a number of frames (e.g., via interpolation and/or skipping frames) can cause playback speed to change without changing framerate).

As illustrated in FIG. 6A, computer system 600 plays back animated background 610 at a speed of 30 frames per second in its locked state (e.g., referred to as “full speed” in this example, which is the normal or “1×” playback speed of the content). In some embodiments, full speed is a different playback speed and/or framerate. Also illustrated in FIG. 6A is touch-sensitive surface 608, which is used herein to illustrate inputs directed to computer system 600, where such inputs control and/or affect the location and actions of pointer 622 displayed by display 602. As illustrated in FIG. 6A, no input is currently detected on touch-sensitive surface 608, but pointer 622 is positioned to be hovering at the bottom of display 602.

At FIG. 6B, computer system 600 has progressed the boat in animated background 610 from its initial position as illustrated in FIG. 6A and continues to display pointer 622 hovering on user account representation 612. Computer system 600 progresses playback of animated background 610 part of the way through its duration, thus background progress indicator 618 is illustrated as having progressed in time (e.g., relative to FIG. 6A). As animated background 610 progresses in time, the boat advances to the right.

At FIG. 6C, computer system 600 has progressed the boat in animated background 610 further across display 602 from its previous position as illustrated in FIG. 6B. Computer system 600 progresses playback of animated background 610 part of the way through its duration, thus background progress indicator 618 is illustrated as having progressed in time (e.g., relative to FIG. 6B). As animated background 610 progresses in time, the boat advances to the right. At FIG. 6C, computer system 600 detects an unlocking input corresponding to input of a password via a keyboard in communication with computer system 600. In some embodiments, the input corresponds to input of biometric data for authenticating the user (e.g., a fingerprint, eye, iris, or facial data). In response to detecting the unlocking input corresponding to input of the password, computer system 600 displays password entry field 630 in which computer system 600 displays the protected form of the typed password. Subsequent to detecting the unlocking input (e.g., when the entered password is correct), computer system 600 begins an unlocking process. Computer system 600 beginning the unlocking process indicates that computer system 600 successfully received the unlocking input (e.g., a typed password). In some examples, if the unlocking input is not successful, computer system 600 does not begin the unlocking process (e.g., and, in some embodiments, displays an unlocking error indication, continues displaying password entry field 630, and/or displays authentication option indicator 614 without displaying password entry field 630).

FIGS. 6D-6E illustrate an intermediate process between computer system 600 displaying lockscreen interface 604 (e.g., as in FIGS. 6D-6E) and desktop interface 638 (e.g., as in FIG. 6F). At FIG. 6D, in response to detecting the unlocking input, computer system 600 replaces authentication option indicator 614 with unlocking indicator 632, which computer system 600 displays to indicate that the unlocking process is ongoing (e.g., or, in some embodiments, about to begin or has completed). Within this intermediate process, computer system 600 is working to unlock and/or prepare the system for unlocked operation (e.g., loading desktop interface 638 and/or calling one or more system processes). During the unlocking process, computer system 600 slows the playback speed of animated background 610 to 15 frames per second (e.g., referred to as “medium speed” in this example), as illustrated by animation speed indicator 620. In some embodiments, the unlocking process is the same speed as when the computer system was locked (e.g., playback speed of animated background 610 remains unchanged). In some embodiments, the unlocking process stops animation (e.g., playback speed goes to zero) of animated background 610. In some embodiments, there is no displayed interface corresponding to an unlocking process (e.g., computer system 600 transitions directly to desktop interface 638 in response to detecting the unlocking input). Computer system 600 progresses playback of animated background 610 part of the way through its duration, thus background progress indicator 618 is illustrated in FIG. 6D as having progressed. As animated background 610 progresses in time, the boat advances to the right.

As illustrated in FIG. 6E, in a continuation of the unlocking process, computer system 600 continues to display unlocking indicator 632. FIG. 6E continues to display animation speed indicator 620 as moving at a rate of 15 frames per second and progresses playback of animated background 610 part of the way through its duration, thus background progress indicator 618 is illustrated as having progressed. As animated background 610 progresses in time, the boat advances to the right.

FIGS. 6F-6J illustrate computer system 600 displaying an animated background as a background of a desktop interface.

As illustrated in FIG. 6F, in response to computer system 600 completing the unlock process, computer system 600 displays desktop interface 638, which includes animated background 610. Desktop interface 638 also includes application dock 648 which allows access to applications (e.g., represented by application indicators 648A-648L). Desktop interface 638 also includes widget 640, widget 642, widget 644, widget 646, and icon list 650. Animated background 610, as described above in relation to FIG. 6A, is a visually dynamic video that is displayed in the background of desktop interface 638. Animated background 610 includes the same representation of a boat (e.g., as in FIG. 6A) that moves to the right as computer system 600 progresses (e.g., plays back) animated background 610 over time. Computer system 600 displays the animated background 610 with a visual appearance that is based on the visual appearance of at lockscreen interface 604 (e.g., at a time when the unlocking process begins). In this embodiment, animated background 610 is displayed at a frame based on its progression at lockscreen interface 604. In some embodiments, desktop interface 638 includes a background different than animated background 610 but that is based on the appearance of lockscreen interface 604 (e.g., is a subsequent visually dynamic video in a set of videos that are configured to playback sequentially (e.g., associated with the user account and/or a user interface (e.g., 604 and/or 638)). In FIG. 6F, animated background 610 continues to progress, causing the boat in animated background 610 to be further to the right in FIG. 6F than in FIG. 6E. In FIG. 6E, progress indicator 618 is further to the right than in FIG. 6E, indicating playback of animated background 610 has progressed in time. As illustrated in FIG. 6F, animation speed indicator 620 is displayed as progressing at a rate of I frame every 10 minutes in the unlocked state.

As illustrated in FIG. 6F, computer system 600 plays back animated background 610 at a different rate (e.g., than lockscreen interface 604 (e.g., 30 frames/second) on desktop interface 638 and while unlocking (e.g., 15 frames/second)). Computer system 600 displays time indicator 634 as having progressed by 10 minutes relative to FIG. 6E (e.g., 9:42 AM in FIG. 6E and 9:52 AM in FIG. 6F), and animation speed indicator 620 indicates that animated background 610 is playing back at “low speed” corresponding to a rate of progression of I frame every 10 minutes. In this example, 10 minutes have passed between FIG. 6E and FIG. 6F, so computer system 600 advances the boat in animated background 610 by only 1 frame due to a reduction in playback speed to low speed-note that between FIGS. 6E and 6F, the boat has not moved much with respect to display 602 over the course of 10 minutes. Contrast this with FIGS. 6A-6E, where the animation progressed much faster, and boat moved a larger distance across display 602 during a much shorter period of time (e.g., each FIGS. 6A-6E were displayed within the same minute at 9:42 AM). At FIG. 6F, computer system 600 detects, via touch-sensitive surface 608, input 605F directed to application 648A and representing a click input.

At FIG. 6G, in response to detecting input 605F on application 648A, computer system 600 opens and displays window 660 in the middle of display 602 and overlaid on top of desktop interface 638. Computer system 600 displays time indicator 634 as having progressed by 10 minutes (e.g., and now reads 10:02 AM) and continues to display animated background 610 advancing at a rate of 1 frame every 10 minutes, which is illustrated by computer system 600 advancing the boat by one frame from its position in FIG. 6F toward the right edge of display 602. Background progress indicator 618 continues to progress at a rate of 1 frame every 10 minutes.

As illustrated in FIG. 6H, computer system 600 displays animated background 610 after another 10 minutes has passed since FIG. 6G. Computer system 600 has advanced the boat in animated background 610 almost completely across display 602 of computer system 600 from its initial position in FIG. 6A. Background progress indicator 618 is also illustrated as being at the end of content duration indicator 616, which indicates that playback has reached the end of the dynamic video. Computer system 600 displays time indicator 634 as having progressed by 10 minutes (e.g., and now reads 10:12 AM). At FIG. 6H, computer system 600 detects input 605H on menu control 636 representing a click. Input 605H is also represented on touch-sensitive surface 608, indicating that input can be detected via touch-sensitive surface 608 to cause input 605H on menu control 636.

As illustrated in FIG. 6I, in response to detecting input 605H on menu control 636, computer system 600 displays menu 662. Computer system 600 lists lockscreen control 664 within menu 662. Also illustrated in FIG. 6I, computer system 600 begins to display animated background 666 (e.g., different from animated background 610) starting on its first frame, which is a new visually dynamic video that depicts a house increasing in size. Computer system 600 begins to display animated background 666 due to animated background 610 reaching the end of its duration and displaying its final frame as illustrated in FIG. 6H. The beginning of the new video is also indicated by background progress indicator 618 beginning again at the opposite end of content duration indicator 616 from what was illustrated in FIG. 6H. Computer system 600 displays time indicator 634 as having progressed by 10 minutes (e.g., and now reads 10:22 AM), reflective of the passage of time since the last frame of animated background 610 was displayed. In some embodiments, computer system 600 changes an animated background (e.g., at desktop interface 638 and/or lockscreen interface 604) between a set of one or more animated backgrounds. In some embodiments, the set of one or more animated backgrounds is configured according to one or more configurations. In some embodiments, the animated backgrounds are configured to be selected from a set of animated visual content with certain properties (e.g., visual content of a particular category (e.g., houses, boats, landscapes, animals, media captured by the user, media selected by a user, and/or media located in a particular directory and/or source location). In this embodiment, animated background 610 and animated background 666 are included in a set of animated visual content selected by a user (e.g., associated with a user account) for display as animated backgrounds. At FIG. 6I, computer system 600 detects, via touch-sensitive surface 608, input 605I directed to lockscreen control 664 representing a click input.

At FIG. 6J, in response to detecting input 605I on lockscreen control 664, computer system 600 begins the process of locking computer system 600, which is represented by fade animation 668. In some embodiments, fade animation 668 includes the gradual fading out and/or reduction in size of user interface elements (e.g., icons, widgets, and/or menus) of desktop interface 638 on display 602. In some examples, fading out includes changing one or more color property, brightness property, blur property, and/or opacity (e.g., to give the appearance that elements affected by the animation are disappearing, getting further away, and/or becoming deemphasized). In some embodiments, input 605I is selection of predetermined portion (e.g., also referred to as a “hot corner”) of display 602 and/or desktop interface 638. As illustrated in FIG. 6J, in response to detecting click gesture 6051 on lockscreen control 664, computer system 600 collapses menu 662 as well as gradually reduces the size of content included in and/or on desktop interface 638, such as window 660, widget 640, widget 642, widget 644, widget 646, icon list 650, and application dock 648. For example, as illustrated in FIG. 6J, a browser window is displayed at a reduced size (e.g., smaller than in FIG. 6I) and with a higher level of translucency (e.g., than in FIG. 6I) (e.g., the house of animated background 666 is visible through the browser window in FIG. 6J). In some embodiments, computer system 600 does not display a fade animation and/or gradually minimize content (e.g., during locking and/or in response to input 605I) (e.g., and instead displays lockscreen interface 604 and ceases to display desktop interface 638). In some embodiments, user interface elements gradually fade in conjunction with an unlocking process and/or displaying desktop interface 638 from lockscreen interface 604. For example, a fade animation can be configured to cause user interface elements to appear (e.g., by changing one or more properties in a manner opposite to fade animation 668).

FIGS. 6K-6P illustrate a progression of animated backgrounds on a lockscreen interface. At FIG. 6K, in response to detecting input 605I, and subsequent to displaying fade animation 668, computer system 600 locks and displays lockscreen interface 604 on display 602. Computer system 600 resumes displaying animated background 666 on lockscreen interface 604 with an appearance based on its appearance as illustrated in FIG. 6J. That is, computer system 600 continues playing back animated background 666 from its point of progression as illustrated in FIG. 6J, and therefore the house continues increasing in size from what it was in FIG. 6J. Animation speed indicator 620 has returned to a progression rate of 30 frames per second and background progress indicator 618 continues to progress from its point as illustrated in FIG. 6J.

As illustrated in FIG. 6L, in response to passage of time at FIG. 6K, computer system 600 continues to play back at a speed corresponding to at a rate of 30 frames per second (e.g., illustrated by animation speed indicator 620) and displays the house in animated background 666 increasing in size. FIG. 6L also illustrates the advancement of background progress indicator 618 from its point as illustrated in FIG. 6K. FIG. 6L illustrates that the house in animated background 666 is slightly larger than it was in FIG. 6K due to the progression of the animation.

As illustrated in FIG. 6M, in response to passage of time at FIG. 6L, computer system 600 continues to play back at a speed corresponding to at a rate of 30 frames per second (e.g., illustrated by animation speed indicator 620) and displays the house in animated background 666 increasing in size. FIG. 6M also illustrates the advancement of background progress indicator 618 from its point as illustrated in FIG. 6L. FIG. 6M illustrates that the house in animated background 666 is slightly larger than it was in FIG. 6L due to the progression of the animation.

As illustrated in FIG. 6N, in response to passage of time at FIG. 6M, computer system 600 continues to play back at a speed corresponding to at a rate of 30 frames per second (e.g., illustrated by animation speed indicator 620) and displays the house in animated background 666 increasing in size. FIG. 6N also illustrates the advancement of background progress indicator 618 from its point as illustrated in FIG. 6M. FIG. 6N illustrates that the house in animated background 666 is slightly larger than it was in FIG. 6M due to the progression of the animation. As illustrated in FIG. 6N, background progress indicator 618 is illustrated as being at the end of content duration indicator 616, which indicates that animated background 666 is complete (e.g., has reached the end of its duration and is displaying its last frame). In some examples, in response to detecting the end of animated visual content, computer system 600 replays the animated visual content that it just completed (e.g., repeating it starting from its first frame).

FIG. 6O illustrates automatically changing of animated visual content of a user interface. As illustrated in FIG. 6O, in response to the completion of animated background 666 and to passage of time at FIG. 6N, computer system 600 displays the first frame of animated background 670, which is a new visually dynamic video (e.g., different from the animated visual content that is animated background 666 and/or animated background 610). In FIG. 6O, computer system 600 displays animated background 670 starting on its first frame that includes a spiral (e.g., which grows in size and complexity as animated background 670 progresses). Each animated background is unique unto itself and separate from other animated backgrounds. The beginning of the new animated background is also indicated by background progression indicator 618 returning to the leftmost position of content duration indicator 616, representing the beginning of the animation (e.g., a first frame and/or time zero of a media timeline). In some embodiments, computer system 600 displays different animated visual content upon reaching completion of a first animated visual content while displaying another user interface (e.g., desktop interface 638).

As illustrated in FIG. 6P, in response to passage of time at FIG. 6O, computer system 600 continues to play back at a speed corresponding to a rate of 30 frames per second (e.g., illustrated by animation speed indicator 620) and displays the spiral shape in animated background 670 increasing in size and detail. FIG. 6P also illustrates the advancement of background progress indicator 618 from its point as illustrated in FIG. 6O. FIG. 6P illustrates that the spiral in animated background 670 is slightly larger than it was in FIG. 6O due to the progression of the animation.

FIGS. 6Q-6T illustrate the process of computer system 600 changing a background of animated visual content while unlocking and transitioning between user interfaces.

As illustrated in FIG. 6Q, computer system 600 displays animated background 610 on lockscreen interface 604. The boat in animated background 610 is about three quarters through its progression across display 602, as indicated by background progress indicator 618. Computer system 600 displays the boat in animated background 610 as advancing at a rate of 30 frames per second, as indicated by animation speed indicator 620.

As illustrated in FIG. 6R, in response to passage of time at FIG. 6Q, computer system 600 continues to play back at a speed corresponding to at a rate of 30 frames per second (e.g., illustrated by animation speed indicator 620) and displays the boat at a further progression position that is further to right than in FIG. 6Q. FIG. 6R also illustrates the advancement of background progress indicator 618 from its point as illustrated in FIG. 6Q. At FIG. 6R, computer system 600 detects input of biometric authentication data (e.g., a fingerprint or facial data) via an input device in communication with computer system 600. In some embodiments, computer system 600 detects a typed password entry.

As illustrated in FIG. 6S, in response to detecting the input of the user entering a biometric password, computer system 600 begins the unlock process, indicated by unlock indicator 632 below user account representation 612. In response to passage of time at FIG. 6R, continues to play back at a speed corresponding to at a rate of 15 frames per second (e.g., illustrated by animation speed indicator 620) and displays the boat at a further progression position that is further to right than in FIG. 6R. FIG. 6S also illustrates the advancement of background progress indicator 618 from its point as illustrated in FIG. 6R. As illustrated in FIG. 6S, background animation 610 has progressed to the end of its duration (e.g., its last frame).

As illustrated in FIG. 6T, in response to detecting the input that began the unlock process, and subsequent to unlocking, computer system 600 displays desktop interface 638 on display 602 (e.g., similar to as illustrated and described with respect to FIG. 6F). Also illustrated in FIG. 6T, in response to detecting that there were no remaining frames of background animation 610 to be displayed, computer system 600 begins to display animated background 666 (e.g., starting at its first frame). That is, as computer system 600 unlocked at the same time that animated background 610 was on its last frame, computer system 600 displays the first frame of animated background 666 concurrently with desktop interface 638.

FIG. 7 is a flow diagram illustrating a method (e.g., method 700) for transitioning user interfaces in accordance with some embodiments. Some operations in method 700 are, optionally, combined, the orders of some operations are, optionally, changed, and some operations are, optionally, omitted.

As described below, method 700 provides an intuitive way for transitioning user interfaces. Method 700 reduces the cognitive burden on a user for transitioning user interfaces, thereby creating a more efficient human-machine interface. For battery-operated computing devices, enabling a user to transitioning user interfaces faster and more efficiently conserves power and increases the time between battery charges.

In some embodiments, method 700 is performed at a computer system (e.g., 600) that is in communication with a display generation component (e.g., 602) (e.g., a display screen and/or a touch-sensitive display) and one or more input devices (e.g., 608) (e.g., a physical input mechanism (e.g., a hardware input mechanism, a rotatable input mechanism, a crown, a knob, a dial, a physical slider, and/or a hardware button), a camera, a touch-sensitive display, a microphone, sensors (e.g., heart rate sensor, monitors, antennas (e.g., using Bluetooth and/or Wi-Fi)), and/or a button). In some embodiments, the computer system is a phone, a processor, a watch, a tablet, a fitness tracking device, a wearable device, a television, a multi-media device, an accessory, a speaker, a head-mounted display (HMD), and/or a personal computing device.

At 702, while the computer system (e.g., 600) is in a locked state (e.g., while displaying a login user interface, a lock screen user interface, a profile selection user interface, a user interface that requires input before proceeding, and/or a user interface that includes an indication (e.g., text and/or one or more graphical representations) that request authentication (e.g., biometric (e.g., using biometric data related to a body part (e.g., eyes, face, mount, and/or fingers)), password, a pin code, and/or another credential)) and while displaying, via the display generation component, a first user interface (e.g., 604) (e.g., lock screen and/or login screen) with a first background (e.g., 610) for the first user interface (e.g., a lock screen background and/or an area of the first user interface that includes display of media content) that includes animated visual content (e.g., a video, an animation (e.g., a GIF and/or HEIC file), a visualization, and/or media that has a visual component can be played back and/or that is actively being played back), the computer system detects, via the one or more input devices, input (e.g., password entry at FIG. 6C) (e.g., a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)) corresponding to (e.g., representing, indicating, and/or being interpreted by the computer system as) a request to unlock the computer system. In some embodiments, the input is an input (e.g., providing and/or entering) of a credential (e.g., biometric (e.g., a fingerprint and/or facial features), a password, a spoken phrase, and/or a physical credential (e.g., badge and/or key card)).

At 704, In response to detecting the input corresponding to the request to unlock the computer system, in accordance with a determination (at 706) that the input was detected while the animated visual content had a first appearance (e.g., 610 at FIG. 6C) (e.g., was at a first progress of animation) (e.g., at a first timestamp, at a first frame, and/or at a first media segment), the computer system displays, via the display generation component, a second user interface (e.g., 638) (e.g., an unlocked user interface, a home screen user interface, or a desktop user interface) with a first background (e.g., 610 at FIG. 6F) for the second user interface (that is optionally different from the first background for the first user interface) (e.g., corresponding to the first state of animation). In some embodiments, the second user interface is a desktop user interface. In some embodiments, the second user interface is a home screen. In some embodiments, the second background is different from the first background. In some embodiments, the second user interface is associated with an unlocked state. In some embodiments, the second background is associated with an unlocked state. In some embodiments, the first progress of animation occurs at a time associated with an operation to unlock the computer system (e.g., time when an unlock operation begins, time when an unlock operation ends, and/or a time after display of an unlock animation). In some embodiments, the input is an input (e.g., providing and/or entering) of a credential (e.g., biometric (e.g., a fingerprint and/or facial features), a password, a spoken phrase, and/or a physical credential (e.g., badge and/or key card)). In some embodiments, in accordance with (e.g., in conjunction with, and/or in response to) detecting the input, the computer system unlocks (e.g., enters an unlocked state, displays a user interface associated with an unlock state, and/or ceases displaying the first user interface). In some embodiments, the input corresponding to the request is verified before unlocking the computer system.

At 704, in response to detecting the input corresponding to the request to unlock the computer system and in accordance with a determination (at 708) that the input (e.g., password entry at FIG. 6C) was detected while the animated visual content had a second appearance (e.g., 610 in FIG. 6R) that is different from the first appearance (e.g., was at a second progress of animation (e.g., at a second timestamp, at a second frame, and/or at a second media segment) that is different from the first progress of animation), the computer system (e.g., 600) displays, via the display generation component, the second user interface with a second background (e.g., 666 at FIG. 6T) for the second user interface that is different (e.g., visually and/or includes other content) from the first background for the second user interface (and is optionally different from the first background for the first user interface). In some embodiments, in accordance with a determination that the input was detected while the animated visual content had a second appearance that is different from the first appearance, the computer system does not display the second background. In some embodiments, in accordance with a determination that the input was detected while the animated visual content had a first appearance, the computer system does not display the third background. In some embodiments, the third background is different from the first background and the second background. In some embodiments, the third user interface and/or the second user interface is a desktop user interface (e.g., 604). In some embodiments, the third user interface and/or the second user interface is a home screen user interface (e.g., 638). In some embodiments, the third user interface and/or the second user interface is associated with an unlocked state. In some embodiments, the third background is associated with an unlocked state. In some embodiments, the second user interface and the third user interface are the same (e.g., the same desktop user interface and/or home screen). In some embodiments, the second user interface and the third user interface are different. In some embodiments, the first background is a frame from animated content. In some embodiments, the second background and/or the third background is a frame from animated content. In some embodiments, the second background and/or the third background is a frame from animated content that does not include the first background. In some embodiments, the first frame is from first visual content and the second frame is from second visual content different from the first visual content. In some embodiments, the third background is a frame from the animated content that is different from the first frame and/or the second frame. In some embodiments, the animated visual content is a video, an animation (e.g., a GIF), a visualization, and/or visual that includes a visual component that can be played back. In some embodiments, animated visual content includes a plurality of frames that can be played back to create an animation. In some embodiments, the second appearance occurs at a time associated with an operation to unlock the computer system (e.g., time when an unlock operation begins, time when an unlock operation ends, and/or a time after display of an unlock animation). Displaying the second user interface with a particular background based on the input being detected while the animated visual content had a particular appearance allows the computer system to automatically reduce visual distractions in the user interface before and after the computer system is transitioned from a locked state to an unlocked state, thereby performing an operation when a set of conditions has been met without requiring further user input and providing improved feedback. Displaying the first user interface with the first background for the first user interface that includes animated visual content allows the computer system to avoid burn-in of the display generation component and performs an operation when a set of conditions has been met without requiring further user input.

In some embodiments, after displaying the first user interface that includes the animated visual content (e.g., and while displaying either the first user interface or the second user interface), the computer system (e.g., 600) displays, via the display generation component, a first frame of first animated visual content (e.g., 610, 666, or 670) (e.g., the animated visual content and/or other animated visual content), and the computer system displays, via the display generation component, a second frame of the first animated visual content (e.g., 610, 666, or 670) different from the first frame of the first animated visual content. In some embodiments, the first frame and second frame are both displayed at the first user interface (e.g., at different times). In some embodiments, the first frame and second frame are both displayed at the second user interface (e.g., 638) (e.g., at different times). In some embodiments, the first frame is displayed at the first user interface (e.g., 604) and second frame is displayed at the second user interface (e.g., at different times). In some embodiments, animated visual content (e.g., a respective animated visual content such as the first animated visual content) includes a sequence of frames (e.g., that when played back in sequence create an animation). In some embodiments, the first frame and the second frame (e.g., and further respective frames) are part of the sequence of frames that are included in and/or make up the animated visual content. In some embodiments, animated visual content refers to an animation, video, and/or a slow-motion video. Displaying a first frame of first animated visual content and displaying a second frame of the first animated visual content, different from the first frame of the first animated visual content, allows the computer system to reduce visual distractions to the user interface and provide an indication of the state of the computer system, thereby performing an operation when a set of conditions has been met without requiring further user input and providing improved feedback. Displaying different frames of animated visual content allows the computer system to avoid burn-in of the display generation component and performs an operation when a set of conditions has been met without requiring further user input.

In some embodiments, after displaying the first user interface (e.g., 604) that includes the animated visual content (e.g., and while displaying either the first user interface or the second user interface), the computer system (e.g., 600) displays, via the display generation component, a first frame of second animated visual content (e.g., 610, 666, or 670) (e.g., the animated visual content and/or other animated visual content), and the computer system displays, via the display generation component, a first frame of third animated visual content (e.g., 610, 666, or 670) different from the second animated visual content. In some embodiments, the first frame and second frame are both displayed at the first user interface (e.g., 604) (e.g., at different times). In some embodiments, the first frame and second frame are both displayed at the second user interface (e.g., 638) (e.g., at different times). In some embodiments, the first frame is displayed at the first user interface and second frame is displayed at the second user interface (e.g., at different times). In some embodiments, animated visual content (e.g., a respective animated visual content such as the second and/or third animated visual content) includes a sequence of frames (e.g., that when played back in sequence create an animation). In some embodiments, the first frame of the second animated visual content and the first frame of the third animated visual content are part of the different sequences of frames that make up different animated visual content. Displaying a first frame of second animated visual content and displaying a first frame of the third animated visual content, different from the second animated visual content, allows the computer system to reduce visual distractions to the user interface and provide an indication of the state of the computer system, thereby performing an operation when a set of conditions has been met without requiring further user input and providing improved feedback. Displaying different frames of animated visual content allows the computer system to avoid burn-in of the display generation component and performs an operation when a set of conditions has been met without requiring further user input.

In some embodiments, the animated visual content is fourth animated visual content (e.g., 610, 666, or 670). In some embodiments, before (or, in some embodiments, after) (and, in some embodiments, while in the locked state) displaying the first user interface (e.g., 604) having the first background (e.g., 610, 666, or 670) for the first user interface that includes the fourth animated visual content, the computer system (e.g., 600) displays, via the display generation component (and, in some embodiments, automatically and without intervening user interface, based on a predetermined period of time and/or the length of the fourth animated visual content passing, and/or based on one or more portions of the animated visual content being played back), the first user interface having a second background for the first user interface that includes fifth animated visual content (e.g., 610, 666, or 670) different from the fourth animated visual content. Displaying the first user interface having a second background for the first user interface that includes fifth animated visual content different from the fourth animated visual content before displaying the first user interface having the first background for the first user interface that includes the fourth animated visual content allows the computer system to automatically change animated content while the computer system is in the locked state, thereby performing an operation when a set of conditions has been met without requiring further user input, reducing the number of inputs needed to display different animated content, and providing improved feedback. Displaying different animated visual content allows the computer system to avoid burn-in of the display generation component and performs an operation when a set of conditions has been met without requiring further user input.

In some embodiments, in accordance with a determination that a setting (e.g., a configuration and/or setting selected by the user and/or a category setting) is in a first state (e.g., display boat animations such as animated background 610), the fourth animated visual content and the fifth animated visual content are selected from a first category (e.g., countries, planets cities, underwater, technology, health, science, and/or wonders of the world) of animated visual content. In some embodiments, in accordance with a determination that the setting is in a second state different from the first state, the fourth animated visual content and the fifth animated visual content are selected from a second category (e.g., countries, planets cities, underwater, technology, health, science, and/or wonders of the world) of animated visual content (and not a part of the first category of animated visual content) different from the first category of animated visual content. In some examples, the computer system (e.g., 600) detects an input representing a request to select a respective state (e.g., the first state or different from the first state) of the setting. In some embodiments, in response to detecting the input representing the request to select the respective state of the setting, the computer system configures the setting to the representative state. Displaying different animated visual content that are of the same category based on the state of a setting provides the user with control over the type of animated content that is displayed, thereby providing the user with one or more additional control options with cluttering the UI and reducing the number of inputs needed to display desired animated content. Displaying different animated visual content allows the computer system to avoid burn-in of the display generation component and performs an operation when a set of conditions has been met without requiring further user input.

In some embodiments, in response to detecting the input corresponding to the request to unlock the computer system (e.g., 600), the computer system changes (e.g., decreasing and/or increasing speed) a speed (and/or velocity, direction, and/or acceleration) of animation while transitioning display of the first user interface to display of the second display. In some embodiments, changing the speed of animation includes changing a playback speed of animation (e.g., a playback speed of 1× refers to the normal intended playback speed, a playback speed of 2× refers to a doubling of the normal playback speed, and a playback speed of 0.5× refers to a halving of the normal playback speed). In some embodiments, changing a playback speed includes changing a frame rate of playback for a same set of frames. In some embodiments changing a playback speed includes maintaining a frame rate of playback and using interpolated additional frames during playback (e.g., playing back more frames at the same frame rate will appear to slow down playback speed of the content representing by the frames). In some embodiments, the computer system displays the first user interface (e.g., 604) with an animation (e.g., 610, 666, or 670) that was displayed at and/or animates at a first speed before detecting the input (e.g., entry of password or biometric data) corresponding to the request to unlock the computer system and, in response to detecting the input corresponding to the request to unlock the computer system, the computer system displays the second user interface (e.g., 638) with an animation that is displayed at and/or animates at a second speed that is different from (and, in some embodiments, slower than) the first speed. In some embodiments, a playback speed (e.g., 620) can change at a different rate when increasing or decreasing (e.g., decrease from 1× to 0.5× speed over a period of 5 seconds, but increase from 0.5× to 1× speed over a period of 2 seconds). Changing a speed of animation while transitioning display of the first user interface to display of the second display in response to detecting the input corresponding to the request to unlock the computer system allows the computer system to reduce visual distractions to the user interface before and after the computer system is transitioned from a locked state to an unlocked state, thereby performing an operation when a set of conditions has been met without requiring further user input and providing improved feedback.

In some embodiments, while the computer system (e.g., 600) is in an unlocked state (e.g., displaying interface 638) (e.g., while displaying a desktop user interface and/or a home screen user interface) and while displaying, via the display generation component, the second user interface (e.g., 638) (e.g., desktop user interface and/or a home screen user interface) with a third background (e.g., 610, 666, or 670) (e.g., the first background for the second user interface, the second background from the second user interface, and/or a different background for the second user interface) for the second user interface that includes second animated visual content (e.g., the same or different than the animated visual content), the computer system detects that a lock event has occurred, (e.g., an input (e.g., user input and/or input form a process), a message, and/or an instruction) (e.g., a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)) the lock event (e.g., input 605I) corresponding to (e.g., representing, indicating, and/or being interpreted by the computer system as) a request to lock the computer system. In some embodiments, in response to detecting the lock event corresponding to the request to lock the computer system: in accordance with (e.g., in conjunction with, and/or in response to) detecting the input, the computer system locks (e.g., enters a locked state, displays a user interface associated with a locked state, and/or ceases displaying the second user interface) (and, optionally, displays the first user interface) (and, optionally, displays a login user interface, a lock screen user interface, a profile selection user interface, a user interface that requires input before proceeding, and/or a user interface that includes an indication (e.g., text and/or one or more graphical representations) that request authentication (e.g., biometric (e.g., using biometric data related to a body part (e.g., eyes, face, mount, and/or fingers)), password, a pin code, and/or another credential). In some embodiments, in response to detecting the lock event corresponding to the request to lock the computer system: in accordance with a determination that the lock event was detected while the second animated visual content (e.g., 610, 666, or 670) had a third appearance (e.g., was at a first progress of animation) (e.g., at a first timestamp, at a first frame, and/or at a first media segment), the computer system displays, via the display generation component, the first user interface (e.g., 604) (e.g., an locked user interface, a login user interface, or a authentication user interface, a login screen, and/or a lock screen) with a third background (e.g., 610, 666, or 670) for the first user interface. In some embodiments, the third background for the first user interface is different from the first background (e.g., 610, 666, or 670) for the first user interface. In some embodiments, the third background for the first user interface is different from the second background for the first user interface. In some embodiments, in response to detecting the lock event corresponding to the request to lock the computer system: in accordance with a determination that the lock event was detected while the animated visual content had a fourth appearance that is different from the third appearance (e.g., was at a fourth progress of animation (e.g., at a third timestamp, at a third frame, and/or at a third media segment) that is different from the third progress of animation), the computer system displays, via the display generation component, the first user interface with a fourth background (e.g., 610, 666, or 670) for the first user interface that is different (e.g., visually and/or includes other content) (e.g., is a different portion of the same animated visual content or a portion of different animated visual content) from the third background for the first user interface. In some embodiments, the fourth background for the first user interface is different from the first background for the first user interface. In some embodiments, the fourth background for the first user interface is different from the second background (e.g., 610, 666, or 670) for the first user interface. Displaying the first user interface with a particular background for the first user interface based on the lock event being detected while the second animated visual content has a particular appearance allows the computer system to automatically reduce visual distractions to the user interface before and after the computer system is transitioned from an unlocked state to a locked state, thereby performing an operation when a set of conditions has been met without requiring further user input and providing improved feedback.

In some embodiments, in response to detecting the input corresponding to the request to unlock the computer system (e.g., 600), the computer system ceases playback (e.g., temporarily, for a predetermined period of time, and/or ceasing playback at a particular speed (e.g., a playback back at a different speed)) on a first frame of the animated visual content, wherein the first frame is displayed as a third background (e.g., 610, 666, or 670) for the second user interface (e.g., 638) (e.g., is the first background for the second user interface or the second background for the second user interface). In some embodiments, ceasing playback on the first frame of the animated visual content includes ceasing playback completely (e.g., stops and/or freezes on). In some embodiments, ceasing playback on the first frame of the animated visual content includes ceasing playback at a particular speed (e.g., 620) (and, in some embodiments, continuing playback at a new playback speed that is different from the particular playback speed (e.g., at a slower speed, at no speed, or at a higher speed)), In some embodiments, while the computer system was locked and prior to detecting the input corresponding to the request to unlock the computer system, playing back, via the display generation component, of the animated visual content. In some embodiments, the playback speed changes over time. In some embodiments, a playback speed of the animated visual content is a first playback speed while the animated visual content is displayed while the computer system is locked (e.g., at the first user interface (e.g., 604)). In some embodiments, a playback speed of the animated visual content is a second playback speed (different from the first playback speed) while the animated visual content is displayed while the computer system is unlocked (e.g., at the second user interface (e.g., 638)). In some embodiments, in response to detecting the lock event corresponding to the request to lock the computer system, the computer system resumes playback of the first animated visual content at the first frame of the first animated visual content, wherein the first frame is displayed as a fifth background (e.g., 610, 666, or 670) for the first user interface. In some embodiments, resuming playback on the first frame of the animated visual content includes resuming playback that is stopped completely (e.g., stops and/or freezes on the first frame). In some embodiments, resuming playback on the first frame of the animated visual content includes resuming playback at a different playback speed (e.g., higher or lower) than a current playback speed and/or at a playback speed that was previously used (e.g., in a locked state before unlocking). Ceasing playback on a first frame of the animated visual content and resuming playback of the first animated visual content at the first frame of the first animated visual content allows the computer system to reduce visual distractions to the user interface before and after the computer system is transitioned from a locked to an unlocked state and back to the locked state, thereby performing an operation when a set of conditions has been met without requiring further user input and providing improved feedback. Resuming playback of animated visual content allows the computer system to avoid burn-in of the display generation component and performs an operation when a set of conditions has been met without requiring further user input.

In some embodiments, detecting that the lock event has occurred includes detecting that a predetermined period of time (e.g., 0.1-100 seconds) has elapsed (e.g., an inactivity and/or idle period without receiving user input) since an interaction (e.g., 605F and/or 605H) with the computer system (e.g., 600) last occurred. Displaying the first user interface with a particular background for the first user interface based on the lock event being detected based on a period of time elapsing since an interaction with the computer system last occurred allows the computer system to automatically reduce visual distractions to the user interface before and after the computer system is transitioned from an unlocked state to a locked state, thereby performing an operation when a set of conditions has been met without requiring further user input and providing improved feedback. Displaying the first user interface with a particular background for the first user interface based on the lock event being detected based on a period of time elapsing since an interaction with the computer system last occurred allows the computer system to avoid burn-in of the display generation component and performs an operation when a set of conditions has been met without requiring further user input.

In some embodiments, detecting that the lock event has occurred includes detecting a set of one or more inputs (e.g., 605I) (e.g., an input on a screen saver control and/or an input directed to a particular location (e.g., 664) on a user interface (e.g., the second user interface (e.g., 638) and/or another user interface) (e.g., while the computer system (e.g., 600) is operating and/or is in an unlock state)) (e.g., one or more tap inputs and/or, in some embodiments, a non-tap inputs (e.g., one or more gazes, air gestures/inputs (e.g., an air tap and/or a turning air gesture/input), one or more mouse clicks, one or more button touches, one or more swipes, and/or a pointing gesture/inputs)). Displaying the first user interface with a particular background for the first user interface based on the lock event being detected based on detecting a set of one or more inputs provides the user with control to transition the computer system into a locked state allows computer system to automatically reduce visual distractions to the user interface, thereby performing an operation when a set of conditions has been met, providing the user with one or more controls options without cluttering the UI, and providing improved feedback. Displaying the first user interface with a particular background for the first user interface based on the lock event being detected based on detecting a set of one or more inputs provides the user with control to transition the computer system into a locked state allows the computer system to avoid burn-in of the display generation component and performs an operation when a set of conditions has been met without requiring further user input.

In some embodiments, the second user interface (e.g., 638) includes a set of one or more user interface elements (e.g., 640, 642, 644, 646, 650, 648, 648A-648L, and/or 634) (e.g., widgets, windows, menu bar, icons, and/or docks). In some embodiments, in response to detecting the lock event corresponding to the request to lock the computer system (e.g., 600) (and, in some embodiments, in conjunction with displaying the first user interface in response to detecting the lock event), ceasing display of the set of one or more user interface elements while transitioning from display of the second user interface to display of the first user interface. In some embodiments, ceasing to display the set of one or more user interface elements includes displaying a visual effect and/or animation (e.g., 668) that ends with the one or more user interface elements ceasing to be displayed (e.g., appearing to gradually fade out, appearing to move off of a display are, appearing to shrink in size, and/or appearing to become deemphasized). Ceasing display of the set of one or more user interface elements while transitioning from display of the second user interface to display of the first user interface in response to detecting the lock event corresponding to the request to lock the computer system allows the computer system to reduce visual distractions to the user interface before and after the computer system is transitioned from a locked state to an unlocked state, thereby performing an operation when a set of conditions has been met and providing improved feedback.

In some embodiments, in response to detecting the lock event (e.g., 6051) corresponding to the request to lock the computer system (e.g., 600), the computer system initiates playback of the animated visual content (e.g., 610, 666, or 670) before ceasing to display the set of one or more user interface elements. In some embodiments, initiating playback of the animated visual content includes resuming playback that is stopped completely (e.g., stops and/or freezes on the first frame). In some embodiments, initiating playback of the animated visual content includes initiating playback at a different playback speed (e.g., higher or lower) than a current playback speed and/or at a playback speed that was previously used (e.g., in a locked state before unlocking). Initiating playback of the animated visual content before ceasing to display the set of one or more user interface elements in response to detecting the lock event corresponding to the request to lock the computer system allows the computer system to reduce visual distractions to the user interface before and after the computer system is transitioned from a locked state to an unlocked state, thereby performing an operation when a set of conditions has been met and providing improved feedback.

In some embodiments, in accordance with a determination that a first user account (e.g., 612) is selected (e.g., is active, was active and/or selected, was last active, and/or selected, was last active and/or selected with respect to the first user interface, and/or was selected to be active and/or to be unlock using) while displaying the first user interface (e.g., 604), the animated visual content is animated visual content corresponding to (e.g., representing, selected by, controlled by, determined by, configured by, associated with, provided by, and/or accessible to) the first user account (e.g., 610). In some embodiments, in accordance with a determination that a second user account (e.g., 806B), different from the first user account, is selected while displaying the first user interface, the animated visual content is animated visual content corresponding to the second user account (e.g., 820) different from the animated visual content corresponding to the first user account. Having animated visual content that corresponds to a particular user account based on a particular account being selected allows the computer system (e.g., 600) to automatically provide different animations for different users and provides an indication of how the computer system is configured in the locked state, thereby providing improved visual feedback, performing an operation when a set of conditions has been met without requiring further user input, improves security of the computer system, and allows the computer system to avoid burn-in of the display generation component.

In some embodiments, displaying the second user interface (e.g., 638) with the first background (e.g., 610, 666, or 670) for the second user interface includes animating the first background for the second user interface over a period of time while displaying the second user interface (e.g., at a low frame rate (e.g., I frame every 1-60 minutes) and/or at a slower frame rate than when the computer system (e.g., 600) displays animating the background for the first user interface over a period of time while displaying the first user interface). In some embodiments, displaying the second user interface with the second background for the second user interface includes animating the second background for the second user interface over the period of time while displaying the second user interface (e.g., at a low frame rate (e.g., 1 frame every 1-60 minutes) and/or at a slower frame rate than when the computer system displays animating the background for the first user interface over a period of time while displaying the first user interface). Animating a background for the second user interface over a period of time while displaying the second user interface allows the computer system to reduce visual distraction between displaying the lock screen with an animation and the unlock screen with an animation, thereby performing an operation when a set of conditions has been met without requiring further user input and providing improved feedback, and allows the computer system to avoid burn-in of the display generation component, and/or allows the computer system to reduce rate of change of content on the display and reduce resource usage required to display the content, thereby reducing power consumption of the computer system.

In some embodiments, while the computer system is in the locked state and while displaying, via the display generation component, the first user interface (e.g., 604) having the first background (e.g., 610, 666, or 670) for the first user interface that includes animated visual content, the computer system (e.g., 600) displays, via the display generation component, an indication of a time (e.g., 606) (e.g., a current time and/or a current time based on a current time setting) and a first control (e.g., 614) that, when selected, initiates a process that transitions the computer system from displaying a user interface (e.g., 604 with 610, 666, or 670) (e.g., a lock screen user interface and/or, in some embodiments, the first user interface) for a third user account (e.g., 612, 806A-806D) to a displaying a user interface for a fourth user account (e.g., 612, 806A-806D) different from the third user account. Displaying a first control that, when selected, initiates a process that transitions the computer system from displaying a user interface for a third user account to a displaying a user interface for a fourth user account different from the third user account provides the user with additional control of the computer system to display a user interface for another user, thereby providing the user with one or more additional control options with cluttering the UI.

In some embodiments, in accordance with a determination that the display (e.g., 602) has (and/or is configured to have) a first characteristic (e.g., a size and/or a resolution): the indication of the time is a first size, and the first control is a second size. In some embodiments, the first size is the same as the second size. In some embodiments, the first size is different from the second size. In some embodiments, in accordance with a determination that the display has a second characteristic different from the first characteristic, the indication of the time is a third size different from the first size, and the first control is a fourth size different from the second size. In some embodiments, the third size is the same as the fourth size. In some embodiments, the third size is different from the fourth size. In some embodiments, the first characteristic is a first set of one or more characteristics. In some embodiments, the second characteristic is a second set of one or more characteristics. In some embodiments, the first characteristic includes different values for a matching set of one or more characteristics in the second characteristic (e.g., first characteristic and second characteristic each include a different value of the same type of characteristic and/or characteristic).

In some embodiments, in response to detecting the input corresponding to the request to unlock (e.g., selection of 614 and/or password entry) the computer system, the computer system (e.g., 600) displays, via the display generation component, an animation of a first set of one or more user interface elements (e.g., 640, 642, 644, 646, 650, 648, 648A-648L, and/or 634) (e.g., icons, widgets, and/or windows) appearing (e.g., by zooming in, zooming out, fading, and/or translating (e.g., from one edge of a display to another edge of a display and/or from one position of the display to another position of the display)) while displaying the second user interface (e.g., 638) with the first background (e.g., 610, 666, or 670) for the second user interface. In some embodiments, the animation of the first of one or more user interface elements appears gradually and/or appears over a predetermined time frame (e.g., 2-20 seconds). In some embodiments, the first set of one or more user interface elements is a first set of one or more desktop user interface element. Displaying, via the display generation component, an animation of a first set of one or more user interface elements appearing while displaying the second user interface with the first background for the second user interface in response to detecting the input corresponding to the request to unlock the computer system allows the computer system to automatically reduce visual distraction to the user interface before and/or after transitioning the computer system from a locked state to an unlocked state, thereby performing an operation when a set of conditions has been met without requiring further user input and providing improved feedback.

In some embodiments, after detecting the input corresponding to the request (e.g., selection of 614 and/or password entry) to unlock the computer system, the computer system (e.g., 600) displays, via the display generation component, a second set of one or more desktop user interface elements (e.g., 640, 642, 644, 646, 650, 648, 648A-648L, and/or 634) (e.g., icons, widgets, and/or windows). In some embodiments, while displaying the second set of one or more desktop user interface element, the computer system detects a condition to transition the computer system to a respective state (e.g., a locked state, idle state, and/or a sleep state). In some embodiments, detecting the condition to transition the computer system to the respective state includes a determination being made that a user has not interacted with the computer system for a predetermined period of time (e.g., 1-10000 seconds). In some embodiments, in response to detecting the condition to transition the computer system to the respective state, the computer system ceases display (e.g., by zooming in, zooming out, fading, and/or translating (e.g., from one edge of a display to another edge of a display and/or from one position of the display to another position of the display)) of the second set of one or more desktop user interface elements while transitioning from display of the second user interface (e.g., 638) to display of the first user interface (e.g., 604) (e.g., as the animated content continues animated at a frame based on the frame being displayed and/or display before the computer system was transitioned from the locked state to an unlock state). In some embodiments, ceasing display of the second set of one or more desktop user interface elements includes displaying an animation (e.g., 668) of the second set of one or more desktop elements disappearing (e.g., disappearing gradually and/or disappearing over a predetermined time frame (e.g., 2-20 seconds)). Ceasing display of the second set of one or more desktop user interface elements while transitioning from display of the second user interface to display of the first user interface in response to detecting the condition to transition the computer system to the respective state allows the computer system to reduce visual distraction while transitioning a user interface, thereby performing an operation when a set of conditions has been met without requiring further user input and providing improved feedback.

Note that details of the processes described above with respect to method 700 (e.g., FIG. 7) are also applicable in an analogous manner to other methods described herein. For example, methods 900, 1100, 1200, 1300, 1500, 1700, and/or 1900 optionally include one or more of the characteristics of the various methods described above with reference to method 700. For example, animated visual content can be used as a desktop background that includes widgets. For brevity, these details are not repeated below.

FIGS. 8A-8J illustrate exemplary user interfaces for selecting user accounts associated with animated visual content accordance with some embodiments. The user interfaces in these figures are used to illustrate the processes described below, including the processes in FIG. 9.

FIGS. 8A-8E illustrate a computer system 600 (e.g., as described above) displaying animated backgrounds that correspond to user profiles on the computer system.

FIG. 8A illustrates computer system 600 displaying lockscreen interface 604 (e.g., as described above with respect to FIGS. 6A-6T), which is a virtual display, on display 602. Lockscreen interface 604 includes animated background 610, which is a visually dynamic video that plays in the background, and time/date indicator 606 which represents the current date and time. At the bottom of display 602, computer system 600 displays user account representation 612, which computer system 600 displays as a visual representation of the user account under which it is currently operating. In some embodiments, user account representations are animated (e.g., avatars and/or representations of a face that move, change expression, change pose, and/or change appearance over a period of time). Below user account representation 612, lockscreen interface 604 includes authentication option indicator 614, which indicates (e.g., to the user) that computer system 600 (and/or the selected user account) can be unlocked using a password and/or using biometric authentication process. Also illustrated in FIG. 8A is touch-sensitive surface 608, which is a visual representation of the location and actions of pointer 622. As illustrated in FIG. 8A, pointer 622 is hovering at a location near the bottom and to the right on display 602.

As illustrated in FIG. 8B, in response to passage of time at FIG. 8A, computer system 600 continues to play back animated background 610 (e.g., similar to as described above with respect to FIGS. 6A-6T) and displays the boat of animated background 610 at a further progression position that is further to right than in FIG. 8A. In this embodiment, animated background 610 corresponds to a user account represented by user account representation 612 (e.g., also referred to the “John Appleseed” account). In some embodiments, a user associated with (e.g., that controls) the John Appleseed account selects animated background 610 for display as a background associated with their user account. In some embodiments, the John Appleseed account corresponds to a different animated background. In some embodiments, the John Appleseed account corresponds to an animated background based on configuration (e.g., a default configuration and/or based on a configuration set by a user account). At FIG. 8B, computer system 600 detects an idle state (e.g., no input is detected from touch-sensitive surface 608 and/or a keyboard for longer than a predetermined period of time).

As illustrated in FIG. 8C, in response to detecting the idle state, computer system 600 displays user account representation cluster 806 in an expanding motion animation, which includes user account representations 806A-806D in a cluster formation around the user account representation of the user that is currently logged into computer system 600, which in this example at FIG. 8C is user account representation 612. In some examples, computer system displays cluster 806 in response to a different state and/or input (e.g., a hover input or a click input).

As illustrated in FIG. 8D, in response to continuing to detect the idle state, computer system 600 displays user account representation cluster 806 continuing the expanding motion animation. In FIG. 8D, cluster 806 is fully expanded. Computer system 600 displays the boat in animated background 610 at a progress further along its duration as advancing across display 602, similar to as described above with respect to FIG. 6B.

FIG. 8D also illustrates representations of various possible arrangements of a user account representation cluster that includes multiple user account representations (e.g., 816, 814, 812, and 806 representing from two to five user accounts). User account representation cluster 812 is a visual representation of a cluster representing four user accounts, user account representation cluster 814 is a visual representation of a cluster representing three user accounts, and user account representation cluster 816 is a visual representation of a cluster representing two user accounts. For the purposes of this example, computer system 600 displays an arrangement of five users (e.g., user account representation cluster 806). In some embodiments, the user that is displayed in the center of the cluster formation is a most recent user account (e.g., most recently logged in and/or most recently selected via a user interface) (e.g., but not necessarily the currently logged in user account). In some embodiments, computer system 600 includes a limit to the number of user accounts that can be displayed in a user account representation cluster (e.g., if computer system includes seven total user accounts, the cluster can be configured (e.g., by a user or by default) to be limited to representations corresponding to only five of those user accounts (e.g., the most recently logged in five user accounts)). In some embodiments, computer system 600 does not include a limit to the number of user account representations that can be displayed in a user account representation cluster. In some embodiments, computer system 600 displays user account representation cluster 806 when the mouse and/or keyboard have been inactive for a predetermined period of time. In some embodiments, in response to detecting the end of the idle state (e.g., when the mouse and/or keyboard become active again), computer system 600 ceases to display user account representation cluster 806 and continues to display user account representation 612 (e.g., as shown in FIG. 8B, without the other representations in a cluster formation). In some embodiments, user account representation cluster 806 is another shape (e.g., any appropriate shape that includes multiple representations).

In some embodiments, the visual prominence (e.g., size, color, shape, highlighting, and/or position) of a user account representation is based on recency (e.g., how recently the user account was logged in and/or how recently the user account was selected at a user interface). For example, the more recently computer system 600 was logged in as a certain user account, the larger that computer system 600 will display the certain user account representation (e.g., even if the most recent user is logged out). In some embodiments, the visual prominence of user account representations in a cluster are relative to each other. For example, the most recent user account is largest, and the least recent user account is smallest. In some embodiments, the relative visual prominences are each different (e.g., and required to be so) (e.g., based on an ordering). In some embodiments, a different set of one or more criteria is used to determine the prominence (e.g., size) of representations. For example, if one user is currently logged in but they are not the most recent user, their representation can be largest; however, where no users are logged in then recency can be used to determine which user account will have the largest representation. In some embodiments, the most visually prominence displayed user account representation (e.g., at the center and/or largest) is the most recently logged in user. As illustrated in FIG. 8D, computer system 600 displays user account representation cluster 806 from most recent to least recent going in a counterclockwise direction beginning on user account representation 612. Computer system 600 continues to display the progression of the boat in animated background 610 across display 602.

At FIG. 8D, computer system 600 detects input 805D, representing a hover input, on user account representation 612. In some embodiments, input 805D is detected after input that moved pointer 622 to a location corresponding to (e.g., on top of, touching, near, and/or signaling an intent directed to) user account representation 612.

As illustrated in FIG. 8E, in response to detecting input 805D on user account representation 612, computer system 600 begins to transition the user account representations of user account representation cluster 806 outward and into an expanded formation. In the example in FIG. 8E, computer system 600 displays the representations of user accounts in user account representation cluster 806 as a vertical line formation. For example, the representation of the most recent user (e.g., illustrated as user account representation 612) at the bottom (e.g., closest to authentication option indicator 614) of the expanded formation, with the expanded formation in order of most recent user to least recent user (e.g., from bottom to top). In some embodiments, computer system 600 displays the expanded formation in order of least recent user to most recent user (e.g., from bottom to top). In some embodiments, representations included in the expanded formation are arranged in any appropriate shape (e.g., indicating relative ordering). In some embodiments, the expanded formation includes more user account representations than in the user account representation cluster (e.g., where the cluster was subject to a limit on number of representations). Computer system 600 displays the boat in animated background 610 at a progress further along its duration as advancing across display 602. At FIG. 8E, computer system 600 continues to detect input 805D.

FIGS. 8F-8J illustrate the process of selecting a different user account. As illustrated in FIG. 8F, in response to detecting (e.g., and/or continuing to detect) input 805D on user account representation 612, computer system 600 continues to expand user account representation cluster 806 into an expanded formation 818 with the most recent user (e.g., illustrated as user account representation 612) at the bottom of the line. Computer system 600 displays the boat in animated background 610 at a progress further along its duration as advancing across display 602. Also illustrated in FIG. 8F is indicator 820 in a location corresponding to the user account representation 612, which computer system 600 displays to indicate the user that is currently selected. In some embodiments, computer system 600 displays an indicator (e.g., 820) at a location corresponding to a user account that is selected (e.g., whose animated background is currently playing back). In some embodiments, computer system 600 displays an indictor (e.g., 820) at a location corresponding to a user account that is currently logged in. In some embodiments, multiple user accounts can be logged in at the same time and cause different indicators to be displayed at locations corresponding to each user account that is logged in. In some embodiments, computer system 600 displays an indictor (e.g., 820) at a location corresponding to a user account that is a most recent user account. In some embodiments, computer system 600 will cease to display expanded formation 818 (e.g., illustrated in FIG. 8F) in response to detecting input corresponding to a location outside of expanded formation 818 (e.g., a click in a location to the left or right of authentication option indicator 614) (e.g., and returns to displaying only the currently selected user, similar to as shown in FIG. 8A). At FIG. 8F, computer system 600 detects input 805F representing a click on user account representation 806B corresponding to the user account “Chloe Appleseed.”

As illustrated in FIG. 8G, in response to detecting input 805F, computer system 600 displays lockscreen interface 604 (e.g., similar to as illustrated in FIG. 8A), displaying user account representation 806B above authentication option indicator 614. Computer system 600 displays a transition (e.g., crossfading) of the background of lockscreen interface 604 from the animated background that corresponds to user account representation 612 (e.g., animated background 610) into an animated background that corresponds to user account representation 806B (e.g., animated background 822). That is, computer system 600 concurrently displays animated background 610 fading out from its progress point as illustrated in FIG. 8F, and animated background 822 fading in from its first frame. In some embodiments, the transition is a transition between animated virtual content corresponding to different users. For example, the boat animation corresponds to John Appleseed and the kite animation corresponds to Chloe Appleseed. A transition between these two animation provides an indication that a currently selected user (e.g., and/or a user that computer system 600 will display most prominently in lockscreen interface 604 and/or be configured to attempt to unlock in response to input). Animated background 610 and animated background 822 are different animated virtual content. In some embodiments, computer system 600 does not display a transition between animated virtual content (e.g., changes the displayed animated visual content without a crossfading transition).

As illustrated in FIG. 8H, in response to the passage of time at FIG. 8G, the transition between animated backgrounds is finished and computer system 600 displays lockscreen interface 604 with animated background 822 faded in completely and without displaying animated background 610. Computer system begins to play back animated background 822, which FIG. 8H illustrates by progressing the kite of animated background 822 to the right across display 602.

As illustrated in FIG. 8I, computer system 600 continues to display the progression of animated background 822 across display 602. In some embodiments, if computer system 600 detects pointer 622 hovering over user account representation 806B, computer system 600 displays user account representations 612, 806A, 806C, and 806D in a cluster formation around user account representation 806B, similar to as described above with respect to FIG. 8D. In some embodiments, computer system 600 detects a click input before a hover input on user account representation 806B (e.g., before pointer 622 is stationary for longer than a predetermined period of time) and does not display the cluster formation animation (e.g., computer system 600 displays user account representation 806B as a single icon and subsequently directly displays user account representations 612, 806A, 806C, and 806D in a vertical formation and/or displays a different animation (e.g., displaying user account representations 612, 806A, 806C, and 806D as emerging from behind user account representation 806B in a straight upward direction)). At FIG. 8I, computer system 600 detects input 8051 representing a click, via touch-sensitive surface 608, on user account representation 806B.

At FIG. 8J, in response to detecting input 8051, computer system 600 expands user account representation cluster 806 outward and into expanded formation 818 (e.g., as described above with respect to FIGS. 8D-8F). FIG. 8J illustrates user account representations 806A-D in a vertical line formation, with the most recent user (e.g., user account representation 806B) displayed at the bottom and the second most recent user (e.g., user account representation 612) above user account representation 806B. Computer system 600 also illustrates indicator 820 on user account representation 806B to indicate that Chloe Appleseed's account is currently selected (e.g., due to input 805F). Computer system 600 continues to display the progression of the kite in animated background 822 across display 602, as it is specific to the user under which computer system 600 currently operates.

FIG. 9 is a flow diagram illustrating a method (e.g., method 900) for displaying a user interface in accordance with some examples. Some operations in method 900 are, optionally, combined, the orders of some operations are, optionally, changed, and some operations are, optionally, omitted.

As described below, method 900 provides an intuitive way for displaying a user interface. Method 900 reduces the cognitive burden on a user for displaying a user interface, thereby creating a more efficient human-machine interface. For battery-operated computing devices, enabling a user to display a user interface faster and more efficiently conserves power and increases the time between battery charges.

In some embodiments, method 900 is performed at a computer system (e.g., 600) that is in communication with a display generation component (e.g., a display screen and/or a touch-sensitive display) and one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, a keyboard, a mouse, and/or a button), wherein the computer system is associated with available user accounts (e.g., user accounts stored on, associated with, and/or authorized to use the computer system). In some embodiments, the computer system is a watch, a phone, a tablet, a processor, a head-mounted display (HMD) device, and/or a personal computing device.

At 902, while the computer system is in a locked state (e.g., at 604 in FIG. 8A) (e.g., at a login screen, at a lock screen, at a profile selection screen, at a screen that requires input before proceeding, and/or at a screen requesting authentication (e.g., biometric, password, and/or another credential)), the computer system (e.g., 600) displays (at 904), via the display generation component, a user interface (e.g., 604) (e.g., lock screen and/or login screen) that includes concurrently displaying (at 906) a representation of first visual content (e.g., 610, 666, or 670) (e.g., an image, a picture, a video, an animation (e.g., a GIF, a high efficiency image container (HEIC) file), a visualization, and/or media that has a visual component can be played back) corresponding to a first user account (e.g., 612) available on the computer system. In some embodiments, visual content corresponding to a user account is one or more visual content item selected (e.g., by the user account and/or by the computer system on behalf of the user account) and/or assigned (e.g., by default and/or by the computer system) to the user account. In some embodiments, the user interface includes a background (e.g., as described in relation to FIGS. 6A-6T) (e.g., a lock screen background and/or an area of the user interface that includes display of visual content content) that includes visual content corresponding to a user account that is available on the computer system. In some embodiments, the background of the user interface is, includes, and/or is included in the representation of the first visual content. In some embodiments, the user interface includes a field for entering a password. In some embodiments, the user interface includes a visual prompt (e.g., text and/or graphics) to unlock the computer system.

At 902, while the computer system is in the locked state, the computer system (e.g., 600) displays (at 904), via the display generation component, the user interface that includes concurrently displaying (at 908) a representation of a second user account (e.g., 806A, 806B, 806C, or 806D (e.g., text and/or graphical element that is associated with the second user account, such as an icon, avatar, image and/or name) available on the computer system, wherein the first user (e.g., 612) account is different from the second user account. In some embodiments, the representation of the second user account is different from the representation of the first visual content. In some embodiments, the representation of the second user account is included in a set of representations of user accounts available on the computer system (e.g., a group of representations and/or a list of representations). In some embodiments, the user interface is an account selection user interface that enables selection of an account of the use accounts available on the computer system (e.g., for unlocking the computer system and/or logging into the respective account). In some embodiments, the set of representations of respective user accounts of the available user accounts are included in the account selection user interface. In some embodiments, the one or more representations are positioned in an arrangement. In some embodiments, the arrangement is a list (e.g., a vertical and/or horizontal arrangement of representations). In some embodiments, the arrangement is a pattern, shape, and/or non-linear placement of representations (e.g., an arrangement with one representation in the center and others encircling it).

At 902, while the computer system is in the locked state, while displaying (at 910) the user interface (e.g., 604) that includes the representation of first visual content (e.g., 610) corresponding to the first user account (and, in some embodiments, while the computer system is in the locked state), the computer system (e.g., 600) detects, via the one or more input devices, an input (e.g., 805F) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) corresponding to selection of the representation of the second user account (e.g., 806B).

At 902, while the computer system is in the locked state and in response to detecting (at 912) the input (e.g., 805F) corresponding to selection of the representation of the second user account, the computer system (e.g., 600) concurrently displays, via the display generation component, a representation of second visual content (e.g., 822) corresponding to the second user account and one or more options (e.g., 614) (e.g., entering biometric data for authentication and/or entering a password for authentication) for initiating a process to unlock the computer system for the second user account (e.g., continuing to display the user interface with an updated background that includes the representation of the representation of the second visual content). In some embodiments, in response to detecting the input, the computer system ceases to display the representation of the first visual content (e.g., 610) corresponding to the first user account (e.g., 612). In some embodiments, displaying the representation of the second visual content includes replacing the representation of first visual content with the representation of the second visual content. In some embodiments, the representation of the second visual content corresponding to the second user account was not displayed before detecting the input corresponding to selection of the representation of the second user account. In some embodiments, in response to detecting an input directed to the one or more options for initiating the process to unlock the computer system for the second user account, the computer system initiates the process to unlock the computer system for the second user account. Displaying the representation of second visual content corresponding to the second user account and one or more options for initiating a process to unlock the computer system for the second user account in response to detecting the input corresponding to selection of the representation of the second user account provides the user with control to switch the locked screen user interface for another user and provides feedback that the locked screen user interface has been switched for another user, thereby providing additional control options without cluttering the user interface with additional displayed controls. Displaying different animated visual content allows the computer system to avoid burn-in of the display generation component and performs an operation when a set of conditions has been met without requiring further user input.

In some embodiments, while displaying the representation of the second visual content (e.g., 822) corresponding to the second user account, the computer system (e.g., 600) displays, via the display generation component, a representation of the first user account (e.g., 612 at FIG. 8J) available on the computer system. In some embodiments, in response to detecting the input, the computer system ceases displaying the representation of the second user account. In some embodiments, in response to detecting the input, the computer system continues displaying the representation of the second user account. In some embodiments, the representation of the first user account available on the computer system is different from the representation of the first visual content. In some embodiments, the representation of the second user account available on the computer system is different from the representation of the second visual content. Displaying, via the display generation component, a representation of the first user account available on the computer system in response to detecting the input corresponding to selection of the representation of the second user account allows the computer system to indicate that the first user account is available on the computer system while displaying a user interface for the second user, thereby providing improved feedback and providing improved security.

In some embodiments, the first visual content (e.g., 610) is animated. In some examples, the second visual content (e.g., 822) is animated. In some embodiments, displaying a representation of the first visual content includes animating display of the first visual content (e.g., as described above in relation to a respective (e.g., first or second) background for the first user interface, a respective (e.g., first or second) background for the second user interface, and/or respective (e.g., first or second) animated visual content). In some embodiments, displaying the representation of the second visual content includes animating display of the second visual content (e.g., as described above in relation to a respective (e.g., first or second) background for the first user interface, a respective (e.g., first or second) background for the second user interface, and/or respective (e.g., first or second) animated visual content). Animating display of the first visual content and animating the second visual content and animating display of the second visual content provides the user with feedback concerning visual content corresponding to a particular user, thereby providing improved feedback. Animated visual content allows the computer system to avoid burn-in of the display generation component and performs an operation when a set of conditions has been met without requiring further user input.

In some embodiments, the representation of first visual content (e.g., 610) corresponding to the first user account is displayed as a background of the user interface. In some embodiments, the representation of second visual content (e.g., 822) corresponding to the second user account is displayed as the background of the user interface. Having the representation of first visual content corresponding to the first user account as a background of the user interface and having the representation of second visual content corresponding to the second user account is displayed as the background of the user interface as the background of the user interface allows the computer system to display an indication for a particular user to which the user interface is directed, thereby providing improved feedback and providing improved security.

In some embodiments, the user interface (e.g., 604) that includes the representation of first visual content (e.g., 610) corresponding to the first user account (e.g., 612) includes a representation (e.g., 822) of the first user account being currently active. In some embodiments, displaying the user interface that includes the representation of first visual content corresponding to the first user account includes emphasizing the representation of the first user account being currently active relative to the representation of the second user account available on the computer system. In some embodiments, a representation of second visual content (e.g., 822) corresponding to the second user account (e.g., 806B) is displayed concurrently with a representation of the first user account available on the computer system and a representation of the second user account being currently active. In some embodiments, the representation of the second user account being currently active is emphasized relative to the representation of the first user account available on the computer system. In some embodiments, emphasizing a representation includes displaying the representation so that it: appears at bottom of a list (e.g., 818), appears at the top of a list, appears bigger (e.g., than other representations and/or than the representation was displayed before), and/or appears at center of an arrangement of representations (e.g., 818). Emphasizing the representation of the first user account being currently active relative to the representation of the second user account available on the computer system provides feedback to the user concerning an indication for a particular user to which the user interface is directed and an indication for one or more users to which the user interface is not directed, thereby providing improved feedback and providing improved security.

In some embodiments, while the computer system is in a locked state and in accordance with a determination that an interaction (e.g., 8051) has not occurred with the computer system for a predetermined period of time (e.g., an inactivity and/or idle period without receiving user input), the computer system (e.g., 600) displays, via the display generation component, one or more representations (e.g., 612, 806, 806A, 806B, 806C, 806D, and/or 818) corresponding to one or more user accounts (e.g., accounts that are available on the computer system, such as the representation of the second user account and/or another user account available on the computer system). Displaying, via the display generation component, one or more representations corresponding to one or more user accounts while the computer system is in a locked state and in accordance with a determination that an interaction has not occurred with the computer system for a predetermined period of time allows the computer system to display representations concerning one or more other users that are available on the computer system, thereby performing an operation when a set of conditions has been met without requiring further user input, providing improved feedback, reducing the number of inputs, and providing improved security.

In some embodiments, while displaying, via the display generation component, the one or more representations (e.g., 612, 806, 806A, 806B, 806C, 806D, and/or 818) corresponding to the one or more user accounts (e.g., such as the representation of the second user account and/or another user account available on the computer system), the computer system detects an input (e.g., 805D) (e.g., a mouse click and/or, in some embodiments, a non-mouse click (e.g., a tap input, a swipe input, a voice input, a gaze input, an air gesture, a biometric input, and/or a keyboard input)), via the one or more input devices, directed to the user interface (e.g., via and/or on a mouse and/or at a keyboard while the user interface is displayed and/or is configured to receive input from the one or more input devices (e.g., currently has focus of input and/or display)) (and, in some embodiments, detecting an input on and/or directed the computer system, such as a tap input, an air gesture, and/or a gaze input). In some embodiments, in response to detecting the input directed to the user interface, the computer system (e.g., 600) ceases to display the one or more representations (e.g., cluster 806) corresponding to the one or more user accounts. In some embodiments, ceasing to display the one or more representations corresponding to the one or more user accounts includes displaying an animation of the one or more representations disappearing. Ceasing to display the one or more representations corresponding to the one or more user accounts in response to detecting the input directed to the user interface provides the user control over the computer system to remove displayed user interface objects, thereby providing the user with one or more controls options without cluttering the user interface.

In some embodiments, a number (e.g., quantity and/or amount) of the one or more representations corresponding to the one or more user accounts (e.g., such as the representation of the second user account and/or another user account available on the computer system (e.g., 600)) that are displayed is less than a threshold number of users (e.g., less than 3, 5 or fewer, 6 or fewer, less than 8, and/or less than 9, and/or 10 or fewer,). Having a number of the one or more representations corresponding to the one or more user accounts that are displayed being less than the threshold number of users allows the computer system to limit the number of representations corresponding to the one or more user accounts being displayed, thereby preserving screen real estate.

In some embodiments, the one or more representations (e.g., 612, 806, 806A, 806B, 806C, 806D, and/or 818) of the one or more user accounts includes a representation corresponding to a third user account (e.g., 612 or 806A) (e.g., available on the computer system) available on the computer system and a representation corresponding to a fourth user account (e.g., 806C or 806D) available on the computer system (e.g., 600). In some embodiments, in accordance with a determination that activity corresponding to the third user account occurred more recently than activity corresponding to the fourth user account available on the computer system, display of the representation corresponding to the third user account is bigger than (or, in some embodiments, smaller than) display of the representation corresponding the fourth user account available on the computer system. In some embodiments, in accordance with a determination that activity corresponding to the fourth user account occurred more recently than activity corresponding to the third user account, display of the representation corresponding to the third user account available on the computer system is smaller than (or, in some embodiments, bigger than) display of the representation corresponding the fourth user account available on the computer system. In some embodiments, the representation corresponding to the third user account is different from the representation corresponding to the fourth user account. In some embodiments, the third user account is different from the fourth user account. In some embodiments, the second size is larger than or smaller than the first size. In some embodiments, the size (e.g., first size or second size) of the representation of the third user account is based on (e.g., used as a variable in the determination of, proportional to, selected according to, and/or assigned according to) how recently the third user account (and, in some embodiments, the representation of the third user account) was active (e.g., since being selected, logged in, and/or interacted with). In some embodiments, a determination that activity corresponding to a user account occurred includes a determination that activity corresponding to the representation corresponding to the user account was detected (e.g., during the first period and/or during the second period). Having the size of a representation of a particular user account be based on the recency of activity corresponding to the particular user account allows the computer system to automatically provide indications of user accounts based on the recent activity concerning the user accounts, thereby performing an operation when a set of conditions has been met without requiring further user input.

In some embodiments, the representation of the second user account (e.g., 806B) available on the computer system (e.g., 600) was displayed in response to detecting an input (e.g., 805D) (e.g., a hover input (e.g., of a pointer or cursor), a mouse click and/or, in some embodiments, a non-mouse click (e.g., a tap input, a swipe input, a voice input, a gaze input, an air gesture, a biometric input, and/or a keyboard input)) directed to a representation corresponding to the first user (e.g., 612) (e.g., for a predetermined period of time (0.05, 0.1, 0.2, 0.3, 0.5, 1, 3, or 5 seconds)). In some embodiments, a list and/or group of representations of respective user accounts available on the computer system is displayed (e.g., some and/or all and/or most user accounts that are available on the computer system) in response to detecting the input directed to the representation corresponding to the first user. Displaying the representation of the second user account available on the computer system in response to detecting an input directed to a representation corresponding to the first user allows the computer system to indicate that the second user account is available on the computer system while displaying a user interface for the first user account, thereby providing improved security and providing improved feedback.

In some embodiments, the representation of the second user account (e.g., 806B) available on the computer system (e.g., 600) includes an avatar (e.g., a graphical representation, a representation of a face, text, and/or a symbol) corresponding to the second user. Displaying the representation of the second user account available on the computer system that includes an avatar corresponding to the second user provides the user with an indication that the second user is available on the computer system, thereby providing improved security and providing improved feedback.

In some embodiments, the representation of the second user account (e.g., 806B) available on the computer system (e.g., 600) includes an avatar that changes over a predetermined period of time (e.g., 1-100 seconds) (e.g., one or more portions of a body and/or face of the avatars moves over time). In some embodiments, an avatar that changes over a predetermined period of time is an avatar that moves inside of a frame (e.g., a border forming the edge of the region in which the avatar is displayed, such as a box or a circle). In some embodiments, the avatar is a visual representation corresponding to a user account (e.g., such as a picture, video, and/or an animated representation of the face of a user associated with the user account). In some embodiments, an avatar that changes over a predetermined period of time is an avatar that changes a pose (e.g., a facial expression, an orientation, and/or a position). Displaying the representation of the second user account available on the computer system that includes the avatar that changes over a predetermined period of time provides the user with an indication that the second user is available on the computer system, thereby providing improved security and providing improved feedback. Displaying the avatar that changes over a predetermined time allows the computer system to avoid burn-in of the display generation component and performs an operation when a set of conditions has been met without requiring further user input.

In some embodiments, in response to detecting the input (e.g., 805F) corresponding to selection of the representation of the second user account (e.g., 806B), the computer system (e.g., 600) displays, via the display generation component, an animation (e.g., as in FIG. 8G) that transitions from display of the representation of first visual content (e.g., 610) corresponding to the first user account to display of the representation of second visual content (e.g., 822) corresponding to the second user account. In some embodiments, the animation is a visual transition such as a crossfading, a sliding animation, and/or a cutting animation. Displaying, via the display generation component, an animation that transitions from display of the representation of first visual content corresponding to the first user account to display of the representation of second visual content corresponding to the second user account in response to detecting the input corresponding to selection of the representation of the second user account allows the computer system to reduce visual distractions while transitioning between display of different visual content, thereby providing improved feedback.

In some embodiments, while displaying the user interface (e.g., 604) that includes the representation of first visual content corresponding to the first user account (e.g., 610) and the representation (e.g., 806B) of the second user account available on the computer system, the computer system (e.g., 600) detects an input (e.g., input directed to background of lockscreen interface 604 at FIG. 8D or 8F) (e.g., a mouse click and/or, in some embodiments, a non-mouse click (e.g., a tap input, a swipe input, a voice input, a gaze input, an air gesture, a biometric input, and/or a keyboard input)) that is not directed to the representation of the second user account available on the computer system. In some embodiments, in response to detecting the input that is not directed to the representation of the second user account available on the computer system, the computer system ceases to display the representation of the second user account available on the computer system (and, in some embodiments, one or more other representations of other user accounts that are available on the computer system). Ceasing to display the representation of the second user account available on the computer system in response to detecting the input that is not directed to the representation of the second user account available on the computer system provides the user control over the computer system to remove displayed user interface objects, thereby providing the user with one or more controls options.

In some embodiments, while the computer system is in the locked state: in accordance with a determination that the first user account is currently active (e.g., a user is logged into the first user account and/or successfully completed authentication), the computer system (e.g., 600) displays, via the display generation component, an indication (e.g., 820) that the first user account is currently active. In some embodiments, displaying an indication that a respective user account (e.g., first user account or a second user account) is currently active includes: displaying a checkmark or other symbol associated with a representation of a currently active account, changing the color of the representation of the currently active account, changing the color of a border or visual region corresponding to the currently active account, and/or changing another visual appearance of the representation of the currently active account (e.g., changing its size and/or location on the display). In some embodiments, while the computer system is in the locked state: in accordance with a determination that the first user account is not currently active, the computer system forgoes displaying, via the display generation component, the indication that the first user account is currently active. In some embodiments, in accordance with a determination that the second user account is currently active (e.g., a user is logged into the first user account), the computer system displays, via the display generation component, the indication that the second user account is currently active; and in accordance with a determination that the second user account is not currently active, the computer system does not display, via the display generation component, the indication that the second user account is currently active. In some embodiments, the indication that the second user is currently active is displayed concurrently with the indication that the first user is currently active (e.g., two users are logged in at the same time, but the computer system is locked). Choosing to display an indication that the first user account is currently active when prescribed conditions are met allows the computer system to automatically provide an indication based on the first user account being active, thereby performing an operation when a set of conditions has been met without requiring further user input.

In some embodiments, the user interface (e.g., 604) that includes the representation of first visual content corresponding to the first user account (e.g., 610) available on the computer system (e.g., 600) and the representation of the second user account (e.g., 806B) available on the computer system includes: one or more options (e.g., 614) to initiate a process to unlock the computer system for the first user account. In some embodiments, the user interface that includes the representation of first visual content corresponding to the first user account available on the computer system and the representation of the second user account available on the computer system includes a representation of the first user account (e.g., 612) (e.g., text and/or graphical element that is associated with the second user account, such as an icon, avatar, image and/or name). In some embodiments, while displaying the one or more options to initiate the process to unlock the computer system for the first user account, the computer system detects an input (e.g., a mouse click and/or, in some embodiments, a non-mouse click (e.g., a tap input, a swipe input, a voice input, a gaze input, an air gesture, a biometric input, and/or a keyboard input)) directed to the one or more options to initiate the process to unlock the computer system for the first user account; and in some embodiments, the input directed to the one or more options to initiate the process to unlock the computer system for the first user account includes a set of one or more of: detecting entry of a password and/or passcode, and/or detecting input of biometric data (e.g., facial data and/or fingerprint data). In some embodiments, in response to detecting the input directed to the one or more options to initiate the process to unlock the computer system for the first user account, the computer system initiates the process to unlock the computer system for the first user account (and, in some embodiments, without initiating the process to unlock the computer system for the second user account and/or another user account). In some embodiments, initiating the process to unlock the computer system for the first user account includes displaying, via the display generation component, a password and/or secret key input field, causing one or more inputs devices (e.g., a camera, a fingerprint sensor, and/or a microphone) to capture biometric data. In some embodiments, the process to unlock the computer system for the first user account is successful. In some embodiments, in accordance with a determination that the process to unlock the computer system for the first user account is successful, the computer system unlocks the computer system for the first user account (e.g., displays a home screen interface for the first user account and/or enables additional operations that are not available when locked). In some embodiments, the process to unlock the computer system for the first user account is not successful. In some embodiments, in accordance with a determination that the process to unlock the computer system for the first user account is not successful, the computer system does not unlock the computer system for the first user account and/or displays an indication corresponding to and/or representing an unsuccessful unlock operation (e.g., displays the options to initiate the process to unlock again (e.g., as displayed prior to the input), displays a message and/or error, and/or displays a visual indication corresponding to the unlock operation not being successful). Initiating the process to unlock the computer system for the first user account in response to detecting the input directed to the one or more options to initiate the process to unlock the computer system for the first user account provides the user with a control option to initiate the process to unlock the computer system for the first user account, thereby providing the user with one or more controls options.

Note that details of the processes described above with respect to method 900 (e.g., FIG. 9) are also applicable in an analogous manner to other methods described herein. For example, methods 700, 1100, 1200, 1300, 1500, 1700, and/or 1900 optionally include one or more of the characteristics of the various methods described above with reference to method 900. For example, animated visual content can be used as background for a lockscreen interface. For brevity, these details are not repeated below.

FIGS. 10A-10AT illustrate exemplary user interfaces for placing and interacting with widgets on a desktop interface, in accordance with some examples. The user interfaces in these figures are used to illustrate the processes described below, including the processes in FIGS. 11, 12, and 13.

FIGS. 10A-10D illustrate editing widgets on a desktop interface. FIG. 10A illustrates computer system 600, which includes display 602 (e.g., as described above). As illustrated in FIG. 10A, desktop interface 638 includes a first group of widgets (e.g., clock widget 1010, notes widget 1012, and photos widget 1014) located on the left side of desktop interface 638 and a second group of widgets (e.g., maps widget 1016 and music widget 1018) located near the middle of desktop interface 638. As illustrated in FIG. 10A, the widgets in the first group are aligned with each other by their top left corners due to being within a predetermined proximity to one another. That is, while the widgets are not identical in shape and/or size, their top left corners align along a vertical axis. In some embodiments, regardless of size and/or shape, each widget maintains the same amount of space between other widgets (e.g., widgets of different shapes and/or dimensions have the same amount of space between them as widgets of the same shape and/or dimensions). In some embodiments, computer system 600 aligns widgets by their top right corners, their bottom right corners, their bottom left corners, and/or their centers. In some embodiments, computer system aligns widgets by one or more edges (e.g., an edge of each respective widget). As illustrated in FIG. 10A, the widgets in the second group are also aligned by their top left corners. Also, in this embodiment, the first group of widgets is different from the second group of widgets. In some embodiments, widgets 1016-1018 are aligned with each other but are not aligned in any relation to widgets 1010-1014. As illustrated in FIG. 10A, widgets 1016-1018 are not aligned with any relation to the top left corners (e.g., or any corners and/or centers) of widgets 1010-1016.

As also illustrated in FIG. 10A, desktop interface 638 includes icon 1022 (e.g., labeled as B), icon 1024 (e.g., labeled as C), icon 1026 (e.g., labeled as A), and icon 1028 (e.g., labeled as D) in the top right corner of desktop interface 638. In some embodiments, icons 1022-1028 can be positioned at other locations on desktop interface 638 (e.g., on the background, within a permitted region of desktop interface 638, and/or a space not occupied by other user interface elements (e.g., icons and/or widgets)). As illustrated in FIG. 10A, icon 1024 is a stack of icons and represents multiple icons (e.g., and/or files, folders, or other element) grouped together under the label of “C” (e.g., grouped according to some configuration, such as by category, by type, and/or manually). In some embodiments, icons 1022-1028 are representations of files (e.g., icon 1022, 1026, and 1028), folders (e.g., icon 1024), photos, and/or documents that are stored on computer system 600.

As illustrated in FIG. 10A, within desktop interface 638, computer system 600 includes application dock 648 (e.g., as described above) at the bottom of desktop interface 638. In some embodiments, computer system 600 displays application dock 648 on a side/edge of desktop interface 638. As illustrated in FIG. 10A, application dock 648 includes icons 648A-L (e.g., as described above). FIG. 10A also illustrates window 1020 near the center of and overlaid on desktop interface 638, which is an internet browser window of a browser application on computer system 600. In some embodiments, window 1020 is in a different location of desktop interface 638 than illustrated in FIG. 10A. Also illustrated in FIG. 10A is touch-sensitive surface 608 (e.g., as described above). At FIG. 10A, computer system detects input 1005A, via touch-sensitive surface 608, representing a right click on (e.g., directed to and/or at a location of) the background of desktop interface 638 (e.g., not directed to a user interface element on desktop interface 638, such as an icon, widget, and/or control).

As illustrated in FIG. 10B, in response to detecting input 1005A on desktop interface 638, computer system 600 displays menu 1030, which includes controls that allow various operations for interacting with the desktop (e.g., reorder icons, arrange icons, and/or create a new folder), at the location of right click input 1005A. As illustrated in FIG. 10B, menu 1030 includes edit control 1030A, which allows a user to enter an editing mode associated with desktop interface 638. In some embodiments, an editing mode is a mode for editing widgets. At FIG. 10B, computer system 600 detects input 1005B representing a click directed to a location of edit control 1030A. Input 1005B is represented on touch-sensitive surface 608.

As illustrated in FIG. 10C, in response to detecting click input 1005B, computer system 600 activates “edit mode,” which is mode that allows a user to manipulate widgets with respect to the desktop. FIG. 10C illustrates computer system 600 displaying widget gallery interface 1034, in this embodiment extended from the bottom edge of desktop interface 638, overlaying desktop interface 638 window 1020. In some embodiments, computer system 600 displays widget gallery interface 1034 at a different location on desktop interface 638 than is illustrated in FIG. 10C (e.g., from the top edge of desktop interface 638, from a side edge of desktop interface 638, and/or unattached to an edge and overlaying a portion of desktop interface 638). In some embodiments, computer system 600 displays widget gallery interface 1034 in response to a determination that the desktop enters edit mode. In some embodiments, widget gallery interface 1034 does not appear when in editing mode. In some embodiments, widget gallery interface 1034 is displayed in response to computer system 600 detecting an input (e.g., 1005B and/or another input). In some embodiments, widget gallery interface 1034 is displayed while computer system 600 is in edit mode or in a regular mode of operation (e.g., a non-edit mode in which widgets are not configured to be edited but can be interacted with respect to their functionality).

As illustrated in FIG. 10C, while in edit mode (e.g., in response to detecting click input 1005B), computer system 600 ceases to display application dock 648. In some embodiments, computer system 600 continues to display application dock 648 while in the edit mode and/or concurrently with displaying widget gallery interface 1034. As illustrated in FIG. 10B, widget gallery interface 1034 includes categories region 1036, suggestions region 1038, widget region 1048, and devices region 1040. In some embodiments, categories region includes categories 1036A-1036I, which computer system 600 can navigate to (e.g., in response to receiving input and/or selection of a respective category) and, in response, display available widgets relative to the selected respective category in widgets region 1048 (e.g., available widgets in a selected category). In some embodiments, devices region 1040 indicates a device is the provider (e.g., source, manager, and/or arbiter) of widget data used by the widget.

As illustrated in FIG. 10C, while in edit mode (e.g., in response to detecting click input 1005B), computer system 600 displays notification interface 1050 in the top right corner of desktop interface 638, overlaying and obscuring a portion of desktop interface 638 that includes icons 1022-1028. In some embodiments, computer system 600 displays notification interface 1050 at a different location on desktop interface 638 than is illustrated in FIG. 10C (e.g., from the top or bottom edge of desktop interface 638, from a different side edge of desktop interface 638). As illustrated in FIG. 10C, notification interface 1050 includes widgets 1050A-1050F in edit mode. In some embodiments, computer system 600 displays notification interface 1050 in response to desktop interface 638 entering edit mode. In some embodiments, notification interface 1050 does not appear in response to entering edit mode. In some embodiments, notification interface 1050 is displayed in response to computer system 600 detecting a user input. In some embodiments, notification interface 1050 is displayed while computer system 600 is in edit mode or in a regular mode of operation (e.g., a non-edit mode in which widgets are not configured to be edited but can be interacted with respect to their functionality). In some embodiments, computer system 600 configures notification interface 1050 to be in an edit mode in accordance with a determination that the desktop interface 638 is in an edit mode.

As illustrated in FIG. 10C, while in editing mode, computer system 600 displays widgets in a receded state (e.g., having a deemphasized visual appearance as compared to when the widgets are not in a receded state, such as illustrated in FIG. 10B). In some embodiments, computer system 600 displays other user interface elements (e.g., other than widgets such as icons and/or controls) in a receded state. In some embodiments, the deemphasized visual appearance of items on the desktop includes a visual appearance defined by one or more features related to color, opacity, saturation, sharpness, and/or brightness. In some embodiments, items having a deemphasized visual appearance are partially translucent (e.g., and pass through (e.g., and/or take on the appearance of) visual properties of a background of the user interface (e.g., receded widget on a red background appears with at least some red coloring (e.g., simulating translucency)). In some embodiments, the deemphasized visual appearance is a desaturated version of a non-receded appearance. In some embodiments, the deemphasized visual appearance uses brightness and/or contrast characteristics derived from the non-receded state and/or color characteristics derived from the background.

As illustrated in FIG. 10C, computer system 600 displays widgets placed on desktop interface 638 (e.g., widgets 1010-1018) with a deemphasized appearance while in edit mode. Notably, computer system 600 displays widgets 1010-1018 as appearing darker in FIG. 10C while displayed with a deemphasized appearance than in FIG. 10A, in which widgets 1010-1018 appear with an emphasized visual appearance (e.g., also referred to as non-deemphasized and/or non-receded visual appearance). In some embodiments, computer system 600 displays widgets as emphasized while in edit mode. As illustrated in FIG. 10C, widgets in notification interface 1050 are displayed with a deemphasized appearance while in edit mode. In some embodiments, widgets in notification interface 1050 are displayed with an emphasized appearance while in edit mode.

As illustrated in FIG. 10C, computer system 600 displays widgets 1010-1018 with a deemphasized visual appearance while in edit mode. In some embodiments, computer system 600 provides the ability to configure settings that control the appearance of widgets, including a setting to disable one or more widgets displayed with a deemphasized appearance. For example, computer system 600 provides an option to disable the automatic switching to a deemphasized visual appearance of widgets (e.g., so that they always appear in their non-receded state (e.g., widgets 1010-1018 appearing as they did in FIG. 10A.)) at the moment that computer system 600 detects the presence of edit mode. At FIG. 10C, computer system 600 detects input 1005C, representing a click and drag, on widget 1048A within widgets region 1048 of widget gallery interface 1034. Input 1005C is represented on touch-sensitive surface 608.

FIGS. 10C-10D illustrate an input being a drag input of a widget from the gallery to the background of the desktop of computer system 600. As illustrated in FIG. 10D, in response to detecting input 1005C, computer system 600 ceases to display notification interface 1050 and displays a top portion of widget gallery interface 1034 as partially visible from behind application dock 648. In some embodiments, computer system 600 resumes displaying widget gallery interface 1034 and/or notification interface 1050 in response to ceasing to detect input 1005C.

FIG. 10D also illustrates grid 1052 (e.g., merely as a visual aid and not necessarily displayed by computer system 600) formed around the first group of widgets that includes widget 1010, widget 1012, and widget 1014. In this embodiment, grid 1052 is based on (e.g., aligned with, generated with respect to, is affected by, and/or is defined by locations of widgets within) the first group of widgets. Grid 1052 illustrates axes (e.g., vertical and horizontal) formed by the positions and dimensions of the first group of widgets. In some embodiments, one or more widgets can be aligned to the axes and/or be “snapped to” (e.g., automatically moved to) a snapping location based on the grid. For example, in response to computer system 6000 detecting a request to place a widget with respect to one or more widgets in the first group of widgets forming the grid, the widget can be placed in one of grid space 1052A, grid space 1052B, grid space 1052C, grid space 1052D, or grid space 1052E (e.g., depending on a location corresponding to (e.g., at the location of) the request to place the widget (e.g., the release of a drag input or during drag input)). In spaces where applicable (e.g., in this example, to the right and/or under existing widgets of the first group), grid spaces 1052A-1052E are illustrated in FIG. 10D (e.g., merely as a visual aid and not necessarily displayed by computer system 600) to illustrate the potential snapping areas (also referred to as a snapping location) of widget 1048A as it is being dragged on desktop interface 638. In FIG. 10D, input 1005C causes computer system 600 to display widget 1048A as being dragged toward the bottom of widget 1014. In some embodiments, a snapping area is an area (e.g., one or more locations) to where a widget can be snapped that corresponds to at least one other widget and/or a grid defined with respect to one or more widgets. As computer system 600 displays widget 1048A being dragged, computer system 600 displays the widget's border as being dotted, which indicates that it is in the process of being moved and is not yet placed anywhere on the desktop or within a menu. In some embodiments, a widget that is being moved maintains a solid border (e.g., and/or otherwise does not change in appearance relative to before and/or after being placed).

In FIG. 10D, computer system 600 also displays grid 1054 around the area previously occupied by the second group of widgets that includes widget 1016 and widget 1018 (e.g., as illustrated in comparing the location of widget 1016 and widget 1018 in FIG. 10C to the location of Grid 1054 in FIG. 10D. Grid 1054 divides widgets into their own spaces and illustrates the possible locations to which a widget can snap to align with other widgets. In spaces where applicable (e.g., in this example, to the right, left, top, and/or under existing widgets), computer system 600 displays grid spaces 1054A-1054G to illustrate the potential snapping areas of widget 1048A in the case that it is dragged near widgets 1016-1018. Note that the grid spaces are the size of widget 1048A in order to illustrate the display of the potential placement of the widget that is being dragged. That is, grid spaces are illustrated where widget 1048A would snap to if it was dragged to that location, and how it would appear. In some embodiments, grid spaces are displayed (e.g., while a widget is being moved and/or while desktop interface is in an edit mode). In some embodiments, grid spaces are a different shape/size than the widget that is being moved (e.g., the size of a nearby widget, the shape of a nearby widget). In some embodiments, grids are not a visual part of the user interface but displayed as visual aid for the purposes of this example to conceptualize potential snapping areas. As described above in relation to FIG. 10A, widgets are aligned by their top left corners, which causes computer system 600 to display the grid spaces aligning to the nearest existing widget (e.g., even if asymmetrical to the grid space) by their top left corners. At FIG. 10D, computer system 600 detects continuation of input 1005C, which is represented on touch-sensitive surface 608.

FIGS. 10E-10G. illustrate schematics that represent the process of widgets snapping to/aligning with other widgets.

FIG. 10E is a schematic separate from the user interfaces described above and is intended to illustrate the process of snapping a widget to a location (e.g., as described with respect to and illustrated in FIG. 10D). FIG. 10E illustrates widget 1050D at a first location that is outside of snapping region 1056 of widget 1010. In this embodiment, widget 1010 is an existing widget on the desktop of computer system 600 and widget 1050D, as indicated by its dotted line border, is a widget that is being moved toward the location of widget 1010. FIG. 10E includes an illustration of snapping region 1056 around widget 1010, which represents a region in which snapping is configured to occur in conjunction with a widget being placed (e.g., while being dragged and/or in response to drag input ending) within (e.g., in whole or in part) the region. As illustrated in FIG. 10E, snapping region 1056 is defined by a border that is separated from the edge of widget 1010 by a distance that is one-third of the width of widget 1010. In some embodiments, snapping region 1056 is a representation of the proximity in which a widget must be in order to snap to a location that is aligned with widget 1010 (e.g., and/or a grid formed by widget 1010 and one or more other widgets). That is, if a widget is not within snapping region 1056, it will not align with widget 1010, as illustrated in FIG. 10E by widget 1050D being outside of snapping region 1056. In some embodiments, snapping region 1056 is a different distance than one-third of the width of the widget 1010. In some embodiments, widgets align with other widgets even when outside of the snapping region. In some embodiments, a snapping region is displayed while moving a widget. In some embodiments, a visual indication of a snapping region is displayed while a widget is within snapping distance of the snapping region (e.g., the visual indication of the snapping region is displayed in response to the widget being dragged within the snapping distance of the snapping region). In some embodiments, a visual indication of a snapping region is not displayed while a widget is outside of a snapping distance of the snapping region (e.g., the visual indication of the snapping region ceases to be displayed in response to the widget being dragged within the snapping distance of the snapping region). In some embodiments, a visual indication for a first snapping region ceases to be displayed in conjunction with starting to display a visual indicator for a second snapping region that is different from the first snapping region (e.g., when the widget is moved from being closer to the first snapping region to being closer to the second snapping region). In some embodiments, a visual indication of a snapping region has a size and/or shape that corresponds to a size and/or shape of the widget that is being moved (e.g., the visual indication indicates where the widget will be displayed if the input ends while the widget is within the snapping distance of a corresponding snapping region). In some embodiments, a first snapping distance at which a visual indication of a snapping region starts to be displayed is different from a second snapping distance at which the visual indication of the snapping region ceases to be displayed (e.g., to avoid rapidly displaying and ceasing to display the visual indicator if the widget is held near the first snapping distance). In some embodiments, a snapping region is not displayed while moving a widget (e.g., remains hidden, but snapping behavior and distance remain the same).

FIG. 10F illustrates widget 1050D at a second location while being dragged to be within snapping region 1056. At FIG. 10F, the dragging input is released.

At FIG. 10G, in response to detecting, while widget 1050D is at the second location, the release of the dragging input that caused widget 1050D to move to the second location, widget 1050D moves to a snapping location different from the second location. At the release of the input, the top left corners of widget 1010 and 1050D align and widget 1050D is placed (e.g., on a desktop interface or a notification interface).

FIGS. 10H-10P illustrate the interactions between widgets and icons on the desktop. As illustrated in FIG. 10H, computer system 600 displays widget 1048A at a snapping location (e.g., within grid space 1052E of FIG. 10C) in response to the end of input 1005C. Note that, as described above in relation to FIG. 10G, widget 1048A snaps to align with widget 1014 after click and drag input 1005C is released. In some embodiments, a widget snaps prior to release of an input (e.g., while the input is still detected).

Also illustrated in FIG. 10H, in response to ceasing to detect input 1005C, computer system 600 resumes displaying widget gallery interface 1034 and notification interface 1050 in an edit mode. FIG. 10H also illustrates widgets on the desktop with a deemphasized appearance. Note that computer system 600 no longer displays widget 1048A in widget gallery interface 1034 after it is placed on the desktop. In some embodiments, computer system 600 continues displaying widget 1048A in widget gallery interface 1034 after it is placed on the desktop. At FIG. 10H, computer system 600 detects input 1005H, via touch-sensitive surface 608, representing a click and drag on widget 1050A, which is represented on touch-sensitive surface 608.

As illustrated in FIG. 10I, in response to detecting input 1005H, computer system 600 moves widget 1050A on the desktop. As illustrated in FIG. 10I, in response to detecting input 1005H, computer system 600 ceases to display widget gallery interface 1034 and notification interface 1050. As illustrated in FIG. 10I, in response to detecting input 1005H, computer system 600 deemphasizes (and/or continues deemphasis of) widgets and icons on the desktop. In some embodiments, computer system 600 does not deemphasize widgets and/or icons during and/or after placement. In some embodiments, computer system 600 deemphasizes widgets but not icons. In some embodiments, computer system 600 deemphasizes icons but not widgets. At FIG. 10I, computer system 600 detects input 1005I, which is a continuation of input 1005H (e.g., a continuous drag input that has not been released), on widget 1050A.

As illustrated in FIG. 10J, in response to detecting input 1005I, computer system 600 places widget 1050A between icon 1024 and icon 1026. In FIG. 10J, computer system 600 adjusts (e.g., moves) icon 1026 and icon 1028 to make space for widget 1050A. At FIG. 10J, computer system 600 has moved icons on desktop interface 638 out of the way of a widget being placed (e.g., while being dragged) so as to avoid conflict between the widget that is being moved and other user interface elements (e.g., icons). In this way, widgets and user interface elements do not visually interfere with each other. In some embodiments, computer system 600 moves one or more widgets that are part of desktop interface 638 in order to avoid conflict with a widget being placed. In some embodiments, both existing widgets and icons move to avoid conflict. In some embodiments, icons do not move and computer system 600 cannot place a widget between icons and instead snaps widget to a location next to icons. At FIG. 10J, computer system 600 detects click and drag input 1005J on widget 1050A, which is represented on touch-sensitive surface 608. In some embodiments, computer system 600 moves one or more user interface elements while input representing a request to move the widget continues to be detected (e.g., icons move out of the way while widget is being dragged around the desktop). In some embodiments, computer system 600 moves one or more user interface elements in response to ceasing to detect the input representing a request to move the widget (e.g., icons do not move out of the way while widget is being dragged around the desktop, but do move in response to widget being dropped and/or the moving input otherwise ending and indicating an intent to place the widget at the respective location). At FIG. 10J, computer system 600 detects input 1005J, which is a continuation of input 1005I (e.g., a continuous drag input that has not been released), on widget 1050A.

As illustrated in FIG. 10K, in response to ceasing to detecting input 1005J and the end of input 1005J (e.g., indicating an intent to place widget 1050A at its location in FIG. 10K), computer system 600 places widget 1050A at the location below icon 1028. In response to computer system 600 moving widget 1050A from between icon 1024 and icon 1026, computer system 600 returns icon 1024 and icon 1026 to their original positions as illustrated in FIG. 10D. That is, icons do not remain separated after a widget is moved from in between them. In some embodiments, icons remain separated (e.g., indefinitely and/or for a predetermined period of time) after a widget is moved from in between them (e.g., and after the widget is subsequently moved).

While displaying a desktop interface as illustrated in FIG. 10K, computer system 600 detects an input representing a request to exit edit mode. As illustrated in FIG. 10L, in response to the input representing a request to exit edit mode, computer system 600 exits edit mode and ceases to display widget gallery interface 1034 and notification interface 1050. As illustrated in FIG. 10L, in response to the input representing a request to exit edit mode, computer system 600 ceases to display a deemphasized visual appearance of widgets and icons on the desktop. At FIG. 10L, computer system 600 detects, via touch-sensitive surface 608, input 1005L representing a right click on desktop interface 638.

As illustrated in FIG. 10M, in response to detecting right click input 1005L, computer system 600 displays menu 1030 from FIG. 10B. Menu 1030 includes order control 1030B, which allows a user to order icons on the desktop alphabetically. At FIG. 10M, detects, via touch-sensitive surface 608, input 1005M click on order control 1030B.

As illustrated in FIG. 10N, in response to detecting click input 1005M, computer system 600 orders icons 1022-1028 alphabetically so that they are ordered as: icon 1026 (e.g., labeled A), icon 1022 (e.g., labeled B), icon 1024 (e.g., labeled C), and icon 1028 (e.g., labeled D). As illustrated in FIG. 10N, widget 1050A remains in its place and does not move in response the ordering operation that affects other user interface elements on desktop interface 638. At FIG. 10N, computer system 600 detects, via touch-sensitive surface 608, input 1005N representing a click on icon 1024, which is a stack of grouped icons.

As illustrated in FIG. 10O, in response to detecting input 1005N, computer system 600 expands the stack of grouped icons that were represented by group icon 1024. In FIG. 10O, computer system 600 expands each icon onto the display into icon 1024A (e.g., labeled as C2) and icon 1024B (e.g., labeled as C3). As part of expanding the stack of icons, computer system 600 reflows the desktop icons in a way that avoid conflict with widget 1050A. For example, computer system 600 displays icon 1024A below icon 1024 (e.g., which now appears as a downward arrow that, when selected, causes icons 1024A and 1024B to be displayed in a stack again) and displays icon 1024B and icon 1028 as forming a new column to the left of the original icon column. Computer system 600 forms a new column so as to avoid conflict with and to leave room for widget 1050A, causing icon 1028 to become part of the new column. At FIG. 10O, computer system 600 detects, via touch-sensitive surface 608, input 1005O representing a click and drag on widget 1050A, which selects and drags widget 1050A to application icon 648L. In response to detecting input 1005O, computer system 600 removes widget from the desktop interface 638 (e.g., deletes the widget from the desktop). As illustrated in FIG. 10P, in response to detecting click and drag input 1005O to application 648A, computer system 600 ceases to display widget 1050A (e.g., computer system 600 deletes the widget in response to input 1005O).

FIGS. 10P-10Q illustrate moving a widget from desktop interface 638 to notification interface 1050. At FIG. 10P, while desktop interface 638 is in edit mode, computer system 600 detects, via touch-sensitive surface 608, input 1005P representing a request to move widget 1016 to allocation on notification interface 1050. While in edit mode, computer system 600 displays widget gallery interface 1034 and notification interface 1050 and deemphasizes widgets 1010-1018. In some embodiments, computer system 600 detects an input to edit widgets but does not display edit mode. As illustrated in FIG. 10P, notification interface 1050 includes a blank space where widget 1050A was previously located (e.g., as in FIG. 10H). At FIG. 10P, computer system 600 detects, via touch-sensitive surface 608, input 1005P representing a click and drag of 1016 to the empty space in notification interface 1050 indicated by the arrow.

FIGS. 10Q-10V illustrate the interactions of open windows with the desktop. As illustrated in FIG. 10Q, in response to detecting input 1005P, computer system 600 places widget 1016 in notification interface 1050. Note that computer system 600 places widget 1016 automatically once computer system 600 detects that widget 1016 is within a predetermined proximity to a region of notification interface 1050. At FIG. 10Q, computer system 600 detects, via touch-sensitive surface 608, input 1005Q representing a click on desktop interface 638 at a location that does not correspond to a user interface element of desktop interface 638.

As illustrated in FIG. 10R, in response to detecting input 1005Q, computer system 600 exits edit mode and displays widgets and icons on desktop interface 638 as being in their non-receded state. That is, computer system 600 displays widgets and icons with an emphasized appearance. At FIG. 10R, computer system 600 detects, via touch-sensitive surface 608, input 1005R representing a click on icon 1026.

As illustrated in FIG. 10S, in response to detecting input 1005R, computer system 600 displays icon 1026 as an open folder illustrated by window 1058 that overlays desktop interface 638 (e.g., overlaying the background and user interface element that are part of desktop interface 638). In some embodiments, window 1058 is a folder that includes documents that are saved to computer system 600. As illustrated in FIG. 10S, window 1058 includes a file that is a photo, labeled in FIG. 10S as file 1032. Note that, in response to computer system 600 opening window 1058, computer system 600 displays widgets and icons on the desktop as having a deemphasized appearance. In some embodiments, opening a window 1058 causes the window to be selected (e.g., and the desktop interface 638 to be not selected). In some embodiments, while desktop interface 638 is not selected (e.g., unselected), one or more types of user interface elements are displayed in a receded state having a deemphasized appearance. At FIG. 10S, computer system 600, via touch-sensitive surface 608, detects input 1005S representing a click and drag of file 1032 to desktop interface 638.

At FIG. 10T, in response to detecting input 1005S, computer system 600 places file 1032 as an icon on desktop interface 638 and corresponding to a location to which it was dragged (e.g., below icon 1028). At FIG. 10T, computer system 600 has opened additional windows (e.g., in response to one or more user inputs), window 1020 and window 1062. As illustrated in FIG. 10T, window 1020 and window 1062 are displayed concurrently with window 1058. At FIG. 10T, window 1062 is currently selected, and so user interface elements of desktop interface 638 are in a receded state with deemphasized appearance. At FIG. 10T, computer system 600 detects, via touch-sensitive surface 608, input 1005T representing a multi-touch (e.g., with four fingers) spreading gesture (e.g., the four fingers move outward from each other). In this embodiment, input 1005T represents a show desktop request (e.g., display a desktop interface 638 and one or more of its user interface elements without being obscured by other interfaces (e.g., windows)). In some embodiments, input 1005T is a different input (e.g., other than a multi-touch spreading gesture).

As illustrated in FIG. 10U, in response to detecting input 1005T, computer system 600 activates a show desktop mode. In the show desktop mode, computer system 600 ceases to display window 1058, window 660, and window 1062 (e.g., temporarily hiding them from view on display 602). In the show desktop mode, desktop interface 638 is displayed with little or no obstruction (e.g., by one or more windows). In some embodiments, one or more windows are moved in show desktop mode but still partially displayed (e.g., a small portion of each window displayed at the edge of display 602) and/or reduced in a non-obstructing manner (e.g., reduced in size and/or moved). At FIG. 10U, computer system 600 slides window 1058, window 1020, and window 1062 across and off display 602 and out of view to allow the user a quick method of viewing the desktop without closing windows that are open.

At FIG. 10V computer system 600 detects, via touch-sensitive surface 608, an input representing a request to end show desktop mode, and, in response to detecting the input, computer system 600 redisplays window 1058, window 1020, and window 1062 on display 602 at their original locations as illustrated in FIG. 10V. That is, computer system 600 returns window 1020 and window 1062 from hiding from view of the user. At FIG. 10V, computer system 600 detects click input 1005VA on exit control 1060, click input 1005VB on exit control 1064, and click input 1005VC on exit control 1066. Click input 1005VA, click input 1005VB, and click input 1005VC are represented separately on touch-sensitive surface 608. In the example of FIG. 10V, each of click input 1005VA, click input 1005VB, and click input 1005VC is a separate click input, but are illustrated with respect to a single figure. In some embodiments, in response to detecting each of input 1005VA, click input 1005VB, and click input 1005VC, the window corresponding to each input is closed. In some embodiments, in response to detecting that a last remaining window is closed, computer system 600 causes desktop interface 638 to be selected (e.g., and causes user interface elements of the desktop to change from receded to non-receded, similar to as shown in FIGS. 10Q-10R).

FIGS. 10W-10AM illustrate the process of placing and interacting with widgets that correspond to an application on the same or different computer system. Widgets that are placed on the desktop can be associated with an application on (e.g., installed on, executing on, controlled by, and/or part of) computer system 600 or on another device (e.g., computer system 1100 of FIG. 10AC). As illustrated in FIGS. 10W-10AM, two versions (e.g., from different sources of data) of a calendar widget are placed on the desktop. A personal calendar widget (e.g., depicting Home Event 1 and Home Event 2) of one version of a calendar widget corresponds to a user's personal email account. A work calendar widget (e.g., depicting Work Event 1 and Work Event 2) corresponds to a user's work email account which corresponds to an application on a different computer system, computer system 1100.

At FIG. 10W, in response to detecting click input 1005VA, click input 1005VB, and/or click input 1005VC, computer system 600 ceases to display window 1058, window 1020, and window 1062. In FIG. 10W, desktop interface 638 is in an edit mode and category 1036I (e.g., corresponding calendar widgets), of categories region 1036 within widget gallery interface 1034, is selected. In some embodiments, in response to detecting an input representing selection of category 1036I, computer system 600 displays widgets region 1048 as being labeled as “Calendar” and populated by calendar related widgets. Also illustrated in FIG. 10W, devices region 1040, which includes controls that allow selection of a device (e.g., computer system 600 and/or computer system 1100) that is the source of the widgets populating widgets region 1048. In FIG. 10W, devices region 1040 includes device selector control 1068, which allows a user to access widgets from computer system 600 (e.g., labeled “on this device”), and device selector control 1070, which allows a user to access widgets from computer system 1100 (e.g., labeled “from phone”). As illustrated in FIG. 10W, device selector control 1068 is displayed as being the selected control because it is surrounded by a solid line border indicated selection. Because “Calendar” is the selected category, computer system 600 displays widget 1072 in widgets region 1048 to the “Calendar” application of computer system 600. At FIG. 10W, computer system 600 detects, via touch-sensitive surface 608, input 1005W representing a request to add (e.g., via drag and drop) widget 1072 (e.g., a work calendar widget corresponding to a calendar application on computer system 600) to desktop interface 638 at the location corresponding to the end of the arrow of input 1005W.

As illustrated in FIG. 10X, in response to detecting input 1005W, computer system 600 places widget 1072 on the desktop to the right of widget 1010 (e.g., in the grid space 1052A as illustrated in FIG. 10D). In FIG. 10X, computer system 600 ceases to display widget 1072 in widgets region 1048. In some embodiments, computer system 600 continues to display widget 1072 in widgets region after placing (e.g., an instance of) widget 1072 on another interface (e.g., desktop interface 638 and/or notification interface 1050). At FIG. 10X, computer system 600 detects, via touch-sensitive surface 608, input 1005X representing selection of device selector control 1070.

As illustrated in FIG. 10Y, in response to detecting input 1005X, computer system 600 displays device selector control 1070 as being selected, which in this embodiment is indicated with a solid line border around it. While device selector control 1070 is selected, widgets in widgets region 1048 are sourced from computer system 1100 which is configured to correspond to the device selector control 1070 (e.g., it is the phone referenced in “from phone”). In some embodiments, a different device is configured to correspond to device selector control 1070 (e.g., a process for doing so is discussed in more detail with respect to FIG. 10AM). As illustrated in FIG. 10Y, in response to detecting input 1005X, computer system 600 displays widget 1074, which corresponds to an application on computer system 1100, in widgets region 1048. Widget 1074 is a widget related to the calendar application of computer system 1100, as “Calendar” is the selected category for widgets region 1048 (e.g., remains unchanged in response to selection of device selector control 1070). Computer system 600 adds category 1036J to the list of categories (e.g., and/or enables selection of category 1036J that was displayed but not selectable when device selector control 1068 is selected) as it is a category that corresponds to one or more application on computer system 1100 and does not correspond to one or more application on computer system 600. That is, computer system 600 displays category 1036J while device selector control 1070 is selected. At FIG. 10Y, computer system 600 detects, via touch-sensitive surface 608, input 1005Y representing a request to add (e.g., via drag and drop) widget 1074 (e.g., a personal (e.g., home) calendar widget corresponding to a calendar application on computer system 1100) to desktop interface 638 at the location corresponding to the end of the arrow of input 1005Y.

As illustrated in FIG. 10Z, in response to detecting input 1005Y, computer system 600 places widget 1074 on the desktop beneath widget 1072 (e.g., in the grid space 1052B as illustrated in FIG. 10D). While widget 1074 was being dragged via input 1005Y computer system 600 displays a peck mode in which the widget gallery interface 1034 and notification interface 1050 are hidden (e.g., cease display of partially or fully) (e.g., and user interface elements of desktop interface 638 continue to be displayed at their respective locations). As illustrated in FIG. 10Z, computer system 600 continues to display widget 1074 in widgets region 1048 as widgets region 1048 displays a list of available widgets (e.g., widget 1074 is still available) from computer system 1100. That is, as widget 1074 remains within widget gallery interface 1034 while computer system 600 also displays widget 1074 (e.g., an instance of widget 1074) on the desktop. In some embodiments, computer system 600 ceases to display a widget in widget gallery interface 1034 after it has been placed on desktop interface 638. At FIG. 10Z, computer system 600 detects, via touch-sensitive surface 608, input 1005Z representing selection of category 1036J.

As illustrated in FIG. 10AA, in response to detecting input 1005Z on category 1036J, computer system 600 displays widgets region 1048 as being labeled as “Streaming,” which is the label of category 1036J. As category 1036J is unique to computer system 600 and not applicable to computer system 1100, computer system 600 displays device selector control 1068 as being grayed out and inaccessible while category 1036J is the selected category. In response to category 1036J being the selected category, computer system 600 displays widget 1076, which relates to category 1036J, in widgets region 1048. As illustrated in FIG. 10AA, device selector control 1068 (e.g., corresponding to the computer system 600) is not selectable (e.g., is displayed as grayed out and/or with a dimmed appearance) because computer system 600 does not include one or more widgets that correspond to an application in category 1036J (e.g., a streaming application). In some embodiments, device selector control 1068 is selectable in the scenario at FIG. 10AA, but corresponds to an empty (e.g., blank and/or without widgets) widgets region 1048. At FIG. 10AA, computer system 600 detects input 1005AA representing a request to add (e.g., via drag and drop) widget 1076 (e.g., a media streaming widget corresponding to a calendar application on computer system 1100) to desktop interface 638 at the location corresponding to the end of the arrow of input 1005AA.

As illustrated in FIG. 10AB, in response to detecting input 1005AA, computer system 600 places widget 1076 on the desktop beneath widget 1074 (e.g., in the grid space 1052C as illustrated in FIG. 10D). In between FIG. 10AA and FIG. 10AB, computer system 600 displays peek mode (e.g., where other user interface items (e.g., non-widget user interface items) are hidden during a drag operation). As illustrated in FIG. 10AB, computer system 600 continues to display widget 1076 in widgets region 1048 while computer system 600 also displays widget 1076 (e.g., an instance of widget 1076) on the desktop.

FIGS. 10AC-10AL illustrate interactions and states associated with widgets that correspond to applications on a different computer system. FIG. 10AC illustrates computer system 1100 in close proximity to computer system 600, which continues to display desktop interface 638 as illustrated in FIG. 10AB. Computer system 600 and computer system 1100 operate under (e.g., logged into and/or associated with) the same user account. Because both systems operate under the same user account, information related to widgets and/or applications and their actions are synced between systems, as will be further described. Computer system 1100 includes display 1102, which displays a home screen interface that includes applications. Application 1078 (e.g., on computer system 1100) corresponds to (e.g., and is the source of) widget 1076 as described above in relation to FIG. 10AB. At FIG. 10AC, computer system 1100 detects, via an input device in communication with computer system 1100, input 1105AC representing a long press on application 1078.

As illustrated in FIG. 10AD, in response to detecting input 1105AC representing a long press at a location corresponding to application 1078, computer system 600 displays contextual menu 1082 that includes controls corresponding to application 1078 (e.g., edit, share, and remove). Also illustrated in FIG. 10AD, computer system 1100 blurs (e.g., deemphasizes) display 1102 (e.g., except for the application on which computer system 1100 detected an input and menu 1082). Menu 1082 includes remove control 1082A, which can be selected to cause computer system 1100 to delete application 1078. At FIG. 10AD, computer system 1100 detects input 1005AD representing selection of remove control 1082A. As illustrated on computer system 600 in FIG. 10AD, in response to computer system 1100 detecting input 1005AD, computer system 600 deletes widget 1076 from desktop interface 638 and from widget gallery interface 1034. In this embodiment, because computer system 1100 deletes an application, computer system 600 deletes one or more widgets that corresponds to that application. In some embodiments, after the deletion of an application on a second device, the corresponding widget remains displayed on a first device with an error message and/or error state appearance.

FIG. 10AE illustrates a scenario in which computer system 1100 is no longer in close proximity to computer system 600, and indicated by separation indicator 1084. As a result of the lack of proximity between computer system 600 and computer system 1100, computer system 600 begins to display an error state. Computer system 600 may not display an error state for a period of time (e.g., a few hours, a day) after detecting a lack of proximity to computer system 1100, as the widget may contain sufficient data to continue functioning. For the purposes of this example, FIG. 10AE illustrates error state appearance 1086D on widget 1074. In some embodiments, computer system 600 displays a widget as having a different error state appearance than is illustrated in FIG. 10AE. Other error state appearances for a widget that is in error will be described below. In some embodiments, there are different types of error state appearances. In some embodiments, the error state appearance depends on the type of error and/or whether an input causes the error state appearance to be displayed.

FIGS. 10AF and 10AG illustrate an exemplary widget in a variety of error state appearances. Error state appearance 1086A, labeled as “Shake,” indicates an error state by shaking the widget from side to side. In some embodiments, an error state is indicated by the widget shaking up and down and/or in any other combination of directions or axes. Error state appearance 1086B, labeled as “Tool Tip,” indicates an error state while pointer 622 hovers (e.g., is stationary within the bounds of and/or remains within the bounds of a widget) over a widget. Error state information is displayed in a pop-up dialog box that includes contextual information about error (e.g., “this widget has not updated in 4 days” as in FIG. 10AF). Error state appearance 1086C, labeled as “Takeover,” indicates an error state by changing a visual appearance (e.g., deemphasizing, covering, obscuring, and/or changing a visual appearance of) the widget and optionally overlaying it with a error state information (e.g., “needs update” as in FIG. 10AF). Error state appearance 1086D, labeled as “Badge,” as illustrated in FIG. 10AE, indicates an error state by displaying a badge over a portion of the widget (e.g., an exclamation point on the top corner of the widget in FIG. 10AF) indicating an error state. In some embodiments, error state appearance 1086D can appear as an indicator other than an exclamation point. In some embodiments, error state appearance 1086D can appear on a different location of a widget (e.g., on a different corner or in the center).

FIG. 10AG illustrates error state appearance 1086E, labeled as “Error on Click,” which displays an error window upon detecting a click on a widget. That is, if computer system 600 detects a click on a widget that is in an error state, an error window opens near the widget that optionally contains contextual information about the error state. Error state appearance 1086F, labeled as “Shrink and Grow,” indicates an error state by continuously increasing and decreasing the size of a widget. In some embodiments, an error state can be indicated by a widget increasing then decreasing in size once and then returning to its default size. Error state appearance 1086G, labeled as “Shake in response to click,” indicates an error state by shaking a widget from side to side in response to a click detected on the widget. That is, if computer system 600 detects a click on a widget that is in an error state, it shakes from side to side. In some embodiments, as error state is indicated by the widget shaking up and down and/or in any other combination of directions and/or axes.

FIGS. 10AH-10AK illustrate interfaces for accessing an application on computer system 1100 from inputs directed to a widget displayed on computer system 600. As illustrated in FIG. 10AH, computer system 600 displays desktop interface 638 as illustrated in FIG. 10AE and also illustrates computer system 1100, which is illustrated as having a blank screen indicating that computer system 1100 is not active (e.g., in a sleep state). At FIG. 10AH, computer system 600 detects, via touch-sensitive surface 608, input 1005AH representing selection of event control 1074A of widget 1074, which is labeled as “Home Event 1.”

As illustrated in FIG. 10AI, in response to computer system 600 detecting input 1005AH, computer system 600 causes computer system 1100 to initiate one or more processes for displaying authentication interface 1088, which prompts a user for input to a biometric authorization process. In some embodiments, computer system 1100 is unlocked and/or otherwise does not display authentication interface 1088 (e.g., skips it and displays a user interface associated with the application of the widget selected at computer system 600). In some embodiments, the authorization process is another type of authorization process (e.g., password entry interface and/or a gesture entry interface). At FIG. 10AI, computer system 1100 detects a biometric password input.

As illustrated in FIG. 10AJ, in response to detecting a biometric input and successfully authenticating with and/or unlocking computer system 1100, computer system 1100 displays calendar interface 1090, which includes an entry 1090A for the same event corresponding to event control 1074A, “Home Event 1.” Computer system 1100 displays event control 1090A and calendar interface 1090 in response to computer system 600 detecting a click input on event control 1074A of widget 1074, as illustrated in FIG. 10AH, which corresponds to a calendar application within computer system 1100. At FIG. 10AJ, computer system 600 detects, via touch-sensitive surface 608, input 1005AG representing a selection of event control 1074B, labeled as “Home Event 2.”

As illustrated in FIG. 10AK, in response to detecting input 1005AG, computer system 600 displays event control 1090B (e.g., “Home Event 2”) as an event on calendar interface 1090 of computer system 1100. For example, a click on a portion of widget at a first device that corresponds to an application on a second device causes the second device to display the interface that relates to the widget and application.

Note that accounts available (e.g., work email account) on computer system 1100 that are not integrated into computer system 600 can be added to computer system 600. Additionally, configuration defaults on computer system 1100 can be set as configuration defaults on computer system 600.

FIG. 10AL illustrates a schematic separate from illustrations of computer system 600 and computer system 1100 that represents the performance of a sub-action. FIG. 10AL illustrates list widget 1092, which includes list items 1092A-1092C. Each list item includes a corresponding list selection control (e.g., 1094A-1094C). At FIG. 10AL, input 10945AL representing selection of list selection control 1094A. The bottom illustration of list widget 1092 in FIG. 10AL illustrates a response to input 1005AL in which confirmation indicator 1096 is displayed on list selection control 1094A (e.g., the circle has been checked and/or selected), which corresponds to list item 1092A. In the example illustrated in FIG. 10AL, a computer system checks and/or selects an item on a list (e.g., modifying a state of data on computer system 600 and/or computer system 1100) on a first device that is associated with an application on a second device. In some embodiments, input on a widget does not cause the corresponding application on a remote computer system (e.g., computer system 1100) to launch, execute, and/or display. For example, displaying a checked box in response to an input that checks off an item in a list widget is a sufficient response, and the computer system 1100 that controls the widget (e.g., via an application) does not need to wake the device and/or cause display of a list application.

FIG. 10AM illustrates exemplary appearances of a settings window 1098 for selecting a remote device to use as a source of remote widgets (e.g., widgets displayed on one device that are controlled by an application on a separate device). FIG. 10AM illustrates settings window 1098 (e.g., displayed by computer system 600) with “Desktop and Dock” being the selected and displayed settings category. In the top half of FIG. 10AM, settings window 1098 displays subcategory 1098A, labeled as “Use phone widgets” with selection control 1098B illustrated as a toggle control (e.g., toggled to on in FIG. 10AM). In some embodiments, selection control 1098B can be a different type of control. In the bottom half of FIG. 10AM, settings window 1098 displays subcategory menu 1098C beneath selection control 1098B, which includes menu item 1098D, menu item 1098E, and menu item 1098F. Menu items 1098D-1098F represent the options of devices (e.g., computer systems) from which computer system 600 accesses remote widgets. A selection indicator (e.g., a check mark) indicates that menu item 1098E is the selected computer system (e.g., “work phone”).

FIGS. 10AN-10AT illustrate exemplary user interfaces for placing and interacting with widgets on a desktop interface, in accordance with some examples.

FIG. 10AN illustrates desktop interface 638 (e.g., as described above for example with respect to FIG. 10A). In FIG. 10AN, desktop interface 638 includes widget 1010, widget 1012, widget 1014, and widget 1048A grouped together as an island (e.g., computer system 600 has the widgets snapped in alignment with one another) on the left side of display 602. Desktop interface 638 is also illustrated as including widget 1016 and widget 1018 grouped together as an island on the right-side area of display 602. To the left of widget 1016 and widget 1018 is a group of icons in a square-like arrangement that includes icon 1022, icon 1024, icon 1026, and icon 1028. As illustrated in FIG. 10AN, computer system 600 displays icon 1022, icon 1024, icon 1026, and icon 1028 at locations to the left of widget 1016. In FIG. 10AN, computer system 600 displays one or more (e.g., and, in some embodiments, all or most) widgets in a receded state, though computer system 600 is not in edit mode, as described above with respect to FIG. 10C. In this embodiment, a user of computer system 600 would like to move widget 1014 to a location that is up and to the right on the desktop interface 638. At FIG. 10AN, computer system 600 detects click and drag input 1005AN on widget 1014. Input 1005AN is represented on touch-sensitive surface 608.

As illustrated in FIG. 10AO, in response to detecting input 1005AN, computer system 600 moves widget 1014 up and to the right toward icons 1022-1028. As computer system 600 moves widget 1014, computer system 600 displays snapping location 1014A (e.g., as described above with respect to FIG. 10D), which is an indication of a location to which computer system 600 will snap widget 1014 if input 1005AN is released at its current location. In FIG. 10AO, computer system 600 displays snapping location 1014A aligned by its top left corner with widget 1012. If computer system 600 displays a snapping location, it determines that a widget is within snapping distance of a snapping location. That is, if computer system 600 were to release widget 1014 from input 1005AN, computer system 600 would snap widget 1014 to the location of snapping location 1014A. Also illustrated in FIG. 10AO, in response to detecting input 1005AN, computer system 600 alters the display of widgets from a receded state to a non-receded state in response to detecting the initiation of a process to move a widget (e.g., entering editing mode, selecting a widget, and/or starting to move a widget) (e.g., through the process described above with respect to FIGS. 10C-10D).

Also illustrated in FIG. 10AO, in response to detecting input 1005AN, computer system 600 enters edit mode but does not display widget gallery interface 1034 or notification interface 1050 because computer system 600 detects widget 1014 as already being dragged. In some embodiments, computer system 600 enters edit mode automatically in response to detecting the input (e.g., 1005AN) that selects and/or moves widget 1014. Computer system 600 automatically initiating edit mode based on an input directed to a widget as opposed to a series of inputs made by a user to edit widgets (e.g., as discussed above in relation to FIGS. 10A-10B allows a reduced number of steps to enter edit mode. In some embodiments, computer system 600 does not enter edit mode in response to detecting the initiation of a process to move a widget. At FIG. 10AO, computer system 600 detects a continuation of click and drag input 1005AN. Input 1005AN is represented on touch-sensitive surface 608.

As illustrated in FIG. 10AP, in response to detecting a continuation of input 1005AN, computer system 600 continues to move widget 1014 up toward icons 1022-1028. In response to the continued movement of input 1005AN, computer system 600 moves widget 1014 into the locations of icon 1022 and icon 1026. In response to computer system 600 moving widget 1014 into the locations of icon 1022 and icon 1026, computer system 600 shifts both icons away from the widget and/or locations. For example, icon 1022 moves up and icon 1026 moves down to avoid being overlapped by, or overlapping, widget 1014. As computer system 600 moves widget 1014 into the locations of icons 1022-1028, computer system 600 displays snapping location 1014B (e.g., as described above with respect to FIG. 10AO) in alignment with widget 1016. That is, if computer system 600 places widget 1014 at the location as illustrated in FIG. 10AP (e.g., in response to detecting the release of input 1005an), computer system 600 would snap widget 1014 to the location outlined by snapping location 1014B. As illustrated in FIG. 10AP, computer system 600 moves icon 1022 and icon 1026 to avoid conflict with snapping location 1014B. If an icon is in locational conflict with a widget that computer system 600 is moving and/or a snapping location that computer system 600 moves along with a widget, the icon will move from its original position. Icons that move from their positions to avoid conflict move at least (e.g., and/or, in some embodiments, only) a minimum amount in order to remain as close to their original positions as possible. Note that computer system 600 displays different snapping locations (e.g., snapping location 1014A, snapping location 1014B) as it moves widget 1014 within proximity to various widgets on display 602. That is, computer system 600 displays a different snapping location for each position to which it could potentially snap a widget as it moves a widget around the display. At FIG. 10AP, computer system 600 detects a continuation of click and drag input 1005AN. Input 1005AN is represented on touch-sensitive surface 608.

As illustrated in FIG. 10AQ, computer system 600 detects the end of input 1005AN. In response to detecting the release of input 1005AN, computer system 600 places widget 1014 (e.g., drops it and/or assigns it to) the location of snapping location 1014B, as illustrated in FIG. 10AP, to be in alignment with widget 1016. Also illustrated in FIG. 10AQ, in response to detecting the release of widget 1014 from input 1005AN, computer system 600 shifts icons 1022-1028 away from widget 1014 to locations corresponding to widget 1014's four corners (e.g., icon 1022 is near widget 1014's top left corner, icon 1024 is near widget 1014's top right corner, icon 1026 is near widget 1014's bottom left corner, and icon 1028 is near widget 1014's bottom right corner), while maintaining the position of each icon a maximum distance away from (e.g., and/or, in some examples, as close to) its original position while not overlapping widget 1014 and maintaining a minimum spacing from widget 1014. Computer system 600 shifts the locations of icons 1022-1028 to avoid being overlapped by, or overlapping, the preferred position of widget 1014. In some embodiments, if computer system 600 detects an excessive amount (e.g., greater than a threshold amount) of icons moving in order to avoid conflict with a widget and/or a snapping location, computer system, 600 displays a tip (e.g., and/or other interface) to the user with suggestions on how to (e.g., and/or one or more controls to) organize icons that includes one or more controls for activating an organization configuration, such as arranging icons in stacks or organizing icons by a certain criteria. Note that, in FIG. 10AQ, computer system 600 continues to display widgets on display 602 in a prominent state even after it has placed widget 1014 on the desktop, in contrast to computer system 600 returning widgets on display 602 to a receded state (e.g., edit mode) after placing a widget, as first illustrated in FIG. 10H. At FIG. 10AQ, computer system 600 detects hover input 1005AQ over widget 1014 on touch-sensitive surface 608.

As illustrated in FIG. 10AR, in response to detecting hover input 1005AQ, computer system 600 displays close control 1003 on the top left corner of widget 1014. In some embodiments, computer system 600 displays close control 1003 on widget 1014 to provide a user with an option to remove and/or hide the widget from display 1002. In some embodiments, computer system 600 displays a close control only when detecting a hover input while detecting input on a particular key (e.g., an option, a shift key, and/or a control key) on a keyboard in communication with computer system 600. In some embodiments, computer system 600 does not display a close control on a widget if it does not detect an input on a modifier key on a keyboard at the same time that it detects a hover input over a widget. At FIG. 10AR, computer system 600 detects click and drag input 1005AR on widget 1014. Input 1005AR is represented on touch-sensitive surface 608.

As illustrated in FIG. 10AR, in response to detecting input 1005AR, computer system 600 drags widget 1014 toward its original position as illustrated in FIG. 10AN. While computer system 600 detects widget 1014 being dragged to a location near a potential snapping region, computer system 600 displays snapping location 1014C at the original position of widget 1014 as illustrated in FIG. 10AN. Also illustrated in FIG. 10AR, computer system 600 drags widget 1014 past its original position and past the left boundary of display 602. That is, in FIG. 10AR, computer system 600 displays widget 1014 partially obscured. At FIG. 10AR, computer system 600 detects the release of input 1005AR from widget 1014.

As illustrated in FIG. 10AS, in response to detecting the release of input 1005AR, computer system 600 snaps widget 1014 to the location of snapping location 1014C, as illustrated in FIG. 10AR. If computer system 600 releases the input from a widget that is partially off of display 602, computer system 600 snaps the widget to a position where the widget is fully visible on display 602 with space (e.g., a padding region) between the edge of the widget and the edge of the display. That is, computer system 600 requires that placed widgets be fully visible on display 602.

Also illustrated in FIG. 10AS, in response to detecting the placement of widget 1014 on its original location as illustrated in FIG. 10AN, computer system 600 returns icons 1022-1028 to their original positions, also as illustrated in FIG. 10AN. Computer system 600 returns icons to their prior locations (e.g., before computer system 600 repositioned them around a widget) after computer system 600 removes a widget from the region where computer system 600 previously displayed icons. At FIG. 10AS, computer system 600 detects two inputs; a click and drag input 1005AS1 on widget 1014 while detecting click and hold input 1005AS2 on Shift control 1001 on a keyboard.

As illustrated in FIG. 10AT, in response to detecting input 1005AS1 while detecting input 1005AS2, computer system 600 moves widget 1010, widget 1012, widget 1014, and widget 1048A as a whole (e.g., as an island) to the right, which is the direction of click and drag input 1005AS1, on display 602. The process of moving an entire group of widgets using Shift control 1001 in conjunction with a drag input provides a distinct method for moving an island of widgets in its entirety in contrast to dragging only one widget with only a click and drag input, as described and illustrated above with respect to FIGS. 10AN-10AS.

FIG. 11 is a flow diagram illustrating a method (e.g., method 1100) for displaying a widget in accordance with some embodiments. Some operations in method 1100 are, optionally, combined, the orders of some operations are, optionally, changed, and some operations are, optionally, omitted.

As described below, method 1100 provides an intuitive way for displaying a widget. Method 1100 reduces the cognitive burden on a user for displaying a widget, thereby creating a more efficient human-machine interface. For battery-operated computing devices, enabling a user to display a widget faster and more efficiently conserves power and increases the time between battery charges.

In some embodiments, method 1100 is performed at a computer system (e.g., 600) that is in communication with a display generation component (e.g., a display screen and/or a touch-sensitive display) and one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some embodiments, the computer system is a watch, a phone, a tablet, a processor, a head-mounted display (HMD) device, and/or a personal computing device.

At 1102, the computer system (e.g., 600) displays, via the display generation component, a respective user interface (e.g., 638) that includes a plurality of user interface objects (e.g., 1010, 1012, 1014, 1016, 1018, 1022, 1024, 1026, 1028, 1048A and/or 648) including a widget (e.g., 1048A) corresponding to an application (e.g., an application installed on the computer system and/or on another computer system). In some embodiments, the respective user interface includes an area (e.g., background, wallpaper, surface and/or canvas) on which graphical user interface elements (e.g., representing widgets, icons, and/or other content) can be placed. In some embodiments, the respective user interface is a desktop user interface (e.g., of an operating system and/or of an application). In some embodiments, the respective user interface is a desktop user interface (e.g., of an operating system and/or of an application). In some embodiments, a widget is a graphical representation of an application. In some embodiments, the application executes on the computer system. In some embodiments, the application executes on a second computer system (e.g., 1100) different from the first computer system. In some embodiments, the application is a first application that is controlled by (e.g., receives data from and/or synchronizes with) a second application, different from the first application, that executes on the second computer system. In some embodiments, the respective user interface includes one or more icons representing content (e.g., one or more files (e.g., media files, documents), one or more folders (e.g., a file directory repository that can include one or more files, one or more applications, and/or one or more folders), and/or one or more representations of applications and/or processes). In some embodiments, the computer system displays the respective user interface that includes the widget in response to detecting input (e.g., 1005Q, 1005T, 1005VA, 1005VB, and/or 1005VC) corresponding to the request to change whether the respective user interface is selected. In some embodiments, the input corresponding to the request to change whether the respective user interface is selected includes a selection of an item (e.g., 1048A) (e.g., widget, icon, and/or background) of the respective user interface. In some embodiments, the input corresponding to the request to change whether the respective user interface is selected includes a selection of an item (e.g., icon, window, and/or application) that is not part of the respective user interface (e.g., causing another user interface to be selected, and/or causing a graphical element that is not part of the respective user interface to be selected). In some embodiments, the input corresponding to the request to change whether the respective user interface is selected is not a selection of the widget (e.g., is selection of an icon, background, item, and/or location that does not include the widget) of the respective user interface. In some embodiments, a portion of the respective user interface is overlaid with one or more windows (e.g., 1058, 1060, and/or 1062) (e.g., application windows and/or windows associated with one or more processes executing on the computer system) and is not currently displayed. In some embodiments, a visible portion of the respective user interface is not overlaid with one or more windows and is displayed concurrently with the one or more windows (e.g., windows are sized and/or positioned such that a portion of the desktop that includes the widget is visible).

At 1104, in accordance with a determination that the respective user interface (e.g., 638 in FIG. 10A or 10L) is selected for display as a focused user interface for the computer system (e.g., 600) (e.g., active, focused, and/or a target of input (e.g., prior input and/or future input)) (e.g., and in some embodiments, in response to detecting input corresponding to changing whether the respective user interface is selected), the widget (e.g., 1010, 1012, 1014, 1016, 1018, and/or 1048A of FIG. 10L) has a first visual appearance (e.g., as in FIG. 10A or 10L) corresponding to a selected state for the respective user interface (e.g., having an emphasized appearance, having a prominent appearance, having a multichromatic appearance, having an appearance that is opaque (or less transparent than a non-selected state appearance), and/or having an appearance with higher level of visual detail (e.g., appears in focus and/or with higher level of sharpness) than the non-selected state, and/or having an appearance with a different style than the non-selected state) while one or more other user interface objects in the respective user interface are displayed with a respective appearance (e.g., that is independent of whether the respective user interface is selected for display as a focused user interface for the computer system). In some embodiments, in accordance with a determination that the respective user interface is selected, the computer system displays a plurality of widgets (e.g., 1010, 1012, 1014, 1016, 1018, and/or 1048A of FIG. 10L) that have the first visual appearance associated with a selected state (e.g., selecting the background and/or an icon of the desktop causes the computer system to display multiple widgets having a visual appearance corresponding to the selected state).

At 1106, in accordance with a determination that the respective user interface (e.g., 638 in FIG. 10C or 10K) is not selected for display as a focused user interface for the computer system (e.g., 600) (e.g., not active, not focused, and/or not a target of input (e.g., prior input and/or future input)) (e.g., and in some embodiments, in response to detecting input corresponding to changing whether the respective user interface is selected), the widget (e.g., 1010, 1012, 1014, 1016, 1018, and/or 1048A of FIG. 10A) is displayed with a second visual appearance (e.g., as in FIG. 10C or 10K) corresponding to a non-selected state, wherein the first visual appearance is different from the second visual appearance (e.g., having a receded appearance, having a monochromatic appearance, having an appearance that is at least partially transparent, and/or having an appearance with different level of visual detail (e.g., out of focus and/or reduced sharpness) than the selected state, and/or having an appearance with a different style than the selected state) while one or more other user interface objects in the respective user interface are displayed with the respective appearance (e.g., that is independent of whether the respective user interface is selected for display as a focused user interface for the computer system). In some embodiments, a visual appearance of the one or more icons (e.g., 1022, 1024, 1026, and/or 1028 of FIG. 10A) are the same for the selected state and the non-selected state (e.g., the widget changes visual appearance based on selection state of the respective user interface, and the one or more icons do not change visual appearance based on selection state of the respective user interface). In some embodiments, in accordance with a determination that the respective user interface is not selected, the computer system displays a plurality of widgets (e.g., 1010, 1012, 1014, 1016, 1018, and/or 1048A of FIG. 10K) that have the second visual appearance associated with the non-selected state (e.g., selecting a window and/or an interface of an application that does not correspond to the respective user interface causes the computer system to display multiple widgets having a visual appearance corresponding to the non-selected state).

In some embodiments, before displaying the respective user interface, the computer system (e.g., 600) detects, via the one or more input devices, a first input (e.g., 1005Q, 1005T, 1005VA, 1005VB, and/or 1005VC) (e.g., a request to display a desktop user interface) (e.g., a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)), wherein the respective user interface is displayed in response to detecting the first input. Displaying the respective user interface in response to detecting the first input provides the user with a control to view the widget (and, in some embodiments, other widgets), thereby reducing the number of inputs needed to perform an operation, providing additional control options without cluttering the user interface with additional displayed controls, and/or performing an operation when a set of conditions has been met without requiring further user input.

In some embodiments, the respective user interface is selected for display as the focused user interface for the computer system (e.g., 600) in response to detecting an input (e.g., 1005Q, 1005T, 1005VA, 1005VB, and/or 1005VC) (e.g., a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)) that is not directed to (e.g., a location, an area, and/or a portion of a user interface that corresponds to) the widget. In some embodiments, the input that is not directed to the widget is directed to the respective user interface (e.g., 638 and/or 638A) and/or a user interface (e.g., 1050) that includes the widget. Selecting the respective user interface as the focused user interface in response to detecting an input that is not directed to the widget provides the user to change display of the widget when performing an input not directed to the widget, thereby reducing the number of inputs needed to perform an operation, providing additional control options without cluttering the user interface with additional displayed controls, and/or performing an operation when a set of conditions has been met without requiring further user input.

In some embodiments, the first visual appearance (e.g., of widget 1010, 1012, 1014, 1016, 1018, and/or 1048C of FIG. 10L) has a first set of one or more visual characteristics (e.g., amount of opacity (e.g., an amount of translucency and/or an amount of an effect giving an appearance of translucency), a color property (e.g., hue, saturation, and/or tone), blur, and/or transparency) (e.g., a property defining whether a visual appearance is monochrome, polychrome, limited in number of colors are used, limited in which colors are used, and/or full color). In some embodiments, the second visual appearance (e.g., of widget 1010, 1012, 1014, 1016, 1018, and/or 1048A of FIG. 10K) has a second set of one or more visual characteristics different from the first set of one or more visual characteristics (e.g., amount of opacity (e.g., an amount of translucency and/or an amount of an effect giving an appearance of translucency), a color property (e.g., hue, saturation, and/or tone), blur, and/or transparency) (e.g., a property defining whether a visual appearance is monochrome, polychrome, limited in number of colors are used, limited in which colors are used, and/or full color). In some embodiments, having different visual properties includes having at least one non-identical configuration of a common visual property (e.g., different configurations of a color property and/or different configurations of an opacity property). In some embodiments, the second set of one or more visual characteristics makes the second visual appearance monochromatic (and, in some embodiments, the first set of one or more visual characteristics does not make the first visual appearance monochromatic). The first visual appearance having a different set of one or more visual characteristics than the second visual appearance provides the user with feedback about a state of the computer system (e.g., 600) and the widget to adapt to the state of the computer system (e.g., whether the respective user interface is a focused user interface), thereby providing improved visual feedback to the user and/or performing an operation when a set of conditions has been met without requiring further user input.

In some, displaying the widget with the second visual appearance includes: in accordance with a determination that a background (e.g., 638A) (and/or wallpaper, backdrop, and/or visual media) of the respective user interface has a third visual appearance, displaying the widget with a third set of one or more visual characteristics. In some embodiments, displaying the widget with the second visual appearance includes: in accordance with a determination that the background of the respective user interface has a fourth visual appearance different from the third visual appearance, displaying the widget with a fourth set of one or more visual characteristics different from the third set of one or more visual characteristics. In some embodiments, a visual appearance is based on the background of the respective user interface due to the background being visible through one or more translucent visual elements (e.g., partially and/or fully) (e.g., the widget and/or one or more portions of the widget that are translucent). In some embodiments, a visual appearance is based on the background of the respective user interface due to the widget (e.g., the widget and/or one or more portions of the widget) having one or more visual elements that have an appearance that is derived from one or more colors sampled from the background (e.g., wallpaper, backdrop, visual content, and/or visual media) of the respective user interface. In some embodiments, a visual appearance of the widget is a result displaying a desaturated representation of the widget displayed over a backing layer that is a blurred representation of a background of the respective user interface (e.g., wallpaper of a desktop user interface). In some embodiments, the backing layer is based on a high radius blur of the background. In some embodiments, the brightness and/or contrast of the widget with the second visual appearance is based on a brightness and/or contrast of the widget (e.g., the widget with the first visual appearance). In some embodiments, the color of the widget with the second visual appearance is based on a color of the backing layer. The second visual appearance having a different set of one or more visual characteristics depending on a visual appearance of the background provides the user with more or less contrast of the respective user interface with respect to the background, thereby providing improved visual feedback to the user and/or performing an operation when a set of conditions has been met without requiring further user input.

In some embodiments, the first visual appearance includes a color fill property. In some embodiments, the second visual appearance does not include the color fill property. In some embodiments, the computer system (e.g., 600) uses the first color fill property to display the widget (e.g., 1048A of FIG. 10L) with the first visual appearance to appear with the color (e.g., corresponding to the first color fill property) filled in one or more regions of the widget (e.g., a background and/or other visual element is filled with color when the first user interface is selected). In some embodiments, the second visual appearance includes a second color fill property, different from the first color fill property. In some embodiments, the computer system uses the second color fill property to display the widget with the second visual appearance to appear without the color (e.g., corresponding to the first color fill property) filled in one or more regions of the widget (e.g., when the widget (e.g., and/or the respective user interface) is not selected, the widget appears monochromatic with less than all (and, in some embodiments, some and/or most) color information and/or the widget appears at least partially translucent so that some color information displayed in the widget is from a background of the respective user interface). The first visual appearance including a color fill property while the second visual appearance does not include the color fill property provides the user with feedback about a state of the computer system, thereby providing improved visual feedback to the user and/or performing an operation (e.g., including the color fill property) when a set of conditions has been met without requiring further user input.

In some embodiments, the widget (e.g., 1048A or 1074) includes a first region (e.g., 1074A) and a second region (e.g., 1074B). In some embodiments, displaying the widget with the first visual appearance includes displaying the first region with a different visual appearance from an appearance of the second region. In some embodiments, displaying the widget with the second visual appearance includes displaying the first region and the second region with a same visual appearance (e.g., that is optionally the same as an appearance of the first region when the widget is displayed with the first visual appearance, the same as an appearance of the second region when the widget is displayed with the first visual appearance, or different from an appearance of the first region when the widget is displayed with the first visual appearance and also different from an appearance of the second region when the widget is displayed with the first visual appearance). In some embodiments, the seventh visual appearance is different from the fifth visual appearance and the sixth visual appearance. In some embodiments, the seventh visual appearance is the same as the fifth visual appearance or the sixth visual appearance. Displaying the widget with different regions having different visual appearances or the same visual appearance depending on a state of the computer system (e.g., 600) provides the user with feedback about the state of the computer system, thereby providing improved visual feedback to the user and/or performing an operation (e.g., including the color fill property) when a set of conditions has been met without requiring further user input.

In some embodiments, the respective user interface (e.g., 638) includes a plurality of widgets (e.g., 1010, 1012, 1014, 1016, 1018, and/or 1048A of FIG. 10L), (e.g., corresponding to one or more applications (e.g., a same application or different applications)) including the widget (e.g., 1048A) (and, in some embodiments, a second widget different form the widget). In some embodiments, the widget corresponds to a first application, and the second widget corresponds to a second application that is different from the first application. In some embodiments, the first application is in a different category (e.g., 1036A-10361) of applications than the second application. In some embodiments, an appearance of the second widget changes when the appearance of the widget changes. The respective user interface including multiple widgets provides the user with display of content corresponding to different widgets at the same time, thereby providing improved visual feedback to the user and/or reducing the number of inputs needed to perform an operation.

In some embodiments, while displaying the respective user interface (e.g., 638), the computer system (e.g., 600) detects, via the and one or more input devices, an input (e.g., 1005B, 1005C, 1005H, 1005I, 1005J, 1005O, 1005P, 1005W, 1005Y, 1005AA, 1005AL) (e.g., a request to display a desktop user interface) (e.g., a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)) corresponding to a request to edit the widget (e.g., an input directed to a edit widget control and/or user interface object). In some embodiments, in response to detecting the input corresponding to the request to edit the widget, the computer system edits the widget (e.g., initiating and/or performing an editing operation (e.g., enter widget editing mode (e.g., edit mode), change a visual appearance of the widget, change a location of the widget, change a form factor and/or footprint of the widget, change a size of the widget, change the information displayed in a widget, and/or delete the widget), displaying the widget changing, updating the widget based on the input corresponding to the request to edit the widget, and/or changing the widget based on the input corresponding to the request to edit the widget). In some embodiments, changing the information displayed in a widget includes changing a manner in which respective information is updated over time (e.g., how often to update and/or which regions to update). In some embodiments, changing the information displayed in a widget includes changing what type of information is displayed (e.g., changing an information source, such as a user account and/or device that is a source of the information, resulting in different information that is provided to the widget) (e.g., a work calendar instead of a personal calendar for a calendar widget, weather for San Francisco instead of New York for a weather widget, or a rain forecast instead of a temperature forecast for a weather widget). In some embodiments, changing the information displayed in a widget includes changing the manner in which information is displayed (e.g., the same information displayed in a different way). Initiating a process to change the widget in response to detecting input while displaying the respective user interface provides the user with the ability to initiate the process to change the widget while viewing the widget, thereby providing improved visual feedback to the user and/or reducing the number of inputs needed to perform an operation.

In some embodiments, detecting the input corresponding to the request to edit the widget includes detecting an input (e.g., a mouse click (e.g., a right mouse click and/or a left mouse click) and/or, in some embodiments, a tap input, a press-and-hold input, a gaze input, an air gesture (e.g., an air tap and hold air gesture, a first air gesture, and/or a clench gesture)) directed to the respective user interface (e.g., 638) (e.g., 1005B or 1005C) (e.g., at a location corresponding to or not corresponding to the widget). In some embodiments, initiating the process to change the widget includes initiating a widget editing mode while continuing to display the respective user interface. In some embodiments, the input corresponding to the request to edit the widget is directed to a location of a desktop (e.g., background and/or a user interface item that is not the first widget). In some embodiments, the computer system (e.g., 600), while in the widget editing mode, is configured to change the widgets in response to one or more additional inputs that correspond to editing operations (e.g., click and drag, delete, move, resize, and/or edit content of). In some embodiments, initiating the widget editing mode includes displaying, via the display generation component, one or more widget-related user interfaces. In some embodiments, a widget-related user interface (e.g., 1034) is a widget selection (e.g., widget gallery) user interface (e.g., 1034) (e.g., that includes one or more controls, that when selected, can be used to select, browse, and or place widgets on the respective user interface). In some embodiments, a widget-related user interface (e.g., 1050) is a widget display user interface (e.g., 1050) (e.g., a notification center that houses widgets and that pops out to cover a portion of the user interface in response to user input).

In some embodiments, the plurality of user interface objects includes one or more user interface objects (e.g., 1022, 1024, 1026, 1028, and/or 648) other than the widget. In some embodiments, while editing the widget, the computer system (e.g., 600) decreases visual emphasis (e.g., 1010, 1012, 1014, 1022, 1024, 1026, 1028, and/or 648 as in FIG. 10C or FIG. 10I) (e.g., decreasing the size, decreasing the brightness, decreasing opacity, removing, partially removing (e.g., a portion of a respective user interface (e.g., 638) object is not visible and a portion is visible on a display generation component), dimming, and/or increasing the amount of translucency) of the one or more user interface objects other than the widget. In some embodiments, while in an editing mode, the computer system decreases visual emphasis of the plurality of user interface objects other than widgets (e.g., multiple and/or all widgets do not include decreased visual emphasis) (e.g., non-widget user interface objects are decreased in visual emphasis while widget user interface objects are not decreased in visual emphasis). Decreasing visual emphasis of one or more user interface objects other than the widget when editing the widget reduces visual pollution and/or distractions while changing the widget, thereby providing improved visual feedback to the user and/or performing an operation when a set of conditions has been met without requiring further user input.

In some embodiments, while continuing to display the respective user interface (e.g., 638) and after decreasing visual emphasis of the one or more user interface objects other than the widget (e.g., 1048A), the computer system (e.g., 600) detects a request (e.g., release of 1005C or 1005Q) to stop editing the widget (e.g., 1048A) (e.g., via a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)). In some embodiments, in response to detecting the request to stop editing the widget, the computer system increases visual emphasis of the one or more user interface objects (e.g., 1010, 1012, 1014, 1022, 1024, 1026, 1028, and/or 648 as in FIG. 10L or FIG. 10R) other than the widget (e.g., restore back visual emphasis before visual emphasis was decreased). In some embodiments, upon exiting an editing mode, the computer system increases visual emphasis of the plurality of user interface objects other than widgets (e.g., non-widget user interface objects are increased in visual emphasis while widget user interface objects are not increased in visual emphasis). In some embodiments, the computer system, in response to detecting the request to stop editing the widget, the computer system displays the widget with the second visual appearance corresponding to the non-selected state. Increasing visual emphasis of one or more user interface objects other than the widget in response to detecting the request to stop editing the widget provides the user with the ability to undo the reduction of visual emphasis that occurred while editing the widget, thereby providing improved visual feedback to the user and/or performing an operation when a set of conditions has been met without requiring further user input.

In some embodiments, the plurality of user interface objects includes a set of one or more application icons (e.g., 648 and/or 648A-648L) (e.g., an application dock and/or an area that includes icons corresponding to applications that when selected initiate a process of the respective application), and wherein the input corresponding to a request to edit the widget is a request to position (e.g., to move, drag and drop, and/or reposition) the widget on the respective user interface (e.g., 638). In some embodiments, the computer system (e.g., 600) displays a widget selection user interface (e.g., 1034) (e.g., a widget gallery user interface and/or a user interface for selecting one or more widgets) concurrently with the respective user interface (e.g., and, in some embodiments, while in a widget editing mode), wherein the input corresponding to a request to edit the widget is detected after (e.g., while, in conjunction with, close in time with, and/or in response to) displaying the widget selection user interface concurrently with the respective user interface. In some examples, while continuing to detect the input (e.g., 1005C) corresponding to a request to edit the widget (e.g., while dragging continues and/or prior to drop at end of dragging), the computer system displays, via the display generation component, the set of one or more application icons. In some embodiments, in response to ceasing to detect the input corresponding to a request to edit the widget, the computer system ceases to display the set of one or more application icons. Displaying the set of one or more application icon while continuing to detect the input corresponding to a request to edit the widget but ceasing to display the set of one or more application icons in response to ceasing to detect the input provides the user with a full view of the respective user interface when detecting the input and more visual real estate (e.g., without display of the set of one or more application icons) in response to ceasing to detect the input, thereby providing improved visual feedback to the user, reducing the number of inputs needed to perform an operation, and/or performing an operation when a set of conditions has been met without requiring further user input.

In some embodiments, while editing the widget (e.g., 1048A), the computer system (e.g., 600) detects a first set of one or more inputs. In some embodiments, in response to detecting the first set of one or more inputs (e.g., 1005C) (e.g., via a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)) (e.g., including the input corresponding to the request to edit the widget and/or one or more other inputs), the computer system performs an editing operation that includes customizing one or more properties of content of the (e.g., displayed in and/or configured to be displayed in) widget. In some embodiments, customizing one or more properties of the content displayed in the widget includes changing one or more configuration settings (e.g., in response to detecting the first set of one or more inputs) related to: an appearance of the widget, type of content included in the widget, organization of content included in the widget, language of content included in the widget, location of content within widget, amount of content included in the widget, sources of content (e.g., one or more devices, domains, and/or addresses) included in the widget, and/or categorization of content included in the widget. Performing an editing operation that includes customizing one or more properties of content of the widget in response to detecting the first set of one or more inputs provides the user with the ability to customize the one or more properties, thereby performing an operation when a set of conditions has been met without requiring further user input.

In some embodiments, while editing the widget, the computer system (e.g., 600) detects a second set of one or more inputs (e.g., 1005C or 1005O). In some embodiments, in response to detecting the second set of one or more inputs (e.g., via a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)) (e.g., including the input corresponding to the request to edit the widget and/or one or more other inputs) and in accordance with a determination that detecting the second set of one or more inputs includes detecting a request (e.g., 1005C) to add the widget to the respective user interface (e.g., 638), the computer system adds a first widget (e.g., 1048A) selected in response to detecting the second set of one or more inputs to the respective user interface. In some embodiments, in response to detecting the second set of one or more inputs and in accordance with a determination that detecting the second set of one or more inputs corresponds to detecting a request (e.g., 1005O) to remove the widget from the respective user interface, the computer system removes a second widget selected in response to detecting the second set of one or more inputs from the respective user interface. Adding or removing a widget selected in response to detecting one or more inputs from the respective user interface while editing the widget provides the user with control of what is displayed, thereby providing improved visual feedback to the user and/or performing an operation when a set of conditions has been met without requiring further user input.

In some embodiments, the computer system (e.g., 600) displays, via the display generation component, a widget display user interface (e.g., 1050) (e.g., a notification center and/or an area that includes one or more widgets that is not part of the respective user interface (e.g., 638)) concurrently with the respective user interface, wherein in accordance with a determination that the respective user interface is in a widget editing mode (e.g., edit mode in FIG. 10C), the widget display user interface is in the widget editing mode. In some embodiments, the widget display user interface and the respective user interface is configurable and/or editable (e.g., at the same time) while in the widget editing mode. In some embodiments, in accordance with a determination that the respective user interface is not in a widget editing mode, the widget display user interface is not in the widget editing mode. Displaying the widget display user interface concurrently with the respective user interface while in the widget editing mode provides the user the ability to not only modify the respective user interface but also the widget display user interface at the same time, thereby providing improved visual feedback to the user, reducing the number of inputs needed to perform an operation, and/or performing an operation when a set of conditions has been met without requiring further user input.

In some embodiments, while editing the widget, the computer system (e.g., 600) detects a set of one or more inputs (e.g., 1005O) corresponding to a request to remove the widget from the respective user interface (e.g., 638). In some embodiments, in response to detecting the set of one or more inputs (e.g., via a tap input and/or, in some embodiments, a non-tap input (e.g., a gaze, an air gesture/input (e.g., an air tap and/or a turning air gesture/input), a mouse click, a button touch, a swipe, lifting of the computer system (e.g., 600) from a first position to a second position, and/or a pointing gesture/input)) (e.g., including the input corresponding to the request to edit the widget and/or one or more other inputs) (e.g., drag to trash, select close icon, one or more keystrokes mapped to a close input, or right click and select a close control within a context menu) corresponding to the request to remove the widget, the computer system removes the widget from the respective user interface. Removing the widget in response to detecting the set of one or more inputs while editing the widget provides the user with the ability to not only change a widget but also remove the widget, thereby reducing the number of inputs needed to perform an operation, providing additional control options without cluttering the user interface with additional displayed controls, and/or performing an operation when a set of conditions has been met without requiring further user input.

In some embodiments, the computer system (e.g., 600) displays, via the display generation component, a widget display user interface (e.g., 1050) (e.g., a notification center or other user interface that includes one or more locations dedicated to one or more widgets (e.g., one or more widgets that are displayed on and/or included in the respective user interface (e.g., 638) and/or one or more widgets that are not displayed on and/or included in the respective user interface)) (e.g., a sidebar and/or a user interface displayed on and/or overlaid on the right, left, top, and/or bottom of the respective user interface and/or another user interface). In some embodiments, the widget display user interface is displayed after and/or concurrently with the respective user interface (e.g., overlapping at least a portion of, adjacent to, and/or at the same time as). In some embodiments, the widget display user interface is displayed over and/or overlaid on top of other content (e.g., rather than hiding content to display the widget display user interface and/or the respective user interface). In some embodiments, while displaying the widget display user interface, the computer system detects, via the one or more input devices, an input (e.g., 1005H or 1005P) (e.g., a request to display a desktop user interface) (e.g., a tap input and/or, in some embodiments, a non-tap input (e.g., a gaze, an air gesture/input (e.g., an air tap and/or a turning air gesture/input), a mouse click, a button touch, a swipe, lifting of the computer system from a first position to a second position, and/or a pointing gesture/input)) corresponding to a second widget. In some embodiments, the second widget is different from the widget. In some embodiments, the second widget is the widget. In some embodiments, in response to detecting the input corresponding to the second widget and in accordance with a determination that detecting the input (e.g., 1005P) corresponding to the second widget includes detecting a request to add the second widget to the widget display user interface, the computer system displays, via the display generation component, the second widget in the widget display user interface (e.g., and, in some embodiments, removing the second widget from the respective user interface and/or moving the second widget from the respective user interface to the widget display user interface). In some embodiments, in response to detecting the input corresponding to the second widget and in accordance with a determination that detecting the input (e.g., 1005H) corresponding to the second widget includes detecting a request to remove the second widget from the widget display user interface, the computer system removes display of the second widget from the widget display user interface (e.g., and, in some embodiments, moving the second widget from the widget display user interface to the respective user interface). Adding or removing the second widget to or from the widget display user interface in response to detecting the input corresponding to the second widget while displaying the widget display user interface provides the user to cater what is included in the widget display user interface while viewing the widget display user interface, thereby providing improved visual feedback to the user, reducing the number of inputs needed to perform an operation, and/or performing an operation when a set of conditions has been met without requiring further user input.

In some embodiments, the respective user interface (e.g., 638) includes a third widget. In some embodiments, while displaying the respective user interface that includes the third widget (e.g., 1016), the computer system (e.g., 600) detects an input (e.g., 1005P) directed to the third widget that moves from the respective user interface to a widget display user interface (e.g., 1050) (e.g., as described above in relation to the widget display user interface). In some embodiments, in response to detecting the input directed to the third widget that moves from the respective user interface to the widget display user interface, the computer system removes display of the third widget from the respective user interface to display the third widget in the widget display user interface (e.g., based on the speed, velocity, and/or acceleration of the input directed to the third widget that moves from the respective user interface to the widget display user interface). Removing display of the third widget from the respective user interface to display the third widget in the widget display user interface in response to detecting the input directed to the third widget that moves from the respective user interface to the widget display user interface provides the user the ability to cater what is included in the respective user interface and the widget display user interface while displaying both, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, the computer system (e.g., 600) displays, via the display generation component, a widget display user interface (e.g., 1050) (e.g., as described above in relation to the widget display user interface) that includes a fourth widget (e.g., 1050A). In some embodiments, while displaying the widget display user interface that includes the fourth widget, the computer system detects an input (e.g., 1005H) directed to the fourth widget that moves from the widget display user interface to the respective user interface (e.g., 638). In some embodiments, in response to detecting the input directed to the fourth widget that moves from the widget display user interface to the respective user interface, the computer system removes display of the fourth widget from the widget display user interface to display the fourth widget in the respective user interface (e.g., based on the speed, velocity, and/or acceleration of the input directed to detecting the input directed to the fourth widget that moves from the third widget display user interface to the respective user interface). Removing display of the fourth widget from the widget display user interface to display the fourth widget in the respective user interface in response to detecting the input directed to the fourth widget that moves from the widget display user interface to the respective user interface provides the user the ability to cater what is included in the respective user interface and the widget display user interface while displaying both, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, while displaying one or more system user interfaces (e.g., application dock, a dedicated widget user interface, a widget gallery, a widget selection interface, a notification interface, and/or a notification center) (e.g., that are not part of the respective user interface (e.g., 638)) (and, in some embodiments, while displaying the respective user interface) (and, in some embodiments, the one or more system user interfaces are overlaid on the respective user interface), the computer system (e.g., 600) detects an input (e.g., 1005C) (e.g., corresponding to a request to display a desktop user interface) (e.g., a swipe and/or drag input and/or, in some embodiments, a non-swipe and/or drag input (e.g., a gaze, an air gesture/input (e.g., an air swipe and/or a moving air gesture/input), a mouse pressing-and-moving input, a button swipe, a swipe, lifting of the computer system from a first position to a second position, a clench and move input, and/or a pointing gesture/input)) corresponding to a request to move a fifth widget (e.g., 1048A) (e.g., with respect to (e.g., onto, off of, and/or to a different location within) the respective user interface and/or the one or more system user interfaces). In some embodiments, the third widget is different from the widget. In some embodiments, the third widget is the widget. In some embodiments, while detecting the input corresponding to the request to move the fifth widget, the computer system ceases display of at least a portion of (e.g., completely, partially, and/or all) the one or more system user interfaces (e.g., hides 1034 and/or 1050 as illustrated by FIG. 10C-10D) (e.g., all or less than all system user interfaces). In some embodiments, the system user interfaces are not part of the respective user interface. Ceasing display of at least a portion of the one or more system user interfaces while detecting the input corresponding to the request to move the fifth widget provides the user with the ability to move the fifth widget without being distracted by the one or more system user interfaces and/or without the one or more system user interfaces taking up visual space, thereby providing improved visual feedback to the user, providing additional control options without cluttering the user interface with additional displayed controls, and/or performing an operation when a set of conditions has been met without requiring further user input.

In some embodiments, in response to detecting an end (e.g., lift off and/or stopping movement for a predetermined period of time (1-5 seconds)) of the input corresponding to the request to move the fifth widget (e.g., 1005C), the computer system (e.g., 600) displays (e.g., ceasing to hide (e.g., completely or partially)), via the display generation component, the portion of the one or more system user interfaces. In some embodiments, displaying the portion of the one or more system user interfaces at one or more respective locations that they occupied just prior to ceasing display. In some embodiments, displaying the portion of the one or more system user interfaces includes overlaying the one or more system user interfaces on the respective user interface (e.g., 638) (e.g., completely or partially). Displaying the portion of the one or more system user interfaces in response to detecting an end of the input corresponding to the request to move the fifth widget provides the user with the ability to see the portion of the one or more system user interface after ceasing to display the portion while detecting the input corresponding to the request to move the fifth widget, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, while displaying the respective user interface (e.g., 638) that includes the plurality of user interface objects including the widget, the computer system (e.g., 600) detects an input (e.g., 1005S) directed to a user interface object (e.g., 1032) representing a file system object (e.g., a file, a folder, multiple files, or multiple folders). In some embodiments, in response to detecting the input directed to the user interface object representing the file system object and in accordance with a determination that detecting the input corresponding to the user interface object includes detecting a request to add the user interface object representing the file system object to the respective user interface, the computer system displays, via the display generation component, the user interface object representing the file system object on the respective user interface (and, in some embodiments, moving the user interface object representing the file system object to the respective user interface). In some embodiments, in response to detecting the input directed to the user interface object representing the file system object and in accordance with a determination that the input corresponding to the user interface object includes detecting a request to remove the user interface object representing the file system object from the respective user interface, the computer system ceases to display the user interface object representing the file system object on (e.g., deletes and/or moves off of) the respective user interface (and, in some embodiments, moving the user interface object representing the file system object from the respective user interface). Displaying the user interface object representing the file system object on the respective user interface or ceasing to display the user interface object representing the file system object on the respective user interface depending on whether detecting a request to add or remote the user interface object provides the user with a configurable user interface that includes both file system objects and widgets, thereby reducing the number of inputs needed to perform an operation, providing additional control options without cluttering the user interface with additional displayed controls, and/or performing an operation when a set of conditions has been met without requiring further user input.

In some embodiments, while displaying the respective user interface (e.g., 638) that includes the plurality of user interface objects including the widget (and, in some embodiments, one or more other widgets, files, folders, applications, icons, and/or application icons), the computer system (e.g., 600) displays one or more application windows (e.g., 1058, 1060, and/or 1062) that are not part of the respective user interface, wherein the one or more application windows are overlaid on a portion (e.g., all or less than all of) of the respective user interface on at least a portion of at least one user interface object in the plurality of user interface objects. In some embodiments, the one or more application windows are overlaid on any portion and/or most portions of the plurality of interface objects located within the portion of the respective user interface. While displaying the respective user interface that includes the plurality of user interface objects including the widget, displaying one or more application windows that are (1) not part of the respective user interface and (2) overlaid on at least a portion of at least one user interface object provides the user the ability to view application windows on top of user interface objects to efficient use displayable areas, thereby reducing the number of inputs needed to perform an operation, providing additional control options without cluttering the user interface with additional displayed controls, and/or performing an operation when a set of conditions has been met without requiring further user input.

In some embodiments, while displaying the respective user interface (e.g., 638) that includes the plurality of user interface objects including the widget, the computer system (e.g., 600) detects, via the one or more input devices, an input (e.g., 1005Q or 1005R) (e.g., a tap input, a swipe input, an air gesture (e.g., a clench, a clench and move input and/or a tap and move input) and/or a gesture input) (e.g., selection of a background of the respective user interface, selection of a user interface element of the respective user interface, or selection of a window corresponding to an application) (e.g., selection of an object, control, and/or region associated with the respective user interface or selection of an object, control, and/or region not associated with the respective user interface) corresponding to a request to change whether the respective user interface is selected for display as the focused user interface for the computer system (e.g., change from not selected to selected, or change from selected to not selected). In some embodiments, in response to detecting the input corresponding to the request to change whether the respective user interface is selected for display as the focused user interface for the computer system, the computer system changes a visual emphasis (e.g., increasing a visual emphasis, such as increasing size, changing color, adding color, brightening, and/or increasing opacity) (e.g., decreasing a visual emphasis, such as decreasing size, changing color, reducing color, darkening, and/or decreasing opacity) of one or more widget user interface elements relative to another portion of the respective user interface. In some embodiments, changing the visual emphasis of one or more widget user interface elements relative to the respective user interface includes changing visual emphasis of one or more widget user interface elements including the widget (e.g., included in the plurality of user interface objects) relative to non-widget user interface elements (e.g., application icons, folders, and/or files) (e.g., included in the plurality of user interface objects). In some embodiments, changing the visual emphasis of the one or more widget user interface elements is based on (e.g., having a different visual emphasis that depends on and/or changes due to) whether the respective user interface is selected as a focused user interface for the computer system. In some embodiments, changing visual emphasis of the one or more widgets relative to the non-widgets includes increasing visual emphasis of the one or more widgets and forgoing increasing visual emphasis of the non-widgets (e.g., decreasing visual emphasis or not changing visual emphasis). In some embodiments, changing visual emphasis of the one or more widgets relative to the non-widgets includes decreasing visual emphasis of the one or more widgets and not decreasing visual emphasis of the non-widgets (e.g., increasing visual emphasis or not changing visual emphasis). In some embodiments, in response to detecting the selection input corresponding to the request to change whether the respective user interface is selected for display as the focused user interface for the computer system, the computer system changes whether the respective user interface is selected for display as a focused user interface for the computer system. Changing a visual emphasis of one or more widget user interface elements relative to another portion of the respective user interface in response to detecting the input corresponding to the request to change whether the respective user interface is selected for display as the focused user interface for the computer system provides the user with the ability to change the visual emphasis by focusing on the respective user interface, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, changing the visual emphasis of the one or more widget user interface elements includes increasing the visual emphasis (e.g., changing from FIG. 10Q to FIG. 10R) (e.g., increasing size, changing color, adding color, brightening, and/or increasing opacity) of the one or more widget user interface elements relative to another portion of the respective user interface (e.g., 638) (e.g., and/or non-widget user interface elements included in the plurality of user interface objects). Increasing the visual emphasis of the one or more widget user interface elements relative to another portion of the respective user interface provides the user a better view of the one or more widget user interface elements, thereby providing improved visual feedback to the user.

In some embodiments, detecting the input corresponding to the request to change whether the respective user interface (e.g., 638) is selected for display as the focused user interface for the computer system (e.g., 600) includes detecting a request (e.g., 1005T) (e.g., a tap input and/or, in some embodiments, a non-tap input (e.g., a multi-figure gesture on a touch sensitive surface, a gaze, an air gesture/input (e.g., an air tap and/or a turning air gesture/input), a mouse click, a button touch, a swipe, and/or a pointing gesture/input)) (e.g., an input corresponding to a request to show a desktop) to display the respective user interface without obstruction (e.g., without being overlaid by windows and/or user interface objects that are not included in the respective user interface). In some embodiments, detecting the input corresponding to the request to change whether the respective user interface is selected for display as the focused user interface for the computer system includes detecting an input directed to control for changing a display mode. Detecting a request to display the respective user interface without obstruction to cause a visual appearance of the widget to change provides the user with the ability to better view the widget when displaying the respective user interface, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, detecting the input corresponding to the request to change whether the respective user interface (e.g., 638) is selected for display as the focused user interface for the computer system (e.g., 600) includes detecting an input (e.g., 1005Q) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) that is directed to a background (e.g., 638A) of the respective user interface. In some embodiments, the background is a wallpaper of a desktop user interface. In some embodiments, in response to the selection input representing selection of the background, the respective user interface is selected. Detecting an input that is directed to a background of the respective user interface to cause a visual appearance of the widget to change provides the user with the ability to better view the widget when displaying the background of the respective user interface, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, detecting the input corresponding to the request to change whether the respective user interface (e.g., 638) is selected for display as the focused user interface for the computer system (e.g., 600) includes detecting an input (e.g., 1005VA, 1005VB, and/or 1005VC) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) corresponding to a request to close a last remaining window (e.g., 1058, 1060, and/or 1062) corresponding to a respective type of application (e.g., a last remaining window of a file manager application or another system application) (e.g., an application for browsing, opening, launching, editing, and/or organizing one or more file system objects (e.g., files, folders, and/or applications)) (e.g., when the last file manager window is the last window that is currently displayed). Detecting an input corresponding to a request to close a last remaining window corresponding to a file manager application (e.g., and not after closing a window that is not the last remaining window corresponding to the file manager application) to cause a visual appearance of the widget to change provides the user with the ability to better view the widget when displaying the respective user interface without remaining windows corresponding to the file manager application, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, changing the visual emphasis of the one or more widget user interface elements includes decreasing the visual emphasis (e.g., decreasing size, changing color, reducing color, darkening, and/or decreasing opacity) of the one or more widget user interface elements relative to another portion of the respective user interface (e.g., 638) (e.g., and/or non-widget user interface elements included in the plurality of user interface objects). Decreasing the visual emphasis of the one or more widget user interface elements relative to another portion of the respective user interface provides the user with less emphasis on the one or more widget user interface elements when likely not viewing such, thereby providing improved visual feedback to the user and/or performing an operation when a set of conditions has been met without requiring further user input.

In some embodiments, detecting the input corresponding to the request to change whether the respective user interface (e.g., 638) is selected for display as the focused user interface for the computer system (e.g., 600) includes detecting an input (e.g., 1005R) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) corresponding to a request to display a user interface (e.g., 1058) (e.g., open a window or other user interface) corresponding to an application. In some embodiments, in response to an input corresponding to a request to open a window corresponding to an application, the respective user interface ceases to be selected. In some embodiments, in response to an input corresponding to a request to open a window corresponding to an application, the computer system displays the application and/or content from the application. Detecting an input corresponding to a request to open a window corresponding to an application to cause a visual appearance of the widget to change provides the user with less emphasis on the one or more widget user interface elements when likely not viewing such, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, detecting the input corresponding to the request to change whether the respective user interface (e.g., 638) is selected for display as the focused user interface for the computer system (e.g., 600) includes detecting an input (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) corresponding to a request to display a widget-only view of the respective user interface (e.g., 638) (e.g., a view that includes only widget user interface elements (e.g., 1010, 1012, and/or 1014) and/or removes some or all non-widget user interface elements (e.g., 1022, 1024, 1026, and/or 1028)). In some embodiments, in response to detecting the input corresponding to the request to change whether the respective user interface is selected for display as the focused user interface for the computer system, the computer system displays, via the display generation component, the widget-only view of the respective user interface that includes widget user interface elements without displaying (e.g., does not display, removes and/or hides) (e.g., temporarily, briefly, until further input, and/or until selection input ceases) non-widget user interface elements (e.g., icons corresponding to one or more applications, files, and/or folders). Displaying the widget-only view of the respective user interface that includes widget user interface elements without displaying non-widget user interface elements in response to detecting the input corresponding to the request to change whether the respective user interface is selected for display as the focused user interface for the computer system provides the user with a view with only widgets (e.g., and no other distractions), thereby reducing the number of inputs needed to perform an operation, providing additional control options without cluttering the user interface with additional displayed controls, and/or performing an operation when a set of conditions has been met without requiring further user input.

In some embodiments, the computer system (e.g., 600) detects a request to disable changing the visual emphasis of the one or more widgets in conjunction with a change in whether the respective user interface (e.g., 638) is selected (e.g., via input or via data received and/or retrieved from one or more other computer systems). In some embodiments, in response to detecting the request to disable changing the visual emphasis of the one or more widgets in conjunction with the change in whether the respective user interface is selected, the computer system disables changing of the visual emphasis of the one or more widgets in conjunction with the change in whether the respective user interface is selected for display as the focused user interface for the computer system. In some embodiments, while the changing of the visual emphasis of the one or more widgets is disabled in conjunction with the change in whether the respective user interface is selected for display as the focused user interface for the computer system, the computer system detects, via the one or more input devices, a subsequent selection input (e.g., subsequent to the selection input) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) (e.g., selection of a background of the respective user interface, selection of a user interface element of the respective user interface, or selection of a window corresponding to an application) (e.g., selection of an object, control, and/or region associated with the respective user interface or selection of an object, control, and/or region not associated with the respective user interface), corresponding to a request to change whether the respective user interface is selected for display as a focused user interface for the computer system (e.g., change from not selected to selected, or change from selected to not selected). In some embodiments, in response to detecting the subsequent selection input corresponding to the request to change whether the respective user interface is selected for display as a focused user interface for the computer system, the computer system forgoes changing a visual emphasis of the one or more widget user interface elements. In some embodiments, in response to detecting the subsequent selection input corresponding to the request to change whether the respective user interface is selected for display as a focused user interface for the computer system, the computer system changes whether the respective user interface is selected for display as a focused user interface for the computer system. In some embodiments, in response to detecting the subsequent selection input corresponding to the request to change whether the respective user interface is selected for display as a focused user interface for the computer system, and in accordance with a determination that the changing of the visual emphasis of the is disabled, the computer system does not change a visual emphasis of the one or more widget user interface elements. While disabling the changing of the visual emphasis of the one or more widgets in conjunction with the change in whether the respective user interface is selected for display as the focused user interface for the computer system, forgoing changing a visual emphasis of the one or more widget user interface elements in response to detecting the subsequent selection input corresponding to the request to change whether the respective user interface is selected for display as a focused user interface for the computer system provides the user the ability to configure the widgets to maintain a particular visual appearance, thereby reducing the number of inputs needed to perform an operation, providing additional control options without cluttering the user interface with additional displayed controls, and/or performing an operation when a set of conditions has been met without requiring further user input. Forgoing changing a visual emphasis of the one or more widget user interface elements in response to detecting the subsequent selection input corresponding to the request to change whether the respective user interface is selected for display as a focused user interface for the computer system provides the user the ability to configure the widgets to maintain a particular visual appearance, thereby reducing the power consumption by the computer system because the display is not being changed as often.

In some embodiments, the plurality of user interface objects includes widget user interface objects (e.g., 1010, 1012, and/or 1014) and non-widget user interface objects (e.g., 1022, 1024, 1026, and/or 1028). In some embodiments, the widget (e.g., 1010) is included in the widget user interface objects and not included in the non-widget user interface objects. In some embodiments, the widget user interface object is displayed in a same virtual plane (e.g., z axis) (e.g., that defines characteristics of how displayed user interface elements appear when displayed relative to other displayed user interface elements that overlap in position at a location on the display) as the non-widget user interface objects (e.g., widget and non-widget user interface objects behave the same with respect to whether they are obscured by windows (e.g., not visible when window is open and shares same location, and/or visible when no windows are open and sharing same location) and at a level higher than a background of the respective user interface (e.g., 638)). In some embodiments, the widget user interface object and the non-widget user interface objects are integrated into the surface of the respective user interface, where the widget user interface object and the non-widget user interface are not overlaid at least some other types of user interface objects, selectable user interface objects, and/or controls, such as windows, application user interfaces, and/or web browsers. In some embodiments, being displayed in a same virtual plane includes being displayed at a same visual depth (e.g., distance from a viewpoint, orientation, and/or perspective). In some embodiments, the visual depth is a visual effect-based depth based on visual effects (e.g., lighting and/or shadows). In some embodiments, the visual depth is a stereoscopically simulated effect-based depth based on using two or more different images and/or perspectives to simulate the perception of depth (e.g., different images being projected to different eyes to generate the illusion of depth). The widget user interface object being displayed in the same virtual plane as the non-widget user interface objects allows for widgets to not be covered by the non-widget user interface objects, thereby providing improved visual feedback to the user and/or reducing the number of inputs needed to perform an operation.

Note that details of the processes described above with respect to method 1100 (e.g., FIG. 11) are also applicable in an analogous manner to other methods described herein, including methods 700, 900, 1200, 1300, 1500, 1700, and/or 1900. For example, method 700 optionally includes one or more of the characteristics of the various methods described above with reference to method 1100. For example, animated visual content can be used as a background for a desktop interface that includes one or more widgets. For brevity, these details are not repeated below.

FIG. 12 is a flow diagram illustrating a method (e.g., method 1200) for placing a widget in accordance with some embodiments. Some operations in method 1200 are, optionally, combined, the orders of some operations are, optionally, changed, and some operations are, optionally, omitted.

As described below, method 1200 provides an intuitive way for placing a widget. Method 1200 reduces the cognitive burden on a user for placing a widget, thereby creating a more efficient human-machine interface. For battery-operated computing devices, enabling a user to place a widget faster and more efficiently conserves power and increases the time between battery charges.

In some embodiments, method 1200 is performed at a computer system (e.g., 600) that is in communication with a display generation component (e.g., a display screen and/or a touch-sensitive display) and one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some embodiments, the computer system (e.g., 600) is a watch, a phone, a tablet, a processor, a head-mounted display (HMD) device, and/or a personal computing device.

At 1202, the computer system (e.g., 600) displays, via the display generation component, a user interface (e.g., 638) that includes a first widget (e.g., 1014) at a respective location. In some embodiments, a widget is a graphical representation of an application (e.g., a set of processes, a set of executable instructions, a program, an applet, and/or an extension). In some embodiments, the application executes on the computer system. In some examples, the application executes on a second computer system (e.g., 1100) different from the first computer system. In some embodiments, the application is a first application that is controlled by (e.g., receives data from and/or synchronizes with) a second application, different from the first application, that executes on the second computer system. In some embodiments, the user interface includes an area (e.g., 638A) (e.g., background, wallpaper, surface and/or canvas) on which graphical user interface elements (e.g., representing widgets, icons, and/or other content (and/or representations thereof)) can be placed. In some embodiments, the user interface is a desktop user interface (e.g., of an operating system and/or of an application). In some embodiments, the user interface is a home screen user interface (e.g., of an operating system and/or of an application).

At 1204, the computer system (e.g., 600) detects, via the one or more input devices, an input (e.g., 1005C) (e.g., a drag near the first or second widget while the input continues to be detected (e.g., touch or click input continues), and/or a drop near the first or second widget (e.g., the input ceases to be detected, such as a touch or click input being released)) (e.g., a tap input and/or, in some embodiments, a non-tap input (e.g., a gaze, an air gesture, a mouse click, a button touch, a swipe, and/or a pointing gesture/input)) (and, in some embodiments, while displaying the user interface that includes the first widget at the respective location) corresponding to a request to move a second widget (e.g., 1048A) (e.g., a widget that is already part of a user interface that is being moved within the user interface, or a new widget that is not already part of the user interface that is being added and placed to the user interface) to a first drag location (e.g., location of 1048A in FIG. 10D) in the user interface (e.g., representing a request to place the second widget at the first drag location within the user interface and/or representing a request to move (e.g., while still selected and/or not placed yet) the second widget to the first drag location within the user interface). In some embodiments, an input associated with placement of a widget within the user interface corresponds to a request to place a new widget on the user interface (e.g., that was previously not included in the user interface). In some embodiments, an input associated with placement of a widget within the user interface corresponds to a request to move an existing widget on the user interface (e.g., that was previously included in the user interface). In some embodiments, an input associated with placement of a widget within the user interface corresponds to a request to move a widget from a different user interface (e.g., a notification user interface, a widget drawer user interface, and/or a user interface that is normally not visible (e.g., collapses when not in use, is hidden, and/or requires user input to appear) to the user interface).

At 1206, in response to detecting the input (e.g., while continuing to detect the input or detecting the end of the input) corresponding to the request to move the second widget (e.g., 1048A) to the first drag location (e.g., location of 1048A in FIG. 10D), in accordance with a determination (at 1208) that the first drag location is within a predetermined distance from the respective location of the first widget (e.g., is within a threshold distance of the first widget at the respective location, is at least partially overlapping the first widget at the respective location, and/or satisfies a location based criteria relative to the first widget at the respective location), the computer system (e.g., 600) moves the second widget to a first snapping location (e.g., 1052E) that is based on (e.g., along one or more edges, faces, and/or points, at a location that is based on an axis formed by and/or a grid (e.g., 1052) that surrounds (e.g., is centered around and/or based on) the respective location (and/or the first widget) but that does not extend the entirety of the user interface, adjacent to one or more edges of the first widget, on the perimeter of the first widget (where, in some embodiments, no other widgets are between the first widget and the second widget while the second widget is displayed at the first snapping location), and/or that is a second predetermined distance (e.g., smaller or larger than the predetermined distance) from the respective location (and/or first widget) (e.g., at a set distance from the edge of the first widget and/or a radius from the respective location)) the respective location of the first widget (e.g., location of 1014) but is different from the first drag location. In some embodiments, the first snapping location is different from the respective location and the first drag location. In some embodiments, the first drag location is different from an initial location of the second widget (e.g., prior to detecting the input and/or prior to movement to the first drag location). In some embodiments, moving the second widget to the first snapping location includes automatically moving the second widget to the first snapping location (e.g., snapping and/or shifting the second widget from the first drag location to the first snapping location). In some embodiments, the first snapping location is based on the respective location due to being aligned (e.g., along one or more edges, faces, and/or points) with the respective location (and/or the widget at the respective location) along at least one axis (e.g., parallel and/or intersecting axes) (e.g., one edge of the second widget aligns with one axis formed by the first widget and/or two edges of the second widget each align with one of two axes formed by the first widget). In some embodiments, the first snapping location is based on multiple locations (e.g., locations of 1010, 1012, and/or 1014) (e.g., multiple different widgets and/or one or more locations associated with each of the widgets) (and/or widgets). In some embodiments, in response to detecting the input corresponding to the request to move the second widget to the first drag location, the computer system displays the widget moving (e.g., to the first drag location and/or a different location than its initial location) (e.g., moves, animates, and/or tracks a location of an input).

At 1206, in response to detecting the input and in accordance with a determination (at 1210) that the first drag location (e.g., location of 1048A in FIG. 10D) is not within the predetermined distance (e.g., 1056) from the respective location of the first widget (e.g., 1014) (e.g., is not within a threshold distance of the first widget at the respective location, is not at least partially overlapping the first widget at the respective location, and/or does not satisfy a location based criteria relative to the first widget at the respective location), the computer system (e.g., 600) moves the second widget (e.g., 1048A) to the first drag location (e.g., forgoing automatically snapping and/or shifting the second widget in response to the placement). In some embodiments, in response to detecting the input and in accordance with the first drag location not being associated with the first widget at the respective location, the computer system moves the second widget to the first drag location (e.g., not the first snapping location and/or not a location associated with the first widget). In some embodiments, forgoing moving the second widget to the first snapping location includes forgoing automatically snapping the second widget to a location (e.g., location of 1048A in FIG. 10D) associated with the first widget. In some embodiments, in response to detecting the input and in accordance with the first drag location not being associated with the first widget at the respective location, the computer system moves the second widget to a second snapping location. In some embodiments, the second snapping location is not associated with a widget prior to moving the second widget (e.g., is not associated with the first widget, and/or is not associated with any other widget of the user interface). In some embodiments, in accordance with the first drag location not being associated with a widget, the computer system moves the second widget without regard to another widget (e.g., moves second widget based on detected input and/or limits, conditions, and/or boundaries that are not configured due to another widget being at a location of the user interface). In some embodiments, the second snapping location is associated with a third widget. In some embodiments, the second snapping location is based on the second respective location of the third widget but is different from the first drag location. In some examples, in response to detecting the input and in accordance with the first drag location being associated with the third widget at a second respective location, the computer system moves the second widget to the second snapping location that is based on the second respective location of the third widget but is different from the first drag location (e.g., the computer system automatically snaps and/or shifts the second widget to the second snapping location associated with a third widget different from the first widget and the second widget). Moving the second widget to a first snapping location that is based on the respective location of the first widget provides the user with control to move the widget on the user interface, thereby providing additional control options without cluttering the user interface with additional displayed controls.

In some embodiments, before moving the second widget (e.g., 1048A) to the first snapping location, the computer system (e.g., 600) detects, via the one or more input devices, initiation of a dragging input (e.g., 1005C) (e.g., a single (e.g., continuous) input that continues until the single input is no longer detected and/or is terminated), wherein the dragging input includes the input corresponding to the request to move the second widget to the first drag location (e.g., location of 1048A in FIG. 10D). In some embodiments, after moving the second widget to the first snapping location (e.g., while continuing to detect the dragging input (e.g., without detecting termination, release, end, and/or lift off of the dragging input)), the computer system continues to detect the dragging input. In some embodiments, detecting the dragging input at different locations of the first user interface causes a visual representation of the first widget (e.g., 1014) to move relative to the first user interface. In some embodiments, the computer system moves the second widget to the first snapping location while continuing to detect the input. In some embodiments, the dragging input includes another input (e.g., a new drag input and/or continued movement of a drag input) corresponding to a request to move the second widget to another drag location. In some embodiments, the other input is different and/or after the input corresponding to the request to move the second widget to the first drag location. In some embodiments, the widget remains at a respective snapping location for a first portion of the continued drag input but moves in accordance with a determination that the other input has moved a threshold distance (e.g., from the respective snapping location and/or another location associated with the widget). In some embodiments, the widget moves more quickly (e.g., than a velocity of the input relative to the user interface) to catch up to the other input (e.g., catching up to a location of a finger or cursor or a location where the object would have moved based on the input without the snapping behavior). Continuing to detect the dragging input after moving the second widget to a first snapping location that is based on the respective location of the first widget provides the user with control to move the widget on the user interface, thereby providing additional control options without cluttering the user interface with additional displayed controls.

In some embodiments, the second widget (e.g., 1048A) moves to the first snapping location in response to detecting, via the one or more input devices, termination (e.g., end, release, and/or lift off) of the input (e.g., 1005C) corresponding to the request to move the second widget to the first drag location (e.g., location of 1048A in FIG. 10D) (e.g., and/or detecting termination of a dragging input including the input corresponding to the request to move the second widget to the first drag location). Moving the second widget to a first snapping location in response to detecting termination of the input corresponding to the request to move the second widget to the first drag location provides the user with control to move the widget on the user interface, thereby providing additional control options without cluttering the user interface with additional displayed controls.

In some embodiments, in response to detecting the input corresponding to the request to move the second widget (e.g., 1048A) to the first drag location (e.g., location of 1048A in FIG. 10D) and in accordance with a determination that the first drag location is within the predetermined distance (e.g., 1056) from a respective location of a third widget (e.g., 1010, 1012, and/or 1014) (e.g., the user interface includes the third widget at the respective location of the third widget) different from the first widget (e.g., 1014) and the second widget, the computer system (e.g., 600) moves the second widget to a respective snapping location (e.g., 1052A-1052D) that is based on the respective location of the third widget but is different from the first drag location and the first snapping location. Moving the second widget to a respective snapping location that is based on the respective location of the third widget but is different from the first drag location and the first snapping location provides the user with control to move the widget on the user interface, thereby providing additional control options without cluttering the user interface with additional displayed controls.

In some embodiments, in accordance with a determination that the respective location of the first widget (e.g., 1014) is a first widget location, the first snapping location (e.g., 1052E) is in a first region of the user interface. In some embodiments, in accordance with a determination that the respective location of the first widget is a second widget location (e.g., location of 1010) different from the first widget location (e.g., location of 1014), the first snapping location (e.g., 1052A) is in a second region of the user interface. In some embodiments, the second region of the user interface is different from the first region of the user interface. In some embodiments, snapping locations are at different regions when the first widget is at different locations. In some embodiments, snapping locations are relative to a current location of the first widget. Having the snapping location be a first snapping location or a second snapping location in accordance with the respective location of the first widget being a first respective location or a second respective location provides the user with control to move the widget on the user interface, thereby providing additional control options without cluttering the user interface with additional displayed controls.

In some embodiments, in response to detecting the input corresponding to the request to move the second widget (e.g., 1048A) to the first drag location (e.g., location of 1048A in FIG. 10D) and in accordance with a determination that the first drag location is closer to a respective location of a fourth widget (e.g., 1014) than a respective location of a fifth widget (e.g., 1010) (e.g., and/or in accordance with a determination that the first drag location is within the predetermined distance (e.g., 1056) from the respective location of the fourth widget), the computer system (e.g., 600) moves the second widget to a first grid location (e.g., 1052E) (e.g., a respective snapping location of the fourth widget) of a first grid (e.g., a visible or non-visible grid) (e.g., the first grid location of the fourth widget is based on the respective location of the fourth widget but is different from the first drag location). In some embodiments, in response to detecting the input corresponding to the request to move the second widget (e.g., 1072) to the first drag location and in accordance with a determination that the first drag location is closer to the respective location of the fifth widget than the respective location of the fourth widget (e.g., and/or in accordance with a determination that the first drag location is within the predetermined distance from the respective location of the fourth widget), the computer system moves the second widget to a second grid location (e.g., 1052A) (e.g., a respective snapping location of the fifth widget) of a second grid (e.g., 1052 or 1054) (e.g., the respective grid location of the fifth widget is based on the respective location of the fifth widget but is different from the first drag location, wherein the respective), wherein the second grid location is different from the first grid location. In some embodiments, the fourth widget is the fifth widget (e.g., refers to the same widget at the same widget location of a user interface). In some embodiments, the first grid is the second grid (e.g., refers to the same grid). In some embodiments, the first grid location and the second grid location are different snapping locations corresponding to a same respective widget (e.g., the first grid location is a snapping location on one side of the respective widget and the second grid location is a snapping location on another side of the respective widget) (e.g., for a square grid centered on a widget, possible snapping locations can include top left, center left, bottom left, top center, bottom center, top right, center right, and/or bottom right). Moving the second widget to a first grid location of a first grid or moving the second widget to a second grid location of a second grid in accordance with the respective location of the first drag location being closer to a respective location of a fifth widget or a fourth widget provides the user with control to move the widget on the user interface, thereby providing additional control options without cluttering the user interface with additional displayed controls and performing an operation when a set of conditions has been met.

In some embodiments, the first grid (e.g., 1052) corresponds to a first portion of the user interface. In some embodiments, the second grid (e.g., 1054) corresponds to a second portion of the user interface. In some embodiments, the second portion is different from the first portion. In some embodiments, the second grid is different from the first grid. In some embodiments, the second grid is not directly adjacent to the first grid. In some embodiments, the second grid is separate from the first grid. In some embodiments, the second grid is not a continuation of the first grid and vice versa. In some embodiments, the user interface includes an area that is between the first grid and the second grid. Having the first grid correspond to a different portion of the user interface than the second grid provides the user with control to move the widget to different portions of the user interface, thereby providing additional control options without cluttering the user interface with additional displayed controls.

In some embodiments, in accordance with a determination that a first set of one or more widgets (e.g., 1010, 1012, and/or 1014) (e.g., including the fourth widget) is at a first respective location of the user interface, the first grid is defined based on locations of the widgets in the first set of widgets. In some embodiments, in accordance with a determination that the first set of one or more widgets (e.g., 1016 and/or 1018) is at a second respective location of the user interface different from the first respective location of the user interface, the first grid is defined based on locations of the widgets in the first set of widgets. In some embodiments, the first manner defines a grid based on a first set of one or more widgets and/or one or more locations corresponding to (e.g., of, near, under, touching, and/or adjacent to) the one or more widgets. In some embodiments, the second manner defines a grid based on a second set of one or more widgets and/or one or more corresponding to associated with the one or more widgets. In some embodiments, the first set of one or more widgets is different from the second set of one or more widgets. In some embodiments, in accordance with a determination that a second set of one or more widgets (e.g., including the fifth widget) is at a third respective location (e.g., different from the first respective location and/or the second respective location) of the user interface, the second grid is defined in a third manner (e.g., different from the first manner and/or the second manner); and in accordance with a determination that the second set of one or more widgets is at a fourth respective location (e.g., different from the first respective location and/or the second respective location) of the user interface different from the third respective location of the user interface, the second grid is defined in a fourth manner (e.g., different from the first manner and/or the second manner) different from the third manner. In some embodiments, the second set of one or more widgets is different from the first set of one or more widgets. Having the first grid defined in the first manner and the second grid in the first manner provides the user with control to move the widget to multiple grids defined in different manners on the user interface, thereby providing additional control options without cluttering the user interface with additional displayed controls.

In some embodiments, the second grid (e.g., 1054) is not aligned with the first grid (e.g., 1052) (e.g., the first grid is not aligned with the second grid). In some embodiments, not aligned means being tilted or offset along a vertical and/or horizontal axis (e.g., so that widgets within a set of one or more widgets (e.g., set of multiple widgets) are aligned with each other but are not required to be aligned with widgets in other sets of one or more widgets).

In some embodiments, the user interface (e.g., 638) is a desktop user interface that includes one or more desktop icons (e.g., a representation of a file, a representation of a folder, a non-widget object, non-widget content, a non-widget user interface element, and/or a selectable user interface element). Having the user interface be a desktop user interface that includes one or more desktop icons allows for widgets to be accessible with other desktop icons and not requiring covering the desktop user interface to view widgets, thereby providing improved visual feedback to the user and/or reducing the number of inputs needed to perform an operation.

In some embodiments, the one or more desktop icons (e.g., 1022, 1024, 1026, and/or 1028) (e.g., and/or content on the desktop user interface including or other than a widget) are organized in a first manner (e.g., subject to a first configuration and/or organization that arranges the one or more desktop icons and/or one or more widgets of the desktop user interface (e.g., based on automatic alignment rules) (e.g., such that the one or more desktop icons avoid locations corresponding to the one or more widgets and/or vice versa)) on the desktop user interface (e.g., while the user interface includes the first widget (e.g., 1014) at the respective location). In some embodiments, a respective desktop icon (e.g., of the one or more desktop icons) on the desktop user interface does not overlap (e.g., visually overlap) a respective widget (e.g., the first widget and/or another widget different from the first widget) on the desktop user interface. In some embodiments, the one or more desktop icons are organized around one or more widgets on the desktop user interface. Having desktop icons, on the desktop user interface, not overlap widgets on the desktop user interface allows for widgets to not be covered by the non-widget user interface objects, thereby providing improved visual feedback to the user and/or reducing the number of inputs needed to perform an operation.

In some embodiments, while the user interface (e.g., 638) includes the first widget (e.g., 1014) and while the user interface is organized in a second manner, the computer system (e.g., 600) detects, via the one or more input devices, an input corresponding to a request to change the user interface to be organized in a third manner different from the first manner (e.g., a request to change one or more automatic alignment rules). In some embodiments, as a result of (e.g., after and/or in response to) detecting the input corresponding to the request to change the user interface to be organized in the third manner, the computer system changes a position (e.g., a location and/or an orientation) of (e.g., moves and/or re-arranges) at least one desktop icon of the one or more desktop icons on the user interface without changing a position of a widget on the user interface, including the first widget. Changing a position of at least one desktop icon of the one or more desktop icons on the user interface without changing a position of a widget on the user interface, including the first widget, provides the user the ability to configure the widgets to maintain particular positions even when alignment rules for other user interface elements in the user interface are reorganized, thereby reducing the number of inputs needed to perform an operation, providing additional control options without cluttering the user interface with additional displayed controls, and/or performing an operation when a set of conditions has been met without requiring further user input.

In some embodiments, while displaying, via the display generation component, the user interface (e.g., 638) that includes the first widget (e.g., 1014) and the one or more desktop icons, the computer system detects, via the one or more input devices, an input corresponding to a request to expand a desktop icon (e.g., a group of one or more desktop icons) of the one or more desktop icons. In some embodiments, the desktop icon corresponds to a desktop folder. In some embodiments, the desktop folder corresponds to and/or includes zero or more desktop folders and one or more desktop files. In some embodiments, in response to detecting the input corresponding to the desktop icon of the one or more desktop icons, the computer system (e.g., 600) displays, via the display generation component, one or more additional desktop icons (e.g., zero or more desktop folders and one or more desktop files) corresponding to the desktop icon without changing a position of a set of one or more widgets on the user interface, including the first widget. In some embodiments, the one or more additional desktop icons were not displayed while detecting the input corresponding to the request to expand the desktop icon of the one or more desktop icons. In some embodiments, in response to detecting the input corresponding to the desktop icon of the one or more desktop icons, the computer system ceases displaying, via the display generation component, the desktop icon of the one or more desktop icons. In some embodiments, in response to detecting the input corresponding to the desktop icon of the one or more desktop icons, the computer system maintains displaying and/or changes display, via the display generation component, of the desktop icon of the one or more desktop icons. In some embodiments, while displaying the one or more additional desktop icons, the computer system detects, via the one or more input devices, an input corresponding to a request to collapse the one or more additional desktop icons (e.g., a request to collapse the desktop icon of the one or more desktop icons). In some embodiments, in response to detecting the input corresponding to a request to collapse the one or more additional desktop icons, the computer system ceases displaying, via the display generation component, the one or more additional desktop icons (e.g., without changing a position of the set of one or more widgets on the user interface) (e.g., based on locations of widgets in the set of one or more widgets). In some embodiments, in response to detecting the input corresponding to a request to collapse the one or more additional desktop icons, the computer system displays, via the display generation component, the desktop icon of the one or more desktop icons. In some embodiments, in response to detecting the input corresponding to a request to collapse the one or more additional desktop icons, the computer system maintains displaying, via the display generation component, the desktop icon of the one or more desktop icons. Displaying one or more additional desktop icons on the user interface without changing a position of a widget on the user interface, including the first widget, provides the user the ability to configure the widgets to maintain particular positions even when alignment rules for other user interface elements in the user interface are reorganized, thereby reducing the number of inputs needed to perform an operation, providing additional control options without cluttering the user interface with additional displayed controls, and/or performing an operation when a set of conditions has been met without requiring further user input.

In some embodiments, while the user interface (e.g., 638) includes the first widget (e.g., 1014) and the one or more desktop icons in a first order (e.g., alphabetical, tags, last opened, last modified, and/or last used) (e.g., and, in some embodiments, while displaying, via the display generation component, the user interface that includes the first widget and the one or more desktops icons in the first order), the computer system (e.g., 600) detects an input corresponding to a request to change from the first order to a second order different from the first order. In some embodiments, the one or more desktop icons are in the first order and the first widget is not in the first order. In some embodiments, in conjunction with (e.g., after and/or in response to) detecting input corresponding to a request to change from the first order to the second order, the computer system changes an order (e.g., a position, a location, and/or an orientation) of (e.g., moves and/or re-arranges) at least one desktop icon of the one or more desktop icons on the user interface without changing an order of a set of one or more widgets on the user interface, including the first widget (e.g., without changing a position of the set of one or more widgets on the user interface) (e.g., based on locations of widgets in the set of one or more widgets). Changing an order of at least one desktop icon of the one or more desktop icons on the user interface without changing an of a widget on the user interface, including the first widget, provides the user the ability to configure the widgets to maintain particular positions even when alignment rules for other user interface elements in the user interface are reorganized, thereby reducing the number of inputs needed to perform an operation, providing additional control options without cluttering the user interface with additional displayed controls, and/or performing an operation when a set of conditions has been met without requiring further user input.

In some embodiments, while displaying, via the display generation component, the user interface (e.g., 638) that includes the first widget (e.g., 1014) and the one or more desktops icons, the computer system detects, via the one or more input devices, an input corresponding to a change to a respective widget (e.g., a request to add, delete, move, resize, and/or otherwise change the respective widget). In some embodiments, in response to detecting the input corresponding to the change to the respective widget, the computer system (e.g., 600) updates (e.g., reflows, modifies, changes, and/or re-arranges display of) the user interface based on the change (e.g., around a new arrangement of widgets (e.g., zero or more widgets) on the user interface), wherein the updating includes moving (e.g., automatically moving (e.g., without detecting input corresponding to a request to move)) at least one desktop icon of the one or more desktop icons. In some embodiments, the updating includes adding the respective widget to the user interface. In some embodiments, the updating includes removing the respective widget from the user interface. In some embodiments, the updating includes modifying and/or changing the respective widget on the user interface. In some embodiments, the updating includes enlarging the respective widget on the user interface. In some embodiments, the updating includes shrinking the respective widget on the user interface. In some embodiments, the updating includes moving the respective widget on the user interface. In some embodiments, moving (e.g., a desktop icon) includes changing a position, location, orientation, organization, ordering, arrangement, grouping, and/or an ordering. In some embodiments, moving includes reflowing an arrangement of one or more desktop icons (e.g., to avoid one or more locations corresponding to widgets, such as to avoid visually overlapping the widgets). Updating the user interface based on the change to the widget, including moving at least one desktop icon, provides the user the ability to configure a change to a widget that causes automatic repositioning of at least one desktop icon in the user interface to avoid interfering with the widget, thereby reducing the number of inputs needed to perform an operation, providing additional control options without cluttering the user interface with additional displayed controls, and/or performing an operation when a set of conditions has been met without requiring further user input.

In some embodiments, while displaying, via the display generation component, the user interface (e.g., 638) that includes the one or more desktop icons, the computer system detects, via the one or more input devices, an input corresponding to a request to place a new widget at a new location on the user interface. In some embodiments, in response to detecting the input corresponding to the request to place the new widget at the new location on the user interface and in accordance with a determination that a respective desktop icon is associated with (e.g., located at, occupied by, corresponding to, and/or within a threshold distance from) the new location, the computer system (e.g., 600) places the new widget on the user interface such that the new widget does not visually overlap (e.g., avoids) the respective desktop icon. In some embodiments, placing the new widget on the user interface includes placing the new widget at the new location on the user interface and moving the respective desktop icon to a respective location different from the new location. In some embodiments, placing the new widget on the user interface includes placing the new widget at a respective location on the user interface different from the new location and maintaining the respective desktop icon at the new location. Placing the new widget on the user interface such that the new widget does not visually overlap the respective desktop icon provides the user the ability to place a widget that automatically avoids visual overlap that affects user experience, thereby reducing the number of inputs needed to perform an operation, providing additional control options without cluttering the user interface with additional displayed controls, and/or performing an operation when a set of conditions has been met without requiring further user input.

In some embodiments, while displaying, via the display generation component, the user interface (e.g., 638) that includes the one or more desktop icons, the computer system (e.g., 600) detects, via the one or more input devices, an input corresponding to a request to place a second new widget at a second new location on the user interface. In some embodiments, in response to detecting the input corresponding to the request to place the second new widget at the second new location on the user interface and in accordance with a determination that a respective system user interface element (e.g., a dock, a status bar, a time, and/or a menu bar) (e.g., that is included in or not included in the user interface) is associated with (e.g., located at, occupied by, corresponding to, and/or within a threshold distance from (e.g., near, close to, and/or adjacent to)) the second new location, the computer system (e.g., 600) places the second new widget on the user interface such that the second new widget does not visually overlap (e.g., avoids) the respective system user interface element. In some embodiments, placing the second new widget on the user interface includes placing the second new widget at the new location on the user interface and moving the respective system user interface element to a respective location different from the new location. In some embodiments, placing the second new widget on the user interface includes placing the second new widget at a respective location on the user interface different from the second new location and maintaining the system user interface element at the new location. Placing the new widget on the user interface such that the new widget does not visually overlap the respective system user interface element provides the user the ability to place a widget that automatically avoids visual overlap that affects user experience, thereby reducing the number of inputs needed to perform an operation, providing additional control options without cluttering the user interface with additional displayed controls, and/or performing an operation when a set of conditions has been met without requiring further user input. In some embodiments, the predetermined distance (e.g., 1056) is equal to or less than one-third of a width (e.g., along an x axis, along a y axis, and/or any directional axis) of the first widget (e.g., 1014).

In some embodiments, in response to detecting the input corresponding to the request to move the second widget (e.g., 1048A) to the first drag location (e.g., location of 1048A in FIG. 10D) and in accordance with a determination that the first drag location is within the predetermined distance (e.g., 1056) from a respective location of a respective widget (e.g., the user interface (e.g., 638) includes the respective widget at the respective location of the respective widget) different from the first widget (e.g., 1014) and the second widget, the computer system (e.g., 600) moves the second widget to a respective snapping location that is not based on the respective location of the first widget (e.g., that is based on the respective location of the respective widget but is different from the first drag location and the first snapping location). In some embodiments, the third widget includes one or more of the features, behaviors, and/or interactions (e.g., snapping to a snapping location based on the location of a respective widget, snapping to a snapping location based on a grid, avoiding visual overlap with certain types and/or all other user interface elements, and/or being part of a desktop user interface) as described above with respect to other widgets (e.g., first widget and/or second widget) Moving the second widget to a respective snapping location that is not based on the respective location of the first widget provides the user with control to move the widget on the user interface, thereby providing additional control options without cluttering the user interface with additional displayed controls.

In some embodiments, before moving the second widget to the first snapping location (e.g., location of 1014A, 1014B, and/or 1014C at FIGS. 10AO, 10AP, and/or 10AR), the computer system (e.g., 600) detects, via the one or more input devices, initiation of a second dragging input (e.g., 1005AN, 1005AQ, and/or 1005AR) (e.g., an input that includes a touch down event followed by lateral movement) (e.g., a single (e.g., continuous) input that continues until the single input is no longer detected and/or is terminated), wherein the second dragging input includes the input corresponding to the request to move the second widget to the first drag location (e.g., location of 1005AN, 1005AQ, and/or 1005AR at FIGS. 10AO, 10AP, 10AQ, and/or 10AR) (e.g., location of widget 1014 at FIGS. 10AO, 10AP, 10AQ, and/or 10AR). In some embodiments, while continuing to detect the second dragging input and in accordance with a determination that a current drag location (e.g., location of 1005AN, 1005AQ, and/or 1005AR at FIGS. 10AO, 10AP, 10AQ, and/or 10AR) (e.g., location of widget 1014 at FIGS. 10AO, 10AP, 10AQ, and/or 10AR) of the second widget is within the predetermined distance from a respective location of a sixth widget (e.g., 1012 and/or 1016 at FIGS. 10AO, 10AP, and/or 10AR), the computer system displays, via the display generation component, an indication (e.g., 1014A, 1014B, and/or 1014C at FIGS. 10AO, 10AP, and/or 10AR) (e.g., an outline and/or a representation of the second widget (e.g., the same or different appearance from the second widget before detecting initiation of the second dragging input)) of a respective snapping location based on the sixth widget (e.g., location of 1014A, 1014B, and/or 1014C at FIGS. 10AO, 10AP, and/or 10AR). In some embodiments, the indication of the respective snapping location is displayed at a location where the second widget would be placed if the second dragging input is terminated. In some embodiments, while continuing to detect the second dragging input and in accordance with a determination that the current drag location of the second widget is not within the predetermined distance from the respective location of the sixth widget, forgoing displaying, via the display generation component, the indication of the respective snapping location based on the sixth widget. Displaying the indication of the respective snapping location while detecting the dragging input provides an indication of the state of the computer system and of an available operation, thereby performing an operation when a set of conditions has been met without requiring further user input and providing improved feedback.

In some embodiments, while continuing to detect the second dragging input (e.g., 1005AN, 1005AQ, and/or 1005AR) and while displaying the indication of a respective snapping location (e.g., 1014A, 1014B, and/or 1014C at FIGS. 10AO, 10AP, and/or 10AR) based on the sixth widget (e.g., 1012 and/or 1016 at FIGS. 10AO, 10AP, and/or 10AR), the computer system (e.g., 600) detects, via the one or more input devices, movement of the second dragging input (e.g., arrows at FIGS. 10AN-10AP and/or 10AR-10AS). In some embodiments, after (and/or, in some examples, in response to and/or while) detecting the movement of the second dragging input and in accordance with a determination that a second current drag location (e.g., location of 1014A, 1014B, and/or 1014C at FIGS. 10AO, 10AP, and/or 10AR) (e.g., different than the current drag location) of the second widget is within the predetermined distance (e.g., as discussed above at FIG. AO) from a respective location (e.g., location of any one of 1010-1048A at FIG. 10AN) of a seventh widget (e.g., 1012 and/or 1016 at FIGS. 10AO, 10AP, and/or 10AR) different from the sixth widget, the computer system (e.g., 600) displays, via the display generation component, an indication of a second respective snapping location (e.g., 1014A, 1014B, and/or 1014C at FIGS. 10AO, 10AP, and/or 10AR) based on the seventh widget. In some embodiments, after, in response to, and/or while detecting the movement of the second dragging input and in accordance with a determination that the second current drag location of the second widget is within the predetermined distance from the respective location of the seventh widget and closer to the respective location of the seventh widget than the respective location of the sixth widget, the computer system ceases displaying, via the display generation component, the indication of the respective snapping location based on the sixth widget. In some embodiments, while detecting the second dragging input and in accordance with a determination that the second current drag location of the second widget is not within the predetermined distance from the respective location of the sixth widget, the computer system ceases displaying, via the display generation component, the indication of the respective snapping location based on the sixth widget. In some embodiments, an indication of a snapping location (e.g., the second respective snapping location) moves as a widget is dragged around the user interface. In some embodiments, one indication of a snapping location is displayed at a time (e.g., the closest snapping location has an indication, and no other potential snapping locations do). In some embodiments, multiple indications of a snapping location are displayed concurrently (e.g., snapping location corresponding to the same and/or different widgets). Displaying the indication of a respective snapping location based on the seventh widget in response to detecting movement of the dragging input provides an indication of the state of the computer system and of an available operation, thereby performing an operation when a set of conditions has been met without requiring further user input and providing improved feedback.

In some embodiments, the sixth widget (e.g., 1010, 1012, 1014, 1016, 1018, and/or 1048A at FIGS. 10AN-10AT) is part of a first group of widgets (e.g., a group including 1010, 1012, 1014, and 1048A and/or a group including 1016 and 1018) (e.g., groups as discussed above at FIG. 10AN) (e.g., such as described herein with respect to computer system 600) and the indication (e.g., 1014A, 1014B, and/or 1014C at FIGS. 10AO, 10AP, and/or 10AR) of the first respective snapping location (e.g., location of 1014A, 1014B, and/or 1014C at FIGS. 10AO, 10AP, and/or 10AR) based on the sixth widget is a snapping location associated with the first group of widgets (e.g., as discussed at FIG. 10AN). In some embodiments, the seventh widget (e.g., 1010, 1012, 1014, 1016, 1018, and/or 1048A at FIGS. 10AN-10AT) is part of a second group of widgets (e.g., 1010-1048A and/or 1016-1018) (e.g., such as described herein with respect to computer system 600) different from the first group of widgets and the indication of the second respective snapping location based on the seventh widget is a snapping location associated with the second group of widgets. Displaying the indication of respective snapping locations based on the sixth widget and seventh widget in response the dragging input provides an indication of the state of the computer system (e.g., 600) and of an available operation, thereby performing an operation when a set of conditions has been met without requiring further user input and providing improved feedback.

In some embodiments, before displaying the indication of the respective snapping location (e.g., 1014A, 1014B, and/or 1014C at FIGS. 10AO, 10AP, and/or 10AR) based on the sixth widget (e.g., 1010, 1012, 1014, 1016, 1018, and/or 1048A at FIGS. 10AN-10AT), the computer system (e.g., 600) displays, via the display generation component, a set of one or more desktop icons (e.g., 1022, 1024, 1026, and/or 1028 at FIGS. 10AN-AT) at a location (e.g., location of 1022, 1024, 1026, and/or 1028 at FIGS. 10AN-AT) corresponding to the respective snapping location based on the sixth widget (e.g., within the bounds of the first respective snapping location, such as delineated by the indication of the first respective snapping location). In some embodiments, while continuing to detect the second dragging input (e.g., 1005AN, 1005AQ, and/or 1005AR) and in accordance with the determination that the current drag location of the second widget is within the predetermined distance from the respective location of the sixth widget (e.g., as discussed above at FIG. 10AP) (e.g., in conjunction with displaying the indication of the respective snapping location based on the sixth widget), the computer system (e.g., 600) moves the set of one or more desktop icons to a location (e.g., location of 1022, 1024, 1026, and/or 1028 at FIGS. 10AP-AR) outside of (and/or away from) the location corresponding to the respective snapping location based on the sixth widget. In some embodiments, displaying the indication of the respective snapping location based on the sixth widget includes moving the set of one or more desktop icons to the location outside of the location corresponding to the respective snapping location based on the sixth widget. In some embodiments, moving the set of one or more desktop icons to the location outside of the location corresponding to the respective snapping location based on the sixth widget includes visually moving and/or animating movement of the set of one or more desktop icons to the location outside of the location corresponding to the respective snapping location based on the sixth widget. In some embodiments, while continuing to detect the second dragging input and in response to ceasing displaying the indication of the respective snapping location based on the sixth widget, the computer system moves the set of one or more desktop icons to (e.g., back to) the location corresponding to the respective snapping location based on the sixth widget. In some embodiments, the set of one or more desktop icons is displayed at the location outside of the location corresponding to the respective snapping location based on the sixth widget while the indication of the respective snapping location based on the sixth widget is displayed. Moving the set of one or more desktop icons to the location outside of the location corresponding to the respective snapping location based on the sixth widget while continuing to detect the second dragging input automatically provides the user additional control options for avoiding visual conflict between user interface elements, thereby reducing the number of inputs needed to perform an operation, performing an operation when a set of conditions has been met without requiring further user input, and providing improved visual feedback to the user.

In some embodiments, in response to detecting the input (e.g., 1005AN, 1005AQ, and/or 1005AR) corresponding to the request to move the second widget (e.g., 1010, 1012, 1014, 1016, 1018, and/or 1048A at FIGS. 10AN-10AT) to the first drag location (e.g., location of 1005AN, 1005AQ, and/or 1005AR at FIGS. 10AO, 10AP, 10AQ, and/or 10AR) (e.g., location of widget 1014 at FIGS. 10AO, 10AP, 10AQ, and/or 10AR) and in accordance with a determination that the first drag location is at least partially located outside of a spatial limit (e.g., bounds of 638 at FIGS. 10AN-10AT) (e.g., a border, a bound, an edge, and/or an area) of the user interface (e.g., 638) (e.g., and at least partially not displayed), the computer system (e.g., 600) moves the second widget to a location that is based on the first drag location (e.g., location of 1014C in FIG. 10AR) and that is within (e.g., fully within) the spatial limit of the user interface (e.g., as discussed above at FIGS. 10AR-10AS) (e.g., such that the second widget is fully visible within the spatial limit of the user interface after moving the second widget to the location that is based on the first location and that is within the spatial limit of the user interface), wherein the location that is based on the first drag location and that is within the spatial limit of the user interface is different from the first drag location. In some embodiments, the location that is based on the first drag location and that is within the spatial limit of the user interface is a respective snapping location that is closest to the first drag location and that is within the spatial limit. In some embodiments, the location that is based on the first drag location and that is within the spatial limit of the user interface is not a snapping location (e.g., is a closest location that is within the spatial bounds). In some embodiments, the location that is based on the first drag location and that is within the spatial limit is a predefined minimum distance from the spatial limit (e.g., a buffer and/or padding region defined by the predefined minimum distance is maintained between the widget and the spatial limit). Moving the second widget to the location that is based on the first drag location and that is within the spatial limit of the user interface automatically provides the user additional control options for avoiding visual conflict between user interface elements, thereby reducing the number of inputs needed to perform an operation, performing an operation when a set of conditions has been met without requiring further user input, and providing improved visual feedback to the user.

In some embodiments, before detecting the input corresponding to the request to move the second widget to the first drag location, the computer system (e.g., 600) displays, via the display generation component, the first widget and the second widget with a first visual appearance corresponding to a non-selected state (e.g., such as described above with respect to method 1100); and while displaying the first widget and the second widget with the first visual appearance, detects a request (e.g., corresponding to an input) to initiate a process to move the second widget (e.g., a process to initiate an editing mode of one or more widgets, a process to select the second widget, and/or a process to move the second widget) (e.g., the beginning of a drag input that includes the input corresponding to the request to move the second widget to the first drag location). In some embodiments, the request corresponds to the detection, initiation, start, and/or beginning of an input, such as a touch down event or a touch down event that is held for a predefined amount of time. In some embodiments, the request corresponds to the detection, initiation, start, and/or beginning of movement of an input, such as the beginning of lateral movement following a touch down event that continues being in contact with the input device (e.g., a dragging input). In some embodiments, in response to detecting the request to initiate the process to move the second widget, displaying, via the display generation component, the first widget and the second widget with a second visual appearance (e.g., a prominent state and/or a prominent visual appearance) corresponding to a selected state (e.g., such as described above with respect to method 1100), wherein the second visual appearance is different from the first visual appearance. Displaying the first widget and the second widget with the second visual appearance in response to detecting the request to initiate the process to move the second widget, provides the user with an indication of the state of the computer system, thereby performing an operation when a set of conditions has been met without requiring further user input and providing improved visual feedback to the user.

In some embodiments, after (or, optionally in conjunction with) moving the second widget (e.g., in response to the input that corresponds to moving the second widget) (e.g., while widget is moving and/or after completion of the request (e.g., input) that causes the movement) (e.g., in response to an end of input, such as a lift off event and/or the end of lateral movement for at least a predefined amount of time), the computer system (e.g., 600) maintains display of the first widget and the second widget with the second visual appearance corresponding to the selected state. In some embodiments, the computer system maintains display of the first widget and the second widget with the second visual appearance corresponding to the selected state while and/or without detecting the request (e.g., input) and/or a different request (e.g., the second visual appearance remains after a widget is moved). Maintaining display of the first widget and the second widget with the second visual appearance provides the user with an indication of the state of the computer system, thereby performing an operation when a set of conditions has been met without requiring further user input and providing improved visual feedback to the user.

In some embodiments, after (or, optionally in conjunction with) moving the second widget (e.g., in response to the input that corresponds to moving the second widget) (e.g., at the completion and/or termination of the process to move the second widget) (e.g., while widget is moving and/or after completion of the request (e.g., dragging input) that causes the movement) (e.g., in response to an end of input, such as a lift off event and/or the end of lateral movement for at least a predefined amount of time), the computer system (e.g., 600) displays, via the display generation component, the first widget and the second widget with the first visual appearance corresponding to the non-selected state. In some embodiments, displaying the first widget and the second widget with the first visual appearance corresponding to the non-selected state includes (e.g., and/or is performed together with) ceasing display of the first widget and the second widget with the second visual appearance corresponding to the selected state (e.g., the first visual appearance takes replaces the second visual appearance). Displaying the first widget and the second widget with the first visual appearance in response to moving the second widget provides the user with an indication of the state of the computer system, thereby performing an operation when a set of conditions has been met without requiring further user input and providing improved visual feedback to the user.

In some embodiments, the computer system (e.g., 600) detects that the input (e.g., 1005AN, 1005AQ, and/or 1005AR) corresponding to the request to move the second widget (e.g., 1010, 1012, 1014, 1016, 1018, and/or 1048A at FIGS. 10AN-10AT) to the first drag location (e.g., location of 1005AN, 1005AQ, and/or 1005AR at FIGS. 10AO, 10AP, 10AQ, and/or 10AR) (e.g., location of widget 1014 at FIGS. 10AO, 10AP, 10AQ, and/or 10AR) in the user interface (e.g., 638) causes the second widget to pass through (e.g., be dragged to occupy (e.g., temporarily as drag continues or permanently when drag ends) and/or be displayed at) one or more locations that include one or more desktop icons (e.g., 1022, 1024, 1026, and/or 1028 at FIGS. 10AN-AT). In some embodiments, in response to detecting that the input corresponding to the request to move the second widget to the first drag location in the user interface causes the second widget to pass through the one or more locations that include the one or more desktop icons, the computer system moves the one or more desktop icons (e.g., around (e.g., in a manner that avoids and/or prevents overlapping with) the second widget) away from the one or more locations while the second widget passes through (e.g., occupies (e.g., temporarily as drag continues or permanently when drag ends) and/or is displayed at) the one or more locations (e.g., as discussed above at FIG. 10AP). In some embodiments, moving the one or more desktop icons includes displaying, via the display generation component, the one or more desktop icons moving (e.g., changing location in one or more directions). In some embodiments, moving the one or more desktop icons around the second widget while the second widget passes through the one or more locations includes displaying, via the display generation component, the one or more desktop icons moving out of the way of the second widget as the second widget moves. In some embodiments, moving the one or more desktop icons around includes moving a desktop icon of the one or more desktop icons to a nearest location that that satisfies a set of one or more icon movement criteria. In some embodiments, the set of one or more icon movement criteria includes a criterion based on one or more of: a minimum distance (e.g., between an icon and the second widget), a maximum distance (e.g., movement of the icon), and/or spatial limits (e.g., icon must say within spatial limits of user interface and/or other user interface elements (e.g., icons moving also move around stationary widgets and/or other desktop icons)). Moving the one or more desktop icons away from the one or more locations while the second widget passes through the one or more locations automatically provides the user additional control options for avoiding visual conflict between user interface elements, thereby reducing the number of inputs needed to perform an operation, performing an operation when a set of conditions has been met without requiring further user input, and providing improved visual feedback to the user.

In some embodiments, after moving the one or more desktop icons away from the one or more locations (e.g., as discussed above at FIG. 10AP) (e.g., while the one or more desktop icons are displayed at a location different from the one or more locations) after the second widget (e.g., 1010, 1012, 1014, 1016, 1018, and/or 1048A at FIGS. 10AN-10AT) passed through the one or more locations (e.g., location of 1022, 1024, 1026, and/or 1028 at FIGS. 10AN-AT) and in accordance with a determination that the second widget is no longer positioned at (e.g., due to a continuation of the input movement and/or due to a subsequent input) the one or more locations, the computer system (e.g., 600) moves the one or more desktop icons to (e.g., back to) the one or more locations (e.g., location of 1022, 1024, 1026, and/or 1028 at FIGS. 10AN-AT). Moving the one or more desktop icons back to the one or more locations in accordance with a determination that the second widget is no longer positioned at the one or more locations automatically provides the user additional control options for avoiding visual conflict between user interface elements, thereby reducing the number of inputs needed to perform an operation, performing an operation when a set of conditions has been met without requiring further user input, and providing improved visual feedback to the user.

In some embodiments, the computer system (e.g., 600) detects, via the one or more input devices, an input (e.g., 1005AQ) (e.g., a hover of a pointer, an input without selection, and/or a gaze) corresponding to (e.g., directed to, on a location of, at a location of, over a location of, hovering over, and/or otherwise associated with a visible or non-visible portion of) the second widget for at least a predefined period of time (e.g., as discussed above at FIG. 10AR) (e.g., while not in a mode for currently moving the second widget). In some embodiments, in response to detecting the input corresponding to the second widget for at least the predefined period of time, the computer system (e.g., 600) displays, via the display generation component, a first control corresponding to the second widget (e.g., the control displayed on widget 1014 in FIG. 10AR, as discussed above at FIG. 10AR) (e.g., at a location of the widget, overlaid on the widget, adjacent to the widget, in close proximity to the widget, and/or otherwise associated with the widget due to placement and/or an indication (e.g., visual and/or textual)). In some embodiments, in response to detecting an input corresponding to the second widget for less than the predefined period of time, the computer system forgoes displaying, via the display generation component, the first control corresponding to the second widget. In some embodiments, while displaying the first control corresponding to the second widget, the computer system (e.g., 600) detects, via the one or more input devices, an input (e.g., a selection input, a hover of a pointer, an input without selection, and/or a gaze) corresponding to (e.g., on a location of, at a location of, over a location of, and/or otherwise associated with a visible or non-visible portion of) selection of the first control corresponding to the second widget (e.g., as discussed above at FIG. 10AR). In some embodiments, in response to detecting the input corresponding to selection of the first control corresponding to the second widget, the computer system ceases to display the second widget on the user interface (e.g., 638) (e.g., closes the widget, deletes the widget (e.g., from the user interface and/or from the computer system), hides the widget, removes the widget, and/or moves the widget to another user interface and/or area). Displaying the first control corresponding to the second widget that when selected causes the second widget to cease to be displayed provides the user additional control options for ceasing to display a widget, thereby reducing the number of inputs needed to perform an operation, performing an operation when a set of conditions has been met without requiring further user input, and providing improved visual feedback to the user.

In some embodiments, the computer system (e.g., 600) detects, via the one or more input devices, a second input (e.g., as discussed above at FIG. 10AR) (e.g., a hover of a pointer, a point without selection, and/or a gaze) corresponding to (e.g., on a location of, at a location of, over a location of, and/or otherwise associated with a visible or non-visible portion of) the second widget (e.g., 1010, 1012, 1014, 1016, 1018, and/or 1048A at FIGS. 10AN-10AT) (e.g., that is not a request to move the second widget and/or that is not a request to select the second widget) (e.g., for at least a second predetermined period of time or for less than the second predetermined period of time). In some examples, in response to detecting the second input corresponding to the second widget: In some embodiments, in accordance with a determination that the second input corresponding to the second widget is detected while a first predefined input (e.g., keypress such as 1005AS2 of key 1001 in FIG. 10AS) is detected (e.g., while a particular key (e.g., modifier key (e.g., control key, shift key, and/or option key)) is pressed (e.g., held down), while a particular button is pressed, and/or while a predetermined control and/or area (e.g., of a touch screen display is being contacted)), the computer system displays, via the display generation component, a second control (e.g., the control displayed on widget 1014 in FIG. 10AR, as discussed above at FIG. 10AR) (e.g., the same or different than the first control) (e.g., a virtual button, an affordance, and/or a graphical user interface object and/or element) corresponding to the second widget (e.g., at a location of the widget, overlaid on the widget, adjacent to the widget, in close proximity to the widget, and/or otherwise associated with the widget due to placement and/or an indication (e.g., visual and/or textual)), wherein the second control is configured to, when selected, cause the computer system (e.g., 600) to cease to display (e.g., as discussed above at FIG. 10AR) the second widget on the user interface (e.g., 638) (e.g., close the widget, delete the widget (e.g., from the user interface and/or from the computer system), hide the widget, remove the widget, and/or move the widget to another user interface and/or area). In some embodiments, in accordance with a determination that the second input corresponding to the second widget is not detected while the first predefined input is detected (e.g., while a particular key is pressed (e.g., held down), while a particular button is pressed, and/or while a predetermined control and/or area (e.g., of a touch screen display) is being contacted), the computer system forgoes displaying the second control corresponding to the second widget (e.g., as discussed above at FIG. 10AR) (e.g., at a location of the widget, overlaid on the widget, adjacent to the widget, in close proximity to the widget, and/or otherwise associated with the widget due to placement and/or an indication (e.g., visual and/or textual)). Displaying the first control corresponding to the second widget that when selected causes the second widget to cease to be displayed provides the user additional control options for ceasing to display a widget, thereby reducing the number of inputs needed to perform an operation, performing an operation when a set of conditions has been met without requiring further user input, and providing improved visual feedback to the user.

In some embodiments, the computer system (e.g., 600) detects, via the one or more input devices, an input (e.g., 1005AS1) (e.g., a hover of a pointer, a point without selection, and/or a gaze) corresponding to (e.g., on a location of, at a location of, over a location of, and/or otherwise associated with a visible or non-visible portion of) a second request to move the second widget (e.g., 1010, 1012, 1014, 1016, 1018, and/or 1048A at FIGS. 10AN-10AT) to a second drag location (e.g., as discussed above at FIG. 10AS) in the user interface (e.g., 638) different from the input corresponding to the request to move the second widget to the first drag location in the user interface. In some embodiments, in response to detecting the input corresponding to the second request to move the second widget to the second drag location in the user interface, in accordance with a determination that the input corresponding to the second request to move the second widget to the second drag location is detected while detecting a second predefined input (e.g., 1005AS2) (e.g., the same or different from the first predefined input) (e.g., while a particular key (e.g., modifier key (e.g., control key, shift key, and/or option key)) is pressed (e.g., held down), while a particular button is pressed, and/or while a predetermined control and/or area (e.g., of a touch screen display is being contacted)), the computer system moves a group of widgets (e.g., 1010-1048A at FIGS. 10AS and/or 10AT) (e.g., two or more widgets) (e.g., two or more widgets assigned to the group of widgets) (e.g., two or more widgets in close relative proximity) (e.g., two or more widgets that are respectively adjacent) (e.g., being dragged across the user interface) to the second drag location based on the input corresponding to the second request, wherein the group of widgets includes the second widget. In some embodiments, in accordance with a determination that the input corresponding to the second request to move the second widget to the second drag location is not detected while detecting the second predefined input, the computer system (e.g., 600) moves the second widget (e.g., being dragged across the user interface) to the second drag location based on the input corresponding to the second request without moving one or more other widgets in the group of widgets (e.g., the second widget is moved relative to one or more other widgets in the group, and/or one or more other widgets in the group remain stationary at their corresponding location (e.g., that they occupied immediately prior to the input corresponding to the second request to move the second widget to the respective location) while the second widget moves). Moving either the group of widgets or moving the second widget based on whether the second predefined input is detected provides the user additional control options for moving one or more widgets, thereby reducing the number of inputs needed to perform an operation, providing additional control options without cluttering the user interface with additional displayed controls, and providing improved visual feedback to the user.

In some embodiments, before moving the second widget (e.g., 1010, 1012, 1014, 1016, 1018, and/or 1048A at FIGS. 10AN-10AT) to the first snapping location (e.g., location of 1014A, 1014B, and/or 1014C at FIGS. 10AO, 10AP, and/or 10AR), the computer system (e.g., 600) detects, via the one or more input devices, initiation of a third dragging input (e.g., 1005AN, 1005AQ, and/or 1005AR) (e.g., an input that includes a touch down event followed by lateral movement) (e.g., a single (e.g., continuous) input that continues until the single input is no longer detected and/or is terminated), wherein the third dragging input includes the input corresponding to the request to move the second widget to the first drag location. In some embodiments, in conjunction with (e.g., while, after, and/or in response to) detecting the third dragging input and in accordance with a determination that the third dragging input causes at least a predefined amount of movement (e.g., a total amount or magnitude of movement and/or a total number) of one or more desktop icons (e.g., as discussed above at FIG. 10AQ) (e.g., that satisfies a set of one or more movement criteria (e.g., that includes a criterion that is satisfied when movement corresponding to (e.g., of and/or due to) the one or more desktop icons exceeds the predefined amount of movement)), the computer system displays, via the display generation component, a notification (e.g., as discussed above at FIG. 10AQ-10AR) (e.g., user interface that includes a message, such as a suggestion or tip regarding how to organize desktop icons and/or to enable a feature for organizing desktop icons (e.g., enabling a feature that stacks like and/or related icons on the desktop in a manner that reduces the overall footprint of those icons on the desktop with stacked)). In some embodiments, the notification includes a control that, when selected, re-organizes the one or more desktop icons. In some embodiments, in conjunction with (e.g., while, after, and/or in response to) detecting the third dragging input and in accordance with a determination that the third dragging input does not cause the predefined amount of movement of the one or more desktop icons (e.g., does not satisfy a set of one or more movement criteria), the computer system forgoes displaying the notification.

Note that details of the processes described above with respect to method 1200 (e.g., FIG. 12) are also applicable in an analogous manner to other methods described herein, including methods 700, 900, 1100, 1300, 1500, 1700, and/or 1900. For example, method 700 optionally includes one or more of the characteristics of the various methods described above with reference to method 1200. For example, animated visual content can be used as a background for a desktop interface that includes one or more widgets. For brevity, these details are not repeated below.

FIG. 13 is a flow diagram illustrating a method (e.g., method 1300) for displaying widget information in accordance with some examples. Some operations in method 1300 are, optionally, combined, the orders of some operations are, optionally, changed, and some operations are, optionally, omitted.

As described below, method 1300 provides an intuitive way for displaying widget information. Method 1300 reduces the cognitive burden on a user for displaying widget information, thereby creating a more efficient human-machine interface. For battery-operated computing devices, enabling a user to display widget information faster and more efficiently conserves power and increases the time between battery charges.

In some embodiments, method 1300 is performed at a first computer system that is in communication with a display generation component (e.g., a display screen and/or a touch-sensitive display) and one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some embodiments, the computer system (e.g., 600) is a watch, a phone, a tablet, a processor, a head-mounted display (HMD) device, and/or a personal computing device.

At 1302, the first computer system (e.g., 600) displays, via the display generation component, a widget (e.g., 1074) that includes a widget user interface (e.g., 638) (e.g., the displayed area of the widget in which graphical content, graphical data, and/or a set of controls (e.g., virtual toggles, sliders, and/or buttons) are displayed) representing widget data (e.g., calendar data, weather data, and/or application data), wherein the widget data is provided by an application on a second computer system (e.g., 1100) that is different from the first computer system (e.g., in communication with the first computer system, paired with the second computer system, and/or associated with the first computer system). In some embodiments, a widget is a graphical representation of an application (e.g., a set of processes, a set of executable instructions, a program, an applet, and/or an extension). In some embodiments, the application executes on the first computer system. In some embodiments, the second computer system is different from the first computer system. In some embodiments, the application is a second application, and a first application that executes on the first computer system is controlled by (e.g., receives data from and/or synchronizes with) the second application, different from the first application. In some embodiments, the widget is displayed in a user interface. In some embodiments, the user interface (e.g., 638) includes an area (e.g., background, wallpaper, surface and/or canvas) on which graphical user interface elements (e.g., representing widgets, icons, and/or other content (and/or representations thereof)) can be placed. In some embodiments, the user interface is a desktop user interface (e.g., of an operating system and/or of an application). In some embodiments, the user interface is a home screen user interface (e.g., of an operating system and/or of an application). In some embodiments, the computer system continues to receive updating of the widget data from the second computer system (e.g., while displaying the widget and/or after beginning to display the widget). In some embodiments, the second computer system is not a server, a creator of the widget, and/or used to contribute information provided by the widget.

At 1304, the first computer system (e.g., 600) detects, via the one or more input devices (e.g., 608) of the first computer system, an input (e.g., 1005Y) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) (and, in some embodiments, while displaying the widget (e.g., 1074) that includes the widget interface) corresponding to a request to place (e.g., move, drag from a widget selection interface, and/or drag from a widget drawer) the widget at a location on a user interface. In some embodiments, the input corresponding to a request to place the widget at a location of the user interface (e.g., 638) continues to be detected while displaying the widget at the location (e.g., while still selected and/or not placed yet). In some embodiments, the input corresponding to a request to place the widget at a location of the user interface has ceased to be detected while displaying the widget at the location. In some embodiments, an input corresponding to a request to place a widget within the user interface corresponds to a request to place a new widget on the user interface (e.g., that was previously not included in the user interface). In some embodiments, an input corresponding to a request to place a widget within the user interface corresponds to a request to move an existing widget on the user interface (e.g., that was previously included in the user interface). In some embodiments, an input corresponding to a request to place a widget within the user interface corresponds to a request to move a widget from a different user interface (e.g., a notification user interface, a widget drawer user interface, and/or a user interface that is normally not visible (e.g., collapses when not in use, is hidden, and/or requires user input to appear) to the user interface). In some embodiments, placement of the widget at the location on the user interface is determined based on inputs (e.g., the input and/or one or more other inputs) detected by (e.g., determined by, established by, set by, decided by, arranged by, configured by and/or placed by) the first computer system.

At 1306, in response to detecting the input, the first computer system (e.g., 600) displays, via the display generation component, the widget (e.g., 1074) at the location (e.g., location of 1074 in FIG. 10Z) on the user interface (e.g., 638) (e.g., that was selected based on inputs detected by the first computer system). In some embodiments, in response to detecting the input, the computer system displays the widget at the location on the user interface without regard to the widget data (e.g., and/or other data received from the second computer system (e.g., 1100) and/or the application). In some embodiments, the location of the widget at the location on the user interface is not based on input detected at and/or configuration data transmitted from the second computer system and/or the application. In some embodiments, the first computer system does not transmit data corresponding to the placement of the widget (e.g., position of the widget on the user interface and/or other information regarding the layout of one or more items (e.g., widgets and/or icons) within the user interface). Displaying, via the display generation component, the widget at the location on the user interface provided by an application on a second computer system in response to detecting the input provides the user with control over the first computer system to display a widget that is provided by another computer system, thereby providing additional control options without cluttering the user interface with additional displayed controls.

In some embodiments, while displaying, via the display generation component, the widget (e.g., 1074) at the location (e.g., location of 1074 in FIG. 10Z) on the user interface (e.g., 638) (and, in some embodiments, in response to detecting, via the one or more input devices of the first computer system (e.g., 600), input (e.g., input directed to the widget and/or the first computer system)), the first computer system (e.g., 600) updates the widget based on information (e.g., data and/or user interface elements) provided by the second computer system (e.g., 1100) (e.g., provided by the application on the second computer system). In some embodiments, updating the widget includes displaying, via the display generation component, the information. In some embodiments, updating the widget includes changing a state (e.g., a display and/or non-display state) of a user interface element of the widget (e.g., 1074A and/or 1074B). In some embodiments, updating the widget includes displaying the widget in a different state. In some embodiments, updating the widget includes updating and/or changing the widget user interface and/or the widget data. Updating the widget based on information provided by the second computer system while displaying, via the display generation component, the widget at the location on the user interface allows the first computer system to automatically update the widget based on information provided by another computer system without additional input from the user, thereby performing an operation when a set of conditions has been met without requiring further user input, and reducing the number of inputs.

In some embodiments, after (e.g., while and/or at least partially while) displaying, via the display generation component, the widget (e.g., 1074) at the location (e.g., location of 1074 in FIG. 10Z) on the user interface (e.g., 638) (e.g., 638), the first computer (e.g., 600) system detects, via the one or more input devices of the first computer system (e.g., 600), a set of one or more inputs (e.g., 1005Y) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) (and, in some embodiments, while displaying the widget that includes the widget Interface) including an input (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) corresponding to a request to place (e.g., move, drag from a widget selection interface, and/or drag from a widget drawer) the widget at a second location on the user interface (e.g., one of locations 1054A-1054G), wherein the second location is different from the location. In some embodiments, in response to detecting the set of one or more inputs, the first computer system displays, via the display generation component, the widget at the second location on the user interface, wherein the widget at the second location on the user interface includes (e.g., continues to include) a second widget (e.g., 1048A) user interface (e.g., the widget user interface or a different widget user interface) representing second widget data (e.g., the widget data or different widget data) provided by the second computer system (e.g., 1100) (e.g., provided by the application on the second computer system). Displaying the widget at the second location on the user interface in response to detecting the set of one or more inputs provides the user with control to move the widget on the user interface, thereby providing additional control options without cluttering the user interface with additional displayed controls.

In some embodiments, the application is not available (e.g., installed, installable, executing, executable, running, runnable, and/or supported) on the first computer system (e.g., 600). In some embodiments, the application is available on the second computer system (e.g., 1100). Displaying a widget that includes a widget user interface representing widget data. In some embodiments, the widget data is provided by an application on a second computer system that is not available on the first computer system allows the first computer system to provide access to this content without requiring switching to another computer system, thereby providing additional control options without cluttering the user interface (e.g., 638) with additional displayed controls and/or without requiring additional inputs at another computer system.

In some embodiments, the widget data (e.g., and/or, some embodiments, the widget (e.g., 1074), the widget user interface, and/or application) corresponds to a first account (e.g., a user, computer system, and/or application account) (e.g., the widget data corresponds to the first account) that is not available (e.g., signed into, logged into, and/or supported) on the first computer system (e.g., 600). In some embodiments, the first account is available on the second computer system (e.g., 1100). Displaying a widget that includes a widget user interface representing widget data. In some embodiments, the widget data corresponds to a first account that is not available on the first computer system allows the first computer system to provide access to this content without requiring switching to another computer system, thereby providing additional control options without cluttering the user interface (e.g., 638) with additional displayed controls and/or without requiring additional inputs at another computer system.

In some embodiments, the widget user interface (e.g., and/or, in some embodiments, the widget (e.g., 1074)) is displayed (e.g., and/or configured) according to configuration (e.g., and/or one or more configuration options configured) on the second computer system (e.g., 1100). In some embodiments, the widget user interface and/or the widget is not displayed according to configuration on the first computer system (e.g., 600). In some embodiments, the widget user interface and/or the widget is displayed according to configuration on the first computer system. In some embodiments, in accordance with a determination that the second computer system has a first configuration and/or has a first visual appearance, the widget user interface has a second configuration. In some embodiments, in accordance with a determination that the second computer system has a second configuration, different from the first configuration, the widget user interface has a fourth configuration different from the first configuration and/or has a second visual appearance different from the first visual appearance. Having the widget user interface be displayed according to configuration on the second computer system allows the first computer system to automatically display the widget user interface with a configuration that is based on another computer system, thereby performing an operation when a set of conditions has been met without requiring further user input and reducing the number of inputs.

In some embodiments, after (e.g., while and/or while no longer) displaying, via the display generation component, the widget (e.g., 1074) at the location (e.g., location of 1074 in FIG. 10Z) on the user interface (e.g., 638), the first computer system detects (e.g., via the one or more input devices of the first computer system (e.g., 600) or via one or more input devices of the second computer system (e.g., 1100)) an input (e.g., 1005AD) (e.g., a message and/or indication received from the second computer system) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) (and, in some embodiments, while displaying the widget that includes the widget interface) corresponding to a request to remove (e.g., delete, no longer display, remove, uninstall, stop running, and/or stop executing) the application (e.g., and/or the widget) from the second computer system. In some embodiments, in response to detecting the input corresponding to the request to remove the application (e.g., and/or the widget) from the second computer system, the first computer system removes (e.g., deletes, erases and/or ceases to display) the widget from the first computer system. In some embodiments, removing the widget from the first computer system includes ceasing displaying, via the display generation component, the widget. In some embodiments, removing the widget from the first computer system includes deleting (e.g., from the first computer system and/or memory of the first computer system) a portion of data corresponding to the widget. In some embodiments, the computer system removes display of the widget from the first computer system instead of deleting the widget from the first computer system in response to detecting the input corresponding to the request to remove the application from the second computer system. Removing the widget from the first computer system in response to detecting the input corresponding to the request to remove the application from the second computer system allows the first computer system to automatically remove applications that are provided by other computer system based on activity at the other computer systems, thereby providing improved security.

In some embodiments, after (e.g., while and/or while no longer) displaying, via the display generation component, the widget (e.g., 1074) at the location (e.g., location of 1074 in FIG. 10Z) on the user interface (e.g., 638), the first computer system detects that information for the widget is not available from the second computer system (e.g., 1100) (e.g., and/or the application) (e.g., and/or that the first computer system (e.g., 600) is not synchronizing with the second computer system). In some embodiments, in response to detecting that information for the widget is not available from the second computer system (e.g., and/or the application) (and/or, in some embodiments, that the first computer system is not synchronizing with the second computer system) (and, in some embodiments, that data corresponding to the application is not synchronizing between the first computer system and the second computer system), the first computer system displays, via the display generation component, a warning (e.g., one or more of 1086A-1086G) that up to date information for the widget is not available from the second computer system (e.g., an indication that the second computer system is not synchronizing with the first computer system). In some examples, the widget and/or the widget user interface includes display of the warning. In some embodiments, the warning is displayed instead of and/or together with other data (e.g., widget data provided by the application of the second computer system). In some embodiments, the warning is displayed outside, away from, and/or at a location not corresponding to the widget. In some embodiments, the warning includes an indication that the second computer system and the first computer system are not synchronized (or synchronizing). In some embodiments, the warning includes an indication that the widget is not being updated and/or has not been updated. In some embodiments, the computer system outputs an audible and/or haptic warning response to detecting that the second computer system is not synchronizing with the first computer system. Displaying, via the display generation component, a warning in response to detecting that the second computer system is not synchronizing with the first computer system provides the user with feedback concerning synchronization of the first computer system and the second computer system, thereby providing improved feedback and improved security.

In some embodiments, the first computer system (e.g., 600) displays (e.g., after, while, or before displaying the widget (e.g., 1074)), via the display generation component, a widget selection user interface (e.g., 1034) (e.g., widget gallery and/or an interface for selecting widgets for placing on the user interface (e.g., 638)) including a representation of a second widget (e.g., 1048A) (e.g., the widget or a different widget) (e.g., associated with the application on the second computing device and/or a second application on the first computing device and/or the second computing device), wherein the representation of the second widget (e.g., a widget in suggestions region 1038) is included in the widget selection user interface (e.g., included in suggestions region 1038) based on one or more widgets (e.g., the second widget, one or more related widgets, and/or other widgets) being previously configured on (e.g., previously configured to be displayed by, previously configured for the first computer system by, and/or previously configured for a computer system different from the first computer system and/or the second computer system (e.g., 1100) by) the second computer system (e.g., and/or, in some embodiments, based on the second widget not being previously configured for the first computer system). In some embodiments, the widget selection user interface does not include a representation of a third widget different from the second widget. In some embodiments, the third widget is not included in the widget selection user interface based on the third widget not being previously configured on the second computer system. In some embodiments, the widget selection user interface includes a representation of a fourth widget different from the second widget. In some embodiments, the fourth widget is included in the widget selection user interface based on the fourth widget being previously configured on the second computer system. In some embodiments, while displaying, via the display generation component, the widget selection user interface including the representation of the second widget, the first computer system detects an input corresponding to selection of the representation of the second widget. In some embodiments, in response to detecting the input corresponding to selection of the representation of the second widget, the first computer system initiates a process to place the second widget on the user interface (e.g., of the first computer system). In some embodiments, the process to place the second widget on the user interface includes displaying a second representation (e.g., the representation or a different representation) of the second widget at a location on the user interface. In some embodiments, the input corresponding to selection of the representation of the second widget is an input corresponding to a request to place the second widget on a desktop user interface. In some embodiments, the input corresponding to a request to place the second widget is an input corresponding to a drag of the representation of the second widget from a first location (e.g., of the widget selection user interface) to a second location (e.g., of a desktop user interface). Initiating a process to place the second widget on the user interface in response to detecting the input corresponding to selection of the representation of the second widget provides the user with control over the first computer system to place the second widget on the user interface, thereby providing additional control options without cluttering the user interface with additional displayed controls.

In some embodiments, the user interface (e.g., 638) is a desktop user interface of the first computer system (e.g., 600) (e.g., as described above in relation to the respective user interface (e.g., 638) (e.g., that includes a plurality of user interface objects including a widget corresponding to an application)). In some embodiments, the desktop user interface includes a set of one or more user interface objects that include widget user interface objects (e.g., 1010, 1012, 1014, 1016, 1018, 1072, and/or 1074) and non-widget user interface objects (e.g., 1022, 1024, 1026, 1028, 648, and/or 648A-648L). In some embodiments, the widget (e.g., 1074) is included in the widget user interface objects and not included in the non-widget user interface objects. In some embodiments, the widget user interface object is displayed in a same virtual plane (e.g., z axis) (e.g., that defines characteristics of how displayed user interface elements appear when displayed relative to other displayed user interface elements that overlap in position at a location on the display) as the non-widget user interface objects (e.g., widget and non-widget user interface objects behave the same with respect to whether they are obscured by windows (e.g., not visible when window is open and shares same location, and/or visible when no windows are open and sharing same location) and at a level higher than a background of the respective user interface). In some embodiments, the widget user interface object and the non-widget user interface objects are integrated into the surface of the respective user interface, where the widget user interface object and the non-widget user interface are not overlaid at least some other types of user interface objects, selectable user interface objects, and/or controls, such as windows, application user interfaces, and/or web browsers. Displaying user interface object being in a desktop user interface of the first computer system allows for widgets to be accessible with other desktop user interface items and to not be covered by the non-widget user interface objects, thereby providing improved visual feedback to the user and/or reducing the number of inputs needed to perform an operation.

In some embodiments, the first computer system (e.g., 600) is signed into (e.g., logged into, registered with, authenticated for, and/or connected to) a first user account. In some embodiments, the second computer system (e.g., 1100) is signed into the first user account. In some embodiments, the first computer system can be signed into multiple accounts concurrently, and the widget (e.g., 1074) is only available to be displayed in a user interface for an account that is currently active if that account matches the account of the second computer system (e.g., widget only available for a first user account that is signed in but not a second user account that is signed in where the second user account is not signed in on the second computer system). Displaying, via the display generation component, the widget provided by an application on a second computer system, where the first computer system and the second computer is signed into the same user account provides enhanced security regarding the widget.

In some embodiments, the first computer system (e.g., 600) displays (e.g., after, while, or before displaying the widget (e.g., 1074)), via the display generation component, a widget selection user interface (e.g., 1034) (e.g., the widget selection user interface or a different user interface) including a representation of a fourth widget (e.g., 1072, 1074, and/or 1076) (e.g., the widget or a different widget) from (e.g., displayed, displayable, previously displayed, currently displayed, installed, installable, executing, executable, running, runnable, and/or supported on) the first computer system or the second computer system (e.g., 1100). In some embodiments, the fourth widget is from the first computer system and the second computer system. In some embodiments, the widget selection user interface (e.g., 1034) does not include a representation of a fifth widget (e.g., 1076) different from the fourth widget. In some embodiments, the fifth widget is not included in the widget selection user interface (e.g., 1034) based on the fifth widget not being from the first computer system and/or the second computer system. In some embodiments, the widget selection user interface includes a representation of a sixth widget (e.g., 1072, 1074, and/or 1076) different from the fourth widget. In some embodiments, the sixth widget is included in the widget user interface based on the sixth widget being from the first computer system and/or the second computer system. In some embodiments, while displaying, via the display generation component, the widget selection user interface including the representation of the fourth widget, the first computer system detects an input (e.g., 1005W and/or 1005AA) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) corresponding to selection of the representation of the fourth widget. In some embodiments, in response to detecting the input corresponding to selection of the representation of the fourth widget, the first computer system initiates a process to place the fourth widget on the user interface (e.g., 638) (e.g., of the first computer system). In some embodiments, the process to place the fourth widget on the user interface includes displaying a second representation (e.g., the representation or a different representation) of the fourth widget at a location on the user interface (e.g., location of 1072 in FIG. 10X and/or location of 1076 in FIG. 10AB). Initiating a process to place the fourth widget on the user interface in response to detecting the input corresponding to selection of the representation of the fourth widget provides the user with control over the first computer system to place the fourth widget on the user interface, thereby providing additional control options without cluttering the user interface with additional displayed controls.

In some embodiments, displaying, via the display generation component, the widget selection user interface (e.g., 1034) includes displaying, via the display generation component, a representation of a sixth widget (e.g., 1074 in FIG. 10Y) (e.g., the fourth widget or a different widget) from the second computer system (e.g., 1100) while the first computer system (e.g., 600) is not in communication with the second computer system (e.g., the first computer system is not nearby the second computer system). Displaying the representation of the sixth widget from the second computer system while the first computer system is not in communication with the second computer system provides the user with the ability to utilize a widget from the second computer system when the first computer system is not in communication with the first computer system, thereby providing additional control options without cluttering the user interface (e.g., 638) with additional displayed controls.

In some embodiments, the representation of the sixth widget (e.g., 1074 in FIG. 10Y) includes a preview (e.g., a cached and/or non-cached preview) of the sixth widget (e.g., based on data provided by the second computer system (e.g., 1100)) while (e.g., in accordance with (e.g., a determination that)) the first computer system (e.g., 600) is in communication with (e.g., has received respective widget data from that is still valid (e.g., not stale, not expired, not received longer ago than a predefined period of time, or invalid for any reason)) (e.g., and/or nearby or within a threshold distance from) the second computer system. In some embodiments, the representation of the sixth widget does not include the preview of the sixth widget when (e.g., in accordance with (e.g., a determination that)) the first computer system is not in communication with (e.g., and/or not nearby or not within a threshold distance from) the second computer system. Displaying a preview of the sixth widget while the first computer system is in communication with the second computer system allows the first computer system to provide feedback concerning information corresponding to the sixth widget, thereby providing feedback to the user.

In some embodiments, after (e.g., while and/or while no longer) displaying, via the display generation component, the widget (e.g., 1074) at the location (e.g., location of 1074 in FIG. 10Z) on the user interface (e.g., 638), the first computer system detects that the second computer system (e.g., 1100) has not been in communication with (e.g., nearby and/or within a predefined distance (e.g., 0-10 feet) from) the first computer system (e.g., 600) (e.g., and/or that the first computer system has not been in communication with the second computer system) for a predefined period of time (e.g., 5-30 minutes). In some embodiments, in response to detecting that the second computer system (e.g., and/or the application) has not been in communication with the first computer system (e.g., and/or in some examples, that the first computer system has not been in communication with the second computer system) for the predefined period of time, the first computer system displays, via the display generation component, an indication of an error state (e.g., one or more of 1086A-1086G) (e.g., a warning, a fallback state and/or an indication to user that the widget is not displaying current and/or updated data) (e.g., the widget is displayed in the error state). In some embodiments, the widget and/or the widget user interface includes display of the error state (e.g., while displaying or not displaying other data). In some embodiments, the error state is displayed instead of and/or together with other data (e.g., widget data provided by the application of the second computer system). In some embodiments, the error state is displayed outside, away from, and/or at a location not corresponding to the widget. In some embodiments, the error state is displayed within the widget selection user interface. In some embodiments, the error state is displayed with respect to a representation of respective widget in the widget selection user interface. In some embodiments, in response to detecting that the second computer system has been in communication with the first computer system within the predefined period of time, the first computer system does not display the error state. Displaying, via the display generation component, an error state in response to detecting that the second computer system has not been in communication with the first computer system for the predetermined period of time allows the computer system to automatically display an error in response to detecting that the second computer system has not been in communication with the first computer system, thereby providing improved feedback and providing improved security.

In some embodiments, after (e.g., while and/or while no longer) displaying, via the display generation component, the widget (e.g., 1074) at the location (e.g., location of 1074 in FIG. 10Z) on the user interface (e.g., 638) and in accordance with a determination that a first set of one or more criteria is satisfied, the first computer system displays, via the display generation component, a first indication of an error state (e.g., one or more of 1086A-1086G) corresponding to the widget (e.g., a fallback state and/or an indication to user that the widget is not displaying current and/or updated data) (e.g., an indication of a type of the error state and/or an indication of an event corresponding to the error state). In some embodiments, the widget and/or the widget user interface includes display of the first indication of the error state (e.g., while displaying or not displaying other data). In some embodiments, the first indication of the error state is displayed instead of and/or together with other data (e.g., widget data provided by the application of the second computer system (e.g., 1100)). In some embodiments, the first indication of the error state is displayed outside, away from, and/or at a location not corresponding to the widget. In some embodiments, the first computer system (e.g., 600), after (e.g., while and/or while no longer) displaying, via the display generation component, the widget at the location on the user interface, detects that the second computer system has not been in communication with (e.g., nearby and/or within a predefined distance (e.g., 0-10 feet) from) the first computer system (e.g., and/or that the first computer system has not been in communication with the second computer system) for a predefined period of time (e.g., 5-30 minutes). In some embodiments, the first set of one or more criteria includes a criterion that is satisfied when the second computer system (e.g., and/or the application) has not been in communication with the first computer system (e.g., and/or in some embodiments, that the first computer system has not been in communication with the second computer system) for the predefined period of time. In some embodiments, the first computer system concurrently displays multiple indications (e.g., one or more of 1086A-1086G) of error states corresponding to multiple widgets (e.g., each widget having a separate indication of a respective error state). In some embodiments, in accordance with a determination that the second computer system is not available to provide content for the widget (e.g., no connection to the second computer system can be established and/or the first computer system has not been in within a threshold proximity to the second computer system for longer than a threshold amount of time), the computer system displays an indication of an error state for the widget. In some embodiments, in accordance with a determination that the second computer system is available to provide content for the widget, the computer system does not display an indication of an error state for the widget. Displaying, via the display generation component, an indication of an error state corresponding to the widget in accordance with a determination that a first set of one or more criteria is satisfied allows the computer system to automatically display an error state when prescribed conditions are met, thereby providing improved feedback, providing improved security, and performing an operation when a set of conditions has been met without requiring further user input, and reducing the number of inputs.

In some embodiments, displaying, via the display generation component, the first indication (e.g., one or more of 1086A-1086G) of the error state includes changing the widget (e.g., 1074) from being displayed in a first orientation to be displayed in a second orientation different from the first orientation (e.g., 1086A) (e.g., moving in a shaking animation between the first orientation to the second orientation (e.g., moving from side-to-side-, moving up-and-down, and/or rotating clockwise and/or counter-clockwise)) (e.g., in response to detecting input, in response to detecting that the first set of one or more criteria is satisfied, and/or periodically after detecting that the first set of one or more criteria is satisfied). Changing the widget from being displayed in a first orientation to be displayed in a second orientation different from the first orientation in accordance with a determination that a first set of one or more criteria is satisfied allows the computer system to automatically display an error state via changing the orientation of the widget when prescribed conditions are met, thereby providing improved feedback, providing improved security, and performing an operation when a set of conditions has been met without requiring further user input, and reducing the number of inputs.

In some embodiments, displaying, via the display generation component, the first indication (e.g., one or more of 1086A-1086G) of the error state includes displaying, via the display generation component, an additional user interface (e.g., 1086B) (e.g., on top of and/or overlaid on the user interface (e.g., 638)) at a location corresponding to a current location of an indication of attention (e.g., 622) (e.g., a pointer location, gaze location and/or a cursor location) of the first computer system (e.g., 600) (e.g., a location corresponding to a pointer of a mouse and/or other type of input device). In some embodiments, the additional user interface is displayed in response to detecting that the current location of the one or more input devices of the first computer system has been directed to the widget (e.g., 1074) for a predefined period of time (e.g., 2-10 seconds). Displaying, via the display generation component, an additional user interface at a location corresponding to a current location of the one or more input devices of the first computer system in accordance with a determination that a first set of one or more criteria is satisfied allows the computer system to automatically display an error state when prescribed conditions are met via the additional user interface, thereby providing improved feedback, providing improved security, and performing an operation when a set of conditions has been met without requiring further user input, and reducing the number of inputs.

In some embodiments, displaying, via the display generation component, the first indication (e.g., one or more of 1086A-1086G) of the error state includes replacing display of a portion of the widget (e.g., 1074) with the indication of the error state. In some embodiments, replacing (e.g., 1086C) display of the portion of the widget with the indication of the error state includes displaying the indication of the error state on top of and/or overlaid on the widget. Replacing display of a portion of the widget with the indication of the error state in accordance with a determination that a first set of one or more criteria is satisfied allows the computer system to automatically display an error state when prescribed conditions are met, thereby providing improved feedback, providing improved security, and performing an operation when a set of conditions has been met without requiring further user input, and reducing the number of inputs.

In some embodiments, the first set of one or more criteria includes a criterion that is satisfied in response to (e.g., when) detecting an input (e.g., inputs in FIG. 10AG) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) via the one or more input devices of the first computer system (e.g., 600) (e.g., when a determination is made that the input is detected). In some embodiments, displaying the indication (e.g., one or more of 1086A-1086G) of the first indication of an error state includes changing (e.g., 1086E) display of a representation (e.g., a cursor) of a current location of the one or more input devices of the first computer system. In some examples, the first indication of an indication of the error state is displayed external to the widget (e.g., 1074). Displaying, via the display generation component, an indication of an error state corresponding to the widget in accordance with a determination that a first set of one or more criteria is satisfied allows the computer system to automatically display an error state when prescribed conditions are met, thereby providing improved feedback, providing improved security, and performing an operation when a set of conditions has been met without requiring further user input, and reducing the number of inputs.

In some embodiments, displaying, via the display generation component, the first indication (e.g., one or more of 1086A-1086G) of the error state includes displaying a portion of the indication (e.g., 1086D) of the error state over a portion of the widget (e.g., 1074) (e.g., while continuing to display other information of the widget (e.g., in a location corresponding to the widget)) (e.g., and/or displaying a second portion (e.g., different from the portion) of the indication of the error state over a portion of the user interface (e.g., 638) that does not correspond to the widget). Displaying a portion of the indication of the error state over a portion of the widget in accordance with a determination that a first set of one or more criteria is satisfied allows the computer system to automatically display an error state when prescribed conditions are met, thereby providing improved feedback, providing improved security, and performing an operation when a set of conditions has been met without requiring further user input, and reducing the number of inputs.

In some embodiments, the first set of one or more criteria includes a criterion that is satisfied in response to (e.g., when) detecting an input (e.g., an input as in FIG. 10AG) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) via the one or more input devices of the first computer system (e.g., 600). In some embodiments, displaying, via the display generation component, the first indication of the error includes changing display of the widget (e.g., 1074) (e.g., internal to the widget) (e.g., an appearance of the widget indicates the error state) (e.g., the appearance of the widget is updated in response to detecting the input (e.g., a click)).

In some embodiments, displaying, via the display generation component, the first indication (e.g., one or more of 1086A-1086G) of the error state includes shrinking (e.g., reducing the size of a portion) and enlarging (e.g., 1086F) (e.g., increasing the size of a portion) the widget (e.g., 1074). In some embodiments, the widget is shrunk after the widget is enlarged. In some embodiments, the widget is enlarged after the widget is shrunk. In some embodiments, the size of the widget oscillates, for one or more cycles, between shrinking and enlarging. In some embodiments, the oscillations change in magnitude and or speed over a predetermined period of time (e.g., get smaller and/or slow down). Shrinking and enlarging the widget in accordance with a determination that a first set of one or more criteria is satisfied allows the computer system to automatically display an error state when prescribed conditions are met via shrinking and enlarging the widget, thereby providing improved feedback, providing improved security, and performing an operation when a set of conditions has been met without requiring further user input, and reducing the number of inputs.

In some embodiments, displaying, via the display generation component, the first indication (e.g., one or more of 1086A-1086G) of the error state includes changing the widget (e.g., 1074) from being displayed in a third orientation to be displayed in a fourth orientation different from the third orientation (e.g., 1086G) (e.g., moving in a shaking animation between the third orientation to the fourth orientation (e.g., moving from side-to-side-, moving up-and-down, and/or rotating clockwise and/or counter-clockwise)) (e.g., in response to detecting input, in response to detecting that the first set of one or more criteria is satisfied, and/or periodically after detecting that the first set of one or more criteria is satisfied).

In some embodiments, the first computer system (e.g., 600) displays, via the display generation component, a setting user interface (e.g., 1098) (e.g., a system setting user interface) corresponding to the first computer system. In some embodiments, in accordance with a determination that a third computer system (e.g., 1100) satisfies a second set of one or more criteria, the setting user interface includes display of a representation (e.g., 1098D) of the third computer system. In some embodiments, in accordance with a determination that a fourth computer system satisfies the second set of one or more criteria, the setting user interface includes display of a representation (e.g., 1098E) of the fourth computer system. In some embodiments, the setting user interface includes concurrent display of the representation of the third computer system and the representation of the fourth computer system in accordance with a determination that the third computer system and the fourth computer system satisfies the second set of one or more criteria. In some embodiments, the third computer system is different from the first computer system. In some embodiments, the fourth computer system is different from the third computer system and the first computer system. In some embodiments, after (e.g., while and/or at least partially while) displaying the setting user interface, the first computer system detects a first set of one or more inputs including a respective input corresponding to selection of a representation of a computer system, wherein the second computer system (e.g., 1100) corresponds to the third computer system (e.g., and not the fourth computer system) in accordance with a determination that the respective input corresponds to the representation of the third computer system, and wherein the second computer system corresponds to the fourth computer system (e.g., and not the third computer system) in accordance with a determination that the respective input corresponds to the representation of the fourth computer system.

In some embodiments, the first computer system (e.g., 600) displays (e.g., after, while, or before displaying the widget (e.g., 1074)), via the display generation component, a widget selection user interface (e.g., 1034) (e.g., the widget selection user interface or a different user interface) including a first section (e.g., 1068) corresponding to a first type of widget (e.g., widgets from the first computer system) and a second section (e.g., 1070) corresponding to a second type of widget (e.g., widgets from the second computer system (e.g., 1100)) different from the first type of widget. In some embodiments, the first section includes one or more representations of different widgets of the first type of widget. In some embodiments, the second section includes one or more representations of different widgets of the second type of widget; In some embodiments, the first section includes a representation of a widget from the first computer system. In some embodiments, the second section includes a representation of a widget from the second computer system. In some embodiments, the first section does not include a representation of a widget from the second computer system. In some embodiments, the second section does not include a representation of a widget from the first computer system. In some embodiments, while displaying, via the display generation component, the widget selection user interface including the representation of the second widget (e.g., 1048A), the first computer system detects an input (e.g., 1005W or 1005Y) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) corresponding to selection of a representation of a respective widget (e.g., from the first section and/or the second section) (e.g., of the first type and/or the second type). In some embodiments, in response to detecting the input corresponding to selection of the representation of the respective widget, the first computer system initiates a process to place the respective widget on the user interface (e.g., 638) (e.g., of the first computer system). In some embodiments, the process to place the respective widget on the user interface includes displaying a second representation (e.g., the representation or a different representation) of the respective widget at a location on the user interface.

In some embodiments, while displaying, via the display generation component, the widget (e.g., 1074) at the location (e.g., location of 1074 in FIG. 10Z) on the user interface (e.g., 638), the first computer system detects an input (e.g., 1005AE) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) directed to a respective widget. In some embodiments, in response to detecting the input directed to the respective widget and in accordance with a determination a third set of one or more criteria is satisfied, wherein the third set of one or more criteria includes a criterion that is satisfied when a determination is made that the input is directed to a widget (e.g., 1074) (e.g., the widget of the second computer system (e.g., 1100)) of a computer system (e.g., a widget provided by and/or including data provided by the second computer system) different from the first computer system (e.g., 600), the first computer system causes, via the computer system different from the first computer system, an operation to be performed based on the input directed to the respective widget. In some embodiments, in response to detecting the input directed to the respective widget and in accordance with a determination a fourth set of one or more criteria is satisfied, wherein the fourth set of one or more criteria includes a criterion that is satisfied when a determination is made that the input is directed to a widget (e.g., 1072) of the first computer system (e.g., a widget different than the widget of the second computer system), the first computer system performs, via the first computer system (e.g., and, in some embodiments, via the widget of the first computer system), an operation based on the input directed to the respective widget.

In some embodiments, while displaying, via the display generation component, the widget (e.g., 1074) at the location (e.g., location of 1074 in FIG. 10Z) on the user interface (e.g., 638), the first computer system detects an input (e.g., 1005AE and/or 1005AG) (e.g., a tap input and/or, in some embodiments, a non-tap input (e.g., a gaze, an air gesture/input (e.g., an air tap and/or a turning air gesture/input), a mouse click, a button touch, a swipe, and/or a pointing gesture/input)) directed to the widget. In some embodiments, in response to detecting the input directed to the widget, the first computer system (e.g., 600) sends, to the second computer system (e.g., 1100), a request to perform a respective operation based on the input directed to the widget. In some embodiments, the second computer performs the respective operation (e.g., in response to detecting input directed to the widget and/or based on the input directed to the widget). Sending, to the second computer system, a request to perform a respective operation based on the input directed to the widget in response to detecting the input directed to the widget provides the user with control over requesting that the second computer perform an operation, thereby providing additional control options without cluttering the user interface with additional displayed controls.

In some embodiments, the second computer system (e.g., 1100) requests (e.g., via 1088), via one or more output devices of the second computer system, authentication (e.g., displaying, via a display generation component of the second computer system, a user interface indicating that the authentication needs to be performed) before performing the respective operation. In some embodiments, the first computer system (e.g., 600) requests, via the display generation component (e.g., and/or another output device, such as a speaker) of the first computer system, authentication (e.g., of a user of the first computer system and/or the second computer system) (e.g., by displaying a user interface indicating that the authentication needs to be performed) before causing (e.g., via the first computer system or the second computer system) the respective operation to be performed. In some embodiments, the authentication is performed via a sensor, such as capturing an image and/or reading a health measurement. Having the second computer system request authentication before performing the respective operation provides improve security by requiring authentication before an operation is performed.

In some embodiments, in response to detecting the input directed to the widget (e.g., 1074), the first computer system (e.g., 600) causes display of (e.g., via the display generation component of the first computer system or a display generation component of the second computer system (e.g., 1100)) a respective user interface (e.g., 638) of the application (e.g., calendar application in FIG. 10AK). In some embodiments, the respective user interface of the application is not displayed before detecting the input directed to the widget. In some embodiments, in accordance with a determination that the application is a first application, the respective user interface is a first user interface, and in accordance with a determination that the application is a second application different from the first application, the respective user interface is a second user interface different from the first user interface. In some embodiments, in accordance with a determination that the input directed to the widget corresponds to a first portion of the widget, the respective user interface of the application corresponds to a first state of the application, and in accordance with a determination that the input directed to the widget corresponds to a second portion of the widget different from the first portion, the respective user interface of the application corresponds to a second state of the application different from the first state (e.g., is a different user interface and/or displayed when the application is in a different state) (e.g., selecting a temperature portion of a weather widget causes a temperature user interface to be displayed but selecting a precipitation forecast portion of the same weather widget causes a precipitation user interface to be displayed; selecting a first media item in a media library widget causes the first media item to begin playback but selecting a second media item in the media library widget causes the a second media item to begin playback). Causing display of a respective user interface of the application in response to detecting the input directed to the widget provides the user with control to open an application, thereby providing additional control options without cluttering the user interface (e.g., 638) with additional displayed controls.

In some embodiments, in response to detecting the input (e.g., 1005AL) directed to the widget (e.g., 1092), the first computer system (e.g., 600) updates display of a user interface element (e.g., 1094A) (e.g., a radio button, a check mark, or a toggle) of the widget (e.g., changing a toggle state of the user interface element from “on” to “off” or “off” to “on”). Updating display of a user interface element of the widget in response to detecting the input directed to the widget provides the user with control to update a widget, thereby providing additional control options without cluttering the user interface with additional displayed controls.

In some embodiments, in response to detecting the input directed to the widget (e.g., 1094), the first computer system (e.g., 600) performs an operation (e.g., a sub-operation, an action, and/or a sub-action) corresponding to the widget (and in some embodiments, the first computer system forgoes causing display of a respective user interface (e.g., 638) of the application). In some embodiments, performing the operation includes modifying (e.g., via the second computer system (e.g., 1100) and/or the application of the second computer system) a state of data associated with the application of the second computer system without displaying (e.g., via the first computer system and/or the second computer system) (e.g., other than the widget) a respective user interface of the application of the second computer system. Performing an operation corresponding to the widget in response to detecting the input directed to the widget provides the user with control to perform an operation, thereby providing additional control options without cluttering the user interface (e.g., 638) with additional displayed controls.

In some embodiments, in response to detecting the input (e.g., 1005AE and/or 1005AG) directed to the widget (e.g., 1074), the first computer system (e.g., 600) causes the second computer system (e.g., 1100) to transition from an inactive state (e.g., an off or lower power state) to an active state (e.g., an on or higher power state than the inactive state) (e.g., as in FIGS. 10AH-10AI). In some embodiments, the second device displays a wake screen user interface in conjunction with transitioning from the inactive state to the active state. In some embodiments, in accordance with the second device not requiring unlocking (e.g., already being unlocked), the second device displays a user interface corresponding to the widget in conjunction with transitioning from the inactive state to the active state. In some embodiments, in accordance with the application on the second computer system being a first respective application, the second computer system is caused to display a user interface corresponding to the first respective application (e.g., the first device sends instructions to the second device that cause the second device to display the first application), and in accordance with the application on the second computer system being a second respective application different from the first respective application, the second computer system is caused to display a user interface corresponding to the second respective application different from the user interface (e.g., 638) corresponding to the first respective application (e.g., the first device sends instructions to the second device that cause the second device to display the second application). In some embodiments, in accordance with the second computer system requiring unlocking (e.g., is locked and/or is not unlocked), the second computer system displays an authentication user interface (e.g., a prompt, indicator, and/or request to authenticate and/or enter authentication information (e.g., a password, a passcode, and/or biometric data)) in conjunction with transitioning from the inactive state to the active state. In some embodiments, in accordance with the second computer system being unlocked (e.g., using authentication information) within a predetermined period of time from transitioning from the inactive state to the active state, the second computer system displays a user interface corresponding to the application. In some embodiments, in accordance with the second computer system not being unlocked within the predetermined period of time from transitioning from the inactive state to the active state, the second computer system forgoes displaying a user interface corresponding to the application (e.g., does not display an interface of the application if too much time has passed since the input directed to the widget). Causing the second computer system to transition from an inactive state to an active state in response to detecting the input directed to the widget provides the user with control to change the state of the computer system, thereby providing additional control options without cluttering the user interface with additional displayed controls.

In some embodiments, after (e.g., and while) the second computer system (e.g., 1100) is no longer connected (e.g., as in FIG. 10AE) to the first computer system (e.g., 600) (e.g., after and/or in response to detecting and/or in accordance with a determination that the second computer system is no longer connected to the first computer system) (e.g., when the second computer system is no longer in range of the first computer system) (e.g., after synchronizing with the second computer system and before re-synchronizing with the second computer system), the first computer system continues to display, via the display generation component, the widget (e.g., 1074) at the location (e.g., location of 1074 in FIG. 10Z) on the user interface (e.g., 638) (e.g., maintaining displaying the widget user interface representing widget data provided by the application on the second computer system) (e.g., maintaining display of widget data provided by the application on the second computer system) (e.g., using cached data). In some embodiments, after (e.g., and while) the second computer system is no longer connected to the first computer system: the first computer system detects a request to move the widget to a second location on the user interface, and in response to detecting the request to move the widget to the second location on the user interface, moves the widget to the second location (e.g., widget is moved and/or otherwise caused to be associated with a different location of the user interface while the second computer system is not in communication with the first computer system) (e.g., location of the widget on the user interface is independent of the second computer system). Continuing to display, via the display generation component, the widget at the location on the user interface after the second computer system is no longer connected to the first computer system allows the first computer system to display the widget, thereby providing feedback.

Note that details of the processes described above with respect to method 1300 (e.g., FIG. 13) are also applicable in an analogous manner to the methods described herein, including methods 700, 900, 1100, 1200, 1500, 1700, and/or 1900. For example, method 700 optionally includes one or more of the characteristics of the various methods described above with reference to method 1300. For example, animated visual content can be used as a background for a desktop interface that includes one or more widgets. For brevity, these details are not repeated below.

FIGS. 14A-14J illustrate exemplary user interfaces for displaying widgets in various arrangements based on spatial bounds set by a computer system, in accordance with some examples. The user interfaces in these figures are used to illustrate the processes described below, including the processes in FIG. 15.

FIGS. 14A-14B are schematics separate from the user interfaces that will be described below and are intended to illustrate exemplary operations of creating and/or merging and separating of widget islands based on the addition to and/or removal of a widget from a widget island. Widget islands or widget groups or groups of widgets (e.g., sometimes referred to as islands herein) are widgets that are grouped together and aligned with one another based on their close proximity.

FIG. 14A illustrates a schematic of two example scenarios of the formation of a widget island. The left schematic illustrated in FIG. 14A includes widget 1012, widget 1010, and widget 1050D separate from each other (e.g., as their own individual islands) as indicated by each widget having bolded edges on all sides. Widget islands are illustrated in FIG. 14A as having thick bolded edges along the outside border of edges of widgets in the group. Widget 1010 is indicated by drag input 1405A1 as moving down and to the left. To the right of widget 1012 and above widget 1050D, FIG. 14A illustrates snapping location 1404, which indicates a potential area to which computer system 600 can snap widget 1010, as that is the closest available snapping region, as discussed above with respect to FIG. 10AO. Based on the position of snapping location 1404, a widget can snap to one or either of widget 1012 or widget 1050D. In this embodiment, in response to detecting the release of input from drag input 1405A1, computer system 600 snaps widget 1010 to the area as indicated by snapping location 1404 to be aligned with widget 1012 and widget 1050D. Computer system 600 displays all three widgets as an island, as indicated by the bolded edges around the outside of the widgets. In this example, placing widget 1010 in the gap between individual widget islands caused them to merge into a single island.

FIG. 14A also illustrates a right schematic (e.g., separate from the left schematic) that includes widget 1010, widget 1050A, widget 1050C, and widget 1012 in a cross formation. That is, the widgets are not touching one another and are each individual widgets (e.g., and/or are one-widget islands). FIG. 14A illustrates widget 1050D as moving down and to the left toward snapping location 1404, which is illustrated as being in the middle of the cross formation of widgets. FIG. 14A illustrates snapping location 1404 in response to detecting drag input 1405A2, which represents the path of a drag input to move widget 1050D. In response to detecting the release of the drag input corresponding to arrow 1405A2, computer system 600 snaps widget 1050D to the area indicated by snapping location 1404 to be aligned in the middle of the cross formation of widgets. Computer system 600 displays all five widgets as a single island, as indicated by the bolded edges around the outside of the widgets. In some embodiments, widgets are grouped as islands, but no border (e.g., bolded edge) is displayed (e.g., it is shown in FIG. 14A as an illustrative tool to show when widgets are grouped as an island). At FIG. 14A, computer system 600 determined that a threshold was met to group the widgets and as a result, grouped them into an island. Grouping widgets can cause computer system 600 to, for example, move at least one of them slightly to align and/or enforce a spacing between the widgets and/or make room for center widget (e.g., a widget filling a gap).

FIG. 14B illustrates a schematic of two example scenarios of the removal of a widget from a widget island. FIG. 14B illustrates the widget island as illustrated in the bottom left side of FIG. 14A with input 1405B1 indicating the removal of widget 1050D from the widget island. In response to detecting input 1405B1, computer system 600 displays a widget island that includes widget 1012 and widget 1010, as indicated by the lack of widget 1050D and the bolded edges around the outside of widget 1012 and widget 1010.

FIG. 14B also illustrates the widget island as illustrated in the bottom right side of FIG. 14A with input 1405B2 indicating the removal of widget 1050D from the widget island. In response to detecting input 1405B2, computer system 600 splits the remaining 4 widgets (e.g., widget 1012, widget 1010, widget 1050A, and widget 1050C) into single widget islands, as indicated by the lack of widget 1050D and the bolded edges around the outside edges of the remaining widgets.

FIGS. 14C-14D illustrate exemplary operations and user interfaces related to rearrangement of widgets based on changes to spatial bounds of a display area. FIG. 14C illustrates an interface 1402, displayed on display 602 of computer system 600, which includes widget 1012, widget 1010, widget 1050D, widget 1050A, widget 1050C, and widget 1048A in a vertical formation as island 1440 along the left edge of interface 1402. Also illustrated on the bottom right side of interface 1402 of FIG. 14C are widget 1016 and widget 1072 formed together as island 1442. Interface 1402 as illustrated in the top portion of FIG. 14C may also be referred to as Resolution E, which is the current resolution setting (e.g., set of spatial bounds defining a resolution in pixels).

FIG. 14C also illustrates display of area anchor points on both interfaces, which are points that indicate the area of display 602 to which an island of widgets is anchored (e.g., the corners, sides, and/or center), and will further be discussed below. In some embodiments, anchor points are not visible on display 602 (e.g., are not displayed). The anchor points are included here as a visual aid to illustrate the concept of locations used to decide widget movement and/or arrangement when spatial bounds change. In some embodiments, the shortest connection from location on a widget island to an anchor point out of all of the connections is the point to which the widget island is anchored on display 602. For a widget and/or widget island to be anchored to a certain area of the display can mean that computer system 600 will maintain (e.g., or attempt to maintain as close as conditions allow) the island near to the location of the anchor point to which the island is anchored. Interfaces 1402-1410 include anchor points in every corner, midpoints of the edges, and the center. In some examples, display area anchor points can be positioned at any individual location or combination of locations on display 602. FIG. 14C illustrates anchor point 1402A in the top left corner of display 602, anchor point 1402B in the middle of the left edge of display 602, anchor point 1402C in the bottom left corner of display 602, anchor point 1402D on the middle of the bottom edge of display 602, anchor point 1402E in the bottom right corner of display 602, anchor point 1402F on the middle of the right edge of display 602, anchor point 1402G in the top right corner of display 602, anchor point 1402H on the middle of the top edge of display 602, and anchor point 1402I in the center of display 602.

The bottom half of FIG. 14C illustrates interface 1406, which represents what computer system 600 displays after a decrease in resolution size compared to the interface 1402 of FIG. 14B. A resolution defines a display area (e.g., in pixels) and can be expressed using dimensions such as length and width (e.g., horizontal×vertical pixels, such as 1,920×1,080 (e.g., high definition), 3,840×2,160 (e.g., 4K ultra high definition), and/or any other supported and/or possible area). A decrease in the resolution of display 602 indicates less space for computer system 600 to display widgets. In response to detecting a decrease in resolution, computer system 600 changes a pattern formed by the widgets in island 1440 into a C-shaped island 1444 and maintains island 1442 in its position on interface 1402. The decrease in resolution is illustrated by FIG. 14C in a schematic of resolution scale 1412. Arrow 1458 above resolution scale 1412 indicates the decrease in resolution from Resolution E to Resolution D. In this embodiment despite the changes illustrated by the change in resolution, computer system 600 keeps each widget island together (e.g., whole) and separate from the other island, as well as in the same general location (e.g., closest to the closest anchor) on display 602 as displayed in the original resolution. Interface 1406 as illustrated in the bottom portion of FIG. 14C may further be referred to as Resolution D. In some embodiments, computer system 600 alters the spatial bounds (e.g., resolution dimensions (e.g., 1,920×1,080)) based on the addition of a different display. In some embodiments, computer system 600 alters the spatial bounds based on detecting and/or receiving (e.g., a request for) a different display orientation (e.g., portrait and/or landscape). At FIG. 14C, computer system 600 detects click and drag input 1405C on widget 1048A. In response to detecting input 1405C on widget 1048A, computer system 600 moves widget 1048A to a location beneath widget 1012, as illustrated in FIG. 14C by input 1405C on widget 1048A. At FIG. 14C, after moving widget 1048A to the location beneath widget 1012, computer system 600 detects a request to lower the resolution of interface 1406 from the resolution value as illustrated in Resolution D. In this embodiment, widgets remain the same size (e.g., as resolution decreases or increases). In some embodiments, widgets change in size (e.g., as resolution decreases and/or increases). In some embodiments, the widgets change in size at a different scale and/or rate than the resolution (e.g., a reduction in horizontal width by 50% docs not correlate to a 50% reduction in a horizontal dimension of the widget's size).

As illustrated in the top portion of FIG. 14D, in response to detecting the request to lower the resolution from Resolution D, computer system 600 displays interface 1408 at Resolution B. The decrease in resolution is illustrated at the top of FIG. 14D in a schematic of resolution scale 1412. Arrow 1460 above resolution scale 1412 indicates the decrease in resolution from Resolution D to Resolution B. Resolution B includes a P-shape widget island 1446 and island 1442 in its position/location as illustrated in FIG. 14C. Given that widget 1048A was moved manually by a user, computer system 600 remembers (e.g., stores) this arrangement of widgets (e.g., P-shaped island 1446) to correspond with Resolution D. In some embodiments, computer system 600 applies the arrangement of widgets saved at Resolution D to a different resolution. In some embodiments, computer system causes a manually moved widget to return to the position to which it was moved when computer system 600 returns to the resolution at which it was moved and/or a different resolution. For example, computer system 600 returns to Resolution E from Resolution D or Resolution B, computer system 600 can change island 1444 on interface 1406 or island 1446 on interface 1408 to the shape of island 1440 (e.g., because the straight line island 1440 is the pattern stored and associated with the arrangement (e.g., of all widgets) at Resolution E).

At the bottom portion of FIG. 14D, computer system 600 detects an input to increase the resolution of interface 1408 to a resolution value that is higher that Resolution B and lower than the resolution value of Resolution D. In the bottom portion of FIG. 14D, in response to detecting an input to increase the resolution value of interface 1408, computer system 600 reduces the spatial bounds of the desktop user interface, but does not change the arrangement of widgets of interface 1408 (e.g., because there is enough space to accommodate the pattern from Resolution B and/or Resolution D). Interface 1410, in the bottom portion of FIG. 14D, may also be referred to as Resolution C. The increase in resolution is illustrated in FIG. 14D in a schematic of resolution scale 1412. Arrow 1462 above resolution scale 1412 indicates the increase in resolution from Resolution B to Resolution C. In this embodiment, computer system 600 increased the resolution value from Resolution B, but did not increase the value to such a level as high as Resolution E. That is, Resolution C is closer in value to Resolution D than to Resolution E. As discussed above, computer system 600 can revert back to a previous widget arrangement if the spatial bounds match and/or are closer to the resolution value in which the previous arrangement was displayed. Although Resolution C is at a higher resolution value than Resolution B, Resolution C remains at the same widget arrangement as Resolution B, as it is closer to the resolution value of Resolution D than to the resolution value of Resolution E. The scale of resolution values will be discussed below.

FIGS. 14E-14F are schematics separate from the user interfaces described above and are intended to illustrate which arrangements of icons are saved at each resolution value on a scale of resolutions. FIG. 14E illustrates resolution scale 1412, which is a range of resolutions on which computer system 600 can be configured to display (e.g., based on one or more resolution dimensions). Resolution scale 1412 includes resolution values A-F increasing in value from left to right. Resolution scale 1412 as illustrated in FIG. 14E includes illustrations of the widget arrangements that are saved at Resolution D and Resolution E, as discussed above with respect to FIG. 14C. The schematic illustrated in FIG. 14E displays interface 1402 (e.g., labeled as Arrangement 2 in FIG. 14E) saved at a resolution value E and interface 1406 (e.g., labeled as Arrangement 1 in FIG. 14E) saved at a resolution value D. As described with respect to FIG. 14D above, computer system 600 can use an arrangement of widgets saved as corresponding to one resolution for a different resolution. This is illustrated visually by the brackets in FIG. 14E. For example, the brackets beneath resolution scale 1412 indicate that a display area that has a resolution value extending from a value of Resolution A to a value of Resolution D will be based on the widget arrangement that is saved at Resolution D (e.g., because that is the stored arrangement closest in resolution to each of those resolutions).

It should be noted that a widget arrangement at Resolution A, for example, can be based on the widget arrangement of arrangement 2 (e.g., 1402), but not look identical. This is because the arrangement 2 is used as the beginning basis for layout widgets, but is subject be rearranged subject to spatial constraints. In the case of spatial constraints, widgets can be rearranged according to one or more rules. In some embodiments, if there is a spatial constraint (e.g., widget island 1440 does not fit in Resolution D), widgets are moved. In some embodiments, widgets move to their closest snapping location that is available (e.g., not occupied by another widget and/or not subject to a spatial constraint (e.g., the widget will fit in the location)). In some embodiments, a widget tries to snap to a location within its current island, and if it cannot, then moves to the nearest snapping location (e.g., on another island and/or whether or not the location is on the current island). In some embodiments, widget rearrangement moves one or more widgets into an existing island or with another individual widget, merges two islands of multiple widgets, and/or separates an island and/or one or more widgets from an island. In some embodiments, a widget is selected to be rearranged based on how recently it was selected, placed, and/or moved by a user (e.g., via input). Widget rearrangement can be done in a cascading manner (e.g., one movement follows another which follows another) until computer system 600 reaches an arrangement that satisfies one or more spatial constraints of a widget display area.

Also illustrated in FIG. 14E is the interface 1406 saved at a resolution value D. As indicated by the brackets beneath resolution scale 1412, arrangements of widgets whose interface has a resolution value extending from a value of Resolution E to a value of Resolution F will be displayed as the widget arrangement that is saved at Resolution E. In some embodiments, if a widget arrangement is saved at Resolution A and Resolution B, when computer system 600 displays a widget display area on an interface at a resolution that falls between (e.g., corresponds to a resolution dimension within) the bracketed area on the resolution scale (e.g., is close in resolution value (e.g., total resolution and/or horizontal length) to an arrangement saved at another resolution value), computer system 600 can display the arrangement corresponding to the resolution closest to the resolution (e.g., and/or according to another rule and/or tiebreaker rule).

FIG. 14F illustrates resolutions scale 1412 with the same values and saved arrangements for Resolution D and Resolution E as illustrated in FIG. 14E with the addition of interface 1408 saved at Resolution B and interface 1410 saved at Resolution C. Given that additional arrangements are saved on resolution scale 1412, the brackets beneath the scale alter in size and position from how they were illustrated in FIG. 14E based on a limitation imposed by the system based on using a closest resolution. That is, based on the limitation, a bracket spans only from one saved arrangement to another. Given that there is an arrangement saved at Resolution B, the first bracket spans (e.g., on the high side) from values centered on Resolution B that extends halfway to Resolution C. Given that there is an arrangement saved at Resolution C, the second bracket spans values centered on Resolution C that extends from halfway to Resolution B to halfway to Resolution D. Given that there is an arrangement saved at Resolution D, the third bracket spans from values centered on Resolution D that extends halfway to Resolution E and halfway to Resolution C. The fourth bracket is centered on Resolution E and spans (e.g., on the low side) halfway between Resolution D and Resolution E.

FIG. 14G illustrates that each widget anchor point that indicates symmetrical points on a widget island is anchored to a designated location (e.g., an anchor point) on the widget canvas (e.g., the display of computer system 600). Anchor points indicate the corners, sides, and/or center of the widget canvas. In some embodiments, a computer system indicates anchor points on a different location of the widget canvas.

The top portion of FIG. 14G illustrates interface 1402 of computer system 600 which illustrates widget anchor points on the corners, middle edges, and center of island 1440. Widget anchor points are (e.g., not visible on the display) points illustrated in FIG. 14G as a visual aid to indicate the relationships between widgets and/or widget islands and the desktop as computer system 600 changes spatial bounds of the display. In FIG. 14G, widget anchor points are placed around a box drawn around the edges of a widget island, and include: widget anchor point 1418A on the top left corner of island 1440, widget anchor point 1418B on the middle of the left edge of island 1440, widget anchor point 1418C on the bottom left corner of island 1440, widget anchor point 1418D on the middle of the bottom edge of island 1440, widget anchor point 1418E on the bottom right corner of island 1440, widget anchor point 1418F on the middle of the right edge of island 1440, widget anchor point 1418G on the top right corner of island 1440, widget anchor point 1418H on the middle of the top edge of island 1440, and widget anchor point 1418I on the center of island 1440. In FIG. 14G, a line is illustrated between a widget anchor point and a corresponding display area anchor point (e.g., display area anchor points 1402A-1402I). In some embodiments, the shortest distance (e.g., line) between a widget anchor point to a corresponding an anchor point (e.g., that form a pair of anchor points with the same relative placement (e.g., center-to-center, top right corner-to-top right corner)) out of all of the distances between corresponding pairs of anchor points is the point to which the widget island is anchored on display 602 (e.g., when rearranging widgets in response to spatial bonds changing). In some embodiments, a widget and/or widget island is anchored to an anchor point on the desktop user interface based on the shortest distance to an edge of the widget (e.g., rather than a widget anchor point, distance to an edge can be used). For a widget and/or widget island to be anchored to a certain area of the display means that the island is centered according to the location of the point to which it is anchored. As illustrated in FIG. 14G, widget anchor point 1418A connects to anchor point 1402A, widget anchor point 1418B connects to anchor point 1402B, widget anchor point 1418C connects to anchor point 1402C, widget anchor point 1418D connects to anchor point 1402D, widget anchor point 1418E connects to anchor point 1402E, widget anchor point 1418F connects to anchor point 1402F, widget anchor point 1418G connects to anchor point 1402G, widget anchor point 1418H connects to anchor point 1402H, and widget anchor point 1418I connects to anchor point 1402I. From the length of the connections illustrated in FIG. 14G, the connection between widget anchor point 1418B and anchor point 1402B is the shortest of the connections, which indicates that island 1440 is anchored to anchor point 1402B.

The middle portion of FIG. 14G illustrates interface 1402 of computer system 600 which illustrates widget anchor points on the corners, middle edges, and center of island 1442. Computer system 600 displays widget anchor point 1420A on the top left corner of island 1442, widget anchor point 1420B on the middle of the left edge of island 1442, widget anchor point 1420C on the bottom left corner of island 1442, widget anchor point 1420D on the middle of the bottom edge of island 1442, widget anchor point 1420E on the bottom right corner of island 1442, widget anchor point 1420F on the middle of the right edge of island 1442, widget anchor point 1420G on the top right corner of island 1442, widget anchor point 1420H on the middle of the top edge of island 1442, and widget anchor point 1420I on the center of island 1442. As illustrated in FIG. 14G, widget anchor point 1420A connects to anchor point 1402A, widget anchor point 1420B connects to anchor point 1402B, widget anchor point 1420C connects to anchor point 1402C, widget anchor point 1420D connects to anchor point 1402D, widget anchor point 1420E connects to anchor point 1402E, widget anchor point 1420F connects to anchor point 1402F, widget anchor point 1420G connects to anchor point 1402G, widget anchor point 1420H connects to anchor point 1402H, and widget anchor point 1420I connects to anchor point 1402I. From the length of the connections illustrated in FIG. 14G, the connection between widget anchor point 1420E and anchor point 1402E is the shortest of the connections, which indicates that island 1442 is anchored to anchor point 1402E.

The bottom portion of FIG. 14G illustrates interface 1406 of computer system 600 which illustrates widget anchor points on the corners, middle edges, and center of island 1444. Computer system 600 displays widget anchor point 1422A on the top left corner of island 1444, widget anchor point 1422B on the middle of the left edge of island 1444, widget anchor point 1422C on the bottom left corner of island 1444, widget anchor point 1422D on the middle of the bottom edge of island 1444, widget anchor point 1422E on the bottom right corner island 1444, widget anchor point 1422F on the middle of the right edge of island 1444, widget anchor point 1422G on the top right corner of island 1444, widget anchor point 1422H on the middle of the top edge of island 1444, and widget anchor point 1422I on the center of island 1444. As illustrated in FIG. 14G, widget anchor point 1422A connects to anchor point 1402A, widget anchor point 1422B connects to anchor point 1402B, widget anchor point 1422C connects to anchor point 1402C, widget anchor point 1422D connects to anchor point 1402D, widget anchor point 1422E connects to anchor point 1402E, widget anchor point 1422F connects to anchor point 1402F, widget anchor point 1422G connects to anchor point 1402G, widget anchor point 1422H connects to anchor point 1402H, and widget anchor point 1422I connects to anchor point 1402I. From the length of the connections illustrated in FIG. 14G, the connection between widget anchor point 1422B and anchor point 1402B is the shortest of the connections, which indicates that island 1444 is anchored to anchor point 1402B.

FIGS. 14H-14I illustrate the concept of an overflow region when a widget canvas contains no more space for widgets (e.g., has a spatial constraint due to a decrease in resolution). FIG. 14H includes interface 1424 in the top portion that illustrates island 1440, island 1442, and widget 1426, widget 1018, widget 1428, and widget 1430 in the middle area of interface 1424. At the top portion on FIG. 14H, computer system 600 detects an input to lower the resolution of interface 1424.

As illustrated in the bottom portion of FIG. 14H, in response to detecting an input to lower the resolution of interface 1424, computer system 600 illustrates interface 1425 at a smaller resolution value which is now interface 1425. In response to displaying a smaller resolution value, computer system 600 has no space for certain widgets on interface 1425. In response to detecting a lack of space for all of the present widgets on interface 1425, computer system 600 stacks outside/bordering widgets (e.g., widget 1012, widget 1048A, widget 1016, and widget 1072) in the middle of interface 1425 (e.g., in overflow region 1028 indicated by a dashed border). In some embodiments, computer system 600 selects widgets to display in the overflow region based on which widget is subject to be moved first (e.g., based on rules), and if it cannot be placed then it is placed in the overflow region. In some embodiments, computer system 600 displays the overflow region at a different location on interface 1425. The stacking of outside widgets allows for all widgets to remain visible (e.g., with outside/bordering widgets in a condensed form) to a user on displays with smaller resolutions. Computer system 600 displaying overflow region 1028 can also be an indication to a user that their desktop user interface has run out of space for their current set of widgets and/or that action should be taken to organize widgets and/or desktop UI elements. Next to the stack of widgets is expand control 1432, which allows a user to view the stacked widgets individually on a platter 1434 in the middle of interface 1425. At the bottom portion of FIG. 14H, computer system 600 detects click input 1405H on expand control 1432.

As illustrated in FIG. 14I, in response to detecting input 1405H, computer system 600 expands overflow region 1028 into platter 1434. Overlaid on top of platter 1434 are the fully visible widgets that were stacked in overflow region 1028 as illustrated in FIG. 14H. Computer system 600 contains the option to expand the display of widgets to allow a user full access to widgets as if they were still placed on interface 1425.

FIG. 14J illustrates the process of a widget snapping to the closest available snapping location when no snapping locations are available on the widget's current island. The top portion of FIG. 14J illustrates widget arrangement at interface 1436, similar to widget arrangement at interface 1402, with the addition of widget 1018 and widget 1430 attached to the right of widget 1072. The addition of widget 1018 and widget 1430 increases the size of island 1442 of FIG. 14G which is now referred to as a new island, island 1454 in FIG. 14J. FIG. 14J also illustrates island 1456 on interface 1436. At FIG. 14J, computer system 600 detects an input to lower the resolution of display 602. In response to determining the need to rearrange widgets due island 1454 and island 1446 becoming closer in proximity, computer system 600 moves a widget to a different location of the same island to which the widget is already attached in order to make room for both islands to be within close proximity to one another. If there are no available snapping locations on that island, computer system 600 moves the widget to the closest available island to make room for the widget. Computer system 600 moves widgets in the scenario discussed above based on the recency of the placement of a widget by a user. That is, computer system 600 determines which widget to move to a new island when there are no available snapping locations on the widget's original island based on which widget was least recently placed by a user.

As illustrated on the bottom portion of FIG. 14J, on widget arrangement 1438, in response to detecting an input to lower the resolution of interface 1436, computer system 600 cannot move widget 1016 to the left side of widget 1430 on island 1454 due to the lack of sufficient space between the left side of widget 1430 and the right side of widget 1048A. Computer system 600 looks for a snapping location on another island as there are no remaining snapping locations on island 1454. Computer system 600 determines that the closest available snapping location is on island 1456, to which computer system 600 moves widget 1016. Computer system 600 moves widget 1016 based on the determination that widget 1016 was the widget that a user placed most recently out of the widgets displayed on interface 1436. In this embodiment, computer system 600 moves widget 1016 from island 1454 to island 1456 in this arrangement (e.g., which will affect how it moves in response to further changes in widget spatial arrangement).

FIG. 15 is a flow diagram illustrating a method (e.g., method 1500) for arranging widgets with respect to sets of one or more spatial bounds in accordance with some embodiments. Some operations in method 1500 are, optionally, combined, the orders of some operations are, optionally, changed, and some operations are, optionally, omitted.

As described below, method 1500 provides an intuitive way for arranging widgets with respect to sets of one or more spatial bounds. Method 1500 reduces the cognitive burden on a user for arranging widgets with respect to sets of one or more spatial bounds, thereby creating a more efficient human-machine interface. For battery-operated computing devices, enabling a user to arrange widgets with respect to sets of one or more spatial bounds faster and more efficiently conserves power and increases the time between battery charges.

In some embodiments, method 1500 is performed at a computer system (e.g., 600) that is in communication with a display generation component (e.g., 602) (e.g., a display screen and/or a touch-sensitive display). In some embodiments, the computer system (e.g., 600) is a laptop, a desktop, a watch, a phone, a tablet, a processor, a head-mounted display (HMD) device, and/or a personal computing device. In some embodiments, the computer system is in communication with one or more input devices (e.g., a physical input mechanism (e.g., a hardware input mechanism, a keyboard, a touch-sensitive surface with a display generation component, a touch-sensitive surface with or without a display generation component, a mouse, a pointing device, and/or a hardware button), a camera, a touch-sensitive display, and/or a microphone).

At 1502, the computer system (e.g., 600) displays, via the display generation component (e.g., 602), a set of two or more widgets (e.g., 1040, 1042, 1044, and/or 1046) (e.g., such as described above with respect to method 400) in a first widget spatial arrangement (e.g., arrangement of 1012, 1010, 1016, 1048A, 1050D, 1050A, 1050C and/or 1072 within 1040, 1044, and/or 1046 at FIGS. 14C-14J) (e.g., a relative spatial positioning of widgets in the set of two or more widgets, including one or more data representing location, orientation, placement, dimensions, and/or resolution of widgets) within a widget display area (e.g., 1402, 1406, 1408, and/or 1410) that has a first set of one or more spatial bounds (e.g., bounds of 1402, 1406, 1408, and/or 1410 at FIGS. 14C-14J) (e.g., a canvas, a region, a zone, and/or an area bounded by one or more dimensions defining an area (e.g., such as length and height that form a rectangle, a radius that forms a circle, and/or dimensions that form any other shape)) (e.g., an area of pixels within and/or defined by the set of one or more spatial bounds measured in pixels (e.g., the area of pixels is equal to and/or based on a resolution of a display generation component)).

At 1504, the computer system (e.g., 600) detects a request to display the set of two or more widgets in a widget display area (e.g., change in resolution and/or to a display generation component) (e.g., due to addition of a display generation component, removal of a display generation component, closing a lid and/or disable a display of a laptop, and/or changing a resolution of a user interface displayed on one or more display generation component) with a respective set of one or more spatial bounds (e.g., a request to change spatial bounds) (e.g., as discussed above at FIG. 14C). In some embodiments, detecting the request to display the set of two or more widgets in the widget display area with the respective set of one or more spatial bounds includes detecting, via one or more input devices (e.g., an input port configured to connect to a display generation component, a mouse, a keyboard, a touch-sensitive display, and/or a touch-sensitive surface) in communication with the computer system, an input (e.g., a touch, a tap, a swipe, and/or a mouse click). In some embodiments, detecting the request to display the set of two or more widgets in a widget display area with the respective set of one or more spatial bounds includes detecting, via the computer system, an event (e.g., addition, removal, and/or a change in one or more components (e.g., display generation component) in communication with the computer system). In some embodiments, detecting the request to display the set of two or more widgets in a widget display area with the respective set of one or more spatial bounds includes detecting a request to change one or more screen resolution dimensions (e.g., a screen resolution dimension is an amount (e.g., number and/or area) of pixels configured to be displayed by a display generation component (e.g., a length dimension, a width dimension, a height dimension)). In some embodiments, detecting the request to display the set of two or more widgets in a widget display area with the respective set of one or more spatial bounds includes detecting a request to change an orientation of the widget display area (e.g., changing from portrait orientation (e.g., long edge is vertical) to landscape orientation (e.g., long edge is horizontal) at a same total resolution (e.g., number of pixels) and/or at a different total resolution) and/or content displayed via the display generation component.

At 1506, in response to detecting the request to display the set of two or more widgets in a widget display area with the respective set of one or more spatial bounds and in accordance with (at 1508) a determination that the respective set of one or more spatial bounds is a second set of one or more spatial bounds (e.g., bounds of 1402, 1406, 1408, and/or 1410 at FIGS. 14C-14J) different from the first set of one or more spatial bounds (e.g., from the first set of one or more spatial bounds to a respective set of one or more spatial bounds different from the first set of one or more spatial bounds), the computer system (e.g., 600) displays, via the display generation component, the set of two or more widgets in a second widget spatial arrangement (e.g., arrangement of 1012, 1010, 1016, 1048A, 1050D, 1050A, 1050C and/or 1072 within 1040, 1044, and/or 1046 at FIGS. 14C-14J) different from the first widget spatial arrangement. In some embodiments, displaying the set of two or more widgets in the second widget spatial arrangement different from the first widget spatial arrangement includes displaying widgets in a different order and/or via (e.g., on) different display generation components. In some embodiments, the set of two or more widgets corresponds to (e.g., is associated with, is configured with, and/or is a part of) a plurality of discrete user interface screens (e.g., desktop screens). In some embodiments, different discrete user interface screens of the plurality of discrete user interface screens include different portions of the set of two or more widgets arranged in a relative arrangement (e.g., which is saved and reproduced with the discrete user interface screen that is displayed), wherein a discrete user interface screen is configured to be displayed by a display generation component. In some embodiments, a widget spatial arrangement (e.g., first widget spatial arrangement and/or second widget spatial arrangement) includes fewer than all, or all, discrete user interface screens corresponding to a set of one or more widgets (e.g., the set of one or more widgets can be arranged over five different discrete user interface screens). In some embodiments, whether a discrete user interface screen is displayed by a display generation component as part of a widget spatial arrangement depends on a number of display generation components in communication with the computer system (e.g., if three display generation components are in communication with the computer system, then three discrete user interface screens are displayed, one on a different respective display generation component; if a fourth display generation component is added to be in communication with the computer system, a fourth discrete user interface screen is displayed that includes a previously not displayed portion of the set of a widgets in a relative arrangement). In some embodiments, the respective set of one or more spatial bounds represents a larger, smaller, or same size widget display area than the first set of one or more spatial bounds. In some embodiments, the respective set of one or more spatial bounds has a different orientation from the first set of one or more spatial bounds (e.g., portrait orientation changing to landscape orientation, or landscape orientation changing to portion orientation).

At 1506, in response to detecting the request to display the set of two or more widgets in a widget display area with the respective set of one or more spatial bounds and in accordance with (at 1510) a determination that the respective set of one or more spatial bounds is a third set of one or more spatial bounds (e.g., bounds of 1402, 1406, 1408, and/or 1410 at FIGS. 14C-14J) different from the first set of one or more spatial bounds and different from the second set of one or more spatial bounds, the computer system (e.g., 600) displays, via the display generation component, the set of two or more widgets in a third widget spatial arrangement (e.g., arrangement of 1012, 1010, 1050D, 1050A, 1050C and/or 1048A within 1040, 1044, and/or 1046 at FIGS. 14C-14J) different from the first widget spatial arrangement and the second widget spatial arrangement. In some embodiments, the third set of spatial bounds represents a larger, smaller, or same size widget display area than the second set of spatial bounds. In some embodiments, the third set of one or more spatial bounds has a different orientation from the second set of one or more spatial bounds (e.g., portrait orientation changing to landscape orientation, or landscape orientation changing to portion orientation). Displaying the set of two or more widgets in the third widget spatial arrangement or the second widget spatial arrangement depending on whether the respective set of one or more spatial bounds is a second set or a third set enables the computer system to display widgets in a relevant arrangement in a dynamic manner, thereby performing an operation when a set of conditions has been met without requiring further user input, reducing the number of inputs needed to perform an operation, and providing improved visual feedback to the user.

In some embodiments, in response to detecting the request to display the set of two or more widgets (e.g., 1040, 1042, 1044, and/or 1046) in the widget display area (e.g., 1402, 1406, 1408, and/or 1410) with the respective set of one or more spatial bounds (e.g., bounds of 1402, 1406, 1408, and/or 1410 at FIGS. 14C-14J) and in accordance with a determination that the respective set of one or more spatial bounds is the first set of one or more spatial bounds (e.g., bounds of 1402, 1406, 1408, and/or 1410 at FIGS. 14C-14J), the computer system (e.g., 600) displays, via the display generation component, the set of two or more widgets in the first widget spatial arrangement (e.g., arrangement of 1012, 1010, 1016, 1048A, 1050D, 1050A, 1050C and/or 1072 within 1040, 1044, and/or 1046 at FIGS. 14C-14J) (e.g., redisplaying the widget display area with the first set of one or more spatial bounds causes the first widget spatial arrangement to be displayed). Displaying the set of two or more widgets in the first widget spatial arrangement when the respective set of one or more spatial bounds is the first set enables the computer system to display widgets in a relevant arrangement in a consistent manner, thereby performing an operation when a set of conditions has been met without requiring further user input, reducing the number of inputs needed to perform an operation, and providing improved visual feedback to the user.

In some embodiments, detecting the request to display the set of two or more widgets (e.g., 1040, 1042, 1044, and/or 1046) in the widget display area (e.g., 1402, 1406, 1408, and/or 1410) with the respective set of one or more spatial bounds (e.g., bounds of 1402, 1406, 1408, and/or 1410 at FIGS. 14C-14J) includes detecting a request to display the set of two or more widgets via (e.g., on, through, using, and/or as an output of) a second display generation component different from the display generation component. In some embodiments, the second display generation component corresponds to (e.g., is configured for, causes a configuration to be, and/or otherwise associated with) the respective set of one or more spatial bounds (e.g., bounds of 1402, 1406, 1408, and/or 1410 at FIGS. 14C-14J). In some embodiments, the respective set of one or more spatial bounds is different from the first set of one or more spatial bounds. In some embodiments, the second set of one or more spatial bounds includes an area (e.g., a widget display area) corresponding to a third display generation component different from the display generation component (and/or the second display generation component). In some embodiments, the third set of one or more spatial bounds includes an area (e.g., a widget display area) corresponding to a fourth display generation component different from the display generation component (and/or the third display generation component). In some embodiments, the area corresponding to the third display generation component is not included in the first set of one or more spatial bounds and/or the second set of one or more spatial bounds. In some embodiments, the area corresponding to the fourth display generation component is not included in the first set of one or more spatial bounds and/or the second set of one or more spatial bounds. In some embodiments, detecting the request to display the set of two or more widgets in the widget display area with the respective set of one or more spatial bounds includes detecting a request to display the set of two or more widgets via (e.g., on, through, using, and/or as an output of) a fifth display generation component different from the display generation component. In some embodiments, the first set of one or more spatial bounds does not include an area (e.g., a widget display area) corresponding to the fifth display generation component. Displaying the set of two or more widgets in the second set of one or more spatial bounds includes the area corresponding to a second display generation component different from the enables the computer system (e.g., 600) to display widgets in a relevant arrangement in a dynamic manner, thereby performing an operation when a set of conditions has been met without requiring further user input, reducing the number of inputs needed to perform an operation, and providing improved visual feedback to the user.

In some embodiments, detecting the request to display the set of two or more widgets (e.g., 1040, 1042, 1044, and/or 1046) in the widget display area (e.g., 1402, 1406, 1408, and/or 1410) with the respective set of one or more spatial bounds (e.g., bounds of 1402, 1406, 1408, and/or 1410 at FIGS. 14C-14J) includes detecting a request to change a resolution setting (e.g., a display resolution setting, such as a display resolution setting corresponding to the display generation component (and not another display generation component different from the display generation component)) (e.g., changing one or more spatial dimensions of a widget display area) corresponding to (e.g., configured on, available on, and/or supported by) the display generation component (e.g., as discussed above at FIG. 14C). Displaying the set of two or more widgets in the second set of one or more spatial bounds in response to detecting the request to change a resolution setting enables the computer system (e.g., 600) to display widgets in a relevant arrangement in a dynamic manner, thereby performing an operation when a set of conditions has been met without requiring further user input, reducing the number of inputs needed to perform an operation, and providing improved visual feedback to the user.

In some embodiments, detecting the request to display the set of two or more widgets (e.g., 1040, 1042, 1044, and/or 1046) in the widget display area (e.g., 1402, 1406, 1408, and/or 1410) with the respective set of one or more spatial bounds (e.g., bounds of 1402, 1406, 1408, and/or 1410 at FIGS. 14C-14J) includes detecting a request to change an orientation setting (e.g., as discussed above at FIGS. 14C-14J) (e.g., a display orientation setting, such as a display orientation setting corresponding to the display generation component (and not another display generation component different from the display generation component)) (e.g., representing an orientation (e.g., portrait or landscape orientation) of the display generation component and/or of a widget display area corresponding to the display generation component) corresponding to (e.g., configured on, available on, and/or supported by) the display generation component. In some embodiments, the second set of one or more spatial bounds includes an area (e.g., a widget display area) in a first display orientation. In some embodiments, the first set of one or more spatial bounds includes the area in a second display orientation different from the first display orientation. In some embodiments, the third set of one or more spatial bounds includes the area in a third display orientation different from the first display orientation. In some embodiments, changing a resolution setting corresponding to the display generation component includes changing an orientation of a widget display area that has the first set of one or more spatial bounds (e.g., changing from portrait to landscape orientation). In some embodiments, changing the orientation of the widget display area includes changing a total resolution (e.g., a new width and/or a length). In some embodiments, changing the orientation of the widget display area does not include changing a total resolution (e.g., width*length=length*width). In some embodiments, the second set of one or more spatial bounds includes an area (e.g., a widget display area) at a first display resolution. In some embodiments, the first set of one or more spatial bounds includes the area at a second display resolution different from the first display resolution. In some embodiments, the third set of one or more spatial bounds includes the area at a third display resolution different from the first display resolution. Displaying the set of two or more widgets in the second set of one or more spatial bounds in response to detecting the request to change an orientation setting enables the computer system (e.g., 600) to display widgets in a relevant arrangement in a dynamic manner, thereby performing an operation when a set of conditions has been met without requiring further user input, reducing the number of inputs needed to perform an operation, and providing improved visual feedback to the user.

In some embodiments, displaying the set of two or more widgets (e.g., 1040, 1042, 1044, and/or 1046) in the first widget spatial arrangement (e.g., arrangement of 1012, 1010, 1016, 1048A, 1050D, 1050A, 1050C and/or 1072 within 1040, 1044, and/or 1046 at FIGS. 14C-14J) includes displaying: a first group of widgets (e.g., 1010, 1012, and 1050D and/or 1010, 1012, and 1050A-1050C at FIGS. 14A-14B), wherein widgets in the first group of widgets are visually (and/or spatially) arranged together (e.g., arrangement of lower groups at FIG. 14A) (e.g., according to a common layout guide (e.g., grid), respectively adjacent, in close relative proximity, and/or touching and/or overlapping), and wherein widgets in the first group of widgets are visually (and/or spatially) arranged with respect to (e.g., based on, adjacent to, located near, and/or separated by a predefined spaced from) at least one other widget in the first group of widgets (e.g., as discussed above at FIG. 14A and/or FIG. 14B). In some embodiments, displaying the set of two or more widgets in the first widget spatial arrangement includes displaying: a second group of widgets (e.g., 1010, 1012, and 1050D and/or 1010, 1012, and 1050A-1050C at FIGS. 14A-14B) different from the first group of widgets, wherein widgets in the second group of widgets are visually (and/or spatially) arranged together, and wherein widgets in the second group of widgets are visually (and/or spatially) arranged with respect to at least one other widget in the second group of widgets but not with respect to a widget in the first group of widgets (e.g., as discussed above at FIG. 14A and/or FIG. 14B) (e.g., widgets of the first group that align to a first grid are not required to align with a second grid to which widgets of the second group align). In some embodiments, a group of widgets (e.g., also referred to as an “island” of widgets) is a set of two or more widgets that have one or more relationships with respect to layout (e.g., positioning and/or spacing), snapping (e.g., are snapped to another widget in the island), interaction (e.g., can be moved as a group), and/or rearrangement (e.g., such as described below with respect to method 700). In some embodiments, the user interface includes one or more groups of widgets (e.g., different islands that stand alone from (e.g., are independent of and/or do not share the relationships noted above with) other widgets and/or islands). In some embodiments, a group of widgets can be broken (e.g., split, separated, ungrouped, and/or divided) (e.g., into one or more islands, one or more individual widgets, and/or any combination thereof). In some embodiments, two or more widgets can be combined to create (e.g., form, establish, generate, and/or start) a group of widgets (e.g., two widgets can combine to form an island and/or one widget can be added to an existing island). In some embodiments, the first group of widgets is not visually (and/or spatially) arranged together with respect to the second group of widgets. In some embodiments, the first group of widgets is at least an amount of space corresponding to a single widget away from the second group of widgets. Displaying the set of two or more widgets in the first widget spatial arrangement including displaying the first group of widgets and the second group of widgets enables the computer system (e.g., 600) to display widgets arranged in a custom and/or organized manner, thereby providing additional control options without cluttering the user interface with additional displayed controls and providing improved visual feedback to the user.

In some embodiments, computer system 600 displays the set of two or more widgets (e.g., 1040, 1042, 1044, and/or 1046) in the second widget spatial arrangement (e.g., arrangement of 1012, 1010, 1016, 1048A, 1050D, 1050A, 1050C and/or 1072 within 1040, 1044, and/or 1046 at FIGS. 14C-14J). In some embodiments, displaying widgets in the first group of widgets (e.g., 1010, 1012, and 1050D and/or 1010, 1012, and 1050A-1050C at FIGS. 14A-14B) together and widgets in the second group of widgets (e.g., 1010, 1012, and 1050D and/or 1010, 1012, and 1050A-1050C at FIGS. 14A-14B) together (e.g., the first group of widgets and the second group of widgets continue to be separate groups but are concurrently displayed). In some embodiments, in the second widget spatial arrangement, the first group of widgets and/or the second group of widgets change in arrangement (e.g., rearrange into a different shape) but remain grouped (e.g., the widgets the first group remain in the first group and the widgets in the second group remain in the second group). In some embodiments, displaying widgets in the first group of widgets separate from widgets in the second group of widgets (e.g., as discussed above at FIGS. 14A and/or 14B). In some embodiments, displaying the set of two or more widgets in the third widget spatial arrangement includes: displaying widgets in the first group of widgets together and widgets in the second group of widgets together (e.g., the first group of widgets and the second group of widgets continue to be separate groups); and displaying widgets in the first group of widgets separate from widgets in the second group of widgets. In some embodiments, in the third widget spatial arrangement, the first group of widgets and/or the second group of widgets change in arrangement (e.g., rearrange into a different shape) but remain grouped. Displaying the first group of widgets together and the second group of widgets together in response to detecting the request to display the set of two or more widgets in the widget display area with the respective set of one or more spatial bounds enables the computer system (e.g., 600) to display widgets arranged in a custom and/or organized manner, thereby providing additional control options without cluttering the user interface with additional displayed controls and providing improved visual feedback to the user.

In some embodiments, computer system 600 displays the set of two or more widgets (e.g., 1040, 1042, 1044, and/or 1046) in the second widget spatial arrangement (e.g., arrangement of 1012, 1010, 1016, 1048A, 1050D, 1050A, 1050C and/or 1072 within 1040, 1044, and/or 1046 at FIGS. 14C-14J). In some embodiments, in accordance with a determination that the respective set of one or more spatial bounds causes a spatial constraint with respect to the first group of widgets (e.g., 1010, 1012, and 1050D and/or 1010, 1012, and 1050A-1050C at FIGS. 14A-14B) and the second group of widgets (e.g., 1010, 1012, and 1050D and/or 1010, 1012, and 1050A-1050C at FIGS. 14A-14B) (e.g., does not have enough room to display the first group and the second group of widgets separately due to availability of space and/or limitations), combining the first group of widgets with the second group of widgets into a third group of widgets (e.g., as discussed above at 14A) (e.g., an existing group or a new group). In some embodiments, in accordance with a determination that the respective set of one or more spatial bounds does not cause the spatial constraint with respect to the first group of widgets and the second group of widgets, forgoing combining the first group of widgets with the second group of widgets. In some embodiments, displaying the set of two or more widgets in the second widget spatial arrangement includes, in accordance with a determination that the respective set of one or more spatial bounds does not cause the spatial constraint with respect to the first group of widgets and the second group of widgets, displaying the first group of widgets and the second group of widgets (e.g., the first group of widgets and the second group of widgets continue to be separate groups). Combining the first group of widgets together with the second group of widgets together based on whether spatial bounds cause a space constraint enables the computer system (e.g., 600) to display widgets in a relevant arrangement in a dynamic manner, thereby performing an operation when a set of conditions has been met without requiring further user input, reducing the number of inputs needed to perform an operation, and providing improved visual feedback to the user.

In some embodiments, displaying the set of two or more widgets (e.g., 1040, 1042, 1044, and/or 1046) in the first widget spatial arrangement (e.g., arrangement of 1012, 1010, 1016, 1048A, 1050D, 1050A, 1050C and/or 1072 within 1040, 1044, and/or 1046 at FIGS. 14C-14J) includes displaying: the first group of widgets (e.g., 1010, 1012, and 1050D and/or 1010, 1012, and 1050A-1050C) in closer proximity to (e.g., at, at a respective distance from, and/or closest to) a first location (e.g., location of one or more of 1402A-1402I at FIG. 14G) (e.g., of a display area anchor point) in the widget display area (e.g., 1402, 1406, 1408, and/or 1410) than to a second location (e.g., location of one or more of 1402A-1402I at FIG. 14G) (e.g., of a display area anchor point) in the widget display area, wherein the second location is different from the first location. In some embodiments, displaying the set of two or more widgets in the first widget spatial arrangement includes displaying: the second group of widgets (e.g., 1010, 1012, and 1050D and/or 1010, 1012, and 1050A-1050C) in closer proximity to (e.g., at, at a respective distance from, and/or closest to) the second location than to the first location. In some embodiments, displaying the set of two or more widgets in the second widget spatial arrangement includes displaying: the first group of widgets in closer proximity (e.g., the same or different proximity than the proximity in the first and/or second widget spatial arrangement) to the first location than to the second location. In some embodiments, displaying the set of two or more widgets in the second widget spatial arrangement includes displaying: the second group of widgets in closer proximity to the second location than to the first location. In some embodiments, displaying the set of two or more widgets in the third widget spatial arrangement includes displaying: the first group of widgets in closer proximity to the first location than the second location (e.g., the same or different proximity than the proximity in the first and/or second widget spatial arrangement), and the second group of widgets in closer proximity to the second location than the first location (e.g., the same or different proximity than the proximity in the first and/or second widget spatial arrangement). Displaying the first group of widgets in closer proximity to the first location and the second group of widgets in closer proximity to the second location in the first and second widget spatial arrangements enables the computer system (e.g., 600) to display widgets arranged in a custom and/or organized manner, thereby reducing the number of inputs needed to perform an operation, providing additional control options without cluttering the user interface with additional displayed controls and providing improved visual feedback to the user.

In some embodiments, the widget display area (e.g., 1402, 1406, 1408, and/or 1410) includes (e.g., visibly or not visibly) a set of one or more display area anchor points (e.g., 1402A-1402I at FIG. 14G) (e.g., including one or more anchor points corresponding to (e.g., defined as, located at, affixed to, and/or placed at) locations of the widget display area, such as a corner, an edge (e.g., midway point of the edge), and/or the center) that includes a first display area anchor point (e.g., 1402A-1402I at FIG. 14G) at a third location (e.g., location of 1402A-14021 and/or 1422A-1422I at FIG. 14G) (e.g., in the widget display area or not in the widget display area) and a second display area anchor point (e.g., 1402A-1402I at FIG. 14G) at a fourth location (e.g., location of 1402A-1402I and/or 1422A-1422I at FIG. 14G) (e.g., in the widget display area or not in the widget display area) different from the third location. In some embodiments, in accordance with a determination that the first display area anchor point (e.g., 1402B) is closest (e.g., one of the closest), of the set of one or more anchor points, to a first respective corresponding location (e.g., 1418B) (e.g., location of 1418A-1418I, 1420A-1420I, and/or 1422A-1422I at FIG. 14G) (e.g., widget anchor point and/or location of a widget in the group) of the first group of widgets while displayed in the first widget spatial arrangement, displaying the first group of widgets such that, while in the second widget spatial arrangement, the first display area anchor point remains closest (e.g., one of the closest), of the set of one or more anchor points, to the first respective corresponding location (e.g., widget anchor point and/or location of a widget in the group) of the first group of widgets. In some embodiments, in accordance with a determination that the second display area anchor point (e.g., 1402A-1402I at FIG. 14G) is closest (e.g., one of the closest), of the set of one or more anchor points, to a second respective corresponding location (e.g., widget anchor point and/or location of a widget in the group) of the first group of widgets while displayed in the first widget spatial arrangement, displaying the first group of widgets such that, while in the second widget spatial arrangement, the second respective corresponding display area anchor point remains closest (e.g., one of the closest), of the set of one or more anchor points, to the first respective corresponding location (e.g., widget anchor point and/or location of a widget in the group) of the first group of widgets. In some embodiments, a closest display area anchor point is determined based on a distance and/or measurement: between the (e.g., first or second) display area anchor point and: a widget anchor point of a set of widget anchor points corresponding to (e.g., located at, placed at, and/or drawn with respect to) the group of widgets, and/or some other location or quantity that is associated with the first group of widgets. In some embodiments, a distance measure is made between one or more pairs of anchor points (e.g., a distance between a display area anchor point and a widget anchor point). In some embodiments, the one or more pairs of anchor points are pairs of anchor points corresponding to the same relative position (e.g., a like-for-like matching) (e.g., a top left corner display area anchor point and a top left corner widget anchor point, a top right corner display area anchor point and a top right corner widget anchor point, a bottom left corner display area anchor point and a bottom left corner widget anchor point, a bottom right corner display area anchor point and a bottom right corner widget anchor point, a top edge midpoint display area anchor point and a top edge midpoint widget anchor point, a bottom edge midpoint display area anchor point and a bottom edge midpoint widget anchor point, a left edge midpoint display area anchor point and a left edge midpoint widget anchor point, a right edge midpoint display area anchor point and a right edge midpoint widget anchor point, and/or a central (e.g., in the center) display area anchor point and a central widget anchor point). In some embodiments, the closest display area anchor point is the display area anchor point that corresponds to the pair of anchor points with the smallest distance between them. In some embodiments, display area anchor points and/or widget anchor points can be place at (and/or based on) any location (e.g., not just those mentioned above). Displaying the first group of widgets and the second group of widgets closest to corresponding anchor point location in the first and second widget spatial arrangements enables the computer system (e.g., 600) to display widgets arranged in a custom and/or organized manner, thereby reducing the number of inputs needed to perform an operation, providing additional control options without cluttering the user interface with additional displayed controls, and providing improved visual feedback to the user.

In some embodiments, the computer system (e.g., 600) detects a request to move a respective widget (e.g., 1010 and/or 1050D) to a location (e.g., location of 1010 and/or 1050D at the bottom of FIG. 14A) between the first group of widgets (e.g., 1010, 1012, and 1050D and/or 1010, 1012, and 1050A-1050C at FIGS. 14A-14B) and the second group of widgets (e.g., 1010, 1012, and 1050D and/or 1010, 1012, and 1050A-1050C at FIGS. 14A-14B) (e.g., to a gap between the first group of widgets and the second group of widgets). In some embodiments, in response to detecting the request to move the respective widget to the location between the first group of widgets and the second group of widgets and in accordance with a determination that the location between the first group of widgets and the second group of widgets is within a predetermined distance (e.g., such as described above with respect to method 400) to (e.g., away from and/or separated by) (e.g., and/or satisfies a set of one or more criteria that includes a criterion satisfied when within a predetermined distance) both the first group of widgets and the second group of widgets (e.g., the widget fills in a gap between the first group of widgets and the second group of widgets) (e.g., the location is within the predefined distance to a respective location of the first group of widgets and the location is within the predefined distance to a respective location of the second group of widgets), the computer system (e.g., 600) combines (e.g., as discussed above at FIG. 14A) (e.g., merging and/or grouping) the first group of widgets with the second group of widgets to form a third group of widgets, wherein the third group of widgets is different from the first group of widgets and the second group of widgets. In some embodiments, widgets in the third group of widgets are visually (and/or spatially) arranged together (e.g., according to a common layout guide (e.g., grid), respectively adjacent, in close relative proximity, e.g., touching and/or overlapping). In some embodiments, widgets in the third group of widgets are visually (and/or spatially) arranged (e.g., together) with respect to (e.g., based on, adjacent to, located near, and/or separated by a predefined spaced from) at least one other widget in the third group of widgets (e.g., and not with respect to one or more widgets not included in the third group of widgets). In some embodiments, in response to detecting the request to move the respective widget to the location between the first group of widgets and the second group of widgets and in accordance with a determination that the location between the first group of widgets and the second group of widgets is not within the predetermined distance to (e.g., and/or does not satisfy a set of one or more criteria that includes a criterion satisfied when within a predetermined distance) both the first group of widgets and the second group of widgets (e.g., the location is not within the predefined distance to a respective location of the first group of widgets and/or the location is not within the predefined distance to a respective location of the second group of widgets), the computer system forgoes combining (e.g., maintaining separation as different groups) the first group of widgets with the second group of widgets to form the third group of widgets (e.g., does not form the third group of widgets). Displaying the set of two or more widgets in different groupings depending on a request to move a widget between the first group of widgets and the second group of widgets enables the computer system to display widgets arranged in a custom and/or organized manner, thereby reducing the number of inputs needed to perform an operation, providing additional control options without cluttering the user interface with additional displayed controls, and providing improved visual feedback to the user.

In some embodiments, the computer system (e.g., 600) detects a request to display the set of two or more widgets (e.g., 1040, 1042, 1044, and/or 1046) in a widget display area (e.g., 1402, 1406, 1408, and/or 1410) with a second respective set of one or more spatial bounds (e.g., bounds of 1402, 1406, 1408, and/or 1410 at FIGS. 14C-14J) (e.g., the same or different from the first respective set of one or more spatial bounds). In some embodiments, in response to detecting the request to display the set of two or more widgets in the widget display area with the second respective set of one or more spatial bounds and in accordance with a determination that the first group of widgets (e.g., 1010, 1012, and 1050D and/or 1010, 1012, and 1050A-1050C) is combined with the second group of widgets (e.g., 1010, 1012, and 1050D and/or 1010, 1012, and 1050A-1050C) to form the third group of widgets (e.g., as discussed above at FIG. 14A), the computer system displays, via the display generation component, the set of two or more widgets in a fourth widget spatial arrangement (e.g., as discussed above at FIG. 14A) (e.g., that includes the third group of widgets) (e.g., that does not include the first group of widgets and/or the second group of widgets (e.g., as separate groups)). In some embodiments, in response to detecting the request to display the set of two or more widgets in the widget display area with the second respective set of one or more spatial bounds and in accordance with a determination that the first group of widgets is not combined with the second group of widgets to form the third group of widgets, the computer system displays, via the display generation component, the set of two or more widgets in a fifth widget spatial arrangement (e.g., that includes the first group of widgets and the second group of widgets (e.g., as separate groups)) (e.g., that does not include the third group of widgets) different from the fourth widget spatial arrangement (e.g., how the set of two or more widgets is broken into groups can affect widget position (e.g., as reflected in the widget spatial position) when spatial bounds are changed, resulting in different widget spatial arrangements for the same group of widgets if widget grouping is changed). Displaying the set of two or more widgets in different spatial arrangements depending on whether the first group of widgets has been combined the second group of widgets enables the computer system to display widgets arranged in a custom and/or organized manner, thereby reducing the number of inputs needed to perform an operation, providing additional control options without cluttering the user interface with additional displayed controls, and providing improved visual feedback to the user.

In some embodiments, the computer system (e.g., 600) detects a request to move a respective widget (e.g., 1010, 1012, and/or 1050A-D) of a fourth group of widgets (e.g., 1010, 1012, and 1050D and/or 1010, 1012, and 1050A-1050C) from a location between a first portion of the fourth group of widgets and a second portion of the fourth group of widgets. In some embodiments, widgets in the fourth group of widgets are visually (and/or spatially) arranged together (e.g., according to a common layout guide (e.g., grid), respectively adjacent, in close relative proximity, and/or touching and/or overlapping). In some embodiments, widgets in the fourth group of widgets are visually (and/or spatially) arranged (e.g., together) with respect to (e.g., based on, adjacent to, located near, and/or separated by a predefined spaced from) at least one other widget in the fourth group of widgets (e.g., and not with respect to one or more widgets not included in the fourth group of widgets). In some embodiments, in response to detecting the request to move the respective widget of the fourth group of widgets from the location between the first portion of the fourth group of widgets and the second portion of the fourth group of widgets (e.g., away from the location of 1404 at FIG. 14A), the computer system moves the respective widget of the fourth group of widgets from the location (e.g., to another location that is not) between the first portion of the fourth group of widgets and the second portion of the fourth group of widgets. In some embodiments, in response to detecting the request to move the respective widget of the fourth group of widgets from the location between the first portion of the fourth group of widgets and the second portion of the fourth group of widgets and in accordance with a determination that moving the respective widget of the fourth group of widgets from the location between the first portion of the fourth group of widgets and the second portion of the fourth group of widgets disconnects the first portion of the fourth group of widgets from the second portion of the fourth group of widgets (e.g., as discussed at FIG. 14B) (e.g., creates a gap (e.g., a discontinuity, space, hole, and/or break) in a visual (and/or spatial) pattern formed by the fourth group of widgets immediately prior to moving the respective widget) (e.g., when no other connection exists between the first portion of the fourth group of widgets and the second portion of the fourth group of widgets), the computer system (e.g., 600) separates the fourth group of widgets (e.g., arrangement of the groups of widgets at the top of FIG. 14A and/or bottom of FIG. 14B), including: creating the first group of widgets that includes the first portion of the fourth group of widgets but not the second portion of the fourth group of widgets; and creating the second group of widgets that includes the second portion of the fourth group of widgets but not the first portion of the fourth group of widgets. In some embodiments, in response to detecting the request to move the respective widget of the fourth group of widgets from the location between the first portion of the fourth group of widgets and the second portion of the fourth group of widgets and in accordance with a determination that moving the respective widget of the fourth group of widgets from the location between the first portion of the fourth group of widgets and the second portion of the fourth group of widgets does not disconnect the first portion of the fourth group of widgets from the second portion of the fourth group of widgets, the computer system forgoes separating the fourth group of widgets (e.g., does not separate the fourth group of widgets to create the first group of widgets and the second group of widgets). Displaying the set of two or more widgets in different groupings depending on whether a request to move a widget from between portions of the fourth group of widgets enables the computer system to display widgets arranged in a custom and/or organized manner, thereby reducing the number of inputs needed to perform an operation, providing additional control options without cluttering the user interface with additional displayed controls, and providing improved visual feedback to the user.

In some embodiments, the computer system (e.g., 600) detects a request to display the set of two or more widgets (e.g., 1040, 1042, 1044, and/or 1046) in a widget display area (e.g., 1402, 1406, 1408, and/or 1410) with a third respective set of one or more spatial bounds (e.g., bounds of 1402, 1406, 1408, and/or 1410 at FIGS. 14C-14J). In some embodiments, in response to detecting the request to display the set of two or more widgets in the widget display area with the third respective set of one or more spatial bounds and in accordance with a determination that the fourth group of widgets (e.g., 1010, 1012, and 1050D and/or 1010, 1012, and 1050A-1050C at FIGS. 14A-14B) is separated to form the first group of widgets (e.g., 1010, 1012, and 1050D and/or 1010, 1012, and 1050A-1050C at FIGS. 14A-14B) and the second group of widgets (e.g., 1010, 1012, and 1050D and/or 1010, 1012, and 1050A-1050C at FIGS. 14A-14B), the computer system displays, via the display generation component, the set of two or more widgets in a sixth widget spatial arrangement (e.g., arrangement of 1012, 1010, 1016, 1048A, 1050D, 1050A, 1050C and/or 1072 within 1040, 1044, and/or 1046 at FIGS. 14C-14J) (e.g., that includes the first group of widgets and the second group of widgets) (e.g., that does not include the fourth group of widgets (displayed as a group)). In some embodiments, in response to detecting the request to display the set of two or more widgets in the widget display area with the third respective set of one or more spatial bounds and in accordance with a determination that the fourth group of widgets is not separated to form the first group of widgets and the second group of widgets (e.g., the computer system has foregone separating), the computer system displays, via the display generation component, the set of two or more widgets in a seventh widget spatial arrangement (e.g., that includes the fourth group of widgets) (e.g., that does not include the first group of widgets and the second group of widgets (displayed as separate groups)) different from the sixth widget spatial arrangement (e.g., how the set of two or more widgets is broken into groups can affect widget position (e.g., as reflected in the widget spatial position) when spatial bounds are changed, resulting in different widget spatial arrangements for the same group of widgets if widget grouping is changed). Displaying the set of two or more widgets in different spatial arrangements depending on whether the first group of widgets has been separated from the second group of widgets enables the computer system to display widgets arranged in a custom and/or organized manner, thereby reducing the number of inputs needed to perform an operation, providing additional control options without cluttering the user interface with additional displayed controls, and providing improved visual feedback to the user.

In some embodiments, displaying the set of two or more widgets (e.g., 1040, 1042, 1044, and/or 1046) in the first widget spatial arrangement (e.g., arrangement of 1012, 1010, 1016, 1048A, 1050D, 1050A, 1050C and/or 1072 within 1040, 1044, and/or 1046 at FIGS. 14C-14J) includes displaying: the first group of widgets (e.g., 1010, 1012, and 1050D and/or 1010, 1012, and 1050A-1050C at FIGS. 14A-14B) in a first pattern (e.g., arrangement of 1010, 1012, and 1050D and/or arrangement of 1010, 1012, and 1050A-1050C at FIGS. 14A-14B) (e.g., a first visual (and/or spatial) pattern and/or arrangement); and the second group of widgets (e.g., 1010, 1012, and 1050D and/or arrangement of 1010, 1012, and 1050A-1050C at FIGS. 14A-14B) in a second pattern (e.g., arrangement of 1010, 1012, and 1050D and/or 1010, 1012, and 1050A-1050C at FIGS. 14A-14B) (e.g., a second visual (and/or spatial) pattern and/or arrangement). In some embodiments, displaying the set of two or more widgets in the second widget spatial arrangement includes displaying: the first group of widgets in the first pattern; and the second group of widgets in the second pattern. In some embodiments, displaying the set of two or more widgets in the third widget spatial arrangement includes displaying: the first group of widgets in the first pattern and the second group of widgets in the second pattern. Displaying the first group of widgets in the first pattern and the second group of widgets in the second pattern in different spatial arrangements enables the computer system (e.g., 600) to maintain displaying widgets arranged in a custom and/or organized manner, thereby reducing the number of inputs needed to perform an operation, providing additional control options without cluttering the user interface with additional displayed controls, and providing improved visual feedback to the user.

In some embodiments, displaying the set of two or more widgets (e.g., 1040, 1042, 1044, and/or 1046) in the first widget spatial arrangement (e.g., arrangement of 1012, 1010, 1016, 1048A, 1050D, 1050A, 1050C and/or 1072 within 1040, 1044, and/or 1046 at FIGS. 14C-14J) includes displaying the first group of widgets (e.g., 1010, 1012, and 1050D and/or 1010, 1012, and 1050A-1050C at FIGS. 14A-14B) in a third pattern (e.g., arrangement of 1010, 1012, and 1050D and/or arrangement of 1010, 1012, and 1050A-1050C at FIGS. 14A-14B). In some embodiments, displaying the set of two or more widgets in the first widget spatial arrangement includes displaying the second group of widgets in a fourth pattern. In some embodiments, computer system 600 displays the set of two or more widgets in the second widget spatial arrangement includes (e.g., arrangement of 1012, 1010, 1016, 1048A, 1050D, 1050A, 1050C and/or 1072 within 1040, 1044, and/or 1046 at FIGS. 14C-14J). In some embodiments, in accordance with a determination that the third pattern satisfies a space constraint (e.g., bounds of 1402, 1406, 1408, and/or 1410 at FIGS. 14C-14J) in the second widget spatial arrangement, displaying the first group of widgets in the third pattern (e.g., as shown in 1402 at FIG. 14C) (e.g., a determination that the third pattern fits between bounds of the user interface despite the display area being reduced by a reduction in spatial bounds, so the third pattern is displayed (e.g., without being rearranged into a new pattern) in the second widget arrangement). In some embodiments, in accordance with a determination that the third pattern does not satisfy a space constraint in the second widget spatial arrangement (e.g., a determination that the third pattern does not fit between bounds of the user interface due to the display area being reduced by a reduction in spatial bounds), displaying the first group of widgets in a fifth pattern (e.g., as shown in 1406 at FIG. 14C) different from the third pattern (e.g., the fifth pattern being a rearrangement of the third pattern, but including the same widgets). In some embodiments, displaying the set of two or more widgets in the second widget spatial arrangement includes: in accordance with a determination that the fourth pattern satisfies a space constraint in the second widget spatial arrangement, displaying the second group of widgets in the fourth pattern (e.g., a determination that the fourth pattern fits between bounds of the user interface despite the display area being reduced by a reduction in spatial bounds, so the fourth pattern is displayed (e.g., without being rearranged into a new pattern) in the second widget arrangement). In some embodiments, displaying the set of two or more widgets in the second widget spatial arrangement includes: in accordance with a determination that the fourth pattern does not satisfy a space constraint in the second widget spatial arrangement (e.g., a determination that the fourth pattern does not fit between bounds of the user interface due to the display area being reduced by a reduction in spatial bounds), displaying the second group of widgets in a sixth pattern different from the fourth pattern (e.g., the sixth pattern being a rearrangement of the fourth pattern, but including the same widgets). In some embodiments, displaying the set of two or more widgets in the third widget spatial arrangement includes: in accordance with a determination that the third pattern satisfies a space constraint in the third widget spatial arrangement, displaying the first group of widgets in the third pattern; in accordance with a determination that the third pattern does not satisfy a space constraint in the third widget spatial arrangement, displaying the first group of widgets in the fifth pattern (e.g., or in a different pattern); in accordance with a determination that the fourth pattern satisfies a space constraint in the third widget spatial arrangement, displaying the second group of widgets in the fourth pattern; and in accordance with a determination that the fourth pattern does not satisfy a space constraint in the third widget spatial arrangement, displaying the second group of widgets in the sixth pattern different from the fourth pattern (e.g., or in a different pattern). Displaying the first group of widgets in different patterns and the second group of widgets in different patterns in different spatial arrangements depending on a space constraints enables the computer system (e.g., 600) to maintain displaying widgets arranged in a custom and/or organized manner, thereby reducing the number of inputs needed to perform an operation, providing additional control options without cluttering the user interface with additional displayed controls, and providing improved visual feedback to the user.

In some embodiments, displaying the first group of widgets (e.g., 1010, 1012, and 1050D and/or 1010, 1012, and 1050A-1050C at FIGS. 14A-14B) in the fifth pattern comprises (e.g., arrangement of 1010, 1012, and 1050D and/or arrangement of 1010, 1012, and 1050A-1050C at FIGS. 14A-14B) displaying at least one widget at a different location (e.g., after and/or while moving the at least one widget) (e.g., of a user interface and/or a display generation component) in the fifth pattern than in the third pattern (e.g., rearranging the widgets in the third pattern includes moving a widget to form the fifth pattern (e.g., changing the widget to a different snapping location corresponding to another widget in the first group)). In some embodiments, the at least one widget is selected to be displayed at the different location based on how recently the one or more widget was placed (e.g., as discussed above at FIG. 14J) (e.g., due to user input and/or another event for causing the widget to be placed (e.g., at the corresponding location of the third pattern)) (e.g., the widget that was rearranged to form the fifth pattern (from the third pattern) is selected to be moved (e.g., instead of one or more other widgets) based on how recently it was placed).

In some embodiments, the at least one widget is selected to be displayed at the different location based on being the least recently placed. (e.g., as discussed above at FIG. 14J) (e.g., due to user input and/or another event for causing the widget to be placed (e.g., at the corresponding location of the third pattern)) (e.g., the widget that was rearranged to form the fifth pattern (from the third pattern) is selected to be moved (e.g., instead of one or more other widgets) based on being the least recently placed (e.g., with respect to the other widgets in the first group)) (e.g., if two or more widgets (e.g., that cause the pattern to violate the spatial constraint) need to be moved, they can be moved one at a time based on how recently they were placed (e.g., move the least recently placed widget first, then move the next least recently placed widget with respect to the pattern as modified by the least recently placed widget having moved), which continues until the first group of widgets forms a pattern that satisfies the spatial constraints).

In some embodiments, the different location is a closest (e.g., based on a set of measurement criteria) available (e.g., unobstructed, unoccupied (e.g., by another widget and/or other user interface element that is not configured to move in response to widget snapping), and/or permitted by a configuration setting) snapping location (e.g., as discussed above at 14A) (e.g., such as described above with respect to method 400) to the at least one widget (e.g., the widget that was rearranged to form the fifth pattern (from the third pattern) is moved to the closest available snapping (e.g., corresponding to another widget in the first group)) (e.g., if more than one widget is moved, the widgets are moved to their respective closest available snapping locations) (e.g., if more than one widget is moved, the moving can be performed sequentially (e.g., one at a time until the space constraint is satisfied)) (e.g., one or more widgets (e.g., that cause the pattern to violate the spatial constraint) are moved to a respective closest snapping locations, then if the spatial constraint is not satisfied, then one or more widgets (e.g., the same or different than the first move) are moved to respective closest snapping locations, which continues until the first group of widgets forms a pattern that satisfies the spatial constraints (e.g., are within the bounds of the user interface and/or are not overlapping other user interface objects (e.g., other widgets))).

In some embodiments, before displaying the set of two or more widgets (e.g., 1040, 1042, 1044, and/or 1046) in the second widget spatial arrangement (e.g., arrangement of 1012, 1010, 1016, 1048A, 1050D, 1050A, 1050C and/or 1072 within 1040, 1044, and/or 1046 at FIGS. 14C-14J) and in accordance with a determination that a snapping location (e.g., as discussed above at 14A) based on a widget of the first group of widgets (e.g., 1010, 1012, and 1050D and/or 1010, 1012, and 1050A-1050C at FIGS. 14A-14B) is available, wherein the closest available snapping location is a first snapping location (e.g., as discussed above at 14A) (e.g., such as described above with respect to method 400) based on a widget of the first group of widgets, the computer system (e.g., 600) moves the one or more widgets to the first snapping location and maintaining the at least one widget in the first group of widgets (e.g., not ungrouping the at least one widget in the first group of widgets) (e.g., keeping a widget in the first group of widgets by preferentially moving it to an available snapping location that is based on a widget of the first group of widgets, if available (e.g., even if the closest snapping location corresponds to a widget that is not in the first group of widgets)). In some embodiments, before displaying the set of two or more widgets (e.g., 1040, 1042, 1044, and/or 1046) in the second widget spatial arrangement (e.g., arrangement of 1012, 1010, 1016, 1048A, 1050D, 1050A, 1050C and/or 1072 within 1040, 1044, and/or 1046 at FIGS. 14C-14J) and in accordance with a determination that a snapping location based on a widget of the first group of widgets is not available, wherein the closest available snapping location is a second snapping location based on a widget (e.g., 1428 at FIG. 14J) that is not part of the first group of widgets (e.g., 1454 at FIG. 14J) (e.g., is part of a respective group of widgets different from the first group of widgets), the computer system moves the one or more widgets to the second snapping location and removing the one or more widgets from the first group of widgets (e.g., as shown by widget 1016 at FIG. 14J) (e.g., and adding the one or more widget to the respective group of widgets different from the first group of widgets) (e.g., removing a widget from the first group of widgets if there is no available snapping location that is based on a widget of the first group of widgets, and snapping the widget to a location not based on a widget of the first group of widgets (e.g., to a snapping location based on a widget in a different group of widgets)). In some examples, removing a widget from a group of widgets includes removing the widget from being a member of that group, including deleting relationships between that widget and the group (e.g., layout, spacing, and/or snapping).

In some embodiments, displaying the set of two or more widgets (e.g., 1040, 1042, 1044, and/or 1046) in the second widget spatial arrangement (e.g., arrangement of 1012, 1010, 1016, 1048A, 1050D, 1050A, 1050C and/or 1072 within 1040, 1044, and/or 1046 at FIGS. 14C-14J) includes: in accordance with a determination that the second set of one or more spatial bounds satisfies a set of one or more space criteria (e.g., top of FIG. 14H) (e.g., bounds of 1402, 1406, 1408, and/or 1410 at FIGS. 14C-14J) (e.g., including a criterion satisfied when the second set of one or more spatial bounds defines an area that can support the two or more widgets displayed in a manner that satisfies a set of one or more placement criteria (e.g., no overlapping widgets and/or no overlapping with certain user interface objects)), displaying the set of two or more widgets in the second widget spatial arrangement that does not include at least one widget of the set of two or more widgets displayed in an overflow region (e.g., 1028 in FIG. 14H) (e.g., if there is enough space within the one or more spatial bounds, widgets are arranged on the widget canvas). In some embodiments, an overflow region is a user interface element that includes one or more widgets that are not be placed in response to a changing of spatial bounds. In some embodiments, widgets are not placed due to one or more of spatial constraints and/or one or more configuration settings corresponding to widget placement, grouping, and/or snapping. In some embodiments, displaying the set of two or more widgets (e.g., 1040, 1042, 1044, and/or 1046) in the second widget spatial arrangement (e.g., arrangement of 1012, 1010, 1016, 1048A, 1050D, 1050A, 1050C and/or 1072 within 1040, 1044, and/or 1046 at FIGS. 14C-14J) includes: in accordance with a determination that the second set of one or more spatial bounds does not satisfy the set of one or more space criteria (e.g., bottom of FIG. 14H) (e.g., the second set of one or more spatial bounds defines an area that cannot support the two or more widgets displayed in a manner that satisfies the set of one or more placement criteria), the computer system (e.g., 600) displays the set of two or more widgets in the second widget spatial arrangement that includes at least one widget of the set of two or more widgets displayed in the overflow region (e.g., if there is not enough space within the one or more spatial bounds to display one or more widgets on the widget canvas, those widgets are displayed in an overflow region (e.g., were they can be brought to the attention of a user, for example, to prompt input that causes one or more widgets to be manually arranged, removed, and/or organized)). Displaying at least one widget of the set of two or more widgets in an overflow region based on whether spatial bounds satisfy the set of one or more space criteria enables the computer system to display widgets in a relevant arrangement in a dynamic manner and indicate to a user when a set of space-related criteria is not met, thereby performing an operation when a set of conditions has been met without requiring further user input, reducing the number of inputs needed to perform an operation, and providing improved visual feedback to the user.

In some embodiments, in accordance with a determination that the at least one widget of the set of two or more widgets (e.g., 1040, 1042, 1044, and/or 1046) displayed in the overflow region includes a plurality of widgets (e.g., 1016, 1072, 1048A, and/or 1012 at FIG. 14H), displaying the plurality of widgets in an overlapping manner (e.g., widgets in the overflow region are displayed visually as a stack of widgets, for example, where at least a portion of each widget in the stack is visible) (e.g., at least one widget overlapping one or more other widgets). In some embodiments, displaying the plurality of widgets in an overlapping manner includes displaying the plurality of widgets over a portion of the user interface and/or other user interface elements of the user interface (e.g., covering one or more other widgets and/or icons). In some embodiments, displaying the plurality of widgets in an overlapping manner includes displaying a border for the plurality of widgets displayed in the overlapping banner (e.g., a border and/or a region/box with a border). In some embodiments, displaying the plurality of widgets in an overlapping manner includes displaying an indication that there is not enough space on the user interface to place the widgets (e.g., automatically).

In some embodiments, while displaying the set of two or more widgets (e.g., 1040, 1042, 1044, and/or 1046) in the second widget spatial arrangement (e.g., arrangement of 1012, 1010, 1016, 1048A, 1050D, 1050A, 1050C and/or 1072 within 1040, 1044, and/or 1046 at FIGS. 14C-14J), the computer system (e.g., 600) detects a request (e.g., input such as a tap input or a drag input) to rearrange (e.g., one or more widgets) the set of two or more widgets into an eighth widget spatial arrangement (e.g., arrangement of 1012, 1010, 1016, 1048A, 1050D, 1050A, 1050C and/or 1072 within 1040, 1044, and/or 1046 at FIGS. 14C-14J) different from the second widget spatial arrangement. In some embodiments, in response to detecting the request to rearrange the set of two or more widgets into the eighth widget spatial arrangement, the computer system displays, via the display generation component, the set of two or more widgets in the eighth widget spatial arrangement (e.g., perform the request). In some embodiments, after displaying the set of two or more widgets in the eighth widget spatial arrangement in response to the request to rearrange the set of two or more widgets (e.g., after performing the request) and while displaying the set of two or more widgets in a widget display area with a fourth respective set of one or more spatial bounds (e.g., bounds of 1402, 1406, 1408, and/or 1410 at FIGS. 14C-14J) (e.g., at a visual resolution having a vertical dimension and a horizontal dimension) different from the second set of one or more spatial bounds and while displaying the set of two or more widgets in a third respective widget spatial arrangement (e.g., arranged as one or more particular groups and/or as individual widgets and/or arranged in one or more visual and/or spatial patterns with respect to the user interface (e.g., widget canvas)) different from the eighth widget spatial arrangement, the computer system detects a request to display the set of two or more widgets in a widget display area with a fifth respective set of one or more spatial bounds (e.g., bounds of 1402, 1406, 1408, and/or 1410 at FIGS. 14C-14J) (e.g., a request to change to a different visual resolution having a different vertical dimension and a different horizontal dimension). In some embodiments, after displaying the set of two or more widgets in the eighth widget spatial arrangement in response to the request to rearrange the set of two or more widgets and in response to detecting the request to display the set of two or more widgets in a widget display area with the fifth respective set of one or more spatial bounds and in accordance with a determination that the fifth respective set of one or more spatial bounds is (e.g., is the same as) the second set of one or more spatial bounds (e.g., a request to change back to the visual resolution setting defined by the second set of one or more spatial bounds), the computer system displays, via the display generation component, the set of two or more widgets in the eighth widget spatial arrangement (e.g., as discussed above at FIGS. 14E and/or 14F) (e.g., the computer system remembers the eighth widget spatial arrangement (e.g., created in response to the request) from a previous time (e.g., most recent time) that the set of two or more widgets were displayed in a display area having the second set of one or more spatial bounds, and redisplays the set of two or more widgets in the eighth widget spatial arrangement in response to a subsequent request to display the set of two or more widgets in a widget display area that includes the second set of one or more spatial bounds) (e.g., if widgets are rearranged into a particular widget spatial arrangement for (e.g., while in and/or at) a particular set of one or more spatial bounds, the computer system remembers and uses that particular arrangement when the widgets are displayed within the particular set of one or more spatial bounds again). Redisplaying the set of two or more widgets in the eighth widget spatial arrangement after a request to rearrange the widgets into the eighth widget spatial arrangement at the same set of one or more spatial bounds enables the computer system to display widgets in a relevant arrangement in a dynamic manner, thereby performing an operation when a set of conditions has been met without requiring further user input, reducing the number of inputs needed to perform an operation, and providing improved visual feedback to the user.

In some embodiments, in response to detecting the request to display the set of two or more widgets (e.g., 1040, 1042, 1044, and/or 1046) in a widget display area with the fifth respective set of one or more spatial bounds (e.g., bounds of 1402, 1406, 1408, and/or 1410 at FIGS. 14C-14J), wherein the fifth respective set of one or more spatial bounds is different from the second set of one or more spatial bounds (e.g., bounds of 1402, 1406, 1408, and/or 1410 at FIGS. 14C-14J) and from the third set of one or more spatial bounds (e.g., bounds of 1402, 1406, 1408, and/or 1410 at FIGS. 14C-14J) and in accordance with a determination that the fifth respective set of one or more spatial bounds is closer to the second set of one or more spatial bounds than to the third set of one or more spatial bounds according to a respective measure (e.g., a series of values of a spatial bound, such as width), the computer system (e.g., 600) displays, via the display generation component, the set of two or more widgets in the eighth widget spatial arrangement (e.g., as discussed above at FIGS. 14E and/or 14F) (e.g., if widgets are rearranged into a particular widget spatial arrangement for (e.g., while in and/or at) a particular set of one or more spatial bounds, the computer system remembers and applies that particular arrangement when the widgets are displayed within a different set of one or more spatial bounds that is close to the particular set of one or more spatial bounds (e.g., a similar resolution but slightly larger)) (e.g., if multiple widget spatial arrangements are remembered for (e.g., stored and/or configured to correspond to) different sets of one or more spatial bounds, the widget spatial arrangement corresponding to the closest other set of one or more spatial bounds can be used for a current set of one or more spatial bounds). In some embodiments, the respective measure is a measure of spatial bounds (e.g., length and/or width). In some embodiments, closeness of spatial bounds is based on a distance between spatial bounds (e.g., a spatial bound with a value of 100 is separated by 200 to a spatial bound with a value of 300, and separated by 50 to a spatial bound with a value of 50 (e.g., and so the spatial bound with a value of 100 can be considered closer to the spatial bound with a value of 50, according to this measure, than to the spatial bound with a value of 300)). Displaying the set of two or more widgets in the eighth widget spatial arrangement based on closeness of a current set of one or more spatial bounds to a different set of one or more spatial bounds enables the computer system to display widgets in a relevant arrangement in a dynamic manner, thereby performing an operation when a set of conditions has been met without requiring further user input, reducing the number of inputs needed to perform an operation, and providing improved visual feedback to the user.

In some embodiments, in response to detecting the request to display the set of two or more widgets (e.g., 1040, 1042, 1044, and/or 1046) in a widget display area (e.g., 1402, 1406, 1408, and/or 1410) with the fifth respective set of one or more spatial bounds (e.g., bounds of 1402, 1406, 1408, and/or 1410 at FIGS. 14C-14J), wherein the fifth respective set of one or more spatial bounds is the third set of one or more spatial bounds (e.g., bounds of 1402, 1406, 1408, and/or 1410 at FIGS. 14C-14J) and in accordance with a determination that the request to rearrange the set of two or more widgets into the eighth widget spatial arrangement (e.g., arrangement of 1012, 1010, 1016, 1048A, 1050D, 1050A, 1050C and/or 1072 within 1040, 1044, and/or 1046 at FIGS. 14C-14J) causes at least a threshold amount of (e.g., number of and/or magnitude of) changes (e.g., number of widgets added and/or number of widgets removed, for example, from the spatial arrangement and/or from one or more groups within the spatial arrangement) to rearrange the set of two or more widgets into the eighth widget spatial arrangement (e.g., as discussed above at FIGS. 14E and/or 14F), the computer system (e.g., 600) displays, via the display generation component, the set of two or more widgets in the eighth widget spatial arrangement (e.g., the amount of changes made by the request to form the eighth widget spatial arrangement caused a reset of the default arrangement for multiple (e.g., some or all) different sets of one or more spatial bounds). In some embodiments, in response to detecting the request to display the set of two or more widgets (e.g., 1040, 1042, 1044, and/or 1046) in a widget display area (e.g., 1402, 1406, 1408, and/or 1410) with the fifth respective set of one or more spatial bounds (e.g., bounds of 1402, 1406, 1408, and/or 1410 at FIGS. 14C-14J), wherein the fifth respective set of one or more spatial bounds is the third set of one or more spatial bounds (e.g., bounds of 1402, 1406, 1408, and/or 1410 at FIGS. 14C-14J) and in accordance with a determination that the request to rearrange the set of two or more widgets into the eighth widget spatial arrangement does not cause the threshold amount of (e.g., number of and/or magnitude of) changes to rearrange the set of two or more widgets into the eighth widget spatial arrangement, the computer system (e.g., 600) displays, via the display generation component, the set of two or more widgets in the third widget spatial arrangement (e.g., the amount of changes made by the request to form the eighth widget spatial arrangement did not cause a reset of the default arrangement for multiple (e.g., some or all) different sets of one or more spatial bounds). In some embodiments, in response to detecting the request to rearrange the set of two or more widgets into an eighth widget spatial arrangement, the computer system configures the eighth widget spatial arrangement to correspond to a plurality of sets of one or more spatial bounds (e.g., sets the eighth widget spatial arrangement to be the default arrangement for all sets of spatial bounds configured to be used by the computer system). Displaying the set of two or more widgets in the eighth widget spatial arrangement based on whether the request to rearrange the widgets into the eighth widget spatial arrangement at a different set of one or more spatial bounds caused a threshold amount of changes enables the computer system to display widgets in a relevant arrangement in a dynamic manner, thereby performing an operation when a set of conditions has been met without requiring further user input, reducing the number of inputs needed to perform an operation, and providing improved visual feedback to the user.

In some embodiments, in response to detecting the request to rearrange the set of two or more widgets (e.g., 1040, 1042, 1044, and/or 1046) into the eighth widget spatial arrangement (e.g., arrangement of 1012, 1010, 1016, 1048A, 1050D, 1050A, 1050C and/or 1072 within 1040, 1044, and/or 1046 at FIGS. 14C-14J) and in accordance with a determination that the request to rearrange the set of two or more widgets into the eighth widget spatial arrangement causes at least the threshold amount of (e.g., number of and/or magnitude of) changes (e.g., number of widgets added and/or number of widgets removed, for example, from the spatial arrangement and/or from one or more groups within the spatial arrangement) to rearrange the set of two or more widgets into the eighth widget spatial arrangement, the computer system (e.g., 600) sets the eighth widget spatial arrangement (e.g., a current widget spatial arrangement) to correspond to a plurality of sets of spatial bounds (e.g., the amount of changes made by the request to form the eighth widget spatial arrangement caused a reset (to the then-current eight widget spatial arrangement) of the default arrangement for multiple different sets of one or more spatial bounds (e.g., whether they are closest to the current set of one or more one or more spatial bounds or not)) (e.g., be a default widget spatial arrangement for all and/or more than one sets of one or more spatial bounds), wherein the plurality of sets of spatial bounds includes the first set of one or more spatial bounds, the second set of one or more spatial bounds, and the third set of one or more spatial bounds. In some embodiments, the plurality of sets of spatial bounds includes any and/or all set of spatial bounds the computer system supports (e.g., is, can be, and/or will be configured to use).

Note that details of the processes described above with respect to method 1500 (e.g., FIG. 15) are also applicable in an analogous manner to other methods described herein, such as methods 700, 900, 1100, 1200, 1300, 1700, and/or 1900. For example, method 1700 optionally includes one or more of the characteristics of the various methods described above with reference to method 1500. For example, a request to change spatial bounds of a display area can include changing a set of display generations in communication with a device. For brevity, these details are not repeated below.

FIGS. 16A-16E illustrate exemplary user interfaces and scenarios for arranging widgets on multiple desktop interfaces, in accordance with some embodiments. The user interfaces in these figures are used to illustrate the processes described below, including the processes in FIG. 15.

FIG. 16A illustrates an exemplary first scenario with computer system 600 (e.g., labeled as device A) that includes a display 602. Device A is connected to device B (e.g., display generation component 1604) and device C (e.g., display generation component 1606). Device B is an external display (e.g., display generation component 1604) and includes display 1604A. Device C is an external display (e.g., display generation component 1606) and includes display 1606A. Throughout FIGS. 16A-16E, these three devices can be in different locations relative to one another in physical space. These device labels (e.g., A, B, and C) correspond to the same device in each of FIGS. 16A-16E and are included as a visual aid for easily determining where each device is placed in physical space for each figure. Additionally, the device labels correspond to representations of each device within settings user interface 1610 (e.g., described below), which illustrates a configured arrangement of the displays (e.g., an arrangement stored by device A that is intended to (e.g., but does not necessarily) represent the physical arrangement of devices A, B, and C in physical space).

As illustrated in FIG. 16A, device A (e.g., computer system 600) displays a first desktop user interface that includes three widgets (e.g., 1012, 1010, and 1050D, as described with respect to FIGS. 10A-10AT) arranged as an island within widget arrangement 1608 (e.g., of widgets, as described above). The first desktop user interface is labeled desktop 0 as shown in its bottom right corner. Also illustrated in FIG. 16A, device C displays a second desktop user interface that includes three widgets (e.g., 1050A, 1050C, and 1048A, as described with respect to FIGS. 10A-10AT) arranged as a single widget and a two-widget island in widget arrangement 1612. The second desktop user interface is labeled desktop 1 as shown in its bottom right corner. Also illustrated in FIG. 16A, device B displays a third desktop user interface that includes five widgets (e.g., 1016, 1072, 1426, 1428, and 1018, as described with respect to FIGS. 10A-10AT and 14A-14J) arranged as a three-widget island and a two-widget island in widget arrangement 1610. The third desktop user interface is labeled desktop 2 as shown in its bottom right corner. These desktop labels (0, 1, and 2) correspond to the same desktop user interface (e.g., and its corresponding set of widgets) in each of FIGS. 16A-16E and are included as a visual aid for easily determining where (on which device) different desktop user interfaces are displayed in each figure.

FIG. 16A also illustrates settings user interface 1610, which is an exemplary user interface for viewing and/or changing a configured arrangement of a set of displays (e.g., that are connected to device A and available to be used for outputting a desktop user interface). As can be seen in FIG. 16A, settings user interface 1610 illustrates the configured arrangement of the displays that is stored by device A. As can be seen in settings user interface 1610, device A is the device furthest to the left and slightly lower, device B is in the middle and higher than device A, and device C is furthest to the right and even with device B. In this embodiments, the configured arrangement of devices A, B, and C matches their actual physical placement (e.g., as illustrated in FIG. 16A above settings user interface 1610).

At FIG. 16A, in addition to the configured arrangement of displays, computer system 600 determines which desktop user interface to display on which display according to one or more policies. In some embodiments, a policy can configure computer system 600 to display desktop user interfaces based on one or more priorities associated with the connected set of display generation components. For example, a policy can require that desktop 0 be displayed on a primary (e.g., highest priority display, in the case of a priority ordering of descending priorities) display generation component. In this embodiments, desktop 0 is a main desktop user interface (e.g., where applications are initially displayed after being launched). As can be seen in FIG. 16A, desktop 0 is displayed via device A, which is designated the highest priority display (e.g., or display generation component). In some embodiments, the highest priority display is a built-in display (e.g., a display that is part of a computer system selecting and causing display of desktop user interfaces on displays). For example, in FIG. 16A desktop 0 is displayed on built-in display 602 of computer system 600 due to the policy designating that a particular desktop (e.g., a first desktop in a list, such as desktop 0, and/or a main desktop) be displayed on the highest priority display. In some embodiments, desktop 0 is always first on a list of available desktops to display.

In some embodiments, a policy can configure computer system 600 to display desktop user interfaces based on a display order of display generation components (e.g., and/or their corresponding display). For example, a policy can configure device A to select a display generation for one or more display desktop user interfaces based on an ordering of devices A, B, and/or C. For example, a desktop interface can be selected for a display generation component based on a right-to-left ordering (e.g., begin by assigning the first desktop user interface to the display generation component that is furthest to the right in a configured arrangement, and move to the left) or a left-to-right ordering (e.g., begin by assigning the first desktop user interface to the display generation component that is furthest to the left in a configured arrangement, and move to the right). Similarly, ordering can be bottom-to-top, top-to-bottom, or any other ordering, convention, and/or direction (e.g., clockwise or counterclockwise).

In some embodiments, one or more policies can be used to assign desktop interfaces to display generation components. In the example at FIG. 16A, desktop interfaces 0, 1, and 2 are selected based on multiple policies: that desktop 0 should be displayed on a primary display and that the (e.g., remaining) desktops should be displayed from right to left with respect to the configured arrangement. As illustrated in FIG. 16A, desktop 0 is displayed on display 602 of computer system 600 (e.g., the primary display) subject to the first policy (e.g., and despite being the furthest display to the left) and the remaining desktops 1 and 2 are assigned to respective devices C and B (e.g., in that order) in satisfaction of the second policy that assigns from right to left in the configured arrangement.

FIG. 16B illustrates devices A, B, and C in a different physical arrangement in physical space as compared to FIG. 16A. In FIG. 16B, device B and device C have swapped physical positions-now device B is furthest to the right and device C is in the middle. Despite device B and device C switching places, the configured arrangement shown in settings user interface 1610 has not been updated. In this embodiment, the current physical arrangement of the three display devices has not yet been provided to (e.g., received by, entered into and/or otherwise configured within) settings user interface 1610 and/or device A (e.g., computer system 600). Because a change to the configured arrangement has not been made to reflect the change in physical arrangement of the display generation components, device A has not changed which desktop user interface is displayed on which display. That is, device A continues to display desktop 0 (e.g., due to being the primary display), device C continues to display desktop 1 (e.g., due to be configured as the furthest to the right using the right-to-left ordering of desktops), and device B continues to display desktop 2 (e.g., due to be configured as the next furthest to the right using the right-to-left ordering of desktops), as compared to FIG. 16A.

In some embodiments, a computer system receives the current arrangement via user input. In some embodiments, a computer system receives the current arrangement via a data source (e.g., another application and/or device). In some embodiments, a computer system receives and/or detects the current arrangement automatically (e.g., one or more devices detects the relative or absolute positioning of one or more of the display components and reports it to computer system 600 and/or settings user interface 1610).

FIG. 16C illustrates devices A, B, and C in the same physical arrangement in physical space as compared to FIG. 16B, but the configured arrangement shown in settings user interface 1610 has been updated. In this embodiment, the current physical arrangement of the three display devices been provided to settings user interface 1610 and/or device A (e.g., computer system 600). Because a change to the configured arrangement has been made to reflect the change in physical arrangement of the display generation components, device A has changed which desktop user interface is displayed on which display. That is, device A continues to display desktop 0 (e.g., due to being the primary display), device B now displays desktop 1 (e.g., due to be configured as the furthest to the right using the right-to-left ordering of desktops), and device C now displays desktop 2 (e.g., due to be configured as the next furthest to the right using the right-to-left ordering of desktops), as compared to FIG. 16B.

FIG. 16D illustrates devices A, B, and C in a different physical arrangement in physical space as compared to FIG. 16C. In FIG. 16D, device A and device C have swapped physical positions-now device C is furthest to the left and device A is in the middle. In this embodiment, the current physical arrangement of the three display devices has been provided to settings user interface 1610 and/or device A (e.g., computer system 600). Because a change to the configured arrangement has been made to reflect the change in physical arrangement of the display generation components, device A selects desktops according to the current physical arrangement. In this embodiment, despite the change in physical and configured arrangement, the desktop displayed on each device has not changed. That is, device A continues to display desktop 0 (e.g., due to being the primary display) despite being the middle display, device B continues to display desktop 1 (e.g., due to be configured as the furthest to the right using the right-to-left ordering of desktops), and device C continues to display desktop 2 (e.g., due to be configured as the next furthest to the right using the right-to-left ordering of desktops), as compared to FIG. 16C.

FIG. 16E illustrates devices A, B, and C in the same physical arrangement in physical space as compared to FIG. 16A, but the lid of computer system 600 (e.g., a laptop computer in this example) has been closed and the built-in display disabled. Because the built-in display is disabled, the configured arrangement shown in settings user interface 1610 has been updated (e.g., automatically and/or via user input) to reflect this: settings user interface 1610 does not include a representation of device A because it is not available for displaying a desktop user interface. In this embodiment, the current physical arrangement of the connected display devices has been provided to settings user interface 1610 and/or device A (e.g., computer system 600). Because a change to the configured arrangement has been made to reflect the change in physical arrangement of the display generation components (e.g., the effective physical removal and/or disappearance of device A from the current physical arrangement), settings user interface 1610 displays a representation of device B on the left of a representation of device C. However, because the primary display 602 is no longer connected, device C has been designated the primary display. Therefore, despite the right-to-left policy still applying, device C now displays desktop 0 (e.g., due to being the new primary display) and device B now displays desktop 1. Notably, in this example, device B is the only remaining display (e.g., after applying policy of assigning the primary desktop to the primary display), so regardless of its configured arrangement with respect to device C in settings user interface 1610, device B would display desktop 1 (e.g., because once the primary display is selected to display desktop 0, there is only one remaining device (e.g., desktop B) on which to display using the right-to-left policy).

FIG. 17 is a flow diagram illustrating a method (e.g., method 1700) for arranging widgets with respect to sets of display generation components, in accordance with some embodiment. Some operations in method 1700 are, optionally, combined, the orders of some operations are, optionally, changed, and some operations are, optionally, omitted.

As described below, method 1700 provides an intuitive way for arranging widgets with respect to sets of display generation components. Method 1700 reduces the cognitive burden on a user for arranging widgets with respect to sets of display generation components, thereby creating a more efficient human-machine interface. For battery-operated computing devices, enabling a user to arrange widgets with respect to sets of display generation components faster and more efficiently conserves power and increases the time between battery charges.

In some embodiments, method 1700 is performed at a computer system. In some embodiments, the computer system (e.g., 600) is a laptop, a desktop, a watch, a phone, a tablet, a processor, a head-mounted display (HMD) device, and/or a personal computing device. In some embodiments, the computer system is in communication with one or more input devices (e.g., a physical input mechanism (e.g., a hardware input mechanism, a keyboard, a touch-sensitive surface with a display generation component, a touch-sensitive surface with or without a display generation component, a mouse, a pointing device, and/or a hardware button), a camera, a touch-sensitive display, and/or a microphone).

At 1702, while the computer system (e.g., 600) is in communication with a first set of (e.g., of one, two, three, or more) display generation components (e.g., 1602, 1604, and/or 1606) (e.g., a display screen and/or a touch-sensitive display) (e.g., internal display generation components (e.g., dedicated to, incorporated into, and/or part of the same housing and/or form factor as the computer system) and/or external display generation components (e.g., an external component such as a display, monitor, screen, light emitting device, television, and/or projector connected to the computer system)) corresponding to (e.g., configured in, assigned to, represented in the computer system as, detected as being in, ordered in, and/or placed in) a first display arrangement (e.g., arrangement of 1602, 1606, and/or 1604 within the display located at the bottom of FIGS. 16A-16E) (e.g., a representation of relative spatial positioning of the display generation components in the first set of display generation components, including one or more data representing location, orientation, placement, dimensions, and/or resolution of display generation components), wherein the first set of display generation components includes a first display generation component (e.g., 1602, 1604, and/or 1606 within the display arrangement FIGS. 16A-16E) and a second display generation component (e.g., 1602, 1604, and/or 1606 within the display arrangement FIGS. 16A-16E) different from the first display generation component (e.g., and/or includes a third display generation component different from the first display generation component and from the second display generation component), the computer system (e.g., 600) displays (at 1704), via the first display generation component of the first set of display generation components, a first set of one or more (e.g., of one, two, three, or more) widgets (e.g., 1608, 1610, and/or 1612) (e.g., in a first widget spatial arrangement (e.g., such as described above with respect to computer system 600)).

At 1702, while the computer system (e.g., 600) is in communication with a first set of (e.g., of one, two, three, or more) display generation components (e.g., 1602, 1604, and/or 1606) (e.g., a display screen and/or a touch-sensitive display) corresponding to a first display arrangement (e.g., arrangement of 1602, 1606, and/or 1604 within the display located at the bottom of FIGS. 16A-16E) (e.g., a representation of relative spatial positioning of the display generation components in the first set of display generation components, including one or more data representing location, orientation, placement, dimensions, and/or resolution of display generation components), wherein the first set of display generation components includes a first display generation component (e.g., 1602, 1604, and/or 1606 within the display arrangement FIGS. 16A-16E) and a second display generation component (e.g., 1602, 1604, and/or 1606 within the display arrangement FIGS. 16A-16E) different from the first display generation component (e.g., and/or includes a third display generation component different from the first display generation component and from the second display generation component), the computer system (e.g., 600) displays, via the second display generation component of the first set of display generation components, a second set of one or more (e.g., of one, two, three, or more) widgets (e.g., 1608, 1610, and/or 1612) (e.g., in a second widget spatial arrangement (e.g., such as described above with respect to computer system 600)), wherein the second set of one or more widgets is different from the first set of one or more widgets. In some embodiments, the first subset of widgets and the second subset of widgets do not include the same widgets (e.g., the first subset of widgets includes a mutually exclusive subset of widgets (from the set of widgets) as compared to the second subset of widgets). In some embodiments, the first set of one or more widgets and the second set of one or more widgets include one or more (e.g., some or all) of the same widgets (e.g., different instances and/or the same instances of the widget). In some embodiments, the first set of one or more widgets and the second set of one or more widgets include one or more of the same widgets but in a different arrangement (e.g., orientation, grouping, ordering, and/or relative placement to other widgets and/or bounds of a user interface). In some embodiments, the first set of one or more widgets corresponds to (e.g., is associated with, is configured with, and/or is a part of) a first discrete user interface screen (e.g., such as described above with respect to computer system 600) of a plurality of discrete user interface screens (e.g., desktop screens) that includes one or more widgets arranged in a relative arrangement (e.g., which is saved and reproduced with the discrete user interface screen is displayed) within (e.g., subject to, based on, affected by, bounded by, and/or according to) one or more spatial dimensions (e.g., such as described above with respect to computer system 600) of the display generation component that displays the first discrete user interface. In some embodiments, the second set of one or more widgets corresponds to a second discrete user interface screen (e.g., such as described above with respect to computer system 600) of the plurality of discrete user interface screens that includes one or more widgets arranged in a relative arrangement within one or more spatial dimensions (e.g., such as described above with respect to computer system 600) of the display generation component that displays the second discrete user interface. In some embodiments, one or more discrete user interfaces make up (e.g., define a and/or are included in) a widget spatial arrangement (e.g., first widget spatial arrangement and/or second widget spatial arrangement). In some embodiments, a widget spatial arrangement includes fewer than all, or does include all, discrete user interface screens corresponding to (e.g., that includes all of) a set of one or more widgets (e.g., the set of one or more widgets can be arranged over five different discrete user interface screens, but if only three display generation components are connected then it might be possible to display a maximum of fewer than five discrete user interfaces (e.g., only three, one per display)). In some embodiments, whether a discrete user interface screen is displayed by a display generation component as part of a widget spatial arrangement depends on a number of display generation components in communication with the computer system (e.g., if three display generation components are in communication with the computer system, then three discrete user interface screens are displayed, one a different display generation component; if a fourth display generation component is added to be in communication with the computer system, a fourth discrete user interface screen is displayed that includes a previously not displayed portion of the set of a widgets in a relative arrangement).

At 1708, after (and/or while) displaying the first set of one or more widgets and the second of the set of one or more widgets, the computer system detects an event (e.g., an input, instruction, and/or message) (e.g., corresponding to connection or disconnection of a display, to a reconfiguration of arrangement of displays in corresponding to setting and/or configuration, and/or to closing of a laptop lid) corresponding to a request to switch to a second set of (e.g., of one, two, three, or more) display generation components (e.g., 1602, 1604, and/or 1606) (e.g., the same as the first set of display generation components, different from the first set of display generation components, includes the first set of display generation components, and/or includes fewer than all of the first set of display generation components) corresponding to (e.g., configured in, assigned to, represented in the computer system as, detected as being in, ordered in, and/or placed in) a second display arrangement (e.g., arrangement of 1602, 1606, and/or 1604 within the display located at the bottom of FIGS. 16A-16E) (e.g., a representation of relative spatial positioning of the display generation components in the second set of display generation components, including one or more data representing location, orientation, placement, dimensions, and/or resolution of display generation components) different from the first display arrangement, wherein the second set of display generation components includes a third display generation component (e.g., 1602, 1604, and/or 1606 within the display arrangement FIGS. 16A-16E) and a fourth display generation component different from the third display generation component (e.g., 1602, 1604, and/or 1606 within the display arrangement FIGS. 16A-16E) (e.g., and/or includes a fifth display generation component different from the third display generation component and from the fourth display generation component). In some embodiments, the second set of display generation components includes some or all of the first set of display generation components. In some embodiments, the first set of display generation components includes some or all of the second set of display generation components. In some embodiments, the third display generation component is the first display generation component or the second display generation component. In some embodiments, the fourth display generation component is the first display generation component or the second display generation component.

At 1710, in response to detecting the event (e.g., and while the computer system is in communication with the second set of display generation components configured in the second display arrangement): in accordance with a determination (at 1712) that the second display arrangement corresponds to a first display order (e.g., order of displays (e.g., A, B, and/or C) corresponding to display generation components 1602, 1604, and/or 1606 at FIGS. 16A-16E) (e.g., an order of the display generation components that are in the second display arrangement, represented in a configuration, setting, and/or data corresponding to the second display arrangement), the computer system (e.g., 600) displays (at 1714), via the third display generation component of the second set of display generation components, a third set of one or more (e.g., of one, two, three, or more) widgets (e.g., 1608, 1610, and/or 1612) that is based on the first set of one or more widgets (e.g., in a third widget spatial arrangement (e.g., such as described above with respect to computer system 600) that is based on a spatial arrangement of the first set of one or more widgets).

At 1710, in response to detecting the event (e.g., and while the computer system is in communication with the second set of display generation components configured in the second display arrangement): in accordance with a determination (at 1712) that the second display arrangement corresponds to a first display order (e.g., order of displays (e.g., A, B, and/or C) corresponding to display generation components 1602, 1604, and/or 1606 at FIGS. 16A-16E) (e.g., an order of the display generation components that are in the second display arrangement, represented in a configuration, setting, and/or data corresponding to the second display arrangement), the computer system (e.g., 600) displays (at 1716), via the fourth display generation component of the second set of display generation components, a fourth set of one or more (e.g., of one, two, three, or more) widgets (e.g., 1608, 1610, and/or 1612) that is based on the second set of one or more widgets (e.g., in a fourth widget spatial arrangement (e.g., such as described above with respect to computer system 600), that is based on a spatial arrangement of the second set of one or more widgets), wherein the fourth set of widgets is different from the third set of one or more widgets; and in some embodiments, the third set of one or more widgets (e.g., in a third widget spatial arrangement) and/or the fourth set of one or more widgets (e.g., in a fourth widget spatial arrangement) does not include all widgets displayed by the first set of display generation components while in the first display arrangement. In some embodiments, the third set of one or more widgets (e.g., in a third widget spatial arrangement) and/or the fourth set of one or more widgets (e.g., in a fourth widget spatial arrangement) include more and or the same widgets displayed by the first set of display generation components while in the first display arrangement (e.g., arranged on respective widget canvases in a same or different manner (e.g., orientation, relative spacing, and/or grouping) (e.g., a display arrangement with fewer display generation components includes fewer widgets than a display arrangement with more display generations components)). In some embodiments, the third set of one or more widgets corresponds to a third discrete user interface screen (e.g., such as described above with respect to computer system 600) of the plurality of discrete user interface screens that includes one or more widgets arranged in a relative arrangement within one or more spatial dimensions (e.g., such as described above with respect to computer system 600) of the display generation component that displays the third discrete user interface. In some embodiments, the fourth set of one or more widgets corresponds to a fourth discrete user interface screen (e.g., such as described above with respect to computer system 600) of the plurality of discrete user interface screens that includes one or more widgets arranged in a relative arrangement within one or more spatial dimensions (e.g., such as described above with respect to computer system 600) of the display generation component that displays the fourth discrete user interface.

At 1710, in response to detecting the event (e.g., and while the computer system is in communication with the second set of display generation components configured in the second display arrangement): in accordance with a determination (at 1718) that the second display arrangement corresponds to a second display order (e.g., order of displays (e.g., A, B, and/or C) corresponding to display generation components 1602, 1604, and/or 1606 at FIGS. 16A-16E) (e.g., an order of the display generation components that are in the second display arrangement, represented in a configuration, setting, and/or data corresponding to the second display arrangement) different from the first display order, the computer system (e.g., 600) displays (at 1720), via the third display generation component of the second set of display generation components, the fourth set of one or more (e.g., of one, two, three, or more) widgets that is based on the second set of one or more widgets (e.g., in a fourth widget spatial arrangement (e.g., such as described above with respect to computer system 600), in the first widget spatial arrangement, or in the second widget spatial arrangement).

At 1710, in response to detecting the event (e.g., and while the computer system is in communication with the second set of display generation components configured in the second display arrangement): in accordance with a determination (at 1718) that the second display arrangement corresponds to a second display order (e.g., order of displays (e.g., A, B, and/or C) corresponding to display generation components 1602, 1604, and/or 1606 at FIGS. 16A-16E) (e.g., an order of the display generation components that are in the second display arrangement, represented in a configuration, setting, and/or data corresponding to the second display arrangement) different from the first display order: the computer system (e.g., 600) displays (at 1722), via the fourth display generation component of the second set of display generation components, the third set of one or more (e.g., of one, two, three, or more) widgets that is based on the first set of one or more widgets (e.g., in a third widget spatial arrangement (e.g., such as described above with respect to computer system 600), in the first widget spatial arrangement, or in the second widget spatial arrangement). In some embodiments, in accordance with a determination that the second display arrangement corresponds to the second display order, the computer system displays, via the third display generation component of the second set of display generation components, a fifth set of one or more (e.g., of one, two, three, or more) widgets (e.g., in a fifth widget spatial arrangement (e.g., such as described above with respect to computer system 600), in the first widget spatial arrangement, in the second widget spatial arrangement, third widget spatial arrangement, or fourth widget spatial arrangement), and displays, via the fourth display generation component of the second set of display generation components, a sixth set of one or more (e.g., of one, two, three, or more) widgets (e.g., in a sixth widget spatial arrangement (e.g., such as described above with respect to computer system 600), in the first widget spatial arrangement, in the second widget spatial arrangement, third widget spatial arrangement, or fourth widget spatial arrangement). In some embodiments, the sixth set of widgets is different from the fifth set of widgets. In some embodiments, the fifth set of widgets is different from the third set of widgets and/or the fourth set of widgets. In some embodiments, the sixth set of widgets is different from the third set of widgets and/or the fourth set of widgets.

Displaying the third set of one or more widgets and the fourth set of one or more widgets on the third display generation component or the fourth display generation component based on whether the second display arrangement corresponds to the first display order or the second display order enables the computer system to display widgets in a relevant arrangement in a dynamic manner with respect to different display generation components, thereby performing an operation when a set of conditions has been met without requiring further user input, reducing the number of inputs needed to perform an operation, and providing improved visual feedback to the user.

In some embodiments, a representation of a (e.g., the first and/or a second) display arrangement is displayed by a display generation component in communication with the computer system. In some embodiments, the representation of the display arrangement is displayed in a settings user interface for configuring (e.g., editing, modifying, specifying, changing, and/or adjusting) the display arrangement. In some embodiments, the first display arrangement is a virtual representation (e.g., used by the computer system) that represents an arrangement in physical space of the first set of display generation components (e.g., lined up side-by-side with borders (or specified portions thereof) touching where one of the display generation components is in portrait orientation and two are in landscape orientation). In some embodiments, one or more display generation components of the first set of display generation components correspond to (e.g., supports, allows, is configured to have, and/or provides) a respective set of one or more spatial bounds (e.g., such as described above with respect to computer system 600) (e.g., width and height in pixels). In some embodiments, one or more display generation components of the first set of display generation components include (e.g., supports, allows, configures, makes available, and/or provides) a widget display area (e.g., such as described above with respect to computer system 600).

In some embodiments, the first display order (e.g., order of displays (e.g., A, B, and/or C) corresponding to display generation components 1602, 1604, and/or 1606 at FIGS. 16A-16E) corresponds to a first priority ordering (e.g., order of displays (e.g., A, B, and/or C) corresponding to display generation components 1602, 1604, and/or 1606 at FIGS. 16A-16E) of one or more display generation components in the second set of display generation components. In some embodiments, a priority order defines an order of display generation components listed in an order of priority. In some embodiments, the first member of the list is a primary display generation component. In some embodiments, a priority order defines an order of discrete user interfaces (e.g., desktops). In some embodiments, the first member of the list is the primary discrete user interface. In some embodiments, the primary order includes both an order of display generation components listed in an order of priority and an order of discrete user interfaces. In some embodiments, The second display order (e.g., order of displays (e.g., A, B, and/or C) corresponding to display generation components 1602, 1604, and/or 1606 at FIGS. 16A-16E) corresponds to a second priority ordering (e.g., order of displays (e.g., A, B, and/or C) corresponding to display generation components 1602, 1604, and/or 1606 at FIGS. 16A-16E) of one or more display generation components in the second set of display generation components different from the first priority ordering (e.g., an of a similar type, such as a priority list of display generation components). In some embodiments, the determination that the second display arrangement corresponds to the first display order includes a determination that the third display generation component is higher (e.g., highest) priority than the fourth display generation component in the first priority ordering (e.g., the third display generation component (e.g., priority and/or primary display generation component) is higher priority so it displays the third set of one or more widgets (e.g., and/or a priority and/or primary discrete user interface that includes the third set of one or more widgets)). In some embodiments, the determination that the second display arrangement corresponds to the second display order includes a determination that the fourth set display generation component is higher (e.g., highest) priority than the third display generation component in the second priority ordering (e.g., the third display generation component (e.g., priority and/or primary display generation component) is higher priority so it displays the fourth set of one or more widgets (e.g., and/or a priority and/or primary discrete user interface that includes the fourth set of one or more widgets)). Displaying the third set of one or more widgets and the fourth set of one or more widgets on the third display generation component or the fourth display generation component based on whether the second display arrangement corresponds to the first priority ordering or the second priority ordering enables the computer system (e.g., 600) to display widgets in a relevant arrangement in a dynamic manner with respect to different display generation components, thereby performing an operation when a sct of conditions has been met without requiring further user input, reducing the number of inputs needed to perform an operation, and providing improved visual feedback to the user.

In some embodiments, the third set of one or more widgets (e.g., 1608, 1610, and/or 1612) corresponds to (e.g., are configured to be displayed on) a highest priority display generation component (e.g., 1602, 1604, and/or 1606 within the display arrangement FIGS. 16A-16E). In some embodiments, a set of widgets that correspond to a highest priority display generation component is referred to as a primary set of one or more widgets (e.g., highest priority set of one or more widgets as compared to a respective set of one or more widgets (e.g., that includes the fourth set of one or more widgets)). In some embodiments, the highest priority display generation component is determined based on a configuration setting (e.g., a default and/or a user established setting). In some embodiments, the highest priority display generation component depends on which display generation components are in communication with the computer system (e.g., 600) (e.g., if a highest priority display is disconnect, the second in the priority order becomes the highest priority display generation component). In some embodiments, the determination that the third display generation component (e.g., 1602, 1604, and/or 1606 within the display arrangement FIGS. 16A-16E) is higher priority than the fourth display generation component (e.g., 1602, 1604, and/or 1606 within the display arrangement FIGS. 16A-16E) includes a determination that the third display generation component is the highest priority display generation component (e.g., highest priority in the first priority ordering) for displaying the primary set of one or more widgets. In some embodiments, the determination that the fourth display generation component is higher priority than the third display generation component includes a determination that the fourth display generation component is the highest priority display generation component (e.g., highest priority in the second priority ordering) for displaying the primary set of one or more widgets. In some embodiments, the primary set of one or more widgets is part of a primary discrete user interface. In some embodiments, the primary set of one or more widgets is associated with a configuration setting that designates the primary status (e.g., which can be changed and/or modified via input by a user). In some embodiments, the primary display is associated with a configuration setting that designates the primary status (e.g., which can be changed and/or modified via input by a user). In some embodiments, the primary display is a display generation component that is part of (e.g., built into, permanently affixed to, and/or shares the same housing and/or packaging as) the computer system (e.g., 600) (e.g., such a laptop screen). In some embodiments, the computer system changes the primary display in response to detecting a display generation component (e.g., designated to be primary and/or with a higher priority right to being primary) being disconnected, turned off, disabled, and/or otherwise not used (e.g., laptop lid closed). In some embodiments, the computer system changing the primary display includes designating another display generation component to be the primary display (e.g., for so long as another display generation component with a higher priority to primary display status is connected). Displaying the third set of one or more widgets and the fourth set of one or more widgets on the third display generation component or the fourth display generation component based on which is the highest priority display generation component enables the computer system to display widgets in a relevant arrangement in a dynamic manner with respect to different display generation components, thereby performing an operation when a set of conditions has been met without requiring further user input, reducing the number of inputs needed to perform an operation, and providing improved visual feedback to the user.

In some embodiments, the computer system (e.g., 600) detects an event representing (and/or including) a request to launch (and/or begin executing) an application (e.g., as discussed above at FIG. 16A). In some embodiments, in response to detecting the event representing the request to launch the application and in accordance with a determination that the third display generation component (e.g., 1602, 1604, and/or 1606 within the display arrangement FIGS. 16A-16E) is the primary display, the computer system displays, via the third display generation component, an initial user interface corresponding to the application (e.g., as discussed above at FIG. 16A). In some embodiments, in accordance with a determination that the fourth display generation component (e.g., 1602, 1604, and/or 1606 within the display arrangement FIGS. 16A-16E) is the primary display of the computer system. In some embodiments, the computer system displays, via the fourth display generation component, the initial user interface corresponding to the application. In some embodiments, the computer system displays newly launched applications first (e.g., initially and/or by default) on the current display generation component that is designated the primary display.

In some embodiments, the second set of display generation components (e.g., 1602, 1604, and/or 1606 within the display arrangement FIGS. 16A-16E) corresponds to a spatial ordering of display generation components (e.g., as discussed above at FIG. 16A) (e.g., an ordering of the display generation components that are included in the second set of display generation components). In some embodiments, the spatial order of the display generation components is based on a spatial positioning (e.g., placement in a physical space and/or a configuration representing the relative and/or actual placement in the physical space) of the display generation components (e.g., in relative order such as from left-to-right such that the first position in the ordering is the leftmost and the last position in the ordering is the rightmost). In some embodiments, the spatial ordering can be configured at a settings user interface (e.g., modified, created, and/or deleted). In some embodiments, the determination that the second display arrangement (e.g., arrangement of 1602, 1606, and/or 1604 within the display located at the bottom of FIGS. 16A-16E) corresponds to the first display order (e.g., order of displays (e.g., A, B, and/or C) corresponding to display generation components 1602, 1604, and/or 1606 at FIGS. 16A-16E) includes a determination that the third display generation component (e.g., 1602, 1604, and/or 1606 within the display arrangement FIGS. 16A-16E) is at a first position of the spatial ordering and the fourth display generation component (e.g., 1602, 1604, and/or 1606 within the display arrangement FIGS. 16A-16E) is at a second position of the spatial ordering, wherein the first position is higher in the spatial ordering than the second position (e.g., the third display generation component is higher in the order so it is displayed with the third set of one or more widgets and the third display generation component is lower in the order so it is displayed with the fourth set of one or more widgets). In some embodiments, the determination that the second display arrangement corresponds to the second display order includes a determination that the fourth display generation component is at the first position of the spatial ordering and the third display generation component is at the second position of the spatial ordering (e.g., the fourth display generation component is higher in the order so it is displayed with the third set of one or more widgets and the third display generation component is lower in the order so it is displayed with the fourth set of one or more widgets). In some embodiments, the spatial ordering is subject to one or more exceptions (e.g., a primary display displays a primary discrete user interface, and discrete user interfaces for one or more remaining display generation components are selected and displayed based on the spatial ordering of the remaining display generation components). Displaying the third set of one or more widgets and the fourth set of one or more widgets on the third display generation component or the fourth display generation component based on the spatial ordering of the second set of display generation components enables the computer system (e.g., 600) to display widgets in a relevant arrangement in a dynamic manner with respect to different display generation components, thereby performing an operation when a set of conditions has been met without requiring further user input, reducing the number of inputs needed to perform an operation, and providing improved visual feedback to the user.

In some embodiments, the spatial ordering of display generation components (e.g., 1602, 1604, and/or 1606 within the display arrangement FIGS. 16A-16E) is based on a right-to-left ordering of spatial positions corresponding to respective display generation components of the second set of display generation components (e.g., 1602, 1604, and/or 1606 within the display arrangement FIGS. 16A-16E) (e.g., a rightmost display generation component in a configuration setting is first in the ordering and a leftmost display generation component in a configuration setting is last in the ordering).

In some embodiments, the spatial ordering of display generation components (e.g., 1602, 1604, and/or 1606 within the display arrangement FIGS. 16A-16E) is based on a left-to-right ordering of spatial positions corresponding to respective display generation components of the second set of display generation components (e.g., 1602, 1604, and/or 1606 within the display arrangement FIGS. 16A-16E) (e.g., a leftmost display generation component in a configuration setting is first in the ordering and a rightmost display generation component in a configuration setting is last in the ordering).

In some embodiments, in accordance with a determination that a text layout configuration of the computer system (e.g., 600) is configured in a right-to-left manner (e.g., based on a language setting, such as a default language being a right-to-left written language), the spatial ordering of display generation components (e.g., 1602, 1604, and/or 1606 within the display arrangement FIGS. 16A-16E) is based on a right-to-left ordering of spatial positions corresponding to respective display generation components of the second set of display generation components. In some embodiments, in accordance with a determination that the text layout configuration of the computer system is configured in a left-to-right manner (e.g., based on a language setting, such as a default language being a left-to-right written language), the spatial ordering of display generation components is based on a left-to-right ordering of spatial positions corresponding to respective display generation components of the second set of display generation components (e.g., 1602, 1604, and/or 1606 within the display arrangement FIGS. 16A-16E).

In some embodiments, the spatial ordering of display generation components (e.g., 1602, 1604, and/or 1606 within the display arrangement FIGS. 16A-16E) is based on a top-to-bottom ordering of spatial positions corresponding to respective display generation components of the second set of display generation components (e.g., 1602, 1604, and/or 1606 within the display arrangement FIGS. 16A-16E) (e.g., a topmost display generation component in a configuration setting is first in the ordering and a bottommost display generation component in a configuration setting is last in the ordering). In some embodiments, the spatial ordering of display generation components is based on a bottom-to-top ordering of spatial positions locations corresponding to respective display generation components of the second set of display generation components (e.g., a bottommost display generation component in a configuration setting is first in the ordering and a topmost display generation component in a configuration setting is last in the ordering).

In some embodiments, detecting the event corresponding to the request to switch to the second set of display generation components (e.g., 1602, 1604, and/or 1606 within the display arrangement FIGS. 16A-16E) includes: detecting that an additional display generation component (e.g., 1602, 1604, and/or 1606 within the display arrangement FIGS. 16A-16E) (e.g., the third display generation component or the fourth display generation component) is added to be in communication with the computer system (e.g., as discussed above at FIG. 16A-16E). Displaying the third set of one or more widgets and the fourth set of one or more widgets on the third display generation component or the fourth display generation component in response to detecting that an additional display generation component is added be in communication with the computer system enables the computer system to display widgets in a relevant arrangement in a dynamic manner with respect to different display generation components, thereby performing an operation when a set of conditions has been met without requiring further user input, reducing the number of inputs needed to perform an operation, and providing improved visual feedback to the user.

In some embodiments, detecting the event corresponding to the request to switch to the second set of display generation components (e.g., 1602, 1604, and/or 1606 within the display arrangement FIGS. 16A-16E) includes: detecting that a display generation component (e.g., of the first set of display generation components) (e.g., the first display generation component or the second display generation component) is no longer in communication with the computer system (e.g., as discussed above at FIG. 16A-16E). In some embodiments, detecting that a display generation component is no longer in communication with the computer system includes detecting a new set of display generation components that does not include one of the previously-used display generation components (e.g., the second set of display generation components does not include one or more display generation components from the first set of display generation components). Displaying the third set of one or more widgets and the fourth set of one or more widgets on the third display generation component or the fourth display generation component in response to detecting that a display generation component is no longer in communication with the computer system enables the computer system to display widgets in a relevant arrangement in a dynamic manner with respect to different display generation components, thereby performing an operation when a set of conditions has been met without requiring further user input, reducing the number of inputs needed to perform an operation, and providing improved visual feedback to the user.

In some embodiments, detecting the event corresponding to the request to switch to the second set of display generation components (e.g., 1602, 1604, and/or 1606 within the display arrangement FIGS. 16A-16E) includes: detecting that a display generation component (e.g., 1602 at FIG. 16E) has been removed from a set of one or more display generation components that are used for displaying user interface objects associated with the computer system (e.g., 600) (e.g., a display generation component is integrated into an enclosure of the computer system and the enclosure is in an off and/or closed position) (e.g., but still in communication with the computer system) (e.g., the laptop is closed) (e.g., the display generation component is still connected to and/or in communication with the computer system but has been placed in a deactivated (e.g., off and/or disabled) state). In some embodiments, the computer system is a laptop computer system. In some embodiments, being deactivated includes being disconnected, turned off, disabled, and/or otherwise not used (e.g., laptop lid closed). Displaying the third set of one or more widgets and the fourth set of one or more widgets on the third display generation component or the fourth display generation component in response to detecting that a display generation component is deactivated enables the computer system to display widgets in a relevant arrangement in a dynamic manner with respect to different display generation components, thereby performing an operation when a set of conditions has been met without requiring further user input, reducing the number of inputs needed to perform an operation, and providing improved visual feedback to the user.

In some embodiments, detecting the event corresponding to the request to switch to the second set of display generation components (e.g., 1602, 1604, and/or 1606 within the display arrangement FIGS. 16A-16E) includes: detecting a set of one or more inputs (e.g., a tap input, a tap and drag input, a mouse or touchpad click, and/or a keystroke) (e.g., in a settings user interface), via one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button) in communication with the computer system, corresponding to a request to reconfigure (e.g., as discussed above at FIG. 16A-16E) (e.g., a number, order, priority and/or position in) a spatial arrangement of the display generation components in the second set of display generation components to form the second display arrangement (e.g., a different display arrangement is based on reconfiguring an existing display arrangement (e.g., in a settings user interface)). Displaying the third set of one or more widgets and the fourth set of one or more widgets on the third display generation component or the fourth display generation component in response to a request to reconfigure a spatial arrangement of the display generation components in the second set of display generation components to form the second display arrangement enables the computer system to display widgets in a relevant arrangement in a dynamic manner with respect to different display generation components, thereby performing an operation when a set of conditions has been met without requiring further user input, reducing the number of inputs needed to perform an operation, and providing improved visual feedback to the user.

Note that details of the processes described above with respect to method 1700 (e.g., FIG. 17) are also applicable in an analogous manner to the methods described herein, such as methods 700, 900, 1100, 1200, 1300, 1500, and/or 1900. For example, method 1500 optionally includes one or more of the characteristics of the various methods described above with reference to method 1700. For example, a request to change spatial bounds of a display area can include changing a set of display generations in communication with a device.

FIGS. 18A-18Z illustrate exemplary user interfaces and scenarios for arranging widgets, in accordance with some embodiments. The user interfaces in these figures are used to illustrate the processes described below, including the processes in FIG. 19.

FIGS. 18A-18J illustrate exemplary user interfaces for displaying one or more indications that a widget will snap to be aligned with one or more other widgets in accordance with some embodiments. The user interfaces in these figures are used to illustrate the processes described below, including the processes in FIG. 19.

FIGS. 18A-18E illustrate the process of a user interface displaying indications of a first widget snapping to be aligned to a second and/or a third widget when the first widget is spaced apart from the second and/or third widget by a threshold distance. In some embodiments, a widget snaps to be aligned to a single widget or multiple other widgets based on whether a set of one or more snapping criteria is satisfied, as explained in further detail below.

FIGS. 18A-18C illustrate the ability to perform distance snapping relative to a single distant widget. FIG. 18A illustrates computer system 600, which includes display 602. Computer system 600 displays desktop interface 638 (e.g., as described above), via display 602, which includes widget 1804, widget 1050A, widget 1050C, and widget 1048A. Desktop interface 638 also includes widget 1010 in the bottom left corner of desktop interface 638, widget 1050D in the bottom right corner of desktop interface 638, and widget 1012 near widget 1050D. As illustrated in FIG. 18A, widgets on desktop interface 638 are shown in a receded state (e.g., as described above). FIG. 18A also includes a schematic of keyboard 1820, which is an input device in communication with computer system 600. FIG. 18A also includes a schematic of touch-sensitive surface 608, which is an input device that receives touch inputs and is in communication with computer system 600. For example, touch-sensitive surface 608 can receive (e.g., detect) one or more inputs (e.g., representing a click, a tap, a press, a swipe, a click and hold, and/or a click and drag) that correspond to one or more locations, displayed by display 602 (e.g., a location corresponding to content of desktop interface 638), represented by pointer 622 (e.g., which represents a pointer, cursor, and/or a focus of attention of input). Keyboard 1820 and touch-sensitive surface 608 are illustrated in their entirety as schematics in FIG. 18A and are applicable to (e.g., to be considered present in and/or in communication with computer system 600 in) FIGS. 18A-18Z even if illustrated in part (e.g., not in whole) and/or not illustrated. At FIG. 18A, computer system 600 detects click and drag input 1805A on widget 1048A.

As illustrated in FIG. 18B, in response to detecting input 1805A, computer system 600 moves widget 1048A up and to the right from its original position on desktop interface 638 as illustrated in FIG. 18A. In FIG. 18B, computer system 600 continues to detect input 1805A being performed (e.g., dragging continues and release of input 1805A has not been detected). FIG. 18B illustrates computer system 600 displaying snapping location edge indicator 1822 near widget 1048A as a visual indication that at least partially surrounds the location of where computer system 600 will snap widget 1048A at the time that computer system 600 detects the release (e.g., end and/or liftoff) of input 1805A. In some embodiments, computer system 600 displays an indicator that completely surrounds the location of where computer system 600 will snap widget 1048A (e.g., such as snapping location 1836 as described below) (e.g., instead of snapping location edge indicator 1822). FIG. 18B also illustrates indicator 1824 along the top edge of widget 1804, which indicates the side of widget 1804 to which computer system 600 will align widget 1048A when computer system 600 detects the release of input 1805A. That is, snapping location edge indicator 1822 aligns with indicator 1824 (e.g., as indicated by alignment line 1834, which is not displayed in some embodiments) and indicates that upon release of input 1805B, computer system 600 will align widget 1804 and widget 1048A by their top edges even though they are not within close proximity to one another, as discussed above with respect to other examples. As illustrated in FIG. 18B, in response to detecting input 1805A, computer system 600 changes widgets on desktop interface 638 to a non-receded state (e.g., appearance). As described previously, interacting with one or more receded widget can cause that widget and/or other widgets on desktop interface 638 to change from receded to non-receded states. Note that input 1805B is a continuation of input 1805A. At FIG. 18B, computer system 600 detects the release of input 1805B.

As illustrated in FIG. 18C, in response to detecting the release of input 1805B, computer system 600 snaps widget 1048A to the location of snapping location edge indicator 1822 as it was illustrated in FIG. 18B to be aligned from a distance with the top edge of widget 1804. In FIG. 18C, computer system 600 displays widget 1048A aligned with the top edge of widget 1804 in a new location on desktop interface 638. The new location is the area outlined by snapping indicator 1822 in FIG. 18B. As illustrated in FIG. 18B, in response to detecting the release of input 1805B, computer system 600 changes widgets on desktop interface 638 to a receded state (e.g., appearance). In this embodiment, after interaction with the widget being placed ends, the widgets return to their previous state immediately before the corresponding input began (e.g., which was the receded state illustrated in FIG. 18A in this example). In some embodiments, in response to detecting the release of input 1805B, the widgets of desktop interface 638 remain in the non-receded state.

FIGS. 18D-18E illustrate the ability to perform distance snapping relative to multiple distant widgets simultaneously. At FIG. 18D, computer system 600 detects click and drag input 1805D on widget 1048A. As illustrated in FIG. 18D, in response to detecting input 1805D, computer system 600 moves widget 1048A from its position as illustrated in FIG. 18C, represented by indicator 1826 (e.g., which is optionally displayed) in FIG. 18D, toward the top right corner of desktop interface 638. At its position as illustrated in FIG. 18D, widget 1048A is near to being in distant alignment (e.g., aligned along respective edges while the widgets are spaced apart by greater than a threshold distance) with the top edge of widget 1804 and the right edge of widget 1050D. As computer system 600 detects widget 1048A being in distant alignment with widget 1804 and widget 1050D, computer system 600 displays snapping location 1836 surrounding the location of where computer system 600 will snap widget 1048A at the time that computer system 600 detects the release of input 1805D. In some embodiments, computer system 600 displays an indicator that partially surrounds the location of where computer system 600 will snap widget 1048A (e.g., such as snapping location edge indicator 1822) (e.g., instead of snapping location 1836). FIG. 18D also illustrates alignment line 1834 from the top edge of snapping location 1836 to indicator 1824, which indicates the top edge of widget 1804. FIG. 18D also illustrates alignment line 1832 from the right edge of snapping location 1836 to indicator 1830, which indicates the right edge of widget 1050D. Alignment lines illustrated and described herein are used for illustrative purposes only and are not necessarily displayed on user interfaces of computer system 600. In some embodiments, computer system 600 displays alignment lines (e.g., 1832 and/or 1834). FIG. 18D illustrates alignment line 1834 and alignment line 1832 as visual indications that the top edge of snapping location 1836 aligns with indicator 1824 and the right edge of snapping location 1836 aligns with indicator 1830, and that, upon detecting release of input 1805D, the edges of widgets 1048A, 1804, and 1050D will align to one another (e.g., the top edge of widget 1804 and the right edge of widget 1050D will align with the top edge and right edge of widget 1048A). At FIG. 18D, computer system 600 detects the release of input 1805D.

As illustrated in FIG. 18E, in response to detecting the release of input 1805D, computer system 600 snaps widget 1048A to the location outlined by snapping location 1836 (e.g., as it was displayed in FIG. 18D) to be aligned with the top edge of widget 1804 and the right edge of widget 1050D. Alignment line 1834 and alignment line 1832 continue to be illustrated in FIG. 18E to illustrate the concurrent alignment of widget 1048A, as computer system 600 has placed it on desktop interface 638, with widget 1804 and widget 1050D. Note that FIG. 18E illustrates alignment line 1834 and alignment line 1832 in the same locations as illustrated in FIG. 18D, which indicates that computer system 600 has snapped widget 1048A to the same location of snapping location 1836.

FIGS. 18F-18G illustrate a process for activating distance snapping. The activation of distance snapping can require a set of one or more criteria (e.g., distance snapping criteria) to be satisfied, such as pointer 622 causing a selected widget to remain positioned within a distance snapping threshold distance for (e.g., equal to and/or longer than) a threshold amount of time while an input (e.g., click and drag) (e.g., input 1805F) continues to be detected. In some embodiments, a distance snapping threshold distance represents a distance within which a selected widget (e.g., 1048A) needs to be located (e.g., partially and/or wholly) to activate one or more distance snapping operations. In some embodiments, the distance snapping threshold distance is measured between an edge of the selected widget and one or more axes that are based on one or more distance widgets (e.g., an axis can extend from and/or be tangent to a side of the distant widget). FIG. 18F illustrates desktop interface 638 as illustrated in FIG. 18E with the addition of movement zones 1828A and 1828B near pointer 622. Movement zones 1828A and 1828B are displayed for illustrative purposes and is not necessarily displayed on user interfaces of computer system 600. Movement zone 1828A and movement zone 1828B represent two concentric circles each having a different radius defining an area of pixels on display 602. As discussed in more detail below, each (or both) circles can be used to determine whether to perform a snapping operation, for example such that computer system 600 must detect the presence of pointer 622 for a certain period of time within a movement zone in order to display one or more indicators corresponding to distance snapping operations (e.g., snapping locations and/or alignment indicators). In this example, the inside circle component, movement zone 1828A, has a radius value of 5 pixels, and the outside circle component, movement zone 1828B, has a radius value of 7 pixels. At FIG. 18F, computer system 600 detects click and hold input 1805F, which includes pointer 622 within both radius values of movement zones 1828A and 1828B. As illustrated in FIG. 18F, in response to detecting input 1805F (e.g., the location of which is illustrated by pointer 622) within both radius values of movement zones 1828a and 1828B, computer system 600 continues to display alignment line 1834 and alignment line 1832. That is, as computer system 600 detects pointer 622 staying within a maximum radius value (e.g., represented by movement zone 1828B), computer system 600 continues to display one or more indicators corresponding to distance snapping operations.

As illustrated in FIG. 18G, in response to detecting click and drag input 1805G, which is a continuation of input 1805F, on widget 1048A, computer system 600 moves widget 1048A toward the lower left portion of desktop interface 638. Also illustrated in FIG. 18G, in response to detecting that pointer 622 remains within movement zone 1828A (e.g., as illustrated in FIG. 18F) for greater than a threshold amount of time (e.g., 0.5 seconds), computer system 600 performs a distance snapping operation that includes displaying snapping location 1836 at the location of where computer system 600 previously displayed widget 1048A, as well as alignment line 1834, alignment line 1832, indicator 1824, and indicator 1830. FIG. 18G also illustrates pointer 622 being outside of movement zone 1828A but inside zone 1828B. That is, after moving widget 1048A down and to the left, computer system 600 has moved pointer 622 outside of the range of 5 pixels but not outside of the range of 7 pixels. As selection tool is not outside of the range of 7 pixels, computer system 600 continues to display one or more indicators corresponding to distance snapping.

FIGS. 18H-18I illustrate the process of the suppression of distance snapping when detecting an input on a modifier key. In some embodiments, an input on a modifier key accompanied with an input (e.g., 1805H1) representing a request to move a widget on desktop interface 638 can suppress (e.g., disable) and/or enable snapping operations for widgets to align with and/or snap to one another, whether from a distance or within proximity to one another. The suppression and/or enabling of these snapping operations will be discussed below.

FIG. 18H illustrates computer system 600 continuing to move widget 1048A down and to the left on desktop interface 638 via input 1805H1 (e.g., a continuation of input 1805G of FIG. 18G). Also illustrated in FIG. 18H is movement zones 1864 near pointer 622 with pointer 622 being outside of both movement zone 1828A and movement zone 1828B, which indicates that computer system 600 has moved pointer 622 outside of the movement zone 1828B (e.g., 7 pixels in this example). FIG. 18H also illustrates schematic 1840, which is a portion of keyboard 1820 as illustrated in FIG. 18A. At FIG. 18H, computer system 600 detects press and hold input 1805H2 on modifier key 1840A, which is a key of keyboard 1820 (e.g., as illustrated in FIG. 18A). In some embodiments, in response to computer system 600 detecting selection of modifier key 1840A, computer system 600 modifies aspects of snapping operations of computer system 600. Note that input 1805H1 and input 1805H2 are simultaneous inputs (e.g., computer system 600 detects input 1805H1 while detecting input 1805H2).

As illustrated in FIG. 18H, computer system 600 does not display any alignment indicators on desktop interface 638. As described above, the lack of display of alignment indicators (e.g., indicators representing alignment such as indicators 1822, 1824, and/or 1836 and/or alignment lines 1832 and/or 1834) can be a result of the pointer 622 moving outside of movement zone 1828B. The lack of display of alignment indicators can also be attributed to computer system 600 detecting input 1805H2 on modifier key 1840A. That is, computer system 600 detecting an input on modifier key 1840A simultaneously with a drag input on a widget disables (e.g., suppresses) computer system 600 from performing distance snapping operations. For example, in FIG. 18H computer system 600 does not attempt to align widgets that are spaced distantly apart. At FIG. 18H, computer system 600 continues detecting click and drag input 1805G moving down and to the left as indicated by the arrow which is a continuation of click and drag input 1805HI on modifier key 1840A.

At FIG. 18I, computer system 600 detects input 1805I1, which is a continuation of input 1805H1 on widget 1048A while continuing to detect press and hold input 1805H2 on modifier key 1840A, labeled in FIG. 18I as input 1805I2. As computer system 600 detects simultaneous inputs 1805I1 and 1805I2, computer system 600 suppresses distance snapping and its visual components (e.g., indicators such as indicator 1824 and/or indicator 1830 as illustrated in FIG. 18D) from being displayed. That is, as the left edge of widget 1048A aligns with the left edge of widget 1012 (e.g., along a vertical axis) as illustrated in FIG. 18I, computer system 600 does not display alignment indicators, due to computer system 600 detecting input 1805I2 on modifier key 1840A simultaneously with input 1805I1 on widget 1048A. At FIG. 18I, computer system 600 continues to move widget 1048A to the left on desktop interface 638 in response to detecting input 1805I1.

FIGS. 18J-18K illustrate the process of enabling proximity snapping when detecting an input on a modifier key. The processes described below are different from the processes described above in that they relate to the snapping of widgets that are in close proximity to one another. As illustrated in FIG. 18J, computer system 600 detects input 1805J1, which is a continuation of input 1805J2. In response to detecting input 1805J1, computer system 600 moves widget 1048A to the left to a location near widget 1804, widget 1050A, and widget 1050C. Also illustrated in FIG. 18J is input 1805J2 on modifier key 1840A while computer system 600 continues to detect input 1805J1. As computer system 600 displays widget 1048A as approaching other widgets (e.g., to the right of widget 1804 and above widget 1050C), computer system 600 displays snapping indicator 1844. Snapping indicator 1844 is a visual representation of where computer system 600 will snap widget 1048A upon detecting the release of input 1850J1, with respect to previous examples (e.g., as described above with respect to FIG. 10D). Computer system 600 displays snapping indicator 1844 in response to detecting that widget 1048A satisfies a set of proximity snapping criteria with respect to widget 1050C. For example, the set of proximity snapping criteria can be satisfied when the widget 1048A is moved to within a threshold proximity snapping distance from widget 1050C. In the example in FIG. 18J, a key press of the modifier key 1840A does not disable proximity snapping (e.g., rather the only snapping that is disabled in response to detecting the modifier key press is distance snapping). That is, in response to detecting simultaneous inputs 1805J1 and 1805J2, computer system 600 continues to allow widgets to snap to (e.g., align with) widgets that are in proximity. In some examples, the modifier key enables snapping operations (e.g., enables distance snapping and/or proximity snapping) (e.g., that is otherwise disabled while a modifier key press is not detected). At FIG. 18J, computer system 600 detects the release of input 1805J1 on widget 1048A.

As illustrated in FIG. 18K, in response to detecting the release of input 1805J1, computer system 600 snaps widget 1048A to be in alignment with widget 1050C by performing a proximity snapping operation. FIG. 18K also illustrated that computer system 600 continues to detect input 1805K on modifier key 1840A, which does not disable proximity snapping of widgets, as explained above with respect to FIG. 18J.

FIGS. 18L-18M illustrate an example of another function of the detection of an input on a modifier key. FIGS. 18L-18M illustrate an example in which detecting an input on a modifier key disables proximity snapping. As illustrated in FIG. 18L, computer system 600 displays widget 1048A in a position on desktop interface 638 to the right of where it was displayed in FIG. 18K and in a similar position as in FIG. 18J. FIG. 18L illustrates an alternative scenario to that illustrated in FIGS. 18J-18K (in which the modifier key does not disable proximity snapping). At FIG. 18L, computer system 600 detects click and drag input 1805L1 on widget 1048A simultaneously with input 1805L2 on modifier key 1840A (e.g., a continuation of input 1805I2 from FIG. 18I). In response to detecting input 1805L1 simultaneously with input 1805L2, computer system 600 disables proximity snapping and does not display indicators corresponding to proximity snapping operations (e.g., computer system 600 does not display snapping indicator 1844 of FIG. 18J in FIG. 18L despite the proximity snapping criteria being satisfied by widget 1048A in FIG. 18L). At FIG. 18L, computer system 600 detects the release of input 1805L1.

As illustrated in FIG. 18M, in response to detecting the release of input 1805L1, computer system 600 does not perform a proximity snapping operation (e.g., to cause widget 1048A to move into alignment with widget 1050C) and places widget 1048A on desktop interface 638 at the position at which it was illustrated in FIG. 18L (e.g., at the same location that widget 1048A was dropped at). Note that, at FIG. 18M, computer system 600 continues to detect input 1805M on modifier key 1840A. Computer system 600 detecting input 1805M and computer system 600 not snapping widget 1048A to nearby widgets indicates the disabling of proximity snapping.

FIGS. 18N-18P illustrate a scenario in which both proximity and distance snapping operations are disabled yet a different type of snapping is performed. FIG. 18N illustrates desktop interface 638 as displayed in FIG. 18M with widget 1048A at the position above and to the right of widget 1050C. At FIG. 18N, computer system 600 detects click and drag input 1805N1 on widget 1048A which includes movement to the left and down toward widget 1804, widget 1050A, and widget 1050C. At FIG. 18N, computer system 600 detects a simultaneous press input 1805N2 on modifier key 1840A.

As illustrated in FIG. 18O, in response to detecting movement of input 1805O1, computer system 600 drags widget 1048A to a display location partially overlapping widget 1050C. In FIG. 18O, computer system 600 does not display a snapping location edge indicator near widget 1048A or an alignment indicator near other widgets, as input 1805O2 on modifier key 1840A disables proximity snapping (e.g., and visual feedback corresponding to snapping). At FIG. 18O, computer system 600 detects the release of input 1805O1.

As illustrated in FIG. 18P, in response to detecting the release of input 1805O1, computer system 600 performs proximity snapping and as a result snaps widget 1048A to a snapping position as illustrated in FIG. 18J, aligned with and above widget 1050C by a minimum spacing (e.g., a minimum spacing between widgets that are snapped with respect to each other and/or placed in close proximity) (e.g., the smallest spacing between two widgets that can be placed with in close proximity). In this embodiment, computer system 600 snapped widget 1048A to a location with respect to widget 1050C despite the modifier key causing computer system 600 to suppress proximity snapping for the reason that widget 1048A was overlapping widget 1050C at the time that computer system 600 detected the release of input 1805O1. In the example of FIGS. 18O-18P, computer system 600 is configured to not allow placement of widgets in an overlapping manner and thus performs proximity snapping when overlapping placement is detected. Thus, in this example, as long as computer system 600 detects input 1805O2 on modifier key 1840A while detecting an input to move a widget, it will not snap a widget to be in alignment with other widgets unless the widget that is being moved to overlap another widget, as illustrated in FIG. 18O. In some embodiments, computer system 600 displays snapping locations and alignment indicators while simultaneously detecting input 1805O1 and input 1805O2. For example, snapping indicator 1844 (as illustrated in FIG. 18J) can be displayed in response to detecting a set of criteria corresponding to an overlap (e.g., while widget 1048A is moved to at least partially overlap with widget 1050C but before computer system 600 detects the end of the corresponding input 1805O1). In some embodiments, computer system 600 does not snap an overlapping widget in alignment with another widget at the time that computer system 600 detects the release of the input that is moving a widget.

FIG. 18Q illustrates desktop interface 638 as illustrated in FIG. 18A with widget 1048A in the bottom right corner of desktop interface 638 above widget 1050D. At FIG. 18Q, computer system 600 detects drag input 1805Q dragging widget 1048A down toward widget 1050D, as indicated by click and drag input 1805Q on widget 1048A. In FIG. 18Q, widget 1048A does not satisfy the criteria for proximity snapping with respect to widget 1050D (e.g., widget 1048A is not within close enough proximity to widget 1050D). However, widget 1048A satisfies distance snapping criteria with respect to widget 1050D. Because a set of distance snapping criteria is satisfied, computer system 600 displays snapping location edge indicator 1842 to illustrate the location to which computer system 600 will snap widget 1048A upon detecting the end of input 1805Q. FIG. 18Q also illustrates alignment line 1839 between snapping location edge indicator 1842 and indicator 1830. Indicator 1830 indicates which side of widget 1050D computer system 600 will align widget 1048A with upon release of input 1805Q. That is, if computer system 600 detects the release of input 1805Q while the two widgets are spaced at a distance shown in FIG. 18Q, computer system 600 will align the right side of widget 1048A with the right side of widget 1050C by placing widget 1048A at the location specified by snapping location edge indicator 1842. At FIG. 18Q, computer system 600 detects movement of input 1805Q in a downward direction toward widget 1050D.

As illustrated in FIG. 18R, in response to detecting click and drag input 1805R, computer system 600 moves widget 1048A toward widget 1050D in response to movement of input 1805R such that widget 1048A moves into proximity threshold snapping distance to widget 1050D. In response to detecting that widget 1048A is now within proximity threshold distance to widget 1050D, computer system 600 ceases to display snapping location edge indicator 1842 which is associated with distance snapping. In response to detecting that widget 1048A is now within proximity snapping threshold distance to widget 1050D, computer system 600 displays proximity snapping indicator 1844, as described above with respect to other examples (e.g., FIG. 18D, FIG. 18G, and FIG. 18J). That is, at the time that computer system 600 brings widget 1048A within a distance that is closer than a proximity snapping threshold distance to widget 1050D, computer system 600 displays snapping indicator 1844 as a visual indication of the location to where computer system 600 will snap widget 1048A upon detecting the release of input 1805R. As illustrated in FIG. 18R, computer system 600 displays widget 1048A with a sufficient amount of proximity to widget 1050D that, upon release of input 1805R, computer system 600 will snap the widgets together to form a collective group of widgets that are snapped to and aligned with one another, as discussed previously with respect to widget islands in FIG. 10AN and FIGS. 12A-12B. In some embodiments, computer system 600 continues to display snapping location edge indicator 1842 near widget 1048A even if widget 1048A is closer than a threshold distance to widget 1050D. In some embodiments, computer system 600 does not display proximity snapping indicator 1844 even if widget 1048A is closer than the proximity snapping threshold distance to widget 1050D (e.g., if a modifier key is pressed).

In some of the embodiments described above, a widget is snapped with respect to one or more other widgets. FIGS. 18S-18T illustrate the process of a widget snapping to the edge of desktop interface 638 (e.g., desktop). At FIG. 18S, computer system 600 detects click and drag input 1805S on widget 1048A and moves it to the right of its initial location 1848 (e.g., where click and drag input 1805S began). As illustrated in FIG. 18S, in response to detecting widget 1048A moving to a location that is within an edge snapping threshold distance from the right edge of the desktop (e.g., desktop interface 638), computer system 600 displays indicator 1838 along the right side of widget 1048A. Computer system 600 displays indicator 1838 as an indication of where computer system 600 will place widget 1048A with respect to the edge of desktop interface 638. That is, upon detecting the release of input 1805S, computer system 600 will place widget 1048A on desktop interface 638 at the location of indicator 1838. In this embodiments, indicator 1838 corresponds to an edge snapping operation in which widget 1048A will snap to an edge of desktop interface 638. Computer system 600 displays indicator 1838 with respect to (e.g., aligned with) the right edge (e.g., and not with respect to another widget). At FIG. 18S, computer system 600 detects movement of input 1805S upward along the edge of desktop interface 638.

FIGS. 18T-18U illustrate the process of edge snapping. Edge snapping includes a widget that is partially off the display snapping to be fully on the display in response to detecting the release of an input. As illustrated in FIG. 18T, in response to detecting movement of click and drag input 1805T, which is a continuation of input 1805S, computer system 600 moves widget 1048A to be displayed at a position further upward along the edge of desktop interface 638. In this embodiment, indicator 1838 moves along the edge of desktop interface 638 in response to input 1805T moving along the edge of display (e.g., slides along the edge to track movement of the input) while widget 1048A continues to satisfy a set of one or more edge snapping criteria (e.g., is within the edge snapping threshold distance from the edge). At FIG. 18T, computer system detects movement of input 1805T upward along the edge of desktop interface 638 and to the right.

As illustrated in FIG. 18U, in response to detecting movement of click and drag input 1805T upward and to the right, computer system 600 moves widget 1048A to be displayed at a position further upward along the edge of desktop interface 638. In this embodiment, indicator 1838 moves along the edge of desktop interface 638 in response to input 1805T moving along the edge of display (e.g., slides along the edge to track movement of the input) while widget 1048A continues to satisfy a set of one or more edge snapping criteria (e.g., is within the edge snapping threshold distance from the edge). In FIG. 18U, widget 1048A is also displayed partially off of desktop interface 638 in response to input 1805T moving further to the right than in FIG. 18T. In this embodiment, despite widget 1048A being moved past the edge of desktop interface 638, computer system 600 continues displaying indicator 1838 because widget 1048A continues to satisfy the set of one or more edge snapping criteria. In some embodiments, in response to detecting input of a modifier key press, computer system disables edge snapping. In some embodiments, in response to detecting input of a modifier key press, computer system forgoes disabling edge snapping (e.g., enables and/or does not disable). At FIG. 18U, computer system detects release of input 1805U representing a request to place widget 1048A.

At FIG. 18V, in response to detecting the release of input 1805U, computer system 600 places widget 1048A on desktop interface 638 at the location of indicator 1838 as illustrated in FIG. 18U. As illustrated in FIG. 18S, computer system 600 aligns the right edge of widget 1048A along the edge of desktop interface 638. Notably, computer system 600 snapped widget 1048A back into desktop interface 638 to align with indicator 1838 at the location as displayed in FIG. 18U, even though part of widget 1048A was outside of the visible bounds of desktop interface 638 (e.g., and not displayed).

FIGS. 18W-18X illustrate example scenarios for determining which other widget that a selected widget will be distance snapped with respect to. FIG. 18W illustrates desktop interface 638 as displayed in FIG. 18T, but with widget 1048A at a location outside of a distance snapping proximity threshold and to the right of widget 1050C and 1050A. Widget arrangement 1860 includes widget 1050A, widget 1050C, and widget 1048A illustrates the conditions for widget alignment, which include that widget 1048A being within the distance snapping threshold distance for both the bottom edge of widget 1050A and the bottom edge of widget 1050C. In some embodiments, when widget 1048A satisfies sets of one or more distance snapping criteria with respect to two or more other widgets (e.g., 1050A and 1050C as in FIG. 18W), computer system 600 will align widget 1048A with whichever other widget is within the closest alignment proximity (e.g., the shortest distance from the alignment edge of widget 1048A to the alignment edge of the other widget). In widget arrangement 1860 of FIGS. 18W-18X, widget 1050C is in the location as illustrated in FIG. 18T, widget 1048A is located to the bottom right of widget 1050C, and widget 1050A is located to the bottom left of widget 1050C. Widget 1050C, widget 1048A, and widget 1050A differ in shape and size and are spaced at varying distances from one another. Edge indicator 1850 illustrates an extension of the bottom edge of widget 1050C, which is the edge with which a widget would align if computer system 600 detects that conditions are met. Edge indicator 1850, edge indicator 1852, and edge indicator 1854 are illustrated in FIG. 18W as extending respectively from respective edges of widgets 1050C, 1048A, and 1050A as a visual aid to illustrate the distances between widget 1048A and the other widgets in widget arrangement 1860. Edge indicator 1852 illustrates an extension of the bottom edge of widget 1048A, and edge indicator 1854 illustrates an extension of the bottom edge of widget 1050A. Distance indicators 1856A-1856B (e.g., the space between the arrow tips) illustrate the distance between edge indicators for widget 1050C and widget 1048A, and distance indicators 1858A-1858B illustrate the distance between the edge indicators for widget 1048A and widget 1050A. Note that distance indicators 1856A-1856B represent a longer distance than distance indicators 1858A-1858B. In this example, computer system 600 will configure widget 1048A to align with the bottom edge of widget 1050A for the distance snapping operation (e.g., and not to widget 1050C), as the distance between the bottom edges of widget 1048A and widget 1050A is the shortest distance between edges that will align that satisfy the set of distance snapping criteria. Notably, widget 1048A is physically closer to widget 1050C (e.g., the shortest distance between the two widgets), but instead will align with widget 1050A that is farther away based on widget 1048A being closer to being aligned along an edge (e.g., like edges, such as bottom edge to bottom edge) with widget 1050A.

Widget arrangement 1862 of FIG. 18X illustrates similar conditions as Widget arrangement 1860, except that widget 1048A is positioned slightly higher up on desktop interface 638 so that the bottom edge of widget 1048A is closer to alignment with the bottom edge of widget 1050C than to the bottom edge of widget 1050A. Note that in this example, computer system 600 will configure widget 1048A to align with the bottom edge of widget 1050C for the distance snapping operation (e.g., and not to widget 1050A), as the distance between the bottom edges of widget 1048A and widget 1050C is the shortest distance between edges that will align that satisfy the set of distance snapping criteria.

FIGS. 18Y-18Z include schematics that illustrate criteria for snapping conditions based on the amount of movement made by a selection tool of computer system 600. In particular, FIG. 18Y illustrates examples for determining when a set of one or more distance snapping criteria is initially satisfied (e.g., going from not satisfied to satisfied). The left schematic of FIG. 18Y illustrates movement zone 1870A (e.g., similar and/or the same as described above with respect to movement zone 1828A), which is a representation of an area of a number of pixels through which pointer 622 can move. In response to determining that a widget is moved to within a distance snapping threshold distance (e.g., based on an input (e.g., click and drag input 1805B in FIG. 18B), computer system 600 requires that the input meets a time threshold before determining that the set of one or more distance snapping criteria is satisfied. That is, the set of one or more distance snapping criteria can include a distance criterion (e.g., distance snapping alignment threshold) and a time criterion (e.g., a threshold time). The time criterion can include a requirement that the input dwell (e.g., remain still or within a small area) while the distance snapping alignment threshold is satisfied. For example, looking at FIG. 18Y, if while moving a widget using a click and drag input represented by pointer 622, computer system 600 detects pointer 622 within movement zone 1870A for more than a threshold time (e.g., more than 0.5 seconds), computer system 600 can determine that the set of one or more distance snapping criteria are satisfied and as a result display a snapping location (e.g., a snapping location edge indicator) (e.g., and/or other distance snapping indicators) near the widget that it is being moved by input corresponding to pointer 622. Movement zone 1870A illustrates an area with a radius of 5 pixels, as well as pointer 622 within movement zone 1870A for a first amount of time (e.g., 0.1 second), a second amount of time (e.g., 0.3 seconds), and a third amount of time (e.g., 0.5 seconds). Indicators 1872 and indicators 1874 illustrate the continuous path of movement of pointer 622 over the course of the threshold time (e.g., 0.5 seconds in this example). After detecting pointer 622 within movement zone 1870A (e.g., without leaving movement zone 1870A) for at least the threshold amount of time, computer system 600 determines that the set of one or more distance snapping criteria is satisfied and displays a snapping location edge indicator near the widget that it is moving. In some embodiments, the amounts of time that computer system 600 detects pointer 622 within a movement zone is different (e.g., 0.1, 0.3, 0.7, 1 second) than as described above with respect to this example.

FIG. 18Y also includes a right schematic of movement zone 1870B (e.g., similar and/or the same as described above with respect to movement zone 1828A), which is a representation of an area of a number of pixels through which pointer 622 can move. In response to determining that a widget is moved to within a distance snapping threshold distance (e.g., based on an input (e.g., click and drag input 1805B in FIG. 18B)), computer system 600 requires that the input meets a time threshold before determining that the set of one or more distance snapping criteria is satisfied. That is, the set of one or more distance snapping criteria can include a distance criterion (e.g., distance snapping alignment threshold) and a time criterion (e.g., a threshold time). The time criterion can include a requirement that the input dwell (e.g., remain still or within a small area) while the distance snapping alignment threshold is satisfied. For example, looking at FIG. 18Y, if while moving a widget using a click and drag input represented by pointer 622, computer system 600 detects pointer 622 is not within movement zone 1870B for more than a predetermined period of time (e.g., pointer 622 moves outside of movement zone 1870B before the threshold time is reached), computer system 600 can determine that the set of one or more distance snapping criteria are not satisfied and as a result not display a snapping location (e.g., snapping location edge indicator) (e.g., and/or other distance snapping indicators) near the widget that it is being moved by input corresponding to pointer 622. Movement zone 1870B illustrates an area with a radius of 5 pixels, as well as pointer 622 within movement zone 1870B for a first amount of time (e.g., 0.1 second) and a second amount of time (e.g., 0.3 seconds), but outside of movement zone 1870B at a third amount of time (e.g., 0.5 seconds). Indicators 1872 and indicators 1874 illustrate the continuous path of movement of pointer 622 over the course of the threshold time (e.g., 0.5 seconds in this example). After detecting that pointer 622 does not remain within movement zone 1870B (e.g., without leaving movement zone 1870B) for at least the threshold amount of time, computer system 600 determines that the set of one or more distance snapping criteria is not satisfied and does not display a snapping location edge indicator near the widget that is moving.

The right schematic of FIG. 18Y illustrates movement zone 1870B similarly to movement zone 1870A, with the exception of pointer 622 at a third time outside of movement zone 1870B before the threshold time is exceeded. That is, for a first time (e.g., 0.1 seconds) and a second time (e.g., 0.3 seconds), computer system 600 detects pointer 622 within movement zone 1870B. At a third time (e.g., 0.5 seconds), computer system 600 detects pointer 622 outside of the movement zone required for the display of a snapping location (e.g., 5 pixels, in this example). As computer system 600 does not detect pointer 622 within the threshold amount of pixel distance for at least 0.5 seconds, computer system 600 does not display snapping indicators near the widget that it is moving.

In some embodiments, in response to determining that a widget is moved to within a distance snapping threshold distance (e.g., based on an input (e.g., click and drag input 1805B in FIG. 18B)), computer system 600 requires that the input meets a time threshold before determining that the set of one or more distance snapping criteria is satisfied. That is, the set of one or more distance snapping criteria can include a distance criterion (e.g., distance snapping alignment threshold) and a time criterion (e.g., a threshold time). The time criterion can include a requirement that the input dwell (e.g., remain still or within a small area) while the distance snapping alignment threshold is satisfied. For example, looking at FIG. 18Y, while moving a widget, if computer system 600 detects pointer 622 within movement zone 1870A for more than a predetermined period of time (e.g., more than 0.5 seconds), computer system 600 can determine that the set of one or more distance snapping criteria are satisfied and as a result displays a snapping location (e.g., snapping location edge indicator) (e.g., and/or other distance snapping indicators) near the widget that it is being moved by input corresponding to pointer 622. Movement zone 1870A illustrates an area with a radius of 5 pixels, as well as pointer 622 within movement zone 1870A for a first amount of time (e.g., 0.1 second), a second amount of time (e.g., 0.3 seconds), and a third amount of time (e.g., 0.5 seconds). Indicators 1872 and indicators 1874 illustrate the continuous path of movement of pointer 622 over the course of the threshold time (e.g., 0.5 seconds in this example). After detecting pointer 622 within movement zone 1870A (e.g., without leaving movement zone 1870A) for at least the threshold amount of time, computer system 600 determines that the set of one or more distance snapping criteria is satisfied and displays a snapping location near the widget that it is moving.

FIG. 18Z illustrates examples for determining when a set of one or more distance snapping criteria ceases to be satisfied (e.g., going from satisfied to not satisfied). FIG. 18Z illustrates a left schematic 1864A of movement zone 1870A (e.g., as described above with respect to FIG. 18Y) within movement zone 1878A, which has a radius of 7 pixels. After the set of one or more distance snapping criteria is satisfied and indicators (e.g., snapping indicators) (e.g., snapping locations and/or snapping location edge indicators) are displayed, computer system 600 can detect one or more conditions that indicate that the distance snapping criteria are no longer met (and/or whether distance snapping should cease). The left schematic in FIG. 18Z illustrates pointer 622 outside of movement zone 1870A but within movement zone 1878A. In response to detecting the conditions illustrated in the left schematic of FIG. 18Z (e.g., a selection tool outside the range of a radius of 5 pixels but within the range of a radius of 7 pixels for at least 0.5 seconds), computer system 600 will continue to perform operations associated with distance snapping including displaying a snapping location near the widget that it is moving (e.g., as illustrated in FIG. 18G). In some embodiments, the threshold number of pixels required for the display of snapping indicators vary.

FIG. 18Z also illustrates a right schematic 1864B which includes pointer 622 outside of both movement zone 1870B and movement zone 1878B. For example, pointer 622 as illustrated in FIG. 18Z moved in response to an input to be outside of movement zone 1878B. In response to detecting the conditions illustrated in right schematic 1864B (e.g., a selection tool outside the range of a radius of 5 pixels and outside the range of a radius of 7 pixels for at least 0.5 seconds), computer system 600 will cease to perform operations associated with distance snapping including not displaying snapping indicators near the widget that it is moving. That is, if computer system 600 detects pointer 622 outside of a threshold number of pixels, computer system 600 will cease to display snapping indicators, a process that is illustrated in FIG. 18H.

FIG. 19 is a flow diagram illustrating a method (e.g., method 1900) for aligning widgets in accordance with some embodiments. Some operations in method 1900 are, optionally, combined, the orders of some operations are, optionally, changed, and some operations are, optionally, omitted.

As described below, method 1900 provides an intuitive way for aligning widgets. Method 1900 reduces the cognitive burden on a user for aligning widgets, thereby creating a more efficient human-machine interface. For battery-operated computing devices, enabling a user to align widgets faster and more efficiently conserves power and increases the time between battery charges.

In some embodiments, method 1900 is performed at a computer system (e.g., 600) that is in communication with a display generation component (e.g., a display screen and/or a touch-sensitive display) and one or more input devices (e.g., a physical input mechanism (e.g., a hardware input mechanism, a keyboard, a touch-sensitive surface with a display generation component, a touch-sensitive surface with or without a display generation component, a mouse, a pointing device, and/or a hardware button), a camera, a touch-sensitive display, and/or a microphone). In some embodiments, the computer system is a laptop, a desktop, a watch, a phone, a tablet, a processor, a head-mounted display (HMD) device, and/or a personal computing device.

At 1902, the computer system (e.g., 600) displays, via the display generation component (e.g., 602), a user interface (e.g., 638) (e.g., a desktop interface) (e.g., as described above with respect to method 1100, method 1200, method 1300, method 1500, and/or method 1700) that includes a first widget (e.g., 1048A) (e.g., as described above with respect to method 1100, method 1200, method 1300, method 1500, and/or method 1700) and a second widget (e.g., 1804, 1830, 1050A, and/or 1050C) different from the first widget.

At 1904, while the first widget (e.g., 1048A) is spaced apart from the second widget (e.g., 1804, 1830, 1050A, and/or 1050C) (and, optionally, some or all other widgets in the user interface) by more than (e.g., a distance between a respective location corresponding to (e.g., an edge, a border, and/or a centroid of) the first widget and a respective location corresponding to (e.g., an edge, a border, and/or a centroid of) the second widget and/or one or more other widgets) a threshold distance (e.g., a proximity snapping threshold distance), the computer system (e.g., 600) detects (at 1906), via the one or more input devices (e.g., 608), an input (e.g., 1805B, 1805D1, 1805G, 1805L1, 1805N1, 1805Q, and/or 1805S) (e.g., a drag corresponding to the first widget) (e.g., a tap input and/or in some embodiments, a non-tap input (e.g., a gaze, an air gesture, a mouse click, a button touch, a swipe, and/or a pointing gesture/input)) corresponding to a request to move the first widget (e.g., 1048A) within the user interface (e.g., 638) (e.g., to a first location within the user interface) (e.g., representing a request to place the first widget (e.g., at the first location) within the user interface and/or representing a request to move (e.g., while still selected and/or not placed yet) the first widget (e.g., to the first location) within the user interface). In some embodiments, the input corresponds to a request to place a new widget on the user interface (e.g., that was previously not included in the user interface). In some embodiments, the input corresponds to a request to move an existing widget on the user interface (e.g., that was previously included in the user interface). In some embodiments, the input corresponds to a request to move a widget from a different user interface (e.g., a notification user interface, a widget drawer user interface, and/or a user interface that is normally not visible (e.g., collapses when not in use, is hidden, and/or requires user input to appear) to the user interface). In some embodiments, the computer system performs (e.g., is configured to perform and/or initiates a process for performing) a first type of snapping (e.g., distance snapping) in accordance with a determination that a set of one or more distance snapping criteria is satisfied. In some embodiments, a criterion of the set of one or more distance snapping criteria is satisfied in accordance with a determination that a spacing between the first widget and the second widget exceeds (e.g., is not within) the threshold distance. In some embodiments, while the spacing between the first widget and the second widget exceeds the threshold distance, the computer system does not perform (e.g., is not configured to perform and/or is configured not to perform) a second type of snapping (e.g., proximity snapping) (e.g., as described above with respect to method 1200). In some embodiments, the computer system performs the second type of snapping in accordance with a determination that a set of one or more proximity snapping criteria is satisfied. In some embodiments, a criterion of the set of one or more proximity snapping criteria is satisfied in accordance with a determination that the spacing between the first widget and the second widget is within (e.g., is equal to or less than and/or does not exceed) the threshold distance.

At 1904, while the first widget (e.g., 1048A) is spaced apart from the second widget (e.g., 1804, 1830, 1050A, and/or 1050C) by more than the threshold distance, in response to detecting (at 1908) the input (e.g., 1805B, 1805D1, 1805G, 1805L1, 1805N1, 1805Q, and/or 1805S) (and, in some embodiments, while continuing to detect the input (e.g., prior to detecting release of the input that includes the drag)) corresponding to the request to move the first widget within the user interface, the computer system moves (at 1910) the first widget (e.g., to the first location) within the user interface (e.g., 638).

At 1904, while the first widget is spaced apart from the second widget by more than the threshold distance, in response to detecting (at 1908) the input corresponding to the request to move the first widget within the user interface, in accordance with a determination that the first widget (e.g., at the first location) satisfies a set of one or more snapping criteria (e.g., satisfies one or more criteria based on distance and/or movement characteristics of the first widget) for alignment with the second widget, the computer system (e.g., 600) displays (at 1912), via the display generation component (e.g., 602), an indication (e.g., 1822, 1824, 1830, and/or 1836) (and, in some embodiments, one or more indications) (e.g., an axis, an outline, a border, an area, and/or a visually prominence of one or more features of a respective widget (e.g., glowing and/or highlighted border)) that the first widget will be snapped into alignment with (e.g., at a snapping location based on) the second widget while the first widget remains spaced apart from other widgets (e.g., 1804, 1830, 1050A, and/or 1050C) in the user interface by more than the threshold distance when the input (e.g., 1805B, 1805D1, 1805G, 1805L1, 1805N1, 1805Q, and/or 1805S) ends (e.g., displaying the indication that the first widget will be snapped into alignment with the second widget in response to detecting a portion of the input such as movement to a location that is within a snapping distance of being in alignment with the second widget and/or in response to detecting an end of the input). In some embodiments, while the indication is displayed, in response to a request to place the first widget (e.g., at the first location) (e.g., a release of the input corresponding to the request to move the widget (e.g., to the first location)), the computer system displays the first widget at a first snapping location that is based on (e.g., that aligns with at least one feature of) the second widget. In some embodiments, displaying the first widget at the first snapping location includes moving the first widget to the first snapping location (e.g., from the first location). In some embodiments, the first snapping location is the same as the first location. In some embodiments, the first snapping location is different from the first location. In some embodiments, the first snapping location is based on the first location (e.g., a position of the first snapping location is based at least on a position of the first location) (e.g., the first snapping location aligns with the first location with respect to one or more axes, such as a horizontal and/or vertical axis). In some embodiments, the set of one or more snapping criteria is a set of one or more distance snapping criteria. In some embodiments, a criterion of the set of one or more distance snapping criteria is satisfied in accordance with a determination that a spacing between the first widget and the second widget is not within (e.g., is equal to or less than and/or does not exceed) the threshold distance (e.g., a proximity snapping threshold distance). In some embodiments, a criterion of the set of one or more distance snapping criteria is satisfied in accordance with a determination that a spacing between the first widget and a location that is based on the second widget (e.g., a location on an axis formed by one or more features (e.g., edge, border, and/or centroid) of the second widget is within (e.g., is equal to or less than and/or does not exceed) a threshold alignment distance (e.g., a distance snapping threshold distance)). In some embodiments, the threshold distance and the threshold alignment distance are different distances. In some embodiments, the threshold distance and the threshold alignment distance are the same distance. In some embodiments, in accordance with a determination that the first widget (e.g., at the first location) does not satisfy a set of one or more snapping criteria for alignment with the second widget (e.g., does not satisfy one or more criteria based on distance and/or movement characteristics of the first widget), forgoing displaying the indication that the first widget will snap into alignment with the second widget. In some embodiments, forgoing displaying the indication that the first widget will snap into alignment with the second widget includes displaying a second indication different from the indication that the widget will snap into alignment with the second widget. In some embodiments, the second indication includes a portion of (e.g., less than all of) the indication that the first widget will snap into alignment with the second widget. In some embodiments, in response to detecting the input (and, in some embodiments, while continuing to detect the input (e.g., prior to detecting release of the input that includes the drag)) corresponding to the request to move the first widget (e.g., to the first location), the computer system displays, via the display generation component, the first widget (e.g., at the first location). In some embodiments, in response to detecting the input corresponding to the request to move the first widget (e.g., to the first location), the computer system displays the first widget moving to the first location (e.g., from an initial respective location). In some embodiments, in response to detecting the input corresponding to the request to move the first widget (e.g., to the first location), the computer system moves, animates, and/or tracks a location of the input with the first widget to display the first widget at the first location. In some embodiments, the computer system detects, via the one or more input devices, a second input (e.g., different from the input) (e.g., a drag corresponding to the first widget) (e.g., a tap input and/or in some embodiments, a non-tap input (e.g., a gaze, an air gesture, a mouse click, a button touch, a swipe, and/or a pointing gesture/input)) corresponding to a request to move the first widget (e.g., to a second location different from the first location and/or the first snapping location). In some embodiments, in response to detecting the second input (and, in some embodiments, while continuing to detect the input (e.g., prior to detecting release of the input that includes the drag)) corresponding to the request to move the first widget (e.g., to the second location) and in accordance with a determination that the first widget (e.g., at the second location) satisfies the set of one or more snapping criteria for alignment with a third widget (e.g., different from the first widget and/or the second widget), displaying, via the display generation component, the indication (and, in some embodiments, one or more indications) that the first widget will snap into alignment with (e.g., at a snapping location based on) the third widget. In some embodiments, in response to detecting the second input (and, in some embodiments, while continuing to detect the input (e.g., prior to detecting release of the input that includes the drag)) corresponding to the request to move the first widget (e.g., to the second location) and in accordance with a determination that the first widget (e.g., at the second location) does not satisfy a set of one or more snapping criteria for alignment with the third widget (e.g., does not satisfy one or more criteria based on distance and/or movement characteristics of the first widget), forgoing displaying the indication that the first widget will snap into alignment with the third widget. In some embodiments, the first location and the second location are aligned with respect to at least one axis (e.g., horizontal and/or vertical). In some embodiments, while the spacing between the first widget and the second widget does not exceed (e.g., is within) the threshold distance, the computer system detects a third input corresponding to a request to move the first widget (e.g., to a third location different from the first location). In some embodiments, in response to detecting the third input corresponding to the request to move the first widget (e.g., to the third location), the computer system moves the first widget (e.g., to the third location) and in accordance with a determination that the first widget (e.g., at the third location) satisfies a set of one or more snapping criteria (e.g., satisfies one or more criteria based on distance and/or movement characteristics of the first widget) for alignment with the second widget, displaying, via the display generation component, a third indication (and, in some embodiments, one or more indications) (e.g., an axis, an outline, a border, an area, and/or a visually prominence of one or more features of a respective widget (e.g., glowing and/or highlighted border)) that the first widget will snap into alignment with (e.g., at a snapping location based on) the second widget. In some embodiments, the indication and the third indication are different (e.g., the third indication includes a snapping location, and the indication includes a snapping location and a glowing border of the second widget). Displaying the indication that the first widget will be snapped into alignment with the second widget while the first widget remains spaced apart from other widgets in the user interface by more than the threshold distance when the input ends provides an indication of the state of the computer system and of an available operation, thereby performing an operation when a set of conditions has been met without requiring further user input and providing improved feedback.

In some embodiments, displaying the indication (e.g., 1822, 1824, 1830, and/or 1836) that the first widget (e.g., 1048A) will be snapped into alignment with the second widget (e.g., 1804, 1830, 1050A, and/or 1050C) includes displaying a first visual effect (e.g., 1822) (e.g., an indicator, a visual indication, a border, shading, a highlighting, and/or a first visual appearance that is different from a second visual appearance when the respective snapping will not occur) at a first location (e.g., as illustrated in FIG. 18B) (e.g., based on the first widget) closer to the first widget than to the second widget (e.g., a location near, corresponding to, associated with, of, adjacent to, within a predefined distance of the first widget) (e.g., the first location overlaps the location of the first widget and/or shares at least a portion of the location of the first widget). In some embodiments, the first visual effect indicates a snapping location to where the first widget will be snapped to be in alignment with the second widget. In some embodiments, in response to detecting input that includes movement (e.g., the input), the computer system moves the first visual effect (e.g., to a different location) based on (e.g., in the same direction of and/or to remain near and/or as near as possible to a location of the input) the movement of the input. Displaying the first visual effect at the first location closer to the first widget than to the second widget provides an indication of the state of the computer system and of an available operation, thereby performing an operation when a set of conditions has been met without requiring further user input and providing improved feedback.

In some embodiments, the first visual effect (e.g., 1822) at least partially surrounds a location (e.g., snapping location) to where the first widget will be snapped to be in alignment with the second widget while the first widget (e.g., 1048A) remains spaced apart from other widgets (e.g., 1804, 1830, 1050A, and/or 1050C) in the user interface by more than the threshold distance when the input ends. In some embodiments, the first visual effect has a visual appearance that corresponds to at least a portion of the shape of the first widget (e.g., is an outline and/or a generic placeholder of the same shape (e.g., and size) as the first widget). Displaying the first visual effect at least partially surrounds a location to where the first widget will be snapped provides an indication of a location the first widget will snap to when input ends, thereby performing an operation when a set of conditions has been met without requiring further user input and providing improved feedback.

In some embodiments, displaying the indication (e.g., 1822, 1824, 1830, and/or 1836) that the first widget will be snapped into alignment with the second widget (e.g., 1804, 1830, 1050A, and/or 1050C) includes displaying a second visual effect (e.g., 1824 and/or 1830) (e.g., different from the first visual effect) (e.g., an indicator, a visual indication, a border, shading, a highlighting, and/or a first visual appearance that is different from a second visual appearance when the respective snapping will not occur) at a second location (e.g., based on the second widget) closer to the second widget than to the first widget (e.g., as illustrated in FIG. 18D) (e.g., different from the first location) (e.g., a location near, corresponding to, associated with, of, adjacent to, within a predefined distance of the second widget) (e.g., the second location overlaps the location of the second widget and/or shares at least a portion of the location of the second widget). In some embodiments, the second visual effect indicates an alignment location (e.g., side and/or edge) to where the first widget will be snapped to be in alignment with the second widget. In some embodiments, in response to detecting input that includes movement (e.g., the input), the computer system forgoes moving the location of the second visual effect based on the input (e.g., the second visual effect can remain in the same location (e.g., if the set of one or more criteria continue to be satisfied) even if input moves). In some embodiments, in response to detecting input that includes movement (e.g., the input), the computer system moves the location of the second visual effect based on the input (e.g., the second visual effect moves to a different location, such as to a different border (e.g., of the second widget and/or of a different widget)). In some embodiments, displaying the indication that the first widget will be snapped into alignment with the second widget includes displaying a single visual effect including the first visual effect and the second visual effect (e.g., a continuous line). Displaying the second visual effect at the second location closer to the second widget than to the first widget provides an indication of the state of the computer system and of an available operation, thereby performing an operation when a set of conditions has been met without requiring further user input and providing improved feedback.

In some embodiments, snapping the first widget (e.g., 1048A) into alignment with the second widget (e.g., 1804, 1830, 1050A, and/or 1050C) includes snapping the first widget to a snapping location that aligns with (e.g., along an axis that extends from) a respective side (e.g., top of 1804 in FIG. 18D and/or right side of 1050D in FIG. 18D) of the second widget (and, in some embodiments, one or more other sides). In some embodiments, computer system 600 displays the second visual effect (e.g., 1824 and/or 1830) at the second location. In some embodiments, in accordance with a determination that the respective side is a first side of the second widget (e.g., the first widget will be snapped into alignment with the first side of the second widget), displaying the second visual effect corresponding to (e.g., at a location of, on, aligned with, along, covering, adjacent to, and/or in a manner that identifies and/or indicates) the first side of the second widget (e.g., and not on a second side different from the first side). In some embodiments, in accordance with a determination that the respective side is a second side of the second widget different from the first side (e.g., the first widget will be snapped into alignment with the second side of the second widget), displaying the second visual effect corresponding to the second side of the second widget (e.g., and not on the first side). Displaying the second visual effect at the second location corresponding to a respective side of the second widget provides an indication of which side of the second widget the first widget will snap to when input ends, thereby performing an operation when a set of conditions has been met without requiring further user input and providing improved feedback.

In some embodiments, displaying the second visual effect at the second location includes displaying the second visual effect (e.g., 1824 and/or 1830) along (e.g., adjacent to, running the length of, spanning, highlighting, and/or indicating) the respective side (e.g., one or more sides and/or fewer than all sides) (e.g., an edge and/or one or more edges) of the second widget (e.g., 1804, 1830, 1050A, and/or 1050C) (e.g., to which the first widget will be snapped to align with). In some embodiments, displaying the second visual effect at the second location includes forgoing displaying a respective visual effect (e.g., the second visual effect and/or any visual effect) along one or more edges (e.g., the whole edge and/or a portion of the edge) to which the first widget will not be snapped to align with (e.g., when the input ends) (e.g., the entirety and/or a portion of an edge that will not be aligned with the first widget does not have a corresponding displayed indication). In some embodiments, displaying a respective visual effect (e.g., the second visual effect and/or any visual effect) at the second location includes forgoing displaying the second visual effect along one or more edges (e.g., the whole edge and/or a portion of the edge) of a different respective widget (e.g., a widget other than the second widget) that the first widget will not be snapped to align with (e.g., when the input ends) (e.g., a widget that the first widget will not be aligned with does not have a corresponding displayed indication). In some embodiments, in response to detecting the input corresponding to the request to move the first widget within the user interface, the computer system forgoes displaying, via the display generation component, the indication that the first widget will be snapped into alignment with the second widget while the first widget remains spaced apart from other widgets in the user interface by more than the threshold distance when the input ends (e.g., no visible indication is displayed and/or a different indication is displayed). Displaying the second visual effect at the second location along a respective side of the second widget provides an indication of which side of the second widget the first widget will snap to when input ends, thereby performing an operation when a set of conditions has been met without requiring further user input and providing improved feedback.

In some embodiments, displaying the indication that the first widget will be snapped into alignment with the second widget includes displaying a third visual effect (e.g., 1836) (e.g., an indicator, a visual indication, a border, shading, a highlighting, and/or a first visual appearance that is different from a second visual appearance when the respective snapping will not occur) at a third location (e.g., based on the first widget) closer to the first widget (e.g., 1048A) than to the second widget (e.g., 1804, 1830, 1050A, and/or 1050C) (e.g., a location near, corresponding to, associated with, of, adjacent to, within a predefined distance of the first widget) (e.g., the first location overlaps the location of the first widget and/or shares at least a portion of the location of the first widget). In some embodiments, the third visual effect is different from the second visual effect. In some embodiments, the third visual effect is a snapping location visual effect (e.g., an outline, border, and/or shape). In some embodiments, the second visual effect is a portion of a snapping location visual effect. In some embodiments, the third visual effect is a portion of the snapping location visual effect. Displaying the second visual effect closer to the second widget than to the first widget and different from a third visual effect that is closer to the first widget than to the second widget provides an indication that the indications convey different information related to a snapping operation, thereby performing an operation when a set of conditions has been met without requiring further user input and providing improved feedback.

In some embodiments, the computer system detects, via the one or more input devices, a second input (e.g., 1805G) (e.g., the input, a continuation of the input, and/or a new input different from the input) corresponding to a request to move the first widget (e.g., 1048A) within the user interface. In some embodiments, in response to detecting the second input corresponding to the request to move the first widget within the user interface (e.g., 638), the computer system moves the first widget within the user interface to be spaced apart from the second widget (e.g., 1050C) by less than the threshold distance (e.g., as illustrated in FIG. 18J). In some embodiments, in response to detecting the second input corresponding to the request to move the first widget within the user interface, while first widget within the user interface is spaced apart from the second widget by less than the threshold distance and in accordance with a determination that the first widget satisfies a second set of one or more snapping criteria (e.g., proximity snapping criteria) for alignment with (e.g., snapping to) the second widget, the computer system forgoes displaying, via the display generation component, the second indication (e.g., as illustrated in FIG. 18J) that the first widget will be snapped into alignment with the second widget. In some embodiments, in accordance with the determination that the first widget satisfies the second set of one or more snapping criteria, the computer system displays a snapping location visual effect (e.g., the third visual effect) (e.g., an outline, border, and/or shape). In some embodiments, the snapping location visual effect indicates that that the first widget will be snapped into alignment with the second widget while the first widget remains spaced apart from the second widget in the user interface by less than the threshold distance when the input ends. Forgoing displaying the second visual effect when first widget within the user interface to be spaced apart from the second widget by less than the threshold distance provides an indication of the state of the computer system and that a type of snapping operation is not available, thereby performing an operation when a set of conditions has been met without requiring further user input and providing improved feedback.

In some embodiments, the indication (e.g., 1822, 1824, 1830, 1832, 1834, and/or 1836) that the first widget will be snapped into alignment with the second includes a visual element (e.g., 1832 and/or 1834) (e.g., a set of one or more graphical elements (e.g., one or more displayed objects creating a visual appearance)) (e.g., a line or region) that connects (e.g., an edge, line, and/or path that extends from) a location corresponding to the first widget (e.g., an edge, a point within, and/or a point near to the first widget) to (and/or with) a location corresponding to the second widget (e.g., an edge, a point within, and/or a point near to the first widget). Displaying the visual element that connects the location corresponding to the first widget to the location corresponding to the second widget provides an indication of the state of the computer system and of an available snapping operation involving the first widget and the second widget, thereby performing an operation when a set of conditions has been met without requiring further user input and providing improved feedback.

In some embodiments, while the first widget (e.g., 1048A) is spaced apart from the second widget (e.g., 1804, 1830, 1050A, and/or 1050C) and in response to detecting the input (e.g., 1805B, 1805D1, 1805G, 1805L1, 1805N1, 1805Q, and/or 1805S) corresponding to the request to move the first widget within the user interface, in accordance with a determination that the first widget satisfies a set of one or more snapping criteria for alignment with a third widget different from the second widget, the computer system displays, via the display generation component, an indication that the first widget will be snapped into alignment with the third widget while the first widget remains spaced apart from other widgets in the user interface by more than the threshold distance when the input ends (e.g., without displaying the indication that the first widget will be snapped into alignment with the second widget while the first widget remains spaced apart from other widgets in the user interface by more than the threshold distance when the input ends). Displaying the indication that the first widget will be snapped into alignment with the third widget while the first widget remains spaced apart from other widgets in the user interface by more than the threshold distance when the input ends provides an indication of the state of the computer system and of an available operation, thereby performing an operation when a set of conditions has been met without requiring further user input and providing improved feedback.

In some embodiments, the indication (e.g., 1824) that the first widget will be snapped into alignment with the second widget (e.g., 1804, 1830, 1050A, and/or 1050C) is displayed concurrently with the indication (e.g., 1830) that the first widget (e.g., 1048A) will be snapped into alignment with the third widget (e.g., 1804, 1830, 1050A, and/or 1050C). In some embodiments, a plurality of indications that the first widget will be snapped into alignment are displayed concurrently. In some embodiments, the concurrently displayed indications indicate that the widget will be snapped into alignment with a plurality of widgets (e.g., if input ends while indications are displayed). In some embodiments, a widget aligns to multiple different widgets along different axes (e.g., aligns with the second widget along a horizonal axis and aligns with the third widget along a vertical axis). In some embodiments, a widget aligns to multiple different widgets along the same axis (e.g., aligns with the second widget along a horizontal axis and aligns with the third widget along the same horizontal axis). In some embodiments, the indication that the first widget will be snapped into alignment with the second widget is displayed while (e.g., during a period of time that, for so long as, and/or for a at least a period of time that occurs when) the set of one or more snapping criteria for alignment with the second widget is displayed. In some embodiments, the indication that the first widget will be snapped into alignment with the third widget (e.g., and/or one or more different widgets) is displayed while (e.g., during a period of time that, for so long as, and/or for a at least a period of time that occurs when) the set of one or more snapping criteria for alignment with the third widget (e.g., and/or the one or more different widgets) is displayed. In some embodiments, in accordance with a determination that multiple sets of one or more criteria for alignment with respective widgets are satisfied, multiple indications that the first widget will be snapped into alignment with the corresponding respective widgets are displayed. In some embodiments, there is a maximum number of indications that the first widget will be snapped into alignment with another widget that can be displayed concurrently (e.g., and/or a maximum number that can satisfy respective sets of one or more criteria for alignment with the respective widgets) (e.g., as defined by a customizable and/or non-customizable configuration setting). In some embodiments, there is not a configured maximum number of indications that can be displayed concurrently. Concurrently displaying the indications that the first widget will be snapped into alignment with the second widget and the third widget while the first widget remains spaced apart from other widgets in the user interface by more than the threshold distance when the input ends provides an indication of the state of the computer system and of an available operation involving both the second widget and the third widget, thereby performing an operation when a set of conditions has been met without requiring further user input and providing improved feedback.

In some embodiments, while the indication that the first widget (e.g., 1048A) will be snapped into alignment with the third widget (e.g., 1804, 1830, 1050A, and/or 1050C) is displayed (e.g., while the set of one or more snapping criteria for alignment with the third widget is satisfied), the indication that the first widget will be snapped into alignment with the second widget (e.g., 1804, 1830, 1050A, and/or 1050C) is not displayed (e.g., while the set of one or more snapping criteria for alignment with the second widget is and/or is not satisfied). In some embodiments, while the indication that the first widget will be snapped into alignment with the second widget is displayed, the indication that the first widget will be snapped into alignment with the third widget is not displayed. In some embodiments, the computer system displays one indication at a time. In some embodiments, the indication displayed corresponds to the closest (e.g., nearest) respective widget to the first widget. In some embodiments, the indication displayed corresponds to the respective widget that corresponds to a set of one or more snapping criteria that is most recently satisfied (e.g., most recent to be satisfied by the input, the first widget, and/or due to other conditions and/or criteria). In some embodiments, the computer system displays a plurality of indications that the first widget will be snapped to a plurality of corresponding widgets at a time. In some embodiments, the plurality of indications correspond to all and/or less than all widgets that will be snapped to and/or that correspond to a set of snapping criteria that is satisfied (e.g., two indications are shown that correspond to two widgets corresponding to sets of criteria that are satisfied, but an indication is not shown for a third different widgets corresponding to a set of criteria that is and/or is not satisfied).

In some embodiments, the set of one or more snapping criteria for alignment with the second widget (e.g., 1804, 1830, 1050A, and/or 1050C) include a criterion that is satisfied when (e.g., in accordance with a determination that) the first widget (e.g., 1048A) is within a threshold alignment distance from being aligned (e.g., with an axis that aligns) with the second widget. In some embodiments, the threshold alignment distance represents a distance from a location corresponding to the first widget (e.g., a location on an edge of the widget, the centroid of the widget, and/or a location of the input (e.g., represented visually by a pointer)) to a location corresponding to an alignment axis (e.g., that is parallel to, tangent to, and/or otherwise defined based on a spatial relation to a respective widget that will be snapped into alignment with (e.g., the second widget and/or the third widget)). Displaying the indication that the first widget will be snapped into alignment with the second widget based on a criterion satisfied when the first widget is within the threshold alignment distance provides an indication of the state of the computer system and of an available operation when the first widget is moved within the threshold, thereby providing additional control options without cluttering the user interface with additional displayed controls, performing an operation when a set of conditions has been met without requiring further user input and providing improved feedback.

In some embodiments, the set of one or more snapping criteria for alignment with the second widget (e.g., 1804, 1830, 1050A, and/or 1050C) include a criterion that is satisfied when (e.g., in accordance with detecting) less than a first threshold amount of movement (e.g., 1870A) is detected (e.g., a distance such as 5 pixels) (e.g., corresponding to the input (e.g., of the input and/or of the first widget being moved by the input)). In some embodiments, in accordance with detecting less than the first threshold amount of movement corresponding to the input, the computer system initially displays (e.g., was not displayed before) the indication. In some embodiments, the set of one or more snapping criteria for alignment with the second widget include a criterion that is not satisfied in accordance with detecting equal to or more than the first threshold amount of movement. Displaying the indication that the first widget will be snapped into alignment with the second widget based on a criterion satisfied when less than a threshold amount of movement is detected provides an indication of the state of the computer system and of an available operation when the first widget is moved within the threshold but has dwelled sufficiently to avoid a false positive, thereby providing additional control options without cluttering the user interface with additional displayed controls, performing an operation when a set of conditions has been met without requiring further user input and providing improved feedback.

In some embodiments, the set of one or more snapping criteria for alignment with the second widget (e.g., 1804, 1830, 1050A, and/or 1050C) include a criterion that is satisfied when (e.g., in accordance with detecting) less than the first threshold amount of movement (e.g., 1870A) is detected (e.g., corresponding to the input) for (e.g., over, during, and/or during a period greater to and/or equal to) a threshold amount of time (e.g., 0.1-10 seconds). Displaying the indication that the first widget will be snapped into alignment with the second widget based on a criterion satisfied when less than a threshold amount of movement is detected provides an indication of the state of the computer system and of an available operation when the first widget is moved within the threshold but has dwelled for a sufficient length of time to avoid a false positive, thereby providing additional control options without cluttering the user interface with additional displayed controls, performing an operation when a set of conditions has been met without requiring further user input and providing improved feedback.

In some embodiments, in response to detecting the input corresponding to the request to move the first widget (e.g., 1048A) within the user interface, in accordance with the determination that the first widget satisfies the set of one or more snapping criteria for alignment with the second widget, the computer system performs a first type of snapping operation (e.g., distance snapping). In some embodiments, performing the first type of snapping operation includes (and/or is performed in conjunction with (e.g., before, after, and/or while)) displaying the indication that the first widget will be snapped into alignment with the second widget. In some embodiments, in response to detecting the input corresponding to the request to move the first widget within the user interface, in accordance with a determination that the first widget satisfies a third set of one or more snapping criteria for alignment with the second widget (e.g., 1804, 1830, 1050A, and/or 1050C), the computer system performs a second type of snapping operation (e.g., proximity snapping) different from the first type of snapping operation, wherein the third set of one or more criteria is different from the set of one or more snapping criteria (e.g., the third set of one or more criteria is not associated with a time threshold). In some embodiments, performing the second type of snapping operation includes (and/or is performed in conjunction with (e.g., before, after, and/or while)) displaying a second indication that the first widget will be snapped into alignment with the second widget. In some embodiments, the second type of snapping operation is a proximity snapping operation. In some embodiments, a proximity snapping operation involves snapping the first widget to the second widget (e.g., or snapping together any other combination of two or more widgets) with respect to multiple (e.g., two or more) dimensions (e.g., horizontal dimension and/or vertical dimension) (e.g., proximity snapping the first widget snapping to a top edge of the second widget will align with respect to a vertical axis relative to the second widget (e.g., so that vertical edges of the two widgets are aligned) and with respect to a horizontal axis relative to the second widget (e.g., so that the first widget is spaced apart from the top edge of the second widget by a minimum standoff distance)). In some embodiments, a proximity snapping operation results in the first widget being spaced apart from the second widget (e.g., or any other combination of two or more widgets being spaced apart) by a predetermined distance (e.g., a minimum setoff distance). In some embodiments, a proximity snapping operation is performed on a selected widget with respect to multiple other widgets (e.g., the first widget is proximity snapped to the top of the second widget and to the side of the third widget). In some embodiments, a proximity snapping operation performed with respect to multiple other widgets includes the selected widget snapping to two or more widgets with respect to multiple dimensions (e.g., the first widget snaps to the second widget with respect to two dimensions and the first widget snaps to the third widget with respect to two dimensions (e.g., not necessarily the same dimensions for both the second widget and third widget)). In some embodiments, the first type of snapping operation is a distance snapping operation. In some embodiments, a distance snapping operation involves snapping the first widget to the second widget (e.g., or snapping any other combination of two or more widgets) with respect to one dimension (e.g., horizontal dimension, vertical dimension, or an arbitrarily defined dimension (e.g., diagonal)) (e.g., distance snapping the first widget to a top edge of the second widget will align with respect to a vertical axis relative to the second widget (e.g., so that top edges of the two widgets are aligned) but not necessarily with respect to a horizontal axis relative to the second widget (e.g., so that the first widget is free to be spaced apart from the side edge of the second widget by any distance)). In some embodiments, a distance snapping operation is performed on a selected widget with respect to multiple other widgets (e.g., the first widget is distance snapped to the top edge of the second widget and to the side edge of the third widget). In some embodiments, a distance snapping operation performed with respect to multiple other widgets includes the selected widget snapping to other widgets with respect to one respective dimension (e.g., the first widget snaps to align with the second widget with respect to a horizontal dimension and the first widget snaps to align with the third widget with respect to a vertical dimension (e.g., not necessarily the same dimensions for both the second widget and third widget)). In some embodiments, a distance snapping operation does not result in (e.g., necessarily result in and/or require) the first widget being spaced apart from the second widget (e.g., or any other combination of two or more widgets being spaced apart) by a predetermined distance (e.g., a minimum setoff distance). In some embodiments, the second indication is different from the indication (e.g., displayed based on satisfaction of the set of one or more snapping criteria). In some embodiments, the third set of one or more snapping criteria is not satisfied while the set of one or more snapping criteria is satisfied (e.g., cannot be satisfied at the same time) (e.g., the third set includes a criteria that is satisfied when first widget is within a certain predefined distance, and the set includes a criteria that is satisfied when first widget is not within the certain predefined distance). In some embodiments, the third set of one or more snapping criteria include a criterion that is satisfied in accordance with a determination that the first widget is not (e.g., no longer remains) spaced apart from other widgets in the user interface by more than the threshold distance when the input ends. In some embodiments, the third set of one or more snapping criteria include a criterion that is satisfied in accordance with a determination that the first widget is not (e.g., no longer remains) spaced apart from a third widget (e.g., different from the second widget) in the user interface by more than the threshold distance when the input ends. In some embodiments, the third set of one or more criteria is not associated with a time threshold to be satisfied and the second set of one or more criteria is associated with a time threshold to be satisfied. Performing a first type of snapping operation or a second type of snapping operation based on whether different sets of criteria are satisfied provides an indication of the state of the computer system and of an available operation when the first widget is moved within the user interface, thereby providing additional control options without cluttering the user interface with additional displayed controls, performing an operation when a set of conditions has been met without requiring further user input and providing improved feedback.

In some embodiments, the set of one or more snapping criteria for alignment with the second widget (e.g., 1804, 1830, 1050A, and/or 1050C) includes a criterion that is satisfied when (e.g., in accordance with detecting) less than a second threshold amount of movement (e.g., 1870B) (e.g., a distance such as 1, 5, 10, 20, or 100 pixels) corresponding to the input is detected while displaying the indication that the first widget (e.g., 1048A) will be snapped into alignment with the second widget. In some embodiments, the second threshold amount of movement is larger than the first threshold amount of movement (e.g., 1870A). In some embodiments, in accordance with a determination that movement does not exceed the second threshold amount of movement while the indication is displayed, the computer system continues to display the indication (e.g., moving outside of the first threshold amount of movement does not cause the indication to cease to be displayed). In some embodiments, in accordance with a determination that the movement corresponding to the input exceeds the second threshold amount of movement while the indication is displayed, the computer system ceases displaying the indication (e.g., moving outside of the first threshold amount of movement does not cause the indication to cease to be displayed, but moving outside of the second threshold amount of movement does cause the indication to cease to be displayed). Displaying the indication that the first widget will be snapped into alignment with the second widget based on a criterion satisfied when detecting less than the second threshold amount of movement larger than the first amount of a movement provides an indication of the state of the computer system and of an available operation when the first widget is moved within the user interface and avoids false positives due to movement, thereby providing additional control options without cluttering the user interface with additional displayed controls, performing an operation when a set of conditions has been met without requiring further user input and providing improved feedback.

In some embodiments, while detecting the input corresponding to the request to move the first widget (e.g., 1048A) within the user interface, in accordance with detecting, via the one or more input devices, a predefined type of input (e.g., 1805H) (e.g., a input at a physical and/or virtual control, such as a key of a keyboard), the computer system disables a set of one or more snapping functions (e.g., snapping movement (e.g., during input and/or when input ends) and/or display of snapping-related indications) corresponding to the first widget, wherein while the one or more snapping functions are disabled, the first widget is not snapped to alignment relative to the second widget (e.g., 1804, 1830, 1050A, and/or 1050C) even when the location of the first widget otherwise satisfies the set of one or more snapping criteria for alignment with the second widget. In some embodiments, while the one or more snapping functions are disabled, the first widget does not satisfy the set of one or more snapping criteria for alignment with the second widget. In some embodiments, the predefined type of input is received while detecting the input (e.g., key pressed while first widget is selected and moving). In some embodiments, the predefined type of input is being received when the input is detected (e.g., key pressed before and while the input is received). In some embodiments, the set of one or more snapping criteria for alignment with the second widget includes a criterion that is not satisfied while a predefined type of input is detected (e.g., while a key press (e.g., of a certain key and/or keys of a keyboard input device) is detected and/or while input corresponding to a physical and/or virtual control is detected). In some embodiments, the predefined type of input is input represented selection of a predefined set of keys (e.g., of a keyboard input device in communication with the computer system that is included in the one or more input devices). In some embodiments, in response to detecting the input corresponding to the request to move the first widget within the user interface: in accordance with a determination that the first widget does not satisfy the set of one or more snapping criteria for alignment with the second widget, forgoing displaying, via the display generation component, the indication that the first widget will be snapped into alignment with the second widget (e.g., while the first widget remains spaced apart from other widgets in the user interface by more than the threshold distance when the input ends) (e.g., while the first widget does not remain spaced apart from other widgets in the user interface by more than the threshold distance when the input ends). Disabling a set of one or more snapping functions and determining that the set of one or more snapping criteria for alignment with the second widget is not satisfied in response to detecting the predefined type of input provides the ability to disable functions via an additional input when otherwise criteria might be satisfied during the input, thereby providing additional control options without cluttering the user interface with additional displayed controls, performing an operation when a set of conditions has been met without requiring further user input and providing improved feedback.

In some embodiments, disabling the set of one or more snapping functions corresponding to the first widget (e.g., 1048A) includes forgoing displaying, via the display generation component, the indication (e.g., 1824) that the first widget will be snapped into alignment with the second widget (e.g., 1804, 1830, 1050A, and/or 1050C) (e.g., while the first widget remains spaced apart from other widgets in the user interface by more than the threshold distance when the input ends) (e.g., while the first widget does not remain spaced apart from other widgets in the user interface by more than the threshold distance when the input ends). In some embodiments, forgoing displaying includes ceasing displaying (e.g., In some embodiments, the indication is being displayed when the input for disabling the set of one or more snapping functions is detected).

In some embodiments, the set of one or more snapping criteria for alignment with the second widget (e.g., 1804, 1830, 1050A, and/or 1050C) corresponds to a third type of snapping operation (e.g., distance snapping). In some embodiments, while the one or more snapping functions are disabled and in response to detecting the input (e.g., 1805B, 1805D1, 1805G, 1805L1, 1805N1, 1805Q, and/or 1805S) corresponding to the request to move the first widget (e.g., 1048A) within the user interface (e.g., 638), the computer system moves the first widget within the user interface to be spaced apart from the second widget by less than the threshold distance. In some embodiments, while the one or more snapping functions are disabled and in response to detecting the input corresponding to the request to move the first widget within the user interface, while the first widget within the user interface is spaced apart from the second widget by less than the threshold distance, in accordance with a determination that the first widget satisfies a second set of one or more snapping criteria for alignment with the second widget, the computer system displays, via the display generation component, a second indication (e.g., 1844) that the first widget will be snapped into alignment with the second widget while the first widget is within the threshold distance from the second widget in the user interface when the input ends, wherein: the second set of one or more snapping criteria for alignment with the second widget corresponds to a fourth type of snapping operation (e.g., proximity snapping) different from the third type of snapping operation; the second set of one or more snapping criteria is different from the set of one or more snapping criteria; and the second indication is different from the indication (e.g., 1824). Disabling the third type of snapping operation but not the fourth type of snapping operation in response to detecting the predefined type of input provides the ability to disable a certain function via an additional input but not disabling certain other functions, thereby providing additional control options without cluttering the user interface with additional displayed controls, performing an operation when a set of conditions has been met without requiring further user input and providing improved feedback. In some embodiments, the set of one or more snapping criteria is distance snapping criteria. In some embodiments, distance snapping criteria includes a criterion that is satisfied based on one dimension with respect to another widget (e.g., whether the selected widget aligns with an axis that is defined based on another widget, such as the edge of such widget) (e.g., whether the first widget is within a threshold distance from a horizontal or vertical axis that is based on the second widget). In some embodiments, distance snapping criteria does not include a criterion that is satisfied based on proximity to another widget (e.g., proximity between the first widget and the second widget is not a criterion for distance snapping). In some embodiments, the second set of one or more criteria is proximity snapping criteria (e.g., as described above with respect to method 1200). In some embodiments, proximity snapping criteria includes a criterion that is satisfied based on proximity with respect to another widget (e.g., whether the selected widget is separated from another widget (e.g., using some convention for measuring) by less than a proximity threshold distance) (e.g., whether the first widget is within the proximity threshold distance from the second widget).

In some embodiments, the set of one or more snapping criteria for alignment with the second widget (e.g., 1804, 1830, 1050A, and/or 1050C) correspond to a fifth type of snapping operation (e.g., distance snapping). In some embodiments, while the one or more snapping functions are disabled and in response to detecting the input (e.g., 1805B, 1805D1, 1805G, 1805L1, 1805N1, 1805Q, and/or 1805S) corresponding to the request to move the first widget (e.g., 1048A) within the user interface, the computer system moves the first widget within the user interface to be spaced apart from the second widget by less than the threshold distance. In some embodiments, while the one or more snapping functions are disabled and in response to detecting the input corresponding to the request to move the first widget within the user interface, while the first widget within the user interface is spaced apart from the second widget by less than the threshold distance, in accordance with a determination that the first widget satisfies a fourth set of one or more snapping criteria for alignment with the second widget, the computer system forgoes displaying, via the display generation component, a third indication (e.g., 1844) that the first widget will be snapped into alignment with the second widget while the first widget is within the threshold distance from the second widget in the user interface when the input ends, wherein: the fourth set of one or more snapping criteria for alignment with the second widget is associated with a sixth type of snapping operation (e.g., proximity snapping) different from the fifth type of snapping operation; the fourth set of one or more snapping criteria is different from the set of one or more snapping criteria; and the third indication is different from the indication (e.g., 1824). In some embodiments, the computer system ceases detecting the input. In some embodiments, in response to ceasing detecting the input, in accordance with a determination that (e.g., at least a portion of) the first widget overlaps (e.g., at least a portion of) the second widget when the input ceases to be detected, the computer system moves the first widget to be snapped into alignment with the second widget (e.g., based on the sixth type of snapping operation) (e.g., based on proximity snapping). In some embodiments, in response to ceasing detecting the input, in accordance with a determination that (e.g., at least a portion of) the first widget does not overlap (e.g., at least a portion of) the second widget when the input ceases to be detected, the computer system forgoes moving the first widget to be snapped into alignment with the second widget (e.g., placing the first widget at the location of the input) (e.g., placing the first widget without performing a snapping operation in conjunction with placing the widget) (e.g., do not perform proximity snapping and/or distance snapping). Disabling both the fifth and sixth type of snapping operation in response to detecting the predefined type of input provides the ability to disable multiple snapping functions via an additional input but, thereby providing additional control options without cluttering the user interface with additional displayed controls, performing an operation when a set of conditions has been met without requiring further user input and providing improved feedback.

In some embodiments, in accordance with the determination that the first widget (e.g., 1048A) satisfies the set of one or more snapping criteria for alignment with the second widget (e.g., 1804, 1830, 1050A, and/or 1050C) while the first widget is spaced apart from the second widget by more than the threshold distance (e.g., distance snapping), the computer system forgoes adding the first widget to a group of widgets (e.g., as described above with respect to method 1200 and/or method 1500) that includes the second widget. In some embodiments, in accordance with the determination that the first widget satisfies the set of one or more snapping criteria for alignment with the second widget while the first widget is spaced apart from the second widget by more than the threshold distance (e.g., distance snapping), the computer system adds the first widget to a group of widgets that includes the second widget. In some embodiments, in accordance with the determination that the first widget satisfies a fifth set of one or more snapping criteria for alignment with the second widget while the first widget is spaced apart from the second widget by less than the threshold distance (e.g., proximity snapping) (e.g., as described above with respect to method 1200 and/or method 1500), the computer system adds the first widget to the group of widgets (e.g., 1860) that includes the second widget, wherein the fifth set of one or more criteria is different from the set of one or more snapping criteria. In some embodiments, adding the first widget to the group of widgets that include the second widget includes (and/or is performed in conjunction with (e.g., before, after, and/or while)) displaying the indication that the first widget will be snapped into alignment with the second widget. In some embodiments, adding the first widget to the group of widgets that include the second widget is performed in response to ceasing to detect the input (e.g., detecting an end of the input). In some embodiments, a widget that is part of a group of widgets corresponds to one or more characteristics, features, and/or operations corresponding to a group of widgets (e.g., with respect to movement, snapping, spacing, placement, and/or automatic repositioning (e.g., with respect to spatial bounds), such as described above with respect to method 1100, method 1200, method 1500 and/or method 1700). Adding the first widget to a group of widgets depending on whether the first widget meets criteria while spaced less than or more than the threshold distance from the second widget provides the ability to selectively add the first widget to a group based on one snapping operation but not another snapping operation, thereby providing additional control options without cluttering the user interface with additional displayed controls, performing an operation when a set of conditions has been met without requiring further user input and providing improved feedback.

In some embodiments, in response to detecting the input corresponding to the request to move the first widget (e.g., 1048A) within the user interface, in accordance with a determination that the first widget satisfies a set of one or more snapping criteria for alignment with an edge of the user interface (e.g., 638), the computer system displays, via the display generation component, an indication (e.g., 1838) along the edge that the first widget will be snapped into alignment with the edge. In some embodiments, the set of one or more snapping criteria for alignment with the edge of the user interface includes a criterion that is satisfied when the first widget is spaced apart from the edge by less than an edge snapping threshold distance. In some embodiments, the set of one or more snapping criteria for alignment with the edge includes a criterion that is satisfied when the first widget does not meet a set of one or more criteria for alignment to another widget (e.g., first widget will snap to the edge if another snapping operation is not available). In some embodiments, the indication along the edge that the first widget will be snapped into alignment with the edge includes a portion (e.g., some and/or all) of the indication that the first widget will be snapped into alignment with the second widget. In some embodiments, the indication along the edge that the first widget will be snapped into alignment with the edge moves in response to movement of the input (e.g., slides along the edge as movement changes position with respect to the edge (e.g., parallel to the edge)). In response to detecting the input corresponding to the request to move the first widget within the user interface, in accordance with a determination that the first widget does not satisfy the set of one or more snapping criteria for alignment with an edge of the user interface, forgoing displaying the indication along the edge that the first widget will be snapped into alignment with the edge. Displaying the indication that the first widget will be snapped into alignment with the edge of the user interface provides an indication of the state of the computer system and of an available operation, thereby performing an operation when a set of conditions has been met without requiring further user input and providing improved feedback.

Note that details of the processes described above with respect to method 1900 (e.g., FIG. 19) are also applicable in an analogous manner to the methods described herein, such as methods 700, 900, 1100, 1200, 1300, 1500, and/or 1700. For example, method 1200 optionally includes one or more of the characteristics of the various methods described above with reference to method 1900. For example, displaying widget can include aligning widgets that are spaced apart greater than a threshold distance. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve dynamic content provided to a user. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted dynamic content that is of greater interest to the user. Accordingly, use of such personal information data enables users to have calculated control of the dynamic content that is delivered to the user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of dynamic content provides, the present technology can be configured to allow users to select to “opt in” or “opt out” of participation in the collection of personal information data during registration for services or anytime thereafter. In another example, users can select not to provide information associated with display of dynamic content. In yet another example, users can select to limit the length of time for which dynamic content is displayed. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, dynamic content can be selected and delivered to users by inferring preferences based on non-personal information data or a bare minimum amount of personal information, such as the content being requested by the device associated with a user, other non-personal information available to the dynamic content delivery services, or publicly available information.

What is claimed is:

1. A method, comprising:
at a computer system that is in communication with a display generation component and one or more input devices:
displaying, via the display generation component, a user interface that includes a first widget at a respective location;
detecting, via the one or more input devices, an input corresponding to a request to move a second widget to a first drag location in the user interface; and
in response to detecting the input corresponding to the request to move the second widget to the first drag location:
in accordance with a determination that the first drag location is within a predetermined distance from the respective location of the first widget, moving the second widget to a first snapping location that is based on the respective location of the first widget but is different from the first drag location; and
in accordance with a determination that the first drag location is not within the predetermined distance from the respective location of the first widget, moving the second widget to the first drag location.

2. The method of claim 1, further comprising:
before moving the second widget to the first snapping location, detecting, via the one or more input devices, initiation of a dragging input, wherein the dragging input includes the input corresponding to the request to move the second widget to the first drag location; and
after moving the second widget to the first snapping location, continuing to detect the dragging input.

3. The method of claim 1, wherein the second widget moves to the first snapping location in response to detecting, via the one or more input devices, termination of the input corresponding to the request to move the second widget to the first drag location.

4. The method of claim 1, further comprising:
in response to detecting the input corresponding to the request to move the second widget to the first drag location and in accordance with a determination that the first drag location is within the predetermined distance from a respective location of a third widget different from the first widget and the second widget, moving the second widget to a respective snapping location that is based on the respective location of the third widget but is different from the first drag location and the first snapping location.

5. The method of claim 1, wherein:
in accordance with a determination that the respective location of the first widget is a first widget location, the first snapping location is in a first region of the user interface;
in accordance with a determination that the respective location of the first widget is a second widget location different from the first widget location, the first snapping location is in a second region of the user interface; and
the second region of the user interface is different from the first region of the user interface.

6. The method of claim 1, further comprising:
in response to detecting the input corresponding to the request to move the second widget to the first drag location:
in accordance with a determination that the first drag location is closer to a respective location of a fourth widget than a respective location of a fifth widget, moving the second widget to a first grid location of a first grid; and
in accordance with a determination that the first drag location is closer to the respective location of the fifth widget than the respective location of the fourth widget, moving the second widget to a second grid location of a second grid, wherein the second grid location is different from the first grid location.

7. The method of claim 6, wherein:
the first grid corresponds to a first portion of the user interface;
the second grid corresponds to a second portion of the user interface;
the second portion is different from the first portion; and
the second grid is different from the first grid.

8. The method of claim 7, wherein:
in accordance with a determination that a first set of one or more widgets is at a first respective location of the user interface, the first grid is defined based on locations of the widgets in the first set of widgets; and
in accordance with a determination that the first set of one or more widgets is at a second respective location of the user interface different from the first respective location of the user interface, the first grid is defined based on locations of the widgets in the first set of widgets.

9. The method of claim 7, wherein the second grid is not aligned with the first grid.

10. The method of claim 1, wherein the user interface is a desktop user interface that includes one or more desktop icons.

11. The method of claim 10, wherein the one or more desktop icons are organized in a first manner on the desktop user interface, and wherein a respective desktop icon on the desktop user interface does not overlap a respective widget on the desktop user interface.

12. The method of claim 10, further comprising:
while the user interface includes the first widget and while the user interface is organized in a second manner, detecting, via the one or more input devices, an input corresponding to a request to change the user interface to be organized in a third manner different from the first manner; and
as a result of detecting the input corresponding to the request to change the user interface to be organized in the third manner, changing a position of at least one desktop icon of the one or more desktop icons on the user interface without changing a position of a widget on the user interface, including the first widget.

13. The method of claim 12, further comprising:
while displaying, via the display generation component, the user interface that includes the first widget and the one or more desktop icons, detecting, via the one or more input devices, an input corresponding to a request to expand a desktop icon of the one or more desktop icons;
in response to detecting the input corresponding to the desktop icon of the one or more desktop icons, displaying, via the display generation component, one or more additional desktop icons corresponding to the desktop icon without changing a position of a set of one or more widgets on the user interface, including the first widget;
while displaying the one or more additional desktop icons, detecting, via the one or more input devices, an input corresponding to a request to collapse the one or more additional desktop icons; and
in response to detecting the input corresponding to a request to collapse the one or more additional desktop icons, ceasing displaying, via the display generation component, the one or more additional desktop icons.

14. The method of claim 12, further comprising:
while the user interface includes the first widget and the one or more desktop icons in a first order, detecting an input corresponding to a request to change from the first order to a second order different from the first order; and
in conjunction with detecting input corresponding to a request to change from the first order to the second order, changing an order of at least one desktop icon of the one or more desktop icons on the user interface without changing an order of a set of one or more widgets on the user interface, including the first widget.

15. The method of claim 10, further comprising:
while displaying, via the display generation component, the user interface that includes the first widget and the one or more desktops icons, detecting, via the one or more input devices, an input corresponding to a change to a respective widget; and
in response to detecting the input corresponding to the change to the respective widget, updating the user interface based on the change, wherein the updating includes moving at least one desktop icon of the one or more desktop icons.

16. The method of claim 10, further comprising:
while displaying, via the display generation component, the user interface that includes the one or more desktop icons, detecting, via the one or more input devices, an input corresponding to a request to place a new widget at a new location on the user interface; and
in response to detecting the input corresponding to the request to place the new widget at the new location on the user interface and in accordance with a determination that a respective desktop icon is associated with the new location, placing the new widget on the user interface such that the new widget does not visually overlap the respective desktop icon.

17. The method of claim 1, further comprising:
while displaying, via the display generation component, the user interface that includes the one or more desktop icons, detecting, via the one or more input devices, an input corresponding to a request to place a second new widget at a second new location on the user interface; and
in response to detecting the input corresponding to the request to place the second new widget at the second new location on the user interface and in accordance with a determination that a respective system user interface element is associated with the second new location, placing the second new widget on the user interface such that the second new widget does not visually overlap the respective system user interface element.

18. The method of claim 1, wherein the predetermined distance is equal to or less than one-third of a width of the first widget.

19. The method of claim 1, further comprising:
in response to detecting the input corresponding to the request to move the second widget to the first drag location and in accordance with a determination that the first drag location is within the predetermined distance from a respective location of a respective widget different from the first widget and the second widget, moving the second widget to a respective snapping location that is not based on the respective location of the first widget.

20. A non-transitory computer-readable storage medium storing one or more programs configured to be executed by one or more processors of a computer system that is in communication with a display generation component and one or more input devices, the one or more programs including instructions for:
displaying, via the display generation component, a user interface that includes a first widget at a respective location;
detecting, via the one or more input devices, an input corresponding to a request to move a second widget to a first drag location in the user interface; and
in response to detecting the input corresponding to the request to move the second widget to the first drag location:
in accordance with a determination that the first drag location is within a predetermined distance from the respective location of the first widget, moving the second widget to a first snapping location that is based on the respective location of the first widget but is different from the first drag location; and
in accordance with a determination that the first drag location is not within the predetermined distance from the respective location of the first widget, moving the second widget to the first drag location.

21. A computer system that is in communication with a display generation component and one or more input devices, comprising:
one or more processors; and
memory storing one or more programs configured to be executed by the one or more processors, the one or more programs including instructions for:
displaying, via the display generation component, a user interface that includes a first widget at a respective location;
detecting, via the one or more input devices, an input corresponding to a request to move a second widget to a first drag location in the user interface; and
in response to detecting the input corresponding to the request to move the second widget to the first drag location:
in accordance with a determination that the first drag location is within a predetermined distance from the respective location of the first widget, moving the second widget to a first snapping location that is based on the respective location of the first widget but is different from the first drag location; and
in accordance with a determination that the first drag location is not within the predetermined distance from the respective location of the first widget, moving the second widget to the first drag location.
